(19) United States
(12) Patent Application Publication
(10) Pub. No.: US 2005/0157236 A1
(43) Pub. Date: Jul. 21, 2005

(54) Liquid crystal display device and manufacturing method therefor

(75) Inventor: Kiyohiro Kawasaki, Osaka (JP)

Correspondence Address: BACON & THOMAS, PLLC, 625 SLATERS LANE, FOURTH FLOOR, ALEXANDRIA, VA, 22314, US

(73) Assignee: Quanta Display Inc., Kuei Shan Hsiang (TW)

(21) Appl. No.: 10/950,605

(22) Filed: Sep. 28, 2004

(30) Foreign Application Priority Data
Sep. 29, 2003 (JP) JP2003-336707

(51) Int. Cl. G02F 1/1343

(52) U.S. Cl. 349/139

(57) ABSTRACT

When the channel length is shortened in a conventional manufacturing method with a reduced numbers of processes, the manufacturing margin is decreased, causing a lower yield. A four-mask process and a three-mask process proposal are constructed for a TN type liquid crystal display device made by combining a novel technology for streamlining the signal wire formation process and pixel electrode formation process by adopting a half-tone exposure technology, a novel technology for streamlining the electrode terminal protective layer formation process by adopting a half-tone exposure technology in a publicly known source and drain wiring anodization process, and a novel technology for streamlining the scan line formation process and the semiconductor layer formation process, the scan line formation process and the etch stop layer formation process, and the scan line formation process and the contact formation process.

### BACKGROUND OF THE INVENTION

1. Field of the Invention

The present invention relates to a liquid crystal display device with a color image display function, and in particular to an active type liquid crystal display device.

2. Description of Related Art

Television and various other image display devices that have a liquid crystal display 5 to 50 cm in diagonal length are provided on a mass production commercial base through progress in recent years in micro-fabrication technology, liquid crystal material technology, high-density packaging technology, and the like. In addition, a color display can easily be created by forming an RGB color layer on one of the two glass substrates composing a liquid crystal panel. In particular, in a so-called active liquid crystal panel with a switching element inside each pixel, there is little cross-talk, the response rate is high, and images with a high contrast ratio are guaranteed.

For these liquid crystal displays (liquid crystal panels), the matrix organization generally comprises from 200 to 1200 scan lines and from around 300 to 1600 signal lines, but recently, larger screens and smaller scales are progressing simultaneously in response to the recent increase in display capacity.

FIG. 54 shows a state of a liquid crystal panel packaging; electric signals are provided to an image display part using a packaging method such as COG (Chip-On-Glass) using a conductive adhesive to connect a semiconductor integrated circuit chip 3 for supplying a drive signal to an electrode terminal group 5 on a scan line formed on one of the transparent insulating substrates composing a liquid crystal panel 1, for example a glass substrate 2, or TCP (Tape-Carrier-Package) for fixing a TCP film 4, for example, a thin polyimide-base plastic film with a copper foil terminal plated with gold or solder to an electrode terminal group 6 on a signal line using pressure and an appropriate adhesive including a conductive medium. Here, two packaging methods are shown at the same time for convenience, but in actuality either method may be arbitrarily selected.

Wire paths connecting the interval between the pixel in the image display part positioned nearly in the center of a liquid crystal panel 1 and terminals 5 and 6 of scan line and signal line are 7 and 8, and do not necessarily need to be constructed of the same conductive material as the electrode terminal groups 5 and 6. 9 is a color filter or an opposing glass that is another transparent insulating substrate having transparent conductive opposing electrodes on its opposing side, which is common to all the liquid crystal cells.

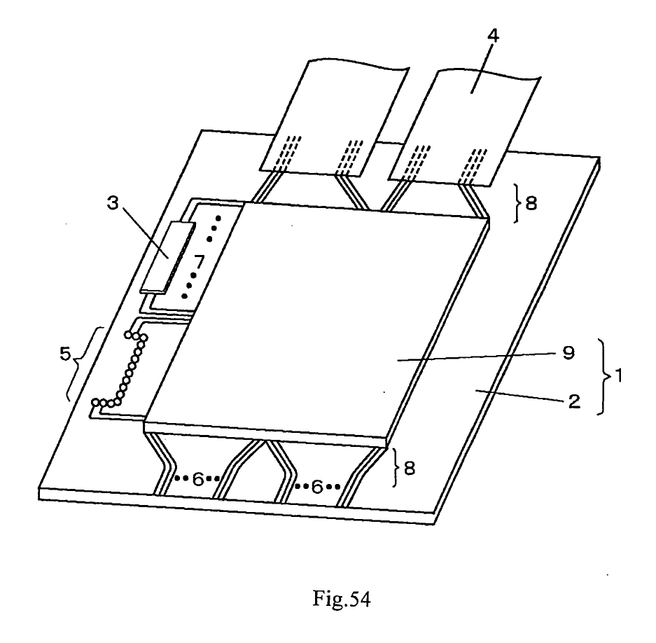

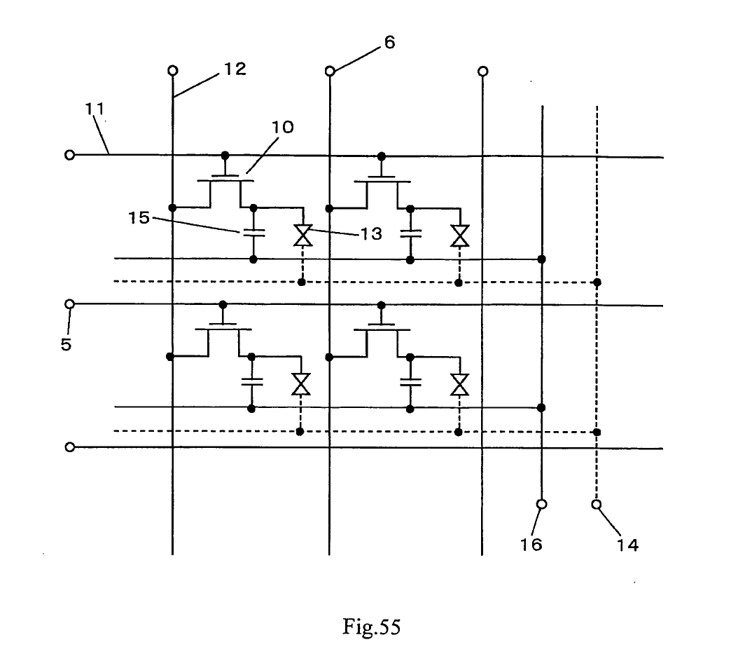

FIG. 55 shows an equivalent circuit view of an active type liquid crystal display device with insulating gate type transistors 10 disposed as switching elements at each pixel. In the figure, 11 (7 in FIG. 54) is a scan line, 12 (8 in FIG. 54) is a signal line, 13 is a liquid crystal cell, and the liquid crystal cell 13 is treated as a capacitance element electrically. The elements drawn with solid lines are formed on the one glass substrate 2 comprising the liquid crystal panel, and opposing electrodes 14 drawn with dotted lines common to all the liquid crystal cells 13 are formed on the main surface opposite the other glass substrate 9. If the off resistance of the insulating gate type transistor 10 or the resistance of the liquid crystal cell 13 is low, or if gradation in the displayed image is to be emphasized, circuitry innovation may be made such as adding an auxiliary storage capacitor 15 in parallel with the liquid crystal 13 as a load to increase the time constant thereof. 16 is a mother line common to the storage capacitors 15.

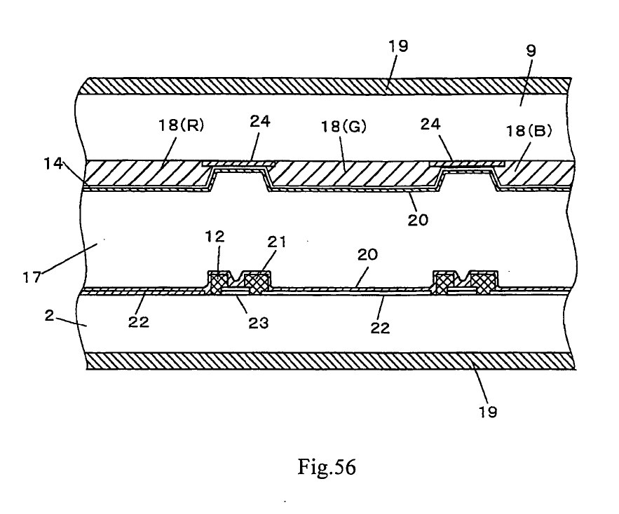

FIG. 56 shows a cross-sectional view of the essential part of an image display part of a liquid crystal display device. The two glass substrates 2 and 9 composing the liquid crystal panel 1 are formed separated by a specified distance of several μm by a spacer material (not illustrated) such as pillar-shaped plastic spacers formed on the color filter 9, or plastic fibers or plastic beads, and that gap is a closed space sealed by a sealing material and an end sealing material made from an organic resin (neither of which are illustrated) at the periphery of the glass substrate 9, and the gap is filled with liquid crystals 17.

To create a color display, a thin organic film about 1 to 2 μm thick containing either a dye or pigment or both called a color layer 18 is deposited on the closed space side of the glass substrate 9, providing a color display function, in which case the glass substrate 9 may also be referred to by the name color filter (abbreviated as CF). Depending on the nature of the liquid crystal material 17, a polarization plate 19 is attached to the top of the glass substrate 9 or the bottom of the glass substrate 2 or both, so the liquid crystal panel 1 functions as an electro-optical element. TN (Twisted-Nematic) type liquid crystal material is currently used in most liquid crystal panels available commercially, and two polarization plates 19 are normally required. Although not illustrated, a back light source is disposed as a light source in the transmission-type liquid crystal panel, emitting white light from below.

A thin polyimide type resin film 20 about 0.1 μm thick, for example, formed on the two glass substrates 2 and 9 and in contact with the liquid crystals 17 is an alignment film for aligning liquid crystal molecules in a fixed direction. 21 is a drain electrode (wire) for connecting a drain of the insulating gate type transistor 10 and a transparent conductive pixel electrode 22, and is often formed at the same time as a signal line (source line) 12. A semiconductor layer 23 is positioned between the signal line 12 and the drain electrode 21 and is described in further detail below. A thin Cr film layer 24 about 0.1 μm thick formed at the interface of the adjacent color layer 18 on the color filter 9 is a light shield material for preventing external light from radiating on the semiconductor layer 23, the scan line 11 or the signal line 12. This is an established technology referred to as black matrix (abbreviated as BM).

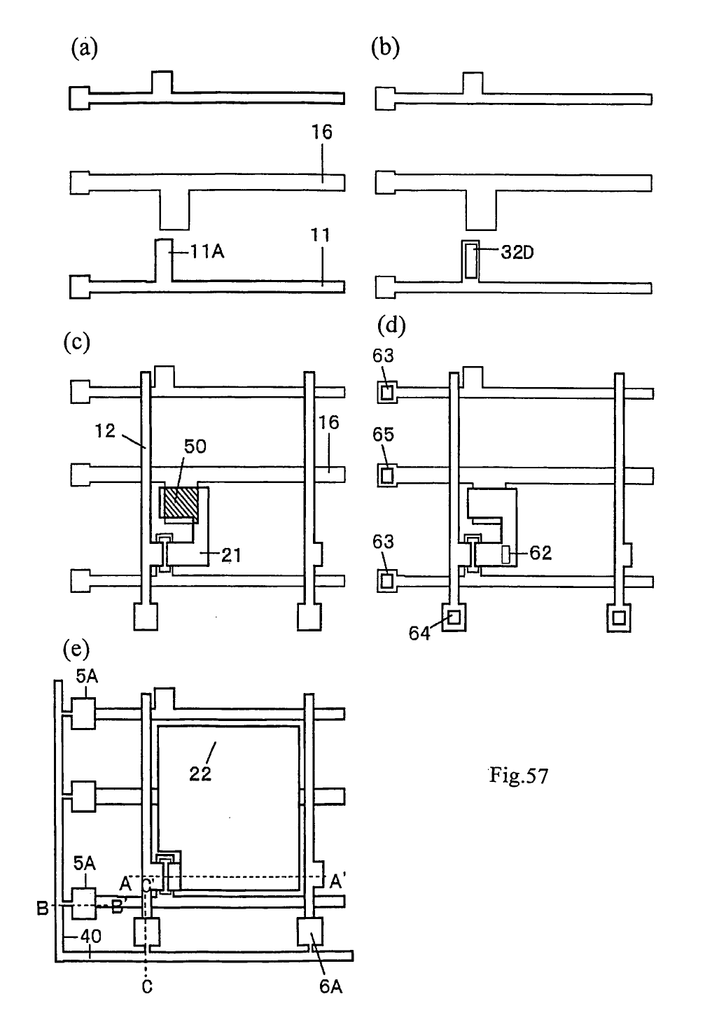

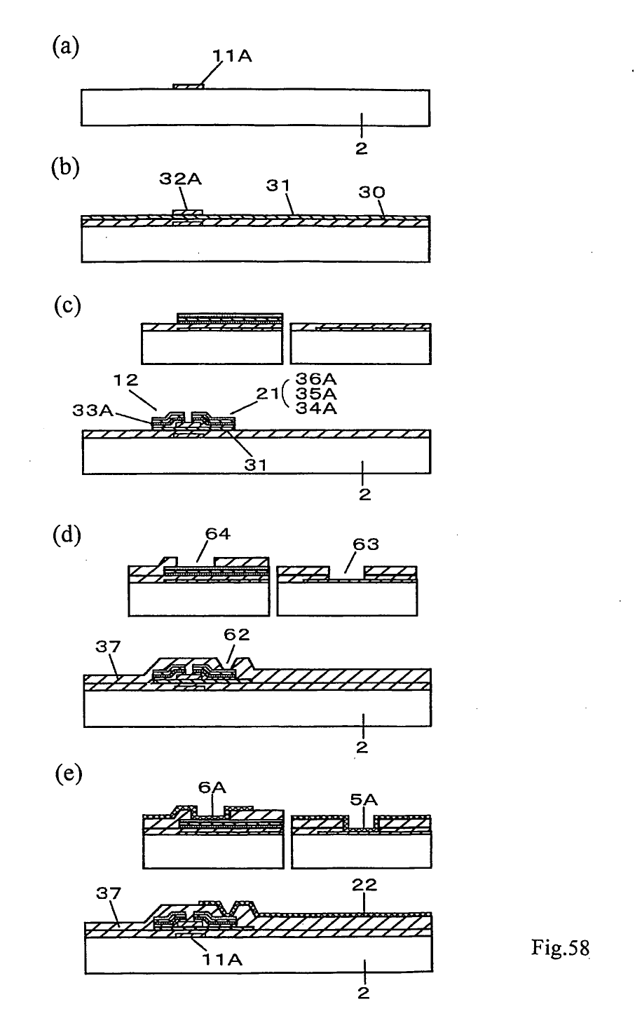

Next, a description is given of the structure of an insulating gate type transistor as a switching element and a manufacturing method therefor. Two types of insulating gate type transistors are currently used commonly, one of which will be introduced as a conventional example and be referred to as an etch stop type. FIG. 57 is a plan view of a unit pixel of an active substrate (semiconductor device for display devices) composing a conventional liquid crystal panel. Cross-section views of lines A-A′, B-B′ and C-C′ in FIG. 57(e) are shown in FIG. 58. The manufacturing process therefor is described briefly below.

First, as shown in FIGS. 57(a) and 58(a), a first metal layer about 0.1 to 0.3 μm thick is deposited using a sputter (SPT) or other such vacuum film depositing equipment on the main surface of the glass substrate 2, for example, product number 1737 manufactured by Corning, Inc., about 0.5 to 1.1 mm thick, as an insulating substrate with high heat resistance, high chemical resistance and high transparency, and the scan line 11 doubling as a gate electrode 11A and the storage capacitor line 16 are selectively formed using micro-fabrication technology. The material for the scan lines may be selected taking into consideration the combined properties of heat resistance, chemical resistance, hydrofluoric acid resistance and conductance, though an alloy or a metal with a high heat resistance such as a Cr, Ta or MoW alloy is generally used.

While using Al (aluminum) as the material for the scan lines is reasonable for lowering the resistance value of the scan lines in response to the larger screens and higher definition of liquid crystal panels, by itself, Al has a low heat resistance, so adding an oxide layer (Al2O3) in anodization of the Al surface or laminating with Cr, Ta or Mo or a silicide thereof which are the above-mentioned heat resistance metals is currently the general technology in use. In other words, the scan lines 11 are constructed of one or more metal layers.

Next, a PCVD (plasma CVD) equipment is used to successively deposit three thin layers about 0.3, 0.05, and 0.1 μm thick, for example, comprising a first SiNx (silicon nitride) layer 30 comprising a gate insulating layer, a first amorphous silicon (a-Si) layer 31 comprising a channel for an insulating gate type transistor containing almost no impurities, and a second SiNx layer 32 comprising an insulating layer for protecting the channel, over the entire surface of the glass substrate 2, and micro-fabrication technology is used to selectively leave the second SiNx layer above the gate electrode 11A more narrow than the gate electrode 11A to form a channel protection layer (or an etch stop layer or protective insulating layer) 32D as shown in FIGS. 57(b) and 58(b), exposing the first amorphous silicon layer 31.

Continuing, a second amorphous silicon layer 33 about, for example, 0.05 μm thick, containing phosphorous, for example, as an impurity is deposited over the entire surface using a PCVD equipment in a similar manner. Then, a thin film layer 34 of Ti, Cr, Mo or the like, for example, as a heat resistant metal layer about 0.1 μm thick, an Al thin film layer 35 about 0.3 μm thick as a low resistance wire layer, and a Ti thin film layer 36, for example, as an intermediate conductive layer about 0.1 μm thick are successively deposited over the entire surface as shown in FIGS. 57(c) and 58(c) using an SPT or other vacuum film depositing equipment. A signal line 12 doubling as a source electrode and a drain electrode 21 for the insulating gate type transistor made from a laminate of the three types of thin film layers 34A, 35A and 36A which are source and drain wire materials are selectively formed using micro-fabrication technology. This selective patterning is made by successively etching the Ti thin film layer 36, the Al thin film layer 35 and the Ti thin film layer 34 using a photosensitive resin pattern used in forming the source and drain wires as a mask, and then removing the second amorphous silicon layer 33 between the source and drain electrodes 12 and 21 to expose the second SiNx layer 32D as well as by removing the first amorphous silicon layer 31 in other regions to expose the gate insulating layer 30. The second SiNx layer 32D is thus present as a channel protective layer, and etching of the second amorphous silicon layer 33 automatically ends, so this manufacturing method is referred to as etch stopping.

The source and drain electrodes 12 and 21 are formed such as to overlap in one section (for several ptm) with the etch stop layer 32D in a planar fashion such that the insulating gate type transistor does not have an offset structure. This overlapping has electrical effects as a parasitic capacitance, so less is preferable, but this is decided by the precision of the exposure alignment and of the photomask, the expansion coefficient of the glass substrate and the temperature of the glass substrate during exposure, so a practical value is 2 μm at most.

Next, after removing the above-mentioned photosensitive resin pattern, an SiN-x layer about 0.3 μm thick is deposited over the entire surface of the glass substrate 2 similarly to the gate insulating layer as a transparent insulating layer using a PCVD equipment to form a passivating insulating layer 37, the passivating insulating layer 37 is selectively removed using micro-fabrication technology to form an opening 62 in the drain electrode 21, an opening 63 at the position where the electrode terminal 5 of the scan line 11 is formed in a region outside the image display part, and an opening 64 at the position where the electrode terminal 6 of the signal line 12 is formed as shown in FIGS. 57(d) and 58(d), partially exposing the drain electrode 21, the scan line 11 and the signal line 12. An opening 65 is formed on (the electrode pattern bundled parallel to) the storage capacitor line 16 to partially expose the storage capacitor line 16.

Finally, ITO (indium-tin-oxide) or IZO (indium-zinc-oxide), for example, is deposited as a transparent conductive layer about 0.1 to 0.2 μm thick using an SPT or other vacuum film depositing equipment, and a pixel electrode 22 is selectively formed using micro-fabrication technology on the passivating insulating layer 37 containing the opening 62 to complete the active substrate 2 as shown in FIGS. 57(e) and 58(e). The part of the scan line 11 exposed in the opening 63 may be used as the electrode terminal 5, and the part of the signal line 12 exposed in the opening 64 as the electrode terminal 6, and the electrode terminals 5A and 6A made from ITO on the passivating insulating layer 37 containing the openings 63 and 64 may be selectively formed as illustrated, but a transparent conductive short circuit line 40 is ordinarily formed at the same time connected between the electrode terminals 5A and 6A. The reason for this is so a high resistance can be made as a measure against static electricity by forming the interval between the electrode terminals 5A and 6A and the short circuit wire 40 into a long, narrow striped form to increase the resistance (not illustrated). Similarly, an electrode terminal is formed in the storage capacitor line 16 containing the opening 65.

If wiring resistance of the signal wire 12 is not a problem, a low resistance wire layer 35 made from Al is not necessarily required, in which case it is possible to simplify the layers of the source and drain wires 12 and 21 by selecting heat resistant metal material such as Cr, Ta or Mo. Ensuring an electrical connection with the second amorphous silicon layer using a heat resistant metal layer is thus more important for the source and drain wires; the heat resistance of an insulating gate type transistor is described in detail in Unexamined Patent Application Number H 7-74368 [i.e., 1995-74368] as an example of prior art. A region 50 (a right-slanting oblique part) over which the storage capacitor line 16 and the drain electrode 21 are superimposed in a planar manner via the gate insulating layer 30 in FIG. 57(c) forms a storage capacitor 15, though a detailed description is omitted here.

[Patent Document 1] Unexamined Patent Application Number 7-74368 [i.e., 1995-74368]

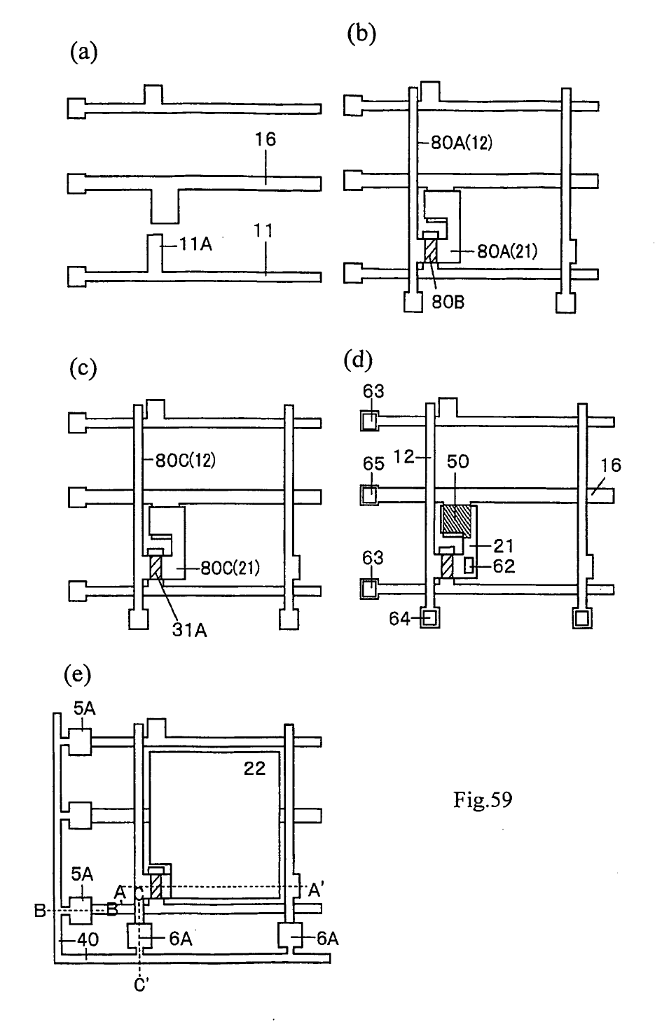

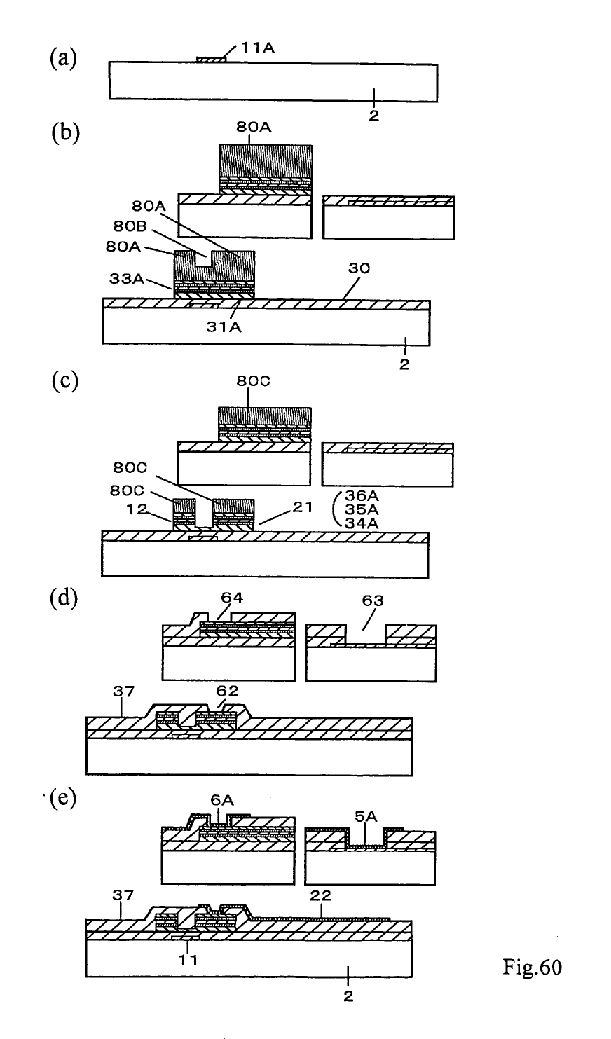

A detailed history of the five-mask process described above is omitted, but it is obtained as the result of streamlining the semiconductor islanding processing and decreasing the contact formation processes by one process. Photomask processes, which initially required seven to eight processes, has been reduced to the current five processes by the introduction of dry etching technology which greatly contributes to the decreasing process costs. That lowering the process cost in the manufacture of the active substrate and the material cost in the panel assembly and module packaging processes is effective in lowering the production costs of liquid crystal display devices is a well-known target of development. To lower process costs, either process may be eliminated to make the process shorter, or inexpensive process development or process replacement is available. Here, a four-mask process resulting in an active substrate with four photomasks is described as an example of eliminating processes. The photo-etching process is eliminated by introducing half-tone exposure technology. FIG. 59 shows a plan view of a unit pixel in an active substrate corresponding to the four-mask process. The cross-section views of lines A-A′, B-B′ and C-C′ in FIG. 59(3) are shown in FIG. 60. As already mentioned, two types of insulating gate type transistors are commonly in use currently. Here, a channel etch type insulating gate type transistor is used.

First, a first metal layer about 0.1 to 0.3 μm thick is deposited on the main surface of the glass substrate 2 using an SPT or other vacuum film depositing equipment similar to as done in the five-mask process, and the storage capacitor line 16 and scan line 11 doubling as the gate electrode 11A are selectively formed using micro-fabrication technology as shown in FIGS. 59(a) and 60(a).

Next, three thin film layers comprising the SiNx layer 30 forming a gate insulating layer, a first amorphous silicon layer 31 forming a channel for a insulating gate type transistor containing hardly any impurities, and a second amorphous silicon layer 33 forming a source and drain for a insulating gate type transistor containing impurities are successively formed about 0.3, 0.2, and 0.05 μm thick, for example, over the entire surface of the glass substrate 2 using a PCVD equipment. Next, a Ti thin film layer 34, for example, as a heat resistant metal layer about 0.1 μm thick, an Al thin film layer 35 as a low resistance wire layer about 0.3 μm thick, and a Ti thin film layer, for example, as an intermediate conductive layer about 0.1 μm thick, that is, source and drain wire material is successively deposited using an SPT or other vacuum film depositing equipment, and a drain electrode 21 for an insulating gate type transistor and a signal line 12 doubling as a source electrode are selectively formed using micro-fabrication technology. In this selective patterning, forming photosensitive resin patterns 80A and 80B thinner than the 3 μm of source and drain wiring formation regions 80A(12) and 80A(21) with the channel formation region 80B (oblique part) between the source and drain 1.5 μm thick, for example, as shown in FIGS. 59(b) and 60(b) using half-tone exposure technology is a major feature.

For such photosensitive resin patterns 80A and 80B, a positive photosensitive resin is ordinarily used in the production of substrates for liquid crystal display devices, so a black, that is, a thin Cr film is formed for the source and drain wiring formation region 80A, a gray, for example, line and space Cr pattern is formed with a width of 0.5 to 1 μm for the channel region 80B, and for other regions, a photomask may be used to make them white, that is, remove the thin Cr film. It is possible to transmit about half of the photomask transmissive light from a lamp source because the lines and spaces are not resolved due to lack of resolution, so the photosensitive resin patterns 80A and 80B may be obtained in the gray region having a cross-section shape such as that shown in FIG. 60(b) corresponding to the residual film characteristics of the positive type photosensitive resin.

After successively etching the Ti thin film layer 36, the Al thin film layer 35, the Ti thin film layer 34, the second amorphous silicon layer 33 and the first amorphous silicon layer 31 using the aforementioned photosensitive resin patterns 80A and 80B as masks to expose the gate insulating layer 30 as shown in FIG. 60(b), the photosensitive resin patterns 80A and 80B are reduced at least 1.5 μm by ashing means such as oxygen plasma, eliminating the photosensitive resin pattern 80B to expose the channel region, and leaving 80C (12) and 80C (21) only on the source and drain wiring formation region as shown in FIGS. 59(c) and 60(c). The Ti thin film layer, Al thin film layer, Ti thin film layer, second amorphous silicon layer 33A and first amorphous silicon layer 31A are successively etched again using the reduced photosensitive resin patterns 80C (12) and 80C (21) as masks, and then the first amorphous silicon layer 31A is etched leaving around 0.05 to 0.1 μm. After the metal layer is etched, the first amorphous silicon layer 31A is etched leaving around 0.05 to 0.1 μm, forming the source and drain wires, so the insulating gate type transistor obtained with such a manufacturing method is referred to as a channel etch. In the above-mentioned oxygen plasma treatment, it is desirable to suppress change in the pattern dimensions by strengthening the anisotropy, the reason for which is given below.

After removing the above-mentioned photosensitive resin patterns 80C (12) and 80C (21), a second SiNx layer about 0.3 μm thick is deposited as a transparent insulating layer over the entire surface of the glass substrate 2 to make a passivating insulating layer 37 as shown in FIGS. 59(d) and 60(d) similarly to the five-mask process; openings 62, 63 and 64 are formed respectively in regions formed as the drain electrode 21, and the electrode terminals of the scan line 11 and the signal line 12; the gate insulating layer 30 and the passivating insulating layer 37 in the opening 63 are removed to expose part of the scan line in the opening 63; and the passivating insulating layer 37 in the openings 62 and 64 are removed to expose a part of the drain electrode 21 and a part of the signal line.

Finally, ITO or IZO, for example, is deposited as a transparent conductive layer about 0.1 to 0.2 μm thick using an SPT or other vacuum film depositing equipment, and a pixel electrode 22 containing the opening 62 is selectively formed on the passivating insulating layer 37 using micro-fabrication technology to complete the active substrate 2 as shown in FIGS. 59(e) and 60(e). For the electrode terminals, transparent conductive electrode terminals 5A and 6A made from ITO are selectively formed on the passivating insulating layer 37 containing the openings 63 and 64.

In this manner, the contact formation processes for the drain electrode 21 and the scan line 11 are carried out at the same time in both the five-mask and four-mask processes, so the thickness and type of the insulating layers in the openings 62 and 63 corresponding thereto differ. The film deposition temperature is lower and the film quality inferior in the passivating insulating layer 37 than in the gate insulating layer 30, the etching rate when using a hydrofluoric acid etching liquid differs by a magnitude of 10 at several thousand Å/minute and several hundred Å/minute respectively, and because the hole diameter cannot be controlled due to an excess of over-etching on the top of the cross-sectional shape of the opening 62 on the drain electrode 21, dry etching utilizing a fluoride gas is used.

Even if dry etching is used, the opening 62 on the drain electrode 21 is only in the passivating insulating layer 37, so unlike the opening 63 of the scan line 11, over-etching of the opening 62 cannot be avoided, and depending on the material, the intermediate conductive layer 36A may be decreased by the etching gas. In the removal of the photosensitive resin pattern after the etching is complete, about 0.1 to 0.3 μm of the surface of the photosensitive resin pattern is first etched away with oxygen plasma ashing to remove the polymer on the fluoridated surface, then chemical treatment is generally carried out using an organic stripper such as stripper 106 manufactured by Tokyo Ohka Kogyo or the like, though when the intermediate conductive layer 36A is reduced to expose the base aluminum layer 35A, an Al2O3 insulator is formed on the surface of the aluminum layer 35A in oxygen plasma ashing treatment, losing ohmic contact with the pixel electrode 22. This problem may be avoided by setting the film thickness to 0.2 μm, for example, so the intermediate conductive layer 36A may be reduced. Alternately, an avoidance measure is possible wherein the aluminum layer 35A is removed when forming the openings 62 to 65 to expose the Ti thin film layer 34A which is the base heat resistant metal layer and then form the pixel electrode 22. This measure has the advantage that the intermediate conductive layer 36A is not required from the beginning.

Still, with the former measure, if the surface uniformity of these film thickness is unfavorable, this approach may not necessarily act effectively either, and this applies identically to cases where the surface uniformity in the etch rate is also unfavorable. With the latter measure, the intermediate conductive layer 36A is unneeded, but a removal process for the aluminum layer 35A is added, and there is the danger that the pixel electrode 22 may be cut off if the cross-section control of the opening 62 is inadequate.

In addition, if the first amorphous silicon layer 31 not containing impurities in the channel region is in no way deposited such as to be on the thick side (ordinarily 0.2 μm or thicker) in the channel etch type insulating gate type transistor, the surface uniformity in the glass substrate greatly affects, leading to a tendency for the transistor characteristics and particularly the off current to be irregular. This is greatly affected by the PCVD operation rate and the generation of particles, and is an extremely important item from the perspective of production costs.

Further, in the channel formation process applied in the four-mask process, the source and drain wire material between the source and drain wires 12 and 21 and the semiconductor layers containing impurities are selectively removed, so this channel formation process determines the length of the channel (4 to 6 μm in products currently being mass produced) which greatly affects the characteristics of the insulating gate type transistor. Fluctuation in the channel length greatly alters the on current value of the insulating gate type transistor, so strict manufacturing controls are ordinarily required, but the channel length, that is, the pattern dimensions of the half-tone exposure region are greatly affected by many parameters such as the exposure quantity (light source strength and photomask pattern precision and particularly the line and space dimensions), coating thickness of the photosensitive resin, developing of the photosensitive resin, and the amount of reduction in the photosensitive resin in the etching process; in addition, stable production with a high yield is not necessarily possible along with uniformity of these quantities in the surface, and even stricter production control is required than that in conventional manufacturing, so it definitely cannot be said that the art is currently at a high level of completion. In particular, if the channel length is 6 μm or less, there is a significant tendency for the effects of the pattern dimensions occurred in conjunction with a decrease in the thickness of the resist pattern to be large.

The present invention takes into account the present state of the art, not only avoiding the defects in forming the contacts common to the conventional five-mask process and the four-mask process, but also decreasing the manufacturing processes used in half-tone exposure technology having a large manufacturing margin. The need to achieve lower-priced liquid crystal panels and earnestly pursue a further decrease in the number of manufacturing processes in response to increased demand is clear. The value of the present invention is thus further enhanced by its contribution of technology to simplify other major manufacturing processes and provide lower costs.

Therefore, it is desirable to provide an improved speech recognition method to mitigate and/or obviate the aforementioned problems.

### SUMMARY OF THE INVENTION

The present invention provides first for a reduction in the manufacturing process by applying half-tone exposure technology to the pixel electrode formation process and the signal wire process. Next, it unites with an anodization technology for forming an insulating layer on the surface of source and drain wires made from aluminum disclosed in Unexamined Patent Application Number 2-216129 [i.e., 1990-216129], prior art for effectively passivating source and drain wires, to achieve a streamlined process and lower temperatures. It also achieves streamlining by using half-tone exposure technology to selectively leave a photosensitive organic insulating layer on only the signal wire, making the formation of a passivating insulating layer unnecessary. It also combines with technology for treating the contact formation process and semiconductor layer or etch stop layer formation process, the scan line formation process and semiconductor layer or etch stop layer formation process, and the scan line formation process and contact formation process with the same photomask using half-tone exposure technology to further decrease the processes.

[Patent Document 2] Unexamined Patent Application Number H 2-216129 [i.e.,1990-216129]

The liquid crystal display device mentioned in Claim 1 which is an active type is characterized by the fact that
a source wire of an insulating gate type transistor comprising a laminate made of a transparent conductive layer and a low resistance metal layer is connected to a first semiconductor layer not containing impurities for forming a channel through a second semiconductor layer containing impurities and a heat resistant metal layer, and
a transparent conductive pixel electrode is connected to the aforementioned first semiconductor layer through a second semiconductor layer containing impurities and a heat resistant metal layer.

This construction provides that the signal line is composed of a laminate made of a transparent conductive layer and a low resistance metal layer, so it is an easy matter to lower the resistance value of the signal line. This is a common construction of the liquid crystal display device of the present invention. As already mentioned, the two types of insulating gate type transistors are an etch stop type and a channel etch stop type. It is possible to construct a variety of embodiments of liquid crystal display devices corresponding thereto. These embodiments are described in detail in Claims 2 to 21.

The liquid crystal display device recited in Claim 2 is characterized by the fact that in a liquid crystal display device in which liquid crystal is filled between a first transparent insulating substrate (active substrate) in which unit pixels having at least an insulating gate type transistor, a signal line doubling as a source wire and a scan line doubling as a gate electrode for the aforementioned insulating gate type transistor, and a pixel connected to a drain wire are arranged in a two-dimensional matrix, and a color filter or a second transparent insulating substrate opposing the aforementioned transparent insulating substrate, wherein at least,
a scan line comprising a first metal layer of one or more layers is formed on a main surface of a first transparent insulating substrate,
a first semiconductor layer not containing impurities is formed in an island form through a gate insulating layer of one or more layers above a gate electrode,
a protective insulating layer is formed finer than the aforementioned gate electrode on the first semiconductor layer,
an opening is formed in a gate insulating layer on a scan line to expose a part of the scan line in the opening outside an image display region,
a pair of source and drain electrodes comprising a laminate of a heat resistant metal layer and a second semiconductor layer containing impurities is formed on a part of the aforementioned protective insulating layer and on a first semiconductor layer,
a signal line comprising a laminate of a low resistance metal layer having a photosensitive organic insulating layer on its surface and a transparent conductive layer is formed on the aforementioned source electrode and gate insulating layer, a transparent conductive pixel electrode is formed on the aforementioned drain electrode and gate insulating layer, and a transparent conductive electrode terminal of a scan line is formed containing the aforementioned opening, and
the aforementioned photosensitive organic insulating layer and low resistance metal layer on the signal line are removed outside an image display region to expose a transparent conductive electrode terminal of a signal line.

Through this construction, a transparent conductive pixel electrode is formed at the same time as a signal line, so it is formed on a gate insulating layer, but a protective insulating layer is formed on a channel between a source and drain to protect the channel and a photosensitive organic insulating layer is formed on a signal line to provide a minimal passivation function, so it is not necessary to deposit a passivating insulating layer over the entire surface of the glass substrate, and the problem of heat resistance of the insulating gate type transistor is eliminated. Also, a TN-type liquid crystal display device is obtained having transparent conductive electrode terminals, and this is the common feature of the liquid crystal display device of the present invention.

The present invention is characterized as in the liquid crystal display device recited in Claim 3 by the facts that, at least,
a scan line comprising a first metal layer of one or more layers is formed on a main surface of a first transparent insulating substrate,
a first semiconductor layer not containing impurities is formed in an island form through a gate insulating layer of one or more layers above a gate electrode,
a protective insulating layer is formed finer than the aforementioned gate electrode on the first semiconductor layer,
an opening is formed in a gate insulating layer on a scan line to expose a part of the scan line in the opening outside an image display region,
a pair of source and drain electrodes comprising a laminate made of an anodizable heat resistant metal layer having an anodized layer on its side and a second semiconductor layer containing impurities and having a silicon oxide layer on its side is formed on a part of the aforementioned protective insulating layer and on a first semiconductor layer except in a region where a pixel electrode and a signal line overlap,
a signal line comprising a laminate made of an anodizable low resistance metal layer having an anodized layer on its surface and a transparent conductive layer is formed on the aforementioned source electrode and gate insulating layer, and a transparent conductive pixel electrode is formed on the aforementioned drain electrode and gate insulating layer, and a transparent conductive electrode terminal of a scan line is formed containing the aforementioned opening, and
an anodized layer and a low resistance metal layer on the aforementioned signal line are removed outside an image display region to expose a transparent conductive electrode terminal of a signal line.

Through this construction, a transparent conductive pixel electrode is formed at the same time as a signal line, so it is formed on a gate insulating layer, but a protective insulating layer is formed on a channel between a source and drain to protect the channel, and aluminum oxide (Al2O3), for example, which is an insulating anodized layer, is formed on the surface of a signal line to provide a passivation function, effects similar to those with the liquid crystal display device recited in Claim 2 are obtained, markedly similar to those recited in Claim 2 except for the construction of the insulating layer on the signal line.

The present invention is characterized as in the liquid crystal display device recited in Claim 4 by the facts that, at least,
a scan line comprising a first metal layer of one or more layers is formed on a main surface of a first transparent insulating substrate,
a first semiconductor layer not containing impurities is formed in an island form through a gate insulating layer of one or more layers above a gate electrode,
   a protective insulating layer is formed finer than the aforementioned gate electrode on the first semiconductor layer,
   an opening is formed in a gate insulating layer on a scan line to expose a part of the scan line in the opening outside an image display region,
   a pair of source and drain electrodes comprising a laminate of a heat resistant metal layer and a second semiconductor layer containing impurities is formed on a part of the aforementioned protective insulating layer and on a first semiconductor layer,
   a signal line comprising a laminate made of a low resistance metal layer having a photosensitive organic insulating layer on its surface and a transparent conductive layer is formed on the aforementioned source electrode and gate insulating layer, a transparent conductive pixel electrode is formed on the aforementioned drain electrode and gate insulating layer, and a transparent conductive electrode terminal of a scan line is formed on an intermediate electrode comprising a laminate of a heat resistant metal layer and a second semiconductor layer formed containing the aforementioned opening
and a first semiconductor layer in its periphery, and
   the aforementioned photosensitive organic insulating layer and low resistance metal layer on the signal line are removed outside an image display region to expose a transparent conductive electrode terminal of a signal line.

Through this construction, a transparent conductive pixel electrode is formed at the same time as a signal line, so it is formed on a gate insulating layer, but a protective insulating layer is formed on a channel between a source and drain to protect the channel, and a photosensitive organic insulating layer is formed on the surface of a signal line to provide a minimal passivation function, so effects similar to those with the liquid crystal display device recited in Claim 2 are obtained, markedly similar to those recited in Claim 2 except for the construction of the electrode terminal on the scan line.

The present invention is characterized as in the liquid crystal display device recited in Claim 5 by the facts that, at least,
a scan line comprising a first metal layer of one or more layers is formed on a main surface of a first transparent insulating substrate,
a first semiconductor layer not containing impurities is formed in an island form through a gate insulating layer of one or more layers above a gate electrode,
   a protective insulating layer is formed finer than the aforementioned gate electrode on the first semiconductor layer,
an opening is formed in a gate insulating layer on a scan line to expose a part of the scan line in the opening outside an image display region,
   a pair of source and drain electrodes comprising a laminate made of an anodizable heat resistant metal layer having an anodized layer on its side and a second semiconductor layer containing impurities and having a silicon oxide layer on its side is formed on a part of the aforementioned protective insulating layer and on a first semiconductor layer except in a region where a pixel electrode and the signal line overlap,
   a signal line comprising a laminate made of an anodizable low resistant metal layer having an anodized layer on its surface and a transparent conductive layer is formed on the aforementioned source electrode and gate insulating layer, a transparent conductive pixel electrode is formed on the aforementioned drain electrode and gate insulating layer, and a transparent conductive electrode terminal of a scan line is formed on an intermediate electrode comprising a laminate of a heat resistant metal layer and a second semiconductor layer formed containing the aforementioned opening and a first semiconductor layer in its periphery, and
   an anodized layer and a low resistance metal layer on the aforementioned signal line are removed outside an image display region to expose a transparent conductive electrode terminal of a signal line

Through this construction, a transparent conductive pixel electrode is formed at the same time as a signal line, so it is formed on a gate insulating layer, but a protective insulating layer is formed on a channel between a source and drain to protect the channel, and aluminum oxide (Al2O3), for example, which is an insulating anodized layer, is formed on the surface of a signal line to provide a passivation function; this is markedly similar to the liquid crystal display device recited in Claim 3 except for the construction of the electrode terminal on the scan line.

The present invention is characterized as in the liquid crystal display device recited in Claim 6 by the facts that, at least;
a scan line having an insulating layer in a side thereof and comprising a first metal layer of one or more layers is formed on a main surface of a first transparent insulating substrate,
   a gate insulating layer of one or more layers is formed on the aforementioned scan line,
   a first semiconductor layer not containing impurities is formed in an island form on a gate insulating layer above a gate electrode,
   a protective insulating layer is formed finer than the aforementioned gate electrode on the first semiconductor layer,
an opening is formed in a gate insulating layer on a scan line to expose a part of the scan line in the opening outside an image display region,
   a pair of source and drain electrodes comprising a laminate of a heat resistant metal layer and a second semiconductor layer containing impurities is formed on a part of the aforementioned protective insulating layer, on a first semiconductor layer and on a first transparent insulating substrate,
   a signal line comprising a laminate made of a low resistance metal layer having a photosensitive organic insulating layer on its surface and a transparent conductive layer is formed on the aforementioned source electrode and a first transparent insulating substrate, a transparent conductive pixel electrode is formed on the aforementioned drain electrode and on a first transparent insulating substrate, and a transparent conductive electrode terminal of a scan line is formed on an intermediate electrode comprising a laminate made of a heat resistant metal layer and a second semiconductor layer formed containing the aforementioned opening and a protective insulating layer and a first semiconductor layer in the periphery of the opening, and
   the aforementioned photosensitive organic insulating layer and low resistance metal layer on the signal line are removed outside an image display region to expose a transparent conductive electrode terminal of a signal line.

Through this construction, a contact is formed self-conforming to a scan line, and a gate insulating layer is formed whose pattern width is identical to that of the scan line, so an insulating layer different from the gate insulating layer is provided in the side of the scan line making it possible for the scan line and signal line to cross. The transparent conductive pixel electrode is formed at the same time as the signal line, so it is formed on the glass substrate. Then, a protective insulating layer is formed on a channel between the source and drain to protect the channel, and a photosensitive organic insulating layer is formed on the surface of the signal line to provide a minimal passivation function, so the effects obtained are similar to those with the liquid crystal display device recited in Claim 2.

The present invention is characterized as in the liquid crystal display device recited in Claim 7 by the facts that, at least,
a scan line having an insulating layer in a side thereof and comprising a first metal layer of one or more layers is formed on a main surface of a first transparent insulating substrate,
a gate insulating layer of one or more layers is formed on the aforementioned scan line,
a first semiconductor layer not containing impurities is formed in an island form on a gate insulating layer above a gate electrode,
a protective insulating layer is formed finer than the aforementioned gate electrode on the first semiconductor layer,
an opening is formed in a gate insulating layer on a scan line to expose a part of the scan line in the opening outside an image display region,
a pair of source and drain electrodes comprising a laminate made of an anodizable heat resistant metal layer having an anodized layer on its side and a second semiconductor layer containing impurities and having a silicon oxide layer on its side is formed on a part of the aforementioned protective insulating layer, on a first semiconductor layer and on a first transparent insulating substrate except in a region where a pixel electrode and a signal line overlap,
a signal line comprising a laminate made of an anodizable low resistance metal layer having an anodized layer on its surface and a transparent conductive layer is formed on the aforementioned source electrode and a first transparent insulating substrate, a transparent conductive pixel electrode is formed on the aforementioned drain electrode and a first transparent insulating substrate, and a transparent conductive electrode terminal of a scan line is formed on an intermediate electrode comprising a laminate made of a heat resistant metal layer and a second semiconductor layer formed containing the aforementioned opening, a protective insulating layer and a first semiconductor layer in the periphery of the opening, and
an anodized layer and a low resistance metal layer on the aforementioned signal line are removed outside an image display region to expose a transparent conductive electrode terminal of a signal line.

Through this construction, a contact is formed self-conforming to a scan line, and a gate insulating layer is formed whose pattern width is identical to that of the scan line, so an insulating layer different from the gate insulating layer is provided in the side of the scan line making it possible for the scan line and signal line to cross. The transparent conductive pixel electrode is formed at the same time as the signal line, so it is formed on the glass substrate. Then, a protective insulating layer is formed on a channel between the source and drain to protect the channel, and aluminum oxide (Al2O3), for example, which is an insulating anodized layer, is formed on the surface of the signal line to provide a passivation function; the effects obtained are similar to those with the liquid crystal display device recited in Claim 3.

The present invention is characterized as in the liquid crystal display device recited in Claim 8 by the facts that, at least,
a scan line having an insulating layer in a side thereof and comprising a first metal layer of one or more layers is formed on a main surface of a first transparent insulating substrate,
a gate insulating layer of one or more layers is formed on the aforementioned scan line,
a first semiconductor layer not containing impurities is formed in an island form on a gate insulating layer above a gate electrode,
a protective insulating layer is formed finer than the aforementioned gate electrode on the first semiconductor layer,
an opening is formed in a gate insulating layer on a scan line to expose a part of the scan line in the opening outside an image display region,
a pair of source and drain electrodes comprising a laminate of a heat resistant metal layer and a second semiconductor layer containing impurities is formed on a part of the aforementioned protective insulating layer, on a first semiconductor layer and on a first transparent insulating substrate,
a signal line comprising a laminate made of a low resistance metal layer having a photosensitive organic insulating layer on its surface and a transparent conductive layer is formed on the aforementioned source electrode and a first transparent insulating substrate, a transparent conductive pixel electrode is formed on the aforementioned drain electrode and a first transparent insulating substrate, and a transparent conductive electrode terminal of a scan line is formed containing the aforementioned opening, and
the aforementioned photosensitive organic insulating layer and low resistance metal layer on the signal line are removed outside an image display region to expose a transparent conductive electrode terminal of a signal line.

Through this construction, a protective insulating layer for a channel is formed self-conforming to a scan line, and a gate insulating layer is formed whose pattern width is identical to that of the scan line, so an insulating layer different from the gate insulating layer is provided in the side of the scan line making it possible for the scan line and signal line to cross. The transparent conductive pixel electrode is formed at the same time as the signal line, so it is formed on the glass substrate. Then, a protective insulating layer is formed on a channel between the source and drain to protect the channel, and a photosensitive organic insulating layer is formed on the surface of the signal line to provide a minimal passivation function; the effects obtained are similar to those with the liquid crystal display device recited in Claim 2.

The present invention is characterized as in the liquid crystal display device recited in Claim 9 by the facts that, at least,
a scan line having an insulating layer in a side thereof and comprising a first metal layer of one or more layers is formed on a main surface of a first transparent insulating substrate,
   a gate insulating layer of one or more layers is formed on the aforementioned scan line,
   a first semiconductor layer not containing impurities is formed in an island form on a gate insulating layer above a gate electrode,
   a protective insulating layer is formed finer than the aforementioned gate electrode on the first semiconductor layer,
an opening is formed in a gate insulating layer on a scan line to expose a part of the scan line in the opening outside an image display region,
   a pair of source and drain electrodes comprising a laminate made of an anodizable heat resistant metal layer having an anodized layer similar on its side and a second semiconductor layer containing impurities and having a silicon oxide layer on its side is formed on a part of the aforementioned protective insulating layer, on a first semiconductor layer and on a first transparent insulating substrate except in a region where a pixel electrode and a signal line overlap,
   a signal line comprising a laminate made of an anodizable low resistance metal layer having an anodized layer on its surface and a transparent conductive layer is formed on the aforementioned source electrode and a first transparent insulating substrate, a transparent conductive pixel electrode is formed on the aforementioned drain electrode and a first transparent insulating substrate, and a transparent conductive electrode terminal of a scan line is formed containing the aforementioned opening, and
   an anodized layer and a low resistance metal layer on the aforementioned signal line are removed outside an image display region to expose a transparent conductive electrode terminal of a signal line.

Through this construction, a protective insulating layer for a channel is formed self-conforming to a scan line, and a gate insulating layer is formed whose pattern width is identical to that of the scan line, so an insulating layer different from the gate insulating layer is provided in the side of the scan line making it possible for the scan line and signal line to cross. The transparent conductive pixel electrode is formed at the same time as the signal line, so it is formed on the glass substrate. Then, a protective insulating layer is formed on a channel between the source and drain to protect the channel, and aluminum oxide (Al2O3), for example, which is an insulating anodized layer, is formed on the surface of the signal line to provide a passivation function; the effects obtained are similar to those with the liquid crystal display device recited in Claim 3.

The present invention is characterized as in the liquid crystal display device recited in Claim 10 by the facts that, at least,
a scan line having an insulating layer in a side thereof and comprising a first metal layer of one or more layers is formed on a main surface of a first transparent insulating substrate,
a gate insulating layer of one or more layers is formed on the aforementioned scan line,
a first semiconductor layer not containing impurities is formed in an island form on a gate insulating layer above a gate electrode,
a protective insulating layer is formed finer than the aforementioned gate electrode on the first semiconductor layer,
an opening is formed in a gate insulating layer on a scan line to expose a part of the scan line in the opening outside an image display region,
a pair of source and drain electrodes comprising a laminate of a heat resistant metal layer and a second semiconductor layer containing impurities is formed on a part of the aforementioned protective insulating layer and on a first semiconductor layer,
a signal line comprising a laminate made of a low resistance metal layer having a photosensitive organic insulating layer on its surface and a transparent conductive layer is formed on the aforementioned source electrode and a first transparent insulating substrate, a transparent conductive pixel electrode is formed on the aforementioned drain electrode and a first transparent insulating substrate, and a transparent conductive electrode terminal of a scan line is formed containing the aforementioned opening, and a heat resistant metal layer, a second semiconductor layer and a first semiconductor layer in the periphery of the opening, and
the aforementioned photosensitive organic insulating layer and low resistance metal layer on the signal line are removed outside an image display region to expose a transparent conductive electrode terminal of a signal line.

Through this construction, a source and drain electrode are formed above a gate electrode, and a gate insulating layer is formed with the same pattern width as the scan line, so an insulating layer different from the gate insulating layer is provided in the side of the scan line making it possible for the scan line and signal line to cross. The transparent conductive pixel electrode is formed at the same time as the signal line, so it is formed on the glass substrate. Then, a protective insulating layer is formed on a channel between the source and drain to protect the channel, and a photosensitive organic insulating layer is formed on the surface of the signal line to provide a minimal passivation function; the effects obtained are similar to those with the liquid crystal display device recited in Claim 2.

The present invention is characterized as in the liquid crystal display device recited in Claim 11 by the facts that, at least,
a scan line having an insulating layer in a side thereof and comprising a first metal layer of one or more layers is formed on a main surface of a first transparent insulating substrate,
a gate insulating layer of one or more layers is formed on the aforementioned scan line,
a first semiconductor layer not containing impurities is formed in an island form on a gate insulating layer above a gate electrode,
a protective insulating layer is formed finer than the aforementioned gate electrode on the first semiconductor layer,
an opening is formed in a gate insulating layer on a scan line to expose a part of the scan line in the opening outside an image display region,
a pair of source and drain electrodes comprising a laminate made of an anodizable heat resistant metal layer having an anodized layer on its side and a second semiconductor layer containing impurities and having a silicon oxide layer on its side is formed on a part of the aforementioned protective insulating layer and on a first semiconductor layer except in a region where a pixel electrode and a signal line overlap,
a signal line comprising a laminate made of an anodizable low resistance metal layer having an anodized layer on its surface and a transparent conductive layer is formed on the aforementioned source electrode and a first transparent insulating substrate, a transparent conductive pixel electrode is formed on the aforementioned drain electrode and a first transparent insulating substrate, and a transparent conductive electrode terminal of a scan line is formed containing the aforementioned opening, a heat resistant metal layer, a second semiconductor layer, and a first semiconductor layer (having an anodized layer and a silicon oxide layer in the side respectively) in the periphery of the opening, and
an anodized layer and a low resistance metal layer on a signal line are removed outside an image display region to expose a transparent conductive electrode terminal of a signal line.

Through this construction, a source and drain electrode are formed above a gate electrode, and a gate insulating layer is formed with the same pattern width as the scan line, so an insulating layer different from the gate insulating layer is provided in the side of the scan line making it possible for the scan line and signal line to cross. The transparent conductive pixel electrode is formed at the same time as the signal line, so it is formed on the glass substrate. Then, a protective insulating layer is formed on a channel between the source and drain to protect the channel, and aluminum oxide (Al2O3), for example, which is an insulating anodized layer, is formed on the surface of the signal line to provide a passivation function; the effects obtained are similar to those with the liquid crystal display device recited in Claim 3.

The present invention is characterized as in the liquid crystal display device recited in Claim 12 by the facts that, at least,
a scan line comprising a first metal layer of one or more layers is formed on a main surface of a first transparent insulating substrate,
a first semiconductor layer not containing impurities is formed in an island form through a gate insulating layer of one or more layers above a gate electrode,
   a pair of source and drain electrodes comprising a laminate made of a second semiconductor layer containing impurities and a heat resistant metal layer is formed on the aforementioned first semiconductor layer,
an opening is formed in a gate insulating layer on a scan line to expose a part of the scan line in the opening outside an image display region,
   a signal line comprising a laminate made of a low resistance metal layer and a transparent conductive layer is formed on the aforementioned source electrode and gate insulating layer, a transparent conductive pixel electrode is formed on the aforementioned drain electrode and gate insulating layer, an electrode terminal of a scan line comprising a laminate made of a low resistance metal layer and a transparent conductive layer or a transparent conductive layer is formed containing the aforementioned opening, and an electrode terminal of a signal line comprising a laminate made of a low resistance metal layer and a transparent conductive layer or a transparent conductive layer comprising a part of the signal line is formed outside an image display part region, and
   a passivating insulating layer having openings on the aforementioned pixel electrode and on the aforementioned electrode terminals of the scan line and the signal line is formed on the aforementioned first transparent insulating substrate.

Through this construction, a transparent conductive pixel electrode is formed on a gate insulating layer at the same time as a signal line, but a passivating insulating layer is formed on the active substrate as in the Conventional Example to protect the channel and the source and drain wires of the insulating gate type transistor. Also, either a transparent conductive layer or low resistance metal layer may be selected for the electrode terminal of the signal line and the scan line.

The present invention is characterized as in the liquid crystal display device recited in Claim 13 by the facts that, at least,
a scan line comprising a first metal layer of one or more layers is formed on a main surface of a first transparent insulating substrate,
   a first semiconductor layer not containing impurities is formed in an island form through a gate insulating layer of one or more layers above a gate electrode,
   a pair of source and drain electrodes comprising a laminate made of an anodizable heat resistant metal layer having an anodized layer on its side and a second semiconductor layer containing impurities and having a silicon oxide layer on its side is formed on the aforementioned first semiconductor layer except in a region where a pixel electrode and a signal line overlap,
   a silicon oxide layer is formed on a first semiconductor layer between the aforementioned source and drain electrodes,
an opening is formed in a gate insulating layer on a scan line to expose a part of the scan line in the opening outside an image display region,
a signal line comprising a laminate made of an anodizable low resistance metal layer having an anodized layer on its surface and a transparent conductive layer is formed on the aforementioned source electrode and gate insulating layer, a transparent conductive pixel electrode is formed on the aforementioned drain electrode and gate insulating layer, a transparent conductive electrode terminal of a scan line is formed containing the aforementioned opening, and
   an anodized layer and a low resistance metal layer on a signal line are removed outside an image display region to expose a transparent conductive electrode terminal of a signal line.

Through this construction, a transparent conductive pixel electrode is formed at the same time as a signal line, so it is formed on a gate insulating layer, but a silicon oxide layer is formed on a channel between a source and drain to protect the insulating gate type transistor channel, and aluminum oxide (Al2O3), for example, which is an insulating anodized layer, is formed on the surface of a drain wire and a signal line to provide a passivation function; the effects obtained are similar to the TN-type liquid crystal display device recited in Claim 3.

The present invention is characterized as in the liquid crystal display device recited in Claim 14 by the facts that, at least,
a scan line having an insulating layer in a side thereof and comprising a first metal layer of one or more layers is formed on a main surface of a first transparent insulating substrate,
a gate insulating layer of one or more layers is formed on the aforementioned scan line,
a first semiconductor layer not containing impurities is formed in an island form on a gate insulating layer above a gate electrode,
a pair of source and drain electrodes comprising a laminate made of a second semiconductor layer containing impurities and a heat resistant metal layer is formed on the aforementioned first semiconductor layer,
an opening is formed in a gate insulating layer on a scan line to expose a part of the scan line in the opening outside an image display region,
a signal line comprising a laminate made of a low resistance metal layer and a transparent conductive layer is formed on the aforementioned source electrode and first transparent insulating substrate, and a transparent conductive pixel electrode is formed on the aforementioned drain electrode and a first transparent insulating substrate, an electrode terminal of a scan line comprising a laminate made of a low resistance metal layer and transparent conductive layer or transparent conductive layer is formed containing the aforementioned opening and a heat resistant metal layer, a second semiconductor layer and a first semiconductor layer in the periphery of the opening, and an electrode terminal of a signal line comprising a laminate made of a low resistance metal layer and a transparent conductive layer or a transparent conductive layer comprising a part of a signal line is formed outside an image display part region, and
a passivating insulating layer having openings on the aforementioned pixel electrode and on the aforementioned electrode terminals of the scan line and the signal line is formed on the aforementioned first transparent insulating substrate.

Through this construction, a contact is formed self-conforming to a scan line, and a gate insulating layer is formed whose pattern width is identical to that of the gate electrode, so an insulating layer different from the gate insulating layer is provided in the side of the gate electrode (scan line) making it possible for the scan line and signal line to cross. The transparent conductive pixel electrode is formed at the same time as the signal line, so it is formed on the glass substrate. Then, a passivating insulating layer as in the Conventional Example is formed on the active substrate to protect the channel and the source and drain wires of the insulating gate type transistor. Also, either a transparent conductive layer or low resistance metal layer may be selected for the electrode terminal of the signal line and the scan line.

The present invention is characterized as in the liquid crystal display device recited in Claim 15 by the facts that, at least,
a scan line having an insulating layer in a side thereof and comprising a first metal layer of one or more layers is formed on a main surface of a first transparent insulating substrate,
a gate insulating layer of one or more layers is formed on the aforementioned scan line,
a first semiconductor layer not containing impurities is formed in an island form on a gate insulating layer above a gate electrode,
a pair of source and drain electrodes comprising a laminate made of an anodizable heat resistant metal layer having an anodized layer on its side and a second semiconductor layer containing impurities and having a silicon oxide layer on its side is formed on the aforementioned first semiconductor layer except in a region where a pixel electrode and a signal line overlap,
a silicon oxide layer is formed on a first semiconductor layer between the aforementioned source and drain electrodes,
an opening is formed in a gate insulating layer on a scan line to expose a part of the scan line in the opening outside an image display region,
a signal line comprising a laminate made of an anodizable low resistance metal layer having an anodized layer on its surface and a transparent conductive layer is formed on the aforementioned source electrode and a first transparent insulating substrate, a transparent conductive pixel electrode is formed on the aforementioned drain electrode and a first transparent insulating substrate, and a transparent conductive electrode terminal of a scan line is formed containing the aforementioned opening, and a heat resistant metal layer, a second semiconductor layer and a first semiconductor layer in the periphery of the opening, and
an anodized layer and a low resistance metal layer on a signal line are removed outside an image display region to expose a transparent conductive electrode terminal of a signal line.

Through this construction, a contact is formed self-conforming to a scan line, and a gate insulating layer is formed whose pattern width is identical to that of the gate electrode, so an insulating layer different from the gate insulating layer is provided in the side of the gate electrode (scan line) making it possible for the scan line and signal line to cross. The transparent conductive pixel electrode is formed at the same time as the signal line, so it is formed on the glass substrate. Then, a silicon oxide layer is formed on a channel between the source and drain to protect the insulating gate type transistor channel, and aluminum oxide (Al2O3), for example, which is an insulating anodized layer, is formed on the surface of the drain wire and the signal wire to provide a passivation function; the effects obtained are similar to the TN-type liquid crystal display device recited in Claim 3.

The present invention is characterized as in the liquid crystal display device recited in Claim 16 by the facts that, at least,
a scan line having an insulating layer in a side thereof and comprising a first metal layer of one or more layers is formed on a main surface of a first transparent insulating substrate,
a gate insulating layer of one or more layers is formed on the aforementioned scan line,
a first semiconductor layer not containing impurities is formed in an island form on a gate insulating layer above a gate electrode,
a pair of source and drain electrodes comprising a laminate made of a second semiconductor layer containing impurities and a heat resistant metal layer is formed on the aforementioned first semiconductor layer,
an opening is formed in a gate insulating layer on a scan line to expose a part of the scan line in the opening outside an image display region,
a signal line comprising a laminate made of a low resistance metal layer and a transparent conductive layer is formed on the aforementioned source electrode and first transparent insulating substrate, and a transparent conductive pixel electrode is formed on the aforementioned drain electrode and a first transparent insulating substrate, an electrode terminal of a scan line comprising a laminate made of a low resistance metal layer and a transparent conductive layer or a transparent conductive layer is formed containing the aforementioned opening, and an electrode terminal of a signal line comprising a laminate made of a low resistance metal layer and a transparent conductive layer or a transparent conductive layer comprising a part of a signal line is formed outside an image display region, and
a passivating insulating layer having openings on the aforementioned pixel electrode and on the aforementioned electrode terminals of the scan line and the signal line is formed on the aforementioned first transparent insulating substrate.

Through this construction, a semiconductor layer is formed self-conforming to a scan line, and a gate insulating layer is formed whose pattern width is identical to that of the gate electrode, so an insulating layer different from the gate insulating layer is provided in the side of the gate electrode (scan line) making it possible for the scan line and signal line to cross. The transparent conductive pixel electrode is formed at the same time as the signal line, so it is formed on the glass substrate. Then, a passivating insulating layer as in the Conventional Example is formed on the active substrate to protect the channel and the source and drain wires of the insulating gate type transistor, and Also, either a transparent conductive layer or low resistance metal layer may be selected for the electrode terminal of the signal line and the scan line.

The present invention is characterized as in the liquid crystal display device recited in Claim 17 by the facts that, at least,
a scan line having an insulating layer in a side thereof and comprising a first metal layer of one or more layers is formed on a main surface of a first transparent insulating substrate,
a gate insulating layer of one or more layers is formed on the aforementioned scan line,
a first semiconductor layer not containing impurities is formed in an island form on a gate insulating layer above a gate electrode,
a pair of source and drain electrodes comprising a laminate made of an anodizable heat resistant metal layer having an anodized layer on its side and a second semiconductor layer containing impurities and having a silicon oxide layer on its side is formed on the aforementioned first semiconductor layer except in a region where a pixel electrode and a signal line overlap,
a silicon oxide layer is formed on a first semiconductor layer between the aforementioned source and drain electrodes,
an opening is formed in a gate insulating layer on a scan line to expose a part of the scan line in the opening outside an image display region,
a signal line comprising a laminate made of an anodizable low resistance metal layer having an anodized layer on its surface and a transparent conductive layer is formed on the aforementioned source electrode and a first transparent insulating substrate, a transparent conductive pixel electrode is formed on the aforementioned drain electrode and a first transparent insulating substrate, and a transparent conductive electrode terminal of a scan line is formed containing the aforementioned opening, and
an anodized layer and a low resistance metal layer on a signal line are removed outside an image display region to expose a transparent electrode terminal of a signal line.

Through this construction, a semiconductor layer is formed self-conforming to a scan line, and a gate insulating layer is formed whose pattern width is identical to that of the gate electrode, so an insulating layer different from the gate insulating layer is provided in the side of the gate electrode (scan line) making it possible for the scan line and signal line to cross. The transparent conductive pixel electrode is formed at the same time as the signal line, so it is formed on the glass substrate. Then, a silicon oxide layer is formed on a channel between the source and drain to protect the insulating gate type transistor channel, and aluminum oxide (Al2O3), for example, which is an insulating anodized layer, is formed on the surface of the drain wire and the signal wire to provide a passivation function; the effects obtained are similar to the TN-type liquid crystal display device recited in Claim 3.

The present invention is characterized as in the liquid crystal display device recited in Claim 18 by the facts that, at least,
a scan line having an insulating layer in a side thereof and comprising a first metal layer of one or more layers is formed on a main surface of a first transparent insulating substrate,
a gate insulating layer of one or more layers is formed on the aforementioned scan line,
a first semiconductor layer not containing impurities is formed in an island form slightly smaller than the aforementioned gate insulating layer on a gate insulating layer above a gate electrode,
a pair of source and drain electrodes comprising a laminate made of a second semiconductor layer containing impurities and a heat resistant metal layer is formed on the aforementioned first semiconductor layer,
an opening is formed in a gate insulating layer on a scan line to expose a part of the scan line in the opening outside an image display region,
a signal line comprising a laminate made of a low resistance metal layer and a transparent conductive layer is formed on the aforementioned source electrode and first transparent insulating substrate, and a transparent conductive pixel electrode is formed on the aforementioned drain electrode and a first transparent insulating substrate, an electrode terminal of a scan line comprising a laminate made of a low resistance metal layer and a transparent conductive layer or a transparent conductive layer is formed containing the aforementioned opening, and an electrode terminal of a signal line comprising a laminate made of a low resistance metal layer and a transparent conductive layer or a transparent conductive layer comprising a part of a signal line is formed outside an image display region, and
a passivating insulating layer having openings on the aforementioned pixel electrode and on the aforementioned electrode terminals of the scan line and the signal line is formed on the aforementioned first transparent insulating substrate.

Through this construction, a semiconductor layer is made slightly finer than a gate electrode on the gate electrode, and a gate insulating layer is formed with the same width as the gate electrode, so an insulating layer different from the gate insulating layer is provided in the side of the gate electrode (scan line) making it possible for the scan line and signal line to cross. The transparent conductive pixel electrode is formed at the same time as the signal line, so it is formed on the glass substrate. Then, a passivating insulating layer as in the Conventional Example is formed on the active substrate to protect the channel and the source and drain wires of the insulating gate type transistor, and Also, either a transparent conductive layer or low resistance metal layer may be selected for the electrode terminal of the signal line and the scan line.

The present invention is characterized as in the liquid crystal display device recited in Claim 19 by the facts that, at least,
a scan line having an insulating layer in a side thereof and comprising a first metal layer of one or more layers is formed on a main surface of a first transparent insulating substrate,
   a gate insulating layer of one or more layers is formed on the aforementioned scan line,
   a first semiconductor layer not containing impurities is formed in an island form slightly smaller than the aforementioned gate insulating layer on a gate insulating layer above a gate electrode,
   a pair of source and drain electrodes is formed comprising a laminate made of an anodizable heat resistant metal layer having an anodized layer on its side and a second semiconductor layer containing impurities and having a silicon oxide layer on its side is formed on the aforementioned first semiconductor layer except in a region where a pixel electrode and a signal line overlap,
   a silicon oxide layer is formed on a first semiconductor layer between the aforementioned source and drain electrodes,
   an opening is formed in a gate insulating layer on a scan line to expose a part of the scan line in the opening outside an image display region,
a signal line comprising a laminate made of a transparent conductive layer and an anodizable low resistance metal layer having an anodized layer on its surface is formed on the aforementioned source electrode and a first transparent insulating substrate, a transparent conductive pixel electrode is formed on the aforementioned drain electrode and a first transparent insulating substrate, and a transparent conductive electrode terminal of a scan line is formed containing the aforementioned opening, and
   an anodized layer and a low resistance metal layer on a signal line are removed outside an image display region to expose a transparent conductive electrode terminal of a signal line.

Through this construction, a semiconductor layer is made slightly finer than a gate electrode on the gate electrode, and a gate insulating layer is formed with the same width as the gate electrode, so an insulating layer different from the gate insulating layer is provided in the side of the gate electrode (scan line) making it possible for the scan line and signal line to cross. The transparent conductive pixel electrode is formed at the same time as the signal line, so it is formed on the glass substrate. Then, a silicon oxide layer is formed on a channel between the source and drain to protect the insulating gate type transistor channel, and aluminum oxide (Al2O3), for example, which is an insulating anodized layer, is formed on the surface of the drain wire and the signal wire to provide a passivation function; the effects obtained are similar to the TN-type liquid crystal display device recited in Claim 3.

The present invention is characterized as in the liquid crystal display device recited in Claim 20 by the facts that, at least,
a scan line having an insulating layer in a side thereof and comprising a first metal layer of one or more layers is formed on a main surface of a first transparent insulating substrate,
   a first semiconductor layer not containing impurities and a gate insulating layer of at least one layer are formed in an island form at a proximity of an intersection of a signal line and a scan line and on a gate electrode,
   a pair of source and drain electrodes comprising a laminate made of a heat resistant metal layer and a second semiconductor layer containing impurities is formed on the aforementioned first semiconductor layer above a gate electrode, and a heat resistant metal layer and a second semiconductor containing impurities are formed on a first semiconductor layer at an intersection of a scan line and a signal line,
   a signal line comprising a laminate of a transparent conductive layer and a low resistance metal layer is formed on the aforementioned source electrode, on a first transparent insulating substrate, and on a heat resistant metal layer at an intersection of a signal line and a scan line, a transparent conductive pixel electrode is formed on the aforementioned drain electrode and on a first transparent insulating substrate, an electrode terminal for a scan line comprising a laminate made of a low resistance metal layer and a transparent conductive layer or a transparent conductive layer is formed on a part of a scan line outside an image display region, and a electrode terminal for a signal line comprising a laminate made of a low resistance metal layer and a transparent conductive layer or a transparent conductive layer comprising a part of a signal line is formed outside an image display region, and
   a passivating insulating layer having openings on the aforementioned pixel electrode and on the aforementioned electrode terminals of the scan line and the signal line is formed on the aforementioned first transparent insulating substrate.

Through this construction, a semiconductor layer is formed self-conforming to a scan line, and a gate insulating layer is formed whose pattern width is identical to that of the gate electrode only above a gate electrode and at a proximity of an intersection of a signal line and a scan line, so an insulating layer different from the gate insulating layer is provided in the side of the gate electrode (scan line) making it possible for the scan line and signal line to cross. The transparent conductive pixel electrode is formed at the same time as the signal line, so it is formed on the glass substrate. Then, a passivating insulating layer as in the Conventional Example is formed on the active substrate to protect the channel and the source and drain wires of the insulating gate type transistor, and Also, either a transparent conductive layer or low resistance metal layer may be selected for the electrode terminal of the signal line and the scan line.

The present invention is characterized as in the liquid crystal display device recited in Claim 21 by the facts that, at least,
a scan line having an insulating layer in its side comprising an anodizable first metal layer of one or more layers is formed on a main surface of a first transparent insulating substrate,
   a first semiconductor layer not containing impurities and a gate insulating layer of at least one layer are formed in an island form at a proximity of an intersection of a signal line and a scan line and on a gate electrode,
   a pair of source and drain electrodes comprising a laminate made of an anodizable heat resistant metal layer having an anodized layer on its side and a second semiconductor layer containing impurities and having a silicon oxide layer on its side is formed on a first semiconductor layer above a gate electrode except in a region where a pixel electrode and a signal line overlap, and a silicon oxide layer is formed on a first semiconductor layer at a proximity of an intersection of a signal line and a scan line except an intersection of a scan line and a signal line, and a heat resistant metal layer having an anodizable layer in its side and a second semiconductor layer having a silicon oxide layer in its side are formed on a first semiconductor layer at an intersection of a scan line and a signal line,
a silicon oxide layer is formed on the aforementioned first semiconductor layer between the source and drain electrodes,
   a signal line comprising a laminate made of a transparent conductive layer and an anodizable low resistance metal layer having an anodized layer on its surface is formed on the aforementioned source electrode, on a first transparent insulating substrate and on a heat resistant metal layer at the aforementioned intersection of a signal line and scan line, a transparent conductive pixel electrode is formed on the aforementioned drain electrode and on a first transparent insulating substrate, and a transparent conductive electrode terminal of a scan line is formed on a part of a scan line outside an image display region,
   an anodizable layer is formed on a scan line except for the aforementioned electrode terminal of the scan line, and
an anodized layer and a low resistance metal layer on a signal line are removed outside an image display region to expose a transparent conductive electrode terminal of a signal line.

Through this construction, a semiconductor layer is formed self-conforming to a scan line, a gate insulating layer is formed whose pattern width is identical to that of the gate electrode only above a gate electrode and at a proximity of an intersection of a signal line and a scan line, and an anodized layer of a scan line is formed on a scan line other than at the proximity of the intersection of the scan line and the signal line, so an insulating layer different from the gate insulating layer is provided in the side of the gate electrode (scan line) making it possible for the scan line and signal line to cross. The transparent conductive pixel electrode is formed at the same time as the signal line, so it is formed on the glass substrate. Then, a silicon oxide layer is formed on a channel between the source and drain to protect the channel of the insulating gate type transistor, and aluminum oxide (Al2O3), for example, which is an insulating anodized layer, is formed on the surface of the drain wire and the signal wire to provide a passivation function; the effects obtained are similar to the TN-type liquid crystal display device recited in Claim 3.

The liquid crystal image display device cited in Claim 22 is the liquid crystal display device recited in Claim 6, Claim 7, Claim 8, Claim 9, Claim 10, Claim 11, Claim 14, Claim 15, Claim 16, Claim 17, Claim 18, Claim 19, Claim 20, and Claim 21 characterized by the fact that an insulating layer formed in the side of a scan line is an organic insulating layer. Through this construction, an organic insulating layer can be formed by electrodeposition in the side of a scan line regardless of the material or construction of the scan line, and half-tone exposure technology is used to make it possible to repeatedly use one photomask to treat the scan line formation process and the contact formation process as well as the scan line formation process and the etch stop layer or semiconductor layer formation process.

The liquid crystal image display device recited in Claim 23 is the liquid crystal display device recited in Claim 6, Claim 7, Claim 8, Claim 9, Claim 10, Claim 11, Claim 14, Claim 15, Claim 16, Claim 17, Claim 18, Claim 19, Claim 20, and Claim 21 characterized by the fact that a first metal layer comprises an anodizable metal layer and that the insulating layer formed in the side of the scan line is an anodized layer. Through this construction, it is possible to form an anodized layer through anodization in the side of the scan line, and half-tone exposure technology is used to make it possible to repeatedly use one photomask to treat the scan line formation process and the contact formation process as well as the scan line formation process and the etch stop layer or semiconductor layer formation process.

Claim 24 is a manufacturing method for a liquid crystal display device recited in Claim 1 characterized by the fact that the formation of source and drain wires and a pixel electrode comprise:
a process for forming a photosensitive organic insulating layer pattern thicker at a signal line than other regions corresponding to a source wire (signal line), a drain wire comprising a pixel electrode, an electrode terminal of a scan line, and an electrode terminal of a signal line comprising a part of a signal line after depositing a transparent conductive layer and a low resistance metal layer,
a process for forming electrode terminals for a scan line and a signal line, and source and drain wires using the aforementioned photosensitive organic insulating layer pattern as a mask,
a process for decreasing a thickness of the aforementioned photosensitive organic insulating layer pattern to expose a low resistance metal layer on electrode terminals for a scan line and a signal line and on a pixel electrode, and
a process for removing an exposed low resistance metal layer using the aforementioned photosensitive organic insulating layer pattern whose thickness was reduced as a mask, and forming a transparent conductive pixel electrode and transparent conductive electrode terminals of a scan line and a signal line.

Through this construction, it is possible to form a source wire of an insulating gate type transistor comprising a laminate made of a transparent conductive layer and a low resistance metal layer, and a transparent conductive pixel electrode on an active substrate using one photomask. A passivation part is required on the active substrate to protect the active substrate and a scan line in addition to the source and drain wires; embodiments may be constructed for a variety of manufacturing methods corresponding to the differences in the formation sequence and the formation method of the scan line, gate insulating layer and semiconductor layer, and these are described in detail in Claim 27, Claim 29, Claim 31, Claim 33, Claim 35, and Claim 37.

Claim 25 is also the manufacturing method for the liquid crystal display device recited in Claim 1, wherein formation of source and drain wires and a pixel electrode comprise,
a process for forming a photosensitive resin pattern thinner at a signal line than other regions corresponding to a source wire (signal line), a drain wire comprising a pixel electrode, an electrode terminal of a scan line, and an electrode terminal of a signal line comprising a part of a signal line after depositing a transparent conductive layer and an anodizable low resistance metal layer,
a process for forming electrode terminals for a scan line and a signal line, and source and drain wires using the aforementioned photosensitive resin pattern as a mask,
a process for decreasing a thickness of the aforementioned photosensitive resin pattern to expose a signal line,
a process for forming an anodized layer on an exposed signal line using the aforementioned photosensitive resin pattern whose thickness was reduced as a mask, and
a process for removing the aforementioned photosensitive resin pattern whose thickness was reduced, removing a low resistance metal layer using the aforementioned anodized layer as a mask, and forming a transparent conductive pixel electrode, and transparent conductive electrode terminals of a scan line and a signal line.

Through this construction, it is possible to form a source wire of an insulating gate type transistor comprising a laminate made of a transparent conductive layer and a low resistance metal layer, and a transparent conductive pixel electrode on an active substrate using one photomask. A passivation part is required on the active substrate to protect the active substrate and a scan line in addition to the source and drain wires; embodiments may be constructed for a variety of manufacturing methods corresponding to the differences in the formation sequence and the formation method of the scan line, gate insulating layer and semiconductor layer, and these are described in detail in Claim 28, Claim 30, Claim 32, Claim 34, Claim 36, Claim 38, Claim 40, Claim 42, Claim 44, Claim 46, Claim 48, and Claim 50.

Claim 26 is also the manufacturing method for the liquid crystal display device recited in Claim 1, wherein formation of source and drain lines and a pixel electrode comprise
a process for forming a photosensitive resin pattern thinner at least at a pixel electrode than at a signal line corresponding to a source wire (signal line), a drain wire comprising a pixel electrode, an electrode terminal of a scan line, and an electrode terminal of a signal line comprising a part of a signal line after depositing a transparent conductive layer and a low resistance metal layer,
a process for forming electrode terminals for a scan line and a signal line, and source and drain wires using the aforementioned photosensitive resin pattern as a mask,
a process for reducing a thickness of the aforementioned photosensitive resin pattern to expose a low resistance metal layer on a pixel electrode, and
a process for removing an exposed low resistance metal layer using the aforementioned photosensitive resin pattern whose thickness was reduced as a mask, and forming a transparent conductive pixel electrode.

Through this construction, it is possible to form a source wire of an insulating gate type transistor comprising a laminate made of a transparent conductive layer and a low resistance metal layer, and a transparent conductive pixel electrode on an active substrate using one photomask. A passivation part is required on the active substrate to protect the active substrate and a scan line in addition to the source and drain wires; embodiments may be constructed for a variety of manufacturing methods corresponding to the differences in the formation sequence and the formation method of the scan line, gate insulating layer and semiconductor layer, and these are described in detail in Claim 39, Claim 41, Claim 43, Claim 45, Claim 47, and Claim 49.

Claim 27 is the manufacturing method for the liquid crystal display device recited in Claim 2, characterized by the fact of having a process for forming a scan line, a process for forming an etch stop layer, a process for forming a semiconductor layer, a process for forming a contact, a process for forming a signal line and a pixel electrode with half-tone exposure technology using one photomask, and a process for selectively leaving a photosensitive organic insulating layer only on a signal line.

Through this construction, the photosensitive organic insulating layer is selectively left only on the signal line when the pixel electrode and the signal line are formed using one photomask so that the manufacturing process for forming a passivating insulating layer is unneeded and is eliminated, the result of which is that it is possible to produce a TN-type liquid crystal display device using five photomasks.

Claim 28 is the manufacturing method for the liquid crystal display device recited in Claim 3, characterized by the fact of having a process for forming a scan line, a process for forming an etch stop layer, a process for forming a semiconductor layer, a process for forming a contact, a process for forming a signal line and a pixel electrode with half-tone exposure technology using one photomask, and a process for protecting elements other than the signal line from anodization.

Through this construction, the anodized layer is formed only on the signal line when the pixel electrode and the signal line are formed using one photomask so that the manufacturing process for forming a passivating insulating layer is unneeded and is eliminated, the result of which is that it is possible to manufacture a TN-type liquid crystal display device using five photomasks.

Claim 29 is also the manufacturing method for the liquid crystal display device recited in Claim 2, characterized by the fact of having a process for forming a scan line, a process for forming an etch stop layer, a process for forming a contact and a semiconductor layer with half-tone exposure technology using one photomask, a process for forming a pixel electrode and a signal line with half-tone exposure technology using one photomask, and a process for selectively leaving a photosensitive organic insulating layer on the signal line.

Through this construction, the photosensitive organic insulating layer is selectively left only on the signal line when the pixel electrode and the signal line are formed using one photomask so that the manufacturing process for forming a passivating insulating layer is unneeded and is eliminated, and the manufacturing process for forming a contact and semiconductor layer with one photomask is reduced at the same time, so that it is possible to manufacture a TN-type liquid crystal display device using four photomasks.

Claim 30 is also the manufacturing method for the liquid crystal display device recited in Claim 3, characterized by having a process for forming a scan line, a process for forming an etch stop layer, a process for forming a contact and a semiconductor layer with half-tone exposure technology using one photomask, a process for forming a pixel electrode and a signal line with half-tone exposure technology using one photomask, and a process for protecting elements other than the signal line from anodization.

Through this construction, the anodized layer is selectively formed only on the signal line when the pixel electrode and the signal line are formed using one photomask so that the manufacturing process for forming a passivating insulating layer is unneeded and is eliminated, and the manufacturing process for forming a contact and semiconductor layer with one photomask is reduced at the same time, so that it is possible to manufacture a TN-type liquid crystal display device using four photomasks.

Claim 31 is the manufacturing method for the liquid crystal display device recited in Claim 4, characterized by the fact of having a process for forming a scan line, a process for forming a contact and an etch stop layer with half-tone exposure technology using one photomask, a process for forming a semiconductor layer, a process for forming a pixel electrode and a signal line with half-tone exposure technology using one photomask, and a process for selectively leaving a photosensitive organic insulating layer only on the signal line.

Through this construction, the photosensitive organic insulating layer is selectively left only on the signal line when the pixel electrode and the signal line are formed using one photomask so that the manufacturing process for forming a passivating insulating layer is unneeded and is eliminated, and the manufacturing process for forming an etch stop layer and a contact with one photomask is reduced at the same time, so that it is possible to manufacture a TN-type liquid crystal display device using four photomasks.

Claim 32 is the manufacturing method for the liquid crystal display device recited in Claim 5, characterized by the fact of having a process for forming a scan line, a process for forming a contact and an etch stop layer with half-tone exposure technology using one photomask, a process for forming a semiconductor layer, a process for forming a pixel electrode and a signal line with half-tone exposure technology using one photomask, and a process for protecting elements other than the signal line from anodization.

Through this construction, the anodized layer is selectively formed only on the signal line when the pixel electrode and the signal line are formed using one photomask so that the manufacturing process for forming a passivating insulating layer is unneeded and is eliminated, and the manufacturing process for forming an etch stop layer and a contact with one photomask is reduced at the same time, so that it is possible to manufacture a TN-type liquid crystal display device using four photomasks.

Claim 33 is the manufacturing method for the liquid crystal display device recited in Claim 6, characterized by the fact of having a process for forming a scan line and a contact with half-tone exposure technology using one photomask, a process for forming an etch stop layer, a process for forming a semiconductor layer, a process for forming a pixel electrode and a signal line with half-tone exposure technology using one photomask, and a process for selectively leaving a photosensitive organic insulating layer only on a signal line.

Through this construction, the photosensitive organic insulating layer is selectively left only on the signal line when the pixel electrode and the signal line are formed using one photomask so that the manufacturing process for forming a passivating insulating layer is unneeded and is eliminated, and the manufacturing process for forming a scan layer and a contact with one photomask is reduced at the same time, so that it is possible to manufacture a TN-type liquid crystal display device using four photomasks.

Claim 34 is the manufacturing method for the liquid crystal display device recited in Claim 7, characterized by the fact of having a process for forming a scan line and a contact with half-tone exposure technology using one photomask, a process for forming an etch stop layer, a process for forming a semiconductor layer, a process for forming a pixel electrode and a signal line with half-tone exposure technology using one photomask, and a process for protecting elements other than the signal line from anodization.

Through this construction, the anodized layer is selectively formed only on the signal line when the pixel electrode and the signal line are formed using one photomask so that the manufacturing process for forming a passivating insulating layer is unneeded and is eliminated, and the manufacturing process for forming a scan line and a contact with one photomask is reduced at the same time, so that it is possible to manufacture a TN-type liquid crystal display device using four photomasks.

Claim 35 is the manufacturing method for the liquid crystal display device recited in Claim 8, characterized by the fact of having a process for forming a scan line and an etch stop layer with half-tone exposure technology using one photomask, a process for forming a contact and a semiconductor layer with half-tone exposure technology using one photomask, a process for forming a pixel electrode and a signal line with half-tone exposure technology using one photomask, and a process for selectively leaving a photosensitive organic insulating layer only on a signal line.

Through this construction, the photosensitive organic insulating layer is selectively left only on the signal line when the pixel electrode and the signal line are formed using one photomask so that the manufacturing process for forming a passivating insulating layer is unneeded and is eliminated, and the manufacturing process for forming a scan line and an etch stop layer with one photomask is reduced, and the manufacturing process for forming a contact and a semiconductor layer with one photomask is reduced at the same time, so that it is possible to manufacture a TN-type liquid crystal display device using three photomasks.

Claim 36 is the manufacturing method for the liquid crystal display device recited in Claim 9, characterized by the fact of having a process for forming a scan line and an etch stop layer with half-tone exposure technology using one photomask, a process for forming a contact and a semiconductor layer with half-tone exposure technology using one photomask, a process for forming a pixel electrode and a signal line with half-tone exposure technology using one photomask, and a process for protecting elements other than the signal line from anodization.

Through this construction, the anodized layer is selectively formed only on the signal line when the pixel electrode and the signal line are formed using one photomask so that the manufacturing process for forming a passivating insulating layer is unneeded and is eliminated, and the manufacturing process for forming a scan line and an etch stop layer with one photomask is reduced, and the manufacturing process for forming a contact and a semiconductor layer with one photomask is reduced at the same time, so that it is possible to manufacture a TN-type liquid crystal display device using three photomasks.

Claim 37 is the manufacturing method for the liquid crystal display device recited in Claim 10, characterized by the fact of having a process for forming an etch stop layer, a process for forming a scan line and a contact with half-tone exposure technology using one photomask, a process for forming a pixel electrode and a signal line with half-tone exposure technology using one photomask, and a process for selectively leaving a photosensitive organic insulating layer only on the signal line.

Through this construction, the photosensitive organic insulating layer is selectively left only on the signal line when the pixel electrode and the signal line are formed using one photomask so that the manufacturing process for forming a passivating insulating layer is unneeded and is eliminated, and the manufacturing process for forming a scan line and a contact with one photomask and is reduced at the same time, so that it is possible to manufacture a TN-type liquid crystal display device using three photomasks.

Claim 38 is the manufacturing method for the liquid crystal display device recited in Claim 11, characterized by the fact of having a process for forming an etch stop layer, a process for forming a scan line and a contact with half-tone exposure technology using one photomask, a process for forming a pixel electrode and a signal line with half-tone exposure technology using one photomask, and a process for protecting elements other than the signal line from anodization.

Through this construction, the anodization layer is selectively formed only on the signal line when the pixel electrode and the signal line are formed using one photomask so that the manufacturing process for forming a passivating insulating layer is unneeded and is eliminated, and the manufacturing process for forming a scan line and a contact with one photomask is reduced at the same time, so that it is possible to manufacture a TN-type liquid crystal display device using three photomasks.

Claim 39 is the manufacturing method for the liquid crystal display device recited in Claim 12, characterized by the fact of having a process for forming a scan line, a process for forming a semiconductor layer, a process for forming a contact, a process for forming a signal line and a pixel electrode with half-tone exposure technology using one photomask, and a process for forming a passivating insulating layer.

Through this construction, the manufacturing process for forming a pixel electrode and a signal line with one photomask is reduced, the result of which is that it is possible to produce a TN-type liquid crystal display device using five photomasks.

Claim 40 is the manufacturing method for the liquid crystal display device recited in Claim 13, characterized by the fact of having a process for forming a scan line, a process for forming a semiconductor layer, a process for forming a contact, a process for forming a signal line and a pixel electrode with half-tone exposure technology using one photomask, and a process for protecting elements other than the signal line and the channel from anodization.

Through this construction, the anodized layer is formed only on the signal line and on the channel when the pixel electrode and the signal line are formed using one photomask so that the manufacturing process for forming a passivating insulating layer is unneeded and is eliminated, making it possible to manufacture a TN-type liquid crystal display device using four photomasks.

Claim 41 is also the manufacturing method for the liquid crystal display device recited in Claim 12, characterized by the fact of having a process for forming a scan line, a process for forming a semiconductor layer and a contact with half-tone exposure technology using one photomask, a process for forming a pixel electrode and a signal line with half-tone exposure technology using one photomask, and a process for forming a passivating insulating layer.

Through this construction, the manufacturing process for forming a pixel electrode and a signal line with one photomask is reduced, and the manufacturing process for forming a contact and a semiconductor layer with one photomask is reduced at the same time, making it possible to manufacture a TN-type liquid crystal display device using four photomasks.

Claim 42 is also the manufacturing method for the liquid crystal display device recited in Claim 13, characterized by the fact of having a process for forming a scan line, a process for forming a semiconductor layer and a contact with half-tone exposure technology using one photomask, a process for forming a pixel electrode and a signal line with half-tone exposure technology using one photomask, and a process for protecting elements other than the signal line and the channel from anodization.

Through this construction, the anodized layer is formed only on the signal line and on the channel when the pixel electrode and the signal line are formed using one photomask so that the manufacturing process for forming a passivating insulating layer is unneeded and is eliminated, and the manufacturing process for forming a contact and semiconductor layer using one photomask is reduced at the same time, making it possible to manufacture a TN-type liquid crystal display device using three photomasks.

Claim 43 is the manufacturing method for the liquid crystal display device recited in Claim 14, characterized by the fact of having a process for forming a scan line and a contact with half-tone exposure technology using one photomask, a process for forming a semiconductor layer, a process for forming a pixel electrode and a signal line with half-tone exposure technology using one photomask, and a process for forming a passivating insulating layer.

Through this construction, the manufacturing process for forming a pixel electrode and a signal line with one photomask is reduced, and the manufacturing process for forming a contact and a scan line with one photomask is reduced at the same time, making it possible to manufacture a TN-type liquid crystal display device using four photomasks.

Claim 44 is the manufacturing method for the liquid crystal display device recited in Claim 15, characterized by the fact of having a process for forming a scan line and a contact with half-tone exposure technology using one photomask, a process for forming a semiconductor layer, a process for forming a pixel electrode and a signal line with half-tone exposure technology using one photomask, and a process for protecting elements other than the signal line and the channel from anodization.

Through this construction, the anodized layer is formed only on the signal line and on the channel when the pixel electrode and the signal line are formed using one photomask so that the manufacturing process for forming a passivating insulating layer is unneeded and is eliminated, and the manufacturing process for forming a contact and scan line using one photomask is reduced at the same time, making it possible to manufacture a TN-type liquid crystal display device using three photomasks.

Claim 45 is the manufacturing method for the liquid crystal display device recited in Claim 16, characterized by the fact of having a process for forming a scan line and a semiconductor layer with half-tone exposure technology using one photomask, a process for forming a contact, a process for forming a pixel electrode and a signal line with half-tone exposure technology using one photomask, and a process for forming a passivating insulating layer.

Through this construction, the manufacturing process for forming a pixel electrode and a signal line with one photomask is reduced, and the manufacturing process for forming a semiconductor layer and a scan line with one photomask is reduced at the same time, making it possible to manufacture a TN-type liquid crystal display device using four photomasks.

Claim 46 is the manufacturing method for the liquid crystal display device recited in Claim 17, characterized by the fact of having a process for forming a scan line and a semiconductor layer with half-tone exposure technology using one photomask, a process for forming a contact, a process for forming a pixel electrode and a signal line with half-tone exposure technology using one photomask, and a process for protecting elements other than the signal line and the channel from anodization.

Through this construction, the anodized layer is selectively formed only on the signal line and on the channel when the pixel electrode and the signal line are formed using one photomask so that the manufacturing process for forming a passivating insulating layer is unneeded and is eliminated, and the manufacturing process for forming a semiconductor layer and a scan line using one photomask is reduced at the same time, making it possible to manufacture a TN-type liquid crystal display device using three photomasks.

Claim 47 is the manufacturing method for the liquid crystal display device recited in Claim 18, characterized by the fact of having a process for forming a semiconductor layer, a process for forming a scan line and a contact with half-tone exposure technology using one photomask, a process for forming a pixel electrode and a signal line with half-tone exposure technology using one photomask, and a process for forming a passivating insulating layer.

Through this construction, the manufacturing process for forming a pixel electrode and a signal line with one photomask is reduced, and the manufacturing process for forming a scan line and a contact with one photomask is reduced at the same time, making it possible to manufacture a TN-type liquid crystal display device using four photomasks.

Claim 48 is the manufacturing method for the liquid crystal display device recited in Claim 19, characterized by the fact of having a process for forming a semiconductor layer, a process for forming a scan line and a contact with half-tone exposure technology using one photomask, a process for forming a pixel electrode and a signal line with half-tone exposure technology using one photomask, and a process for protecting elements other than the signal line and the channel from anodization.

Through this construction, the anodized layer is selectively formed only on the signal line and on the channel when the pixel electrode and the signal line are formed using one photomask so that the manufacturing process for forming a passivating insulating layer is unneeded and is eliminated, and the manufacturing process for forming a contact and a scan line using one photomask is reduced at the same time, making it possible to manufacture a TN-type liquid crystal display device using three photomasks.

Claim 49 is the manufacturing method for the liquid crystal display device recited in Claim 20, characterized by the fact of having a process for forming a scan line and a semiconductor layer with half-tone exposure technology using one photomask, a process for exposing a scan line, a process for forming a pixel electrode and a signal line with half-tone exposure technology using one photomask, and a process for forming a passivating insulating layer.

Through this construction, the manufacturing process for forming a pixel electrode and a signal line with one photomask is reduced, and the manufacturing process for forming a scan line and a semiconductor layer with one photomask is reduced as well as the manufacturing process for forming a contact is unneeded because the scan line is exposed at the same time, making it possible to manufacture a TN-type liquid crystal display device using three photomasks.

Claim 50 is the manufacturing method for the liquid crystal display device recited in Claim 21, characterized by the fact of having a process for forming a scan line and a semiconductor layer with half-tone exposure technology using one photomask, a process for exposing a scan line, a process for forming a pixel electrode and a signal line with half-tone exposure technology using one photomask, a process for forming a pixel electrode and a signal line using one photomask, and a process for protecting elements other than the signal line and the channel from anodization.

Through this construction, the anodized layer is selectively formed only on the signal line and on the channel when the pixel electrode and the signal line are formed using one photomask so that the manufacturing process for forming a passivating insulating layer is unneeded and is eliminated, and the manufacturing process for forming a scan line and a semiconductor layer with one photomask is reduced as well as the manufacturing process for forming a contact is unneeded because the scan line is exposed at the same time, making it possible to manufacture a TN-type liquid crystal display device using two photomasks.

In a part of the liquid crystal display device described in the present invention, a insulating gate type transistor has a protective insulating layer on the channel, so a passivation function is provided in the active substrate by selectively forming a photosensitive organic insulating layer only on a signal line comprising a laminate made of a low resistance metal layer and a transparent conductive layer in an image display part or by anodizing a signal line comprising a laminate of a transparent conductive layer and an anodizable low resistance metal layer to form an insulating layer thereon. Similarly, in another part of the liquid crystal display device described in the present invention, a silicon oxide layer is formed through anodization on the channel, so a signal line comprising a laminate of a transparent conductive layer and an anodizable low resistance metal layer is anodized at the same time as a channel to form an insulating layer on its surface and thereby provide a passivation function to the active substrate. Accordingly, in the production of an active substrate composing these liquid crystal display devices, not only is a formation process of a passivating insulating layer unneeded, but excessive heat resistance is not needed in the insulating gate type transistor using a amorphous silicon layer as the semiconductor layer as processes with special heat are not used. To put it another way, effects are added wherein the electrical performance does not deteriorate in the formation of passivation. Also, in the formation of an anodized layer or a photosensitive organic insulating layer only on the signal line, it is possible to selectively protect the electrode terminals of the signal line and scan line by using half-tone exposure technology, so special effects are obtained that make it possible to further decrease the number of photographic etching processes.

The reduction of the formation process of the pixel electrode by selectively removing the low resistance metal layer on the drain wire after forming the source and drain wires comprising a laminate of the low resistance metal layer and the transparent conductive layer by introducing half-tone exposure technology is a main purpose of the present invention, and the construction of the electrode terminals of the scan line and the signal line with a transparent conductive layer provides a constructional characteristic.

This, coupled with the combination of streamlining technology to form a contact and an etch stop layer or a semiconductor layer using one photomask, streamlining technology to form a scan line and a contact with one photomask, and streamlining technology to form a scan line and an etch stop layer or a semiconductor layer with one photomask makes it possible to produce a liquid crystal display device with four or three photomasks, reduced from the conventional five photographic etching processes, and from the perspective of reducing costs in liquid crystal display devices, the present invention has an extremely high industrial value. Moreover, the pattern precision of these processes is not so high, so production control without greatly affecting quality or yield is an easy matter.

As is clear from the description above, the gist of the present invention is that for the formation process of the signal line and the pixel electrode in the production of an active substrate, a pixel electrode is formed by selectively removing a low resistance metal layer on a drain wire after forming source and drain wires comprising a laminate of a low resistance metal layer and a transparent conductive layer through the introduction of half-tone exposure technology, and for construction other than that, the fact that the semiconductor device for the display device with different film thickness or material such as the scan line or gate insulating layer, and differences in the manufacturing method therefor belong to the category of the present invention is self-evident, the usefulness of the present invention does not change for liquid crystal display devices using liquid crystal with a vertical aligned orientation or a reflecting-type liquid crystal display device, and the fact that the semiconductor layer for the insulating gate type transistor is not limited to amorphous silicon is also obvious.

Other objects, advantages, and novel features of the invention will become more apparent from the following detailed description when taken in conjunction with the accompanying drawings.

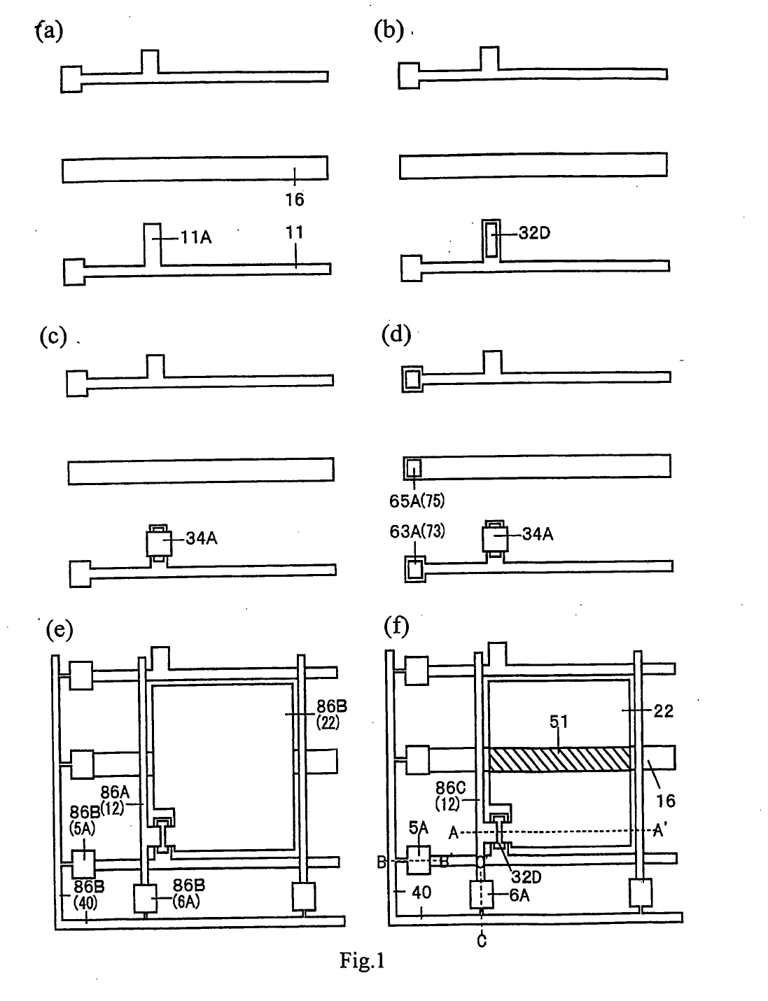

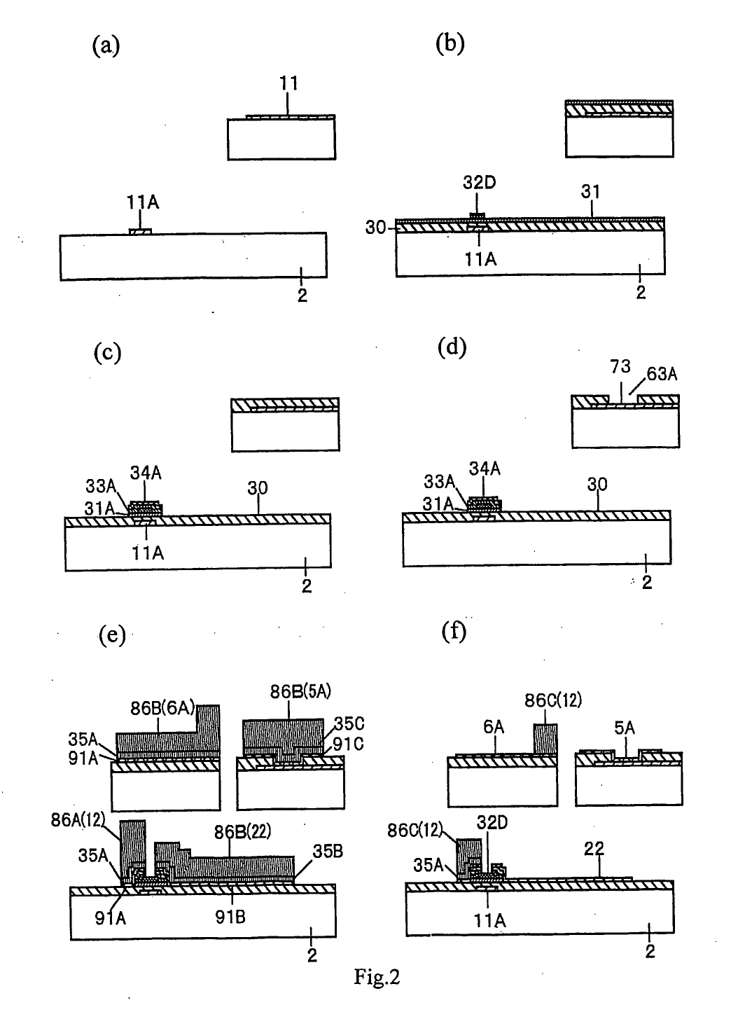

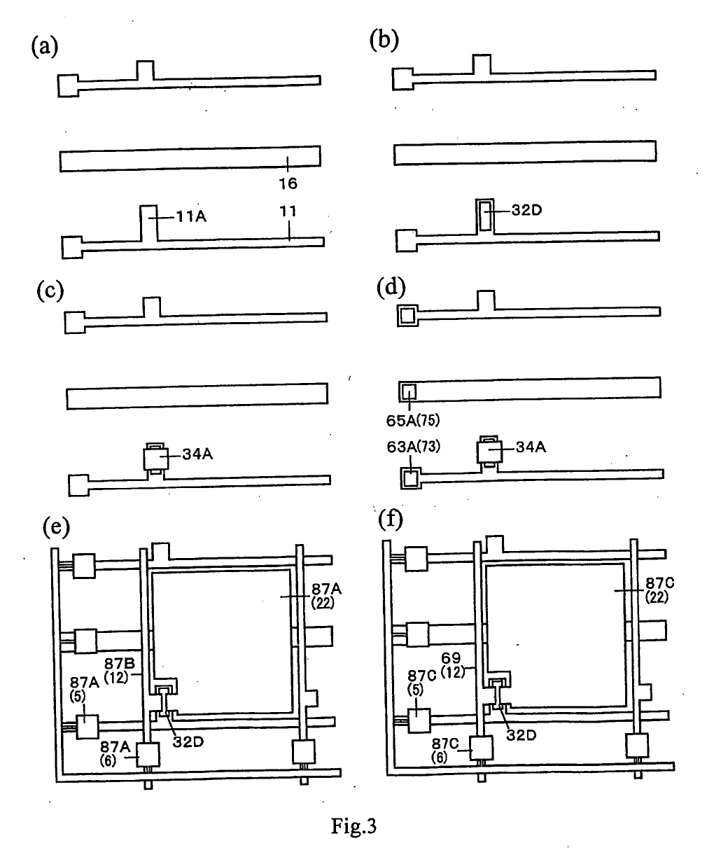

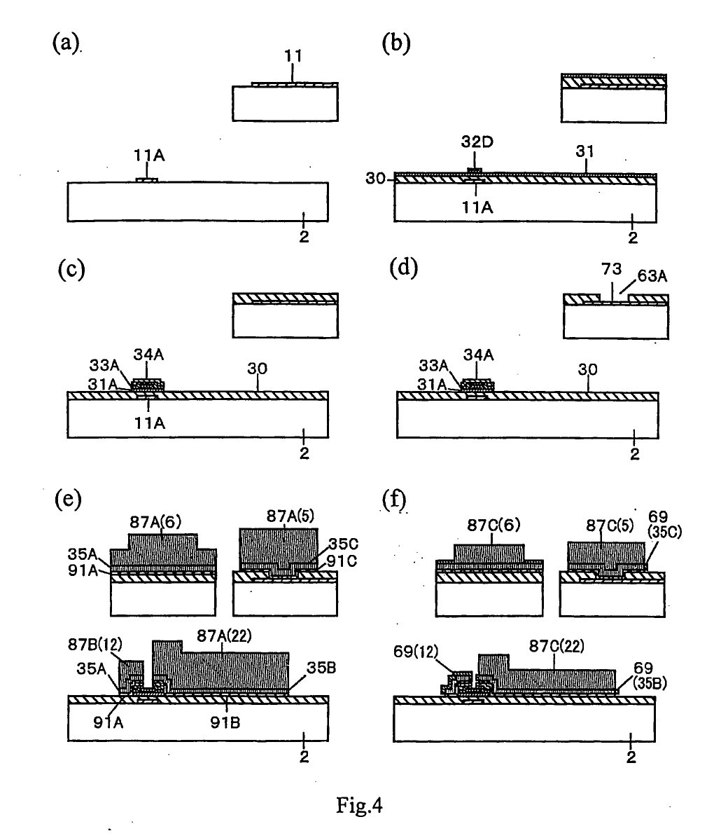

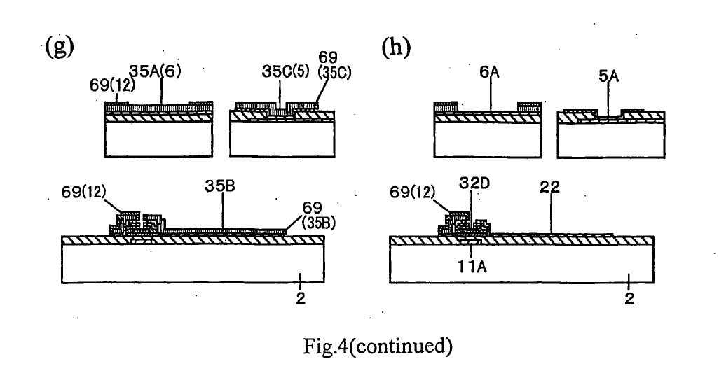

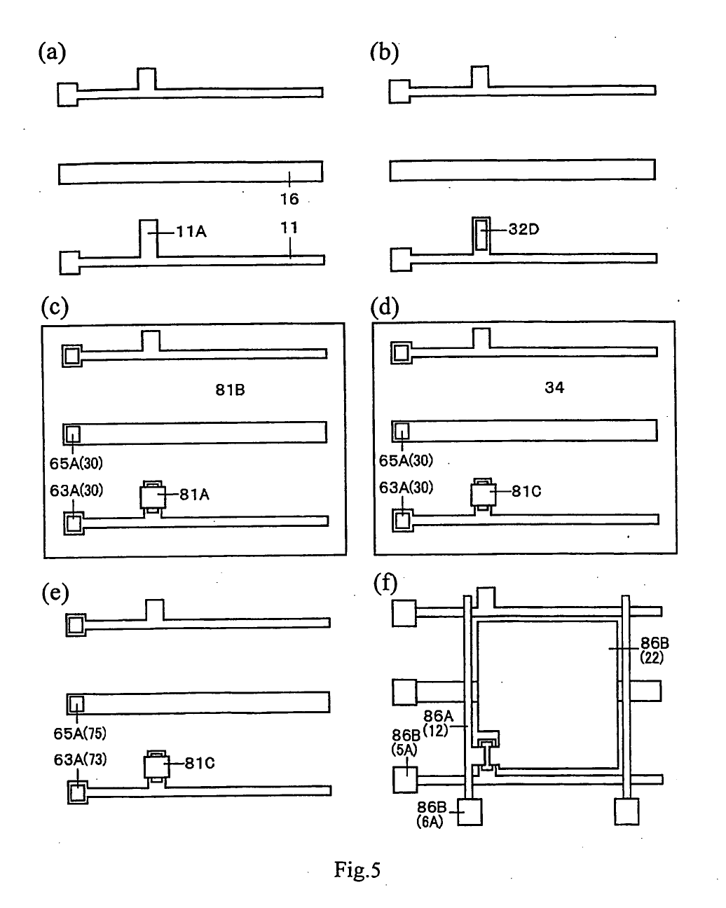

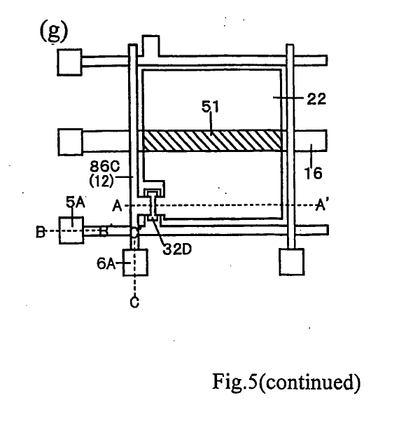

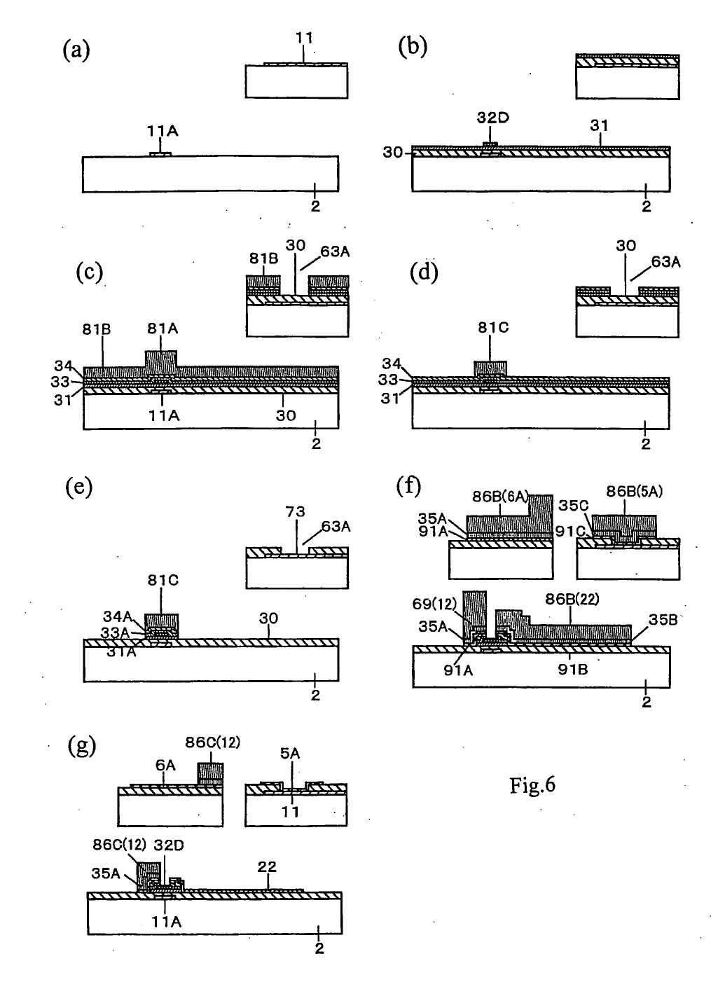

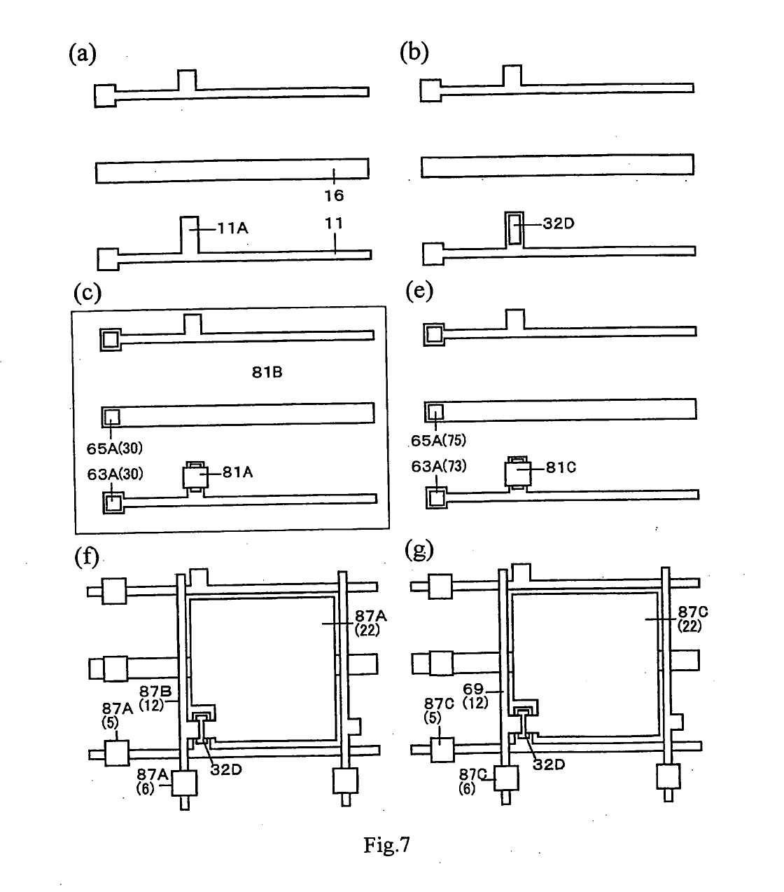

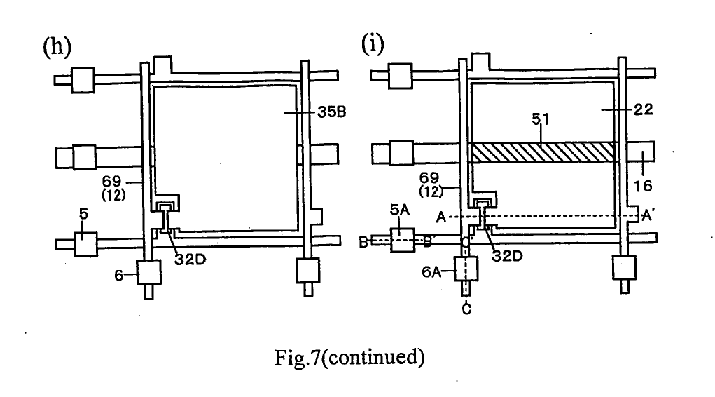

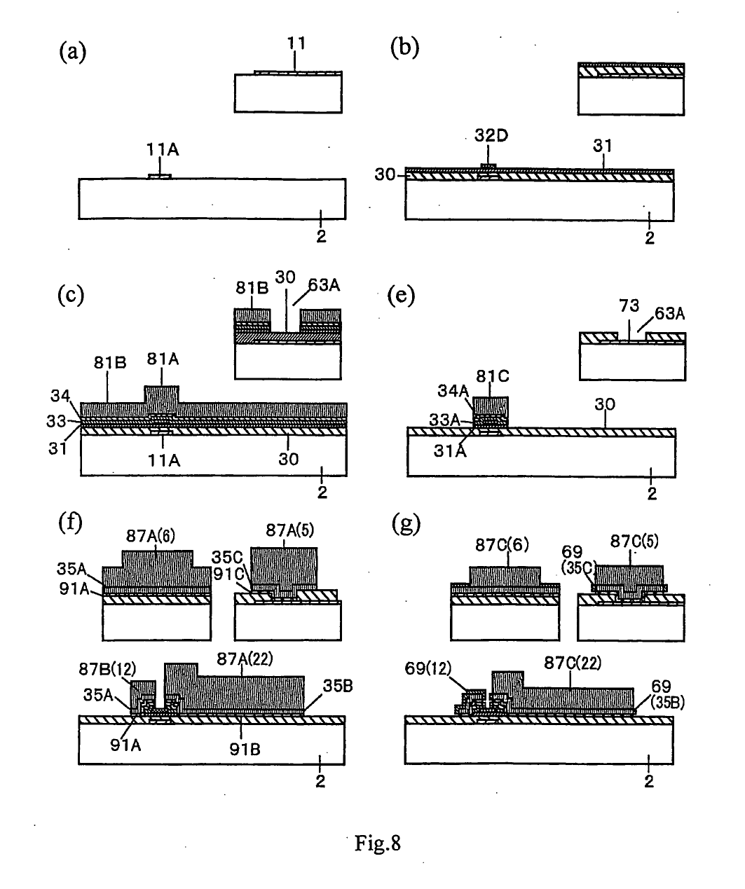

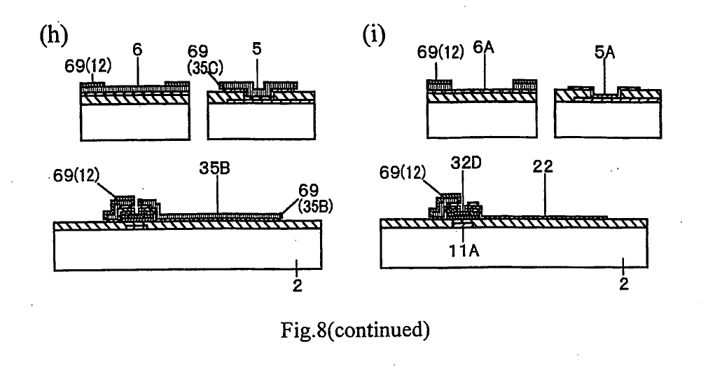

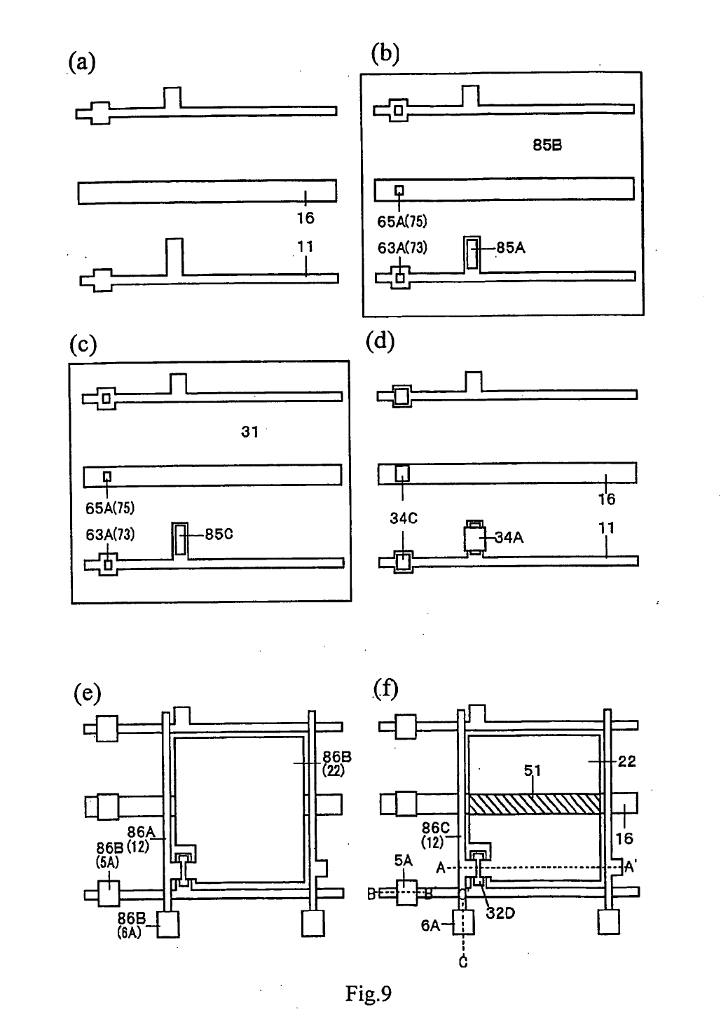

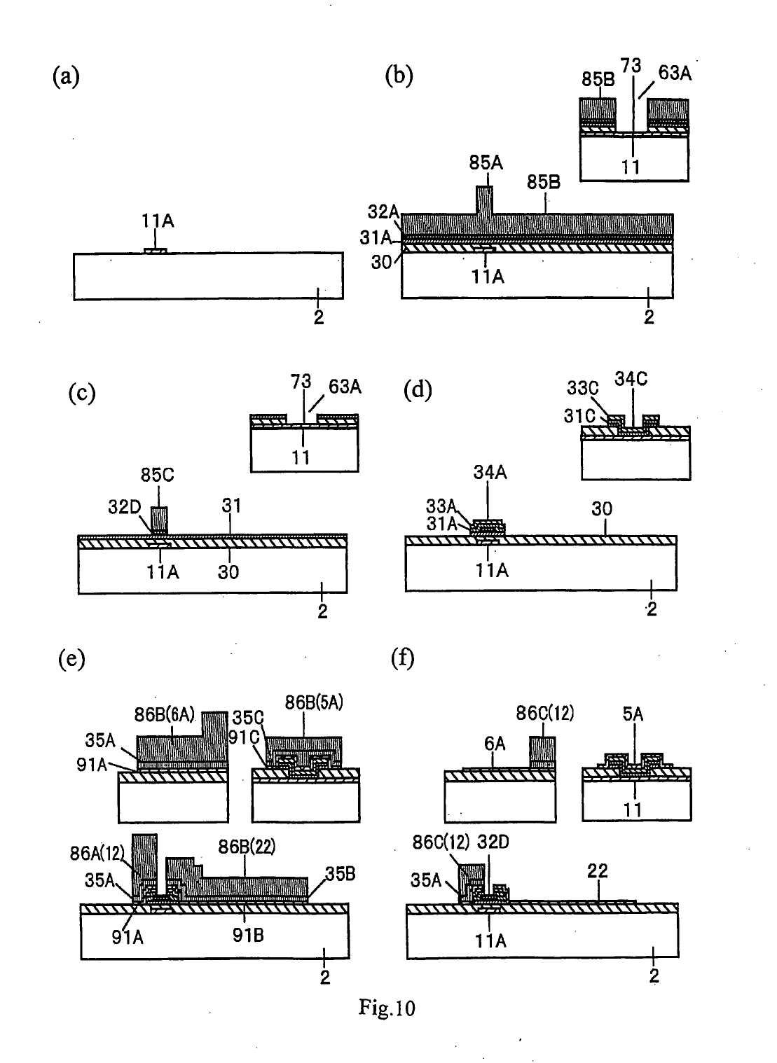

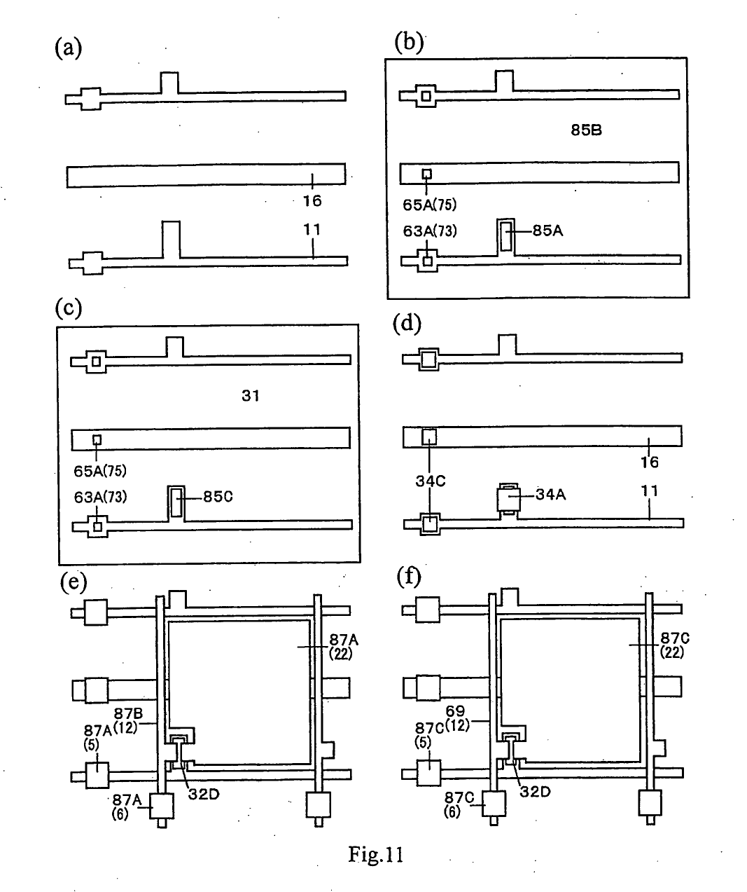

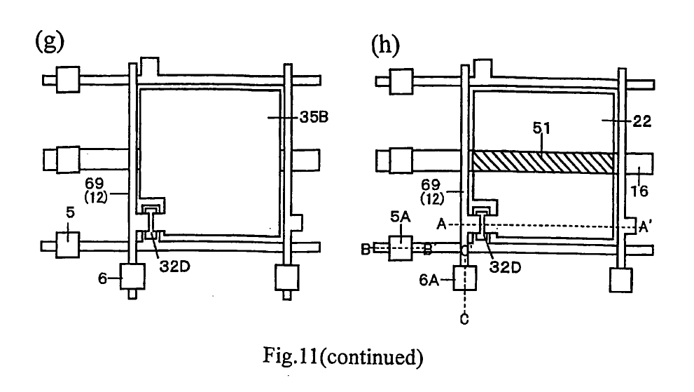

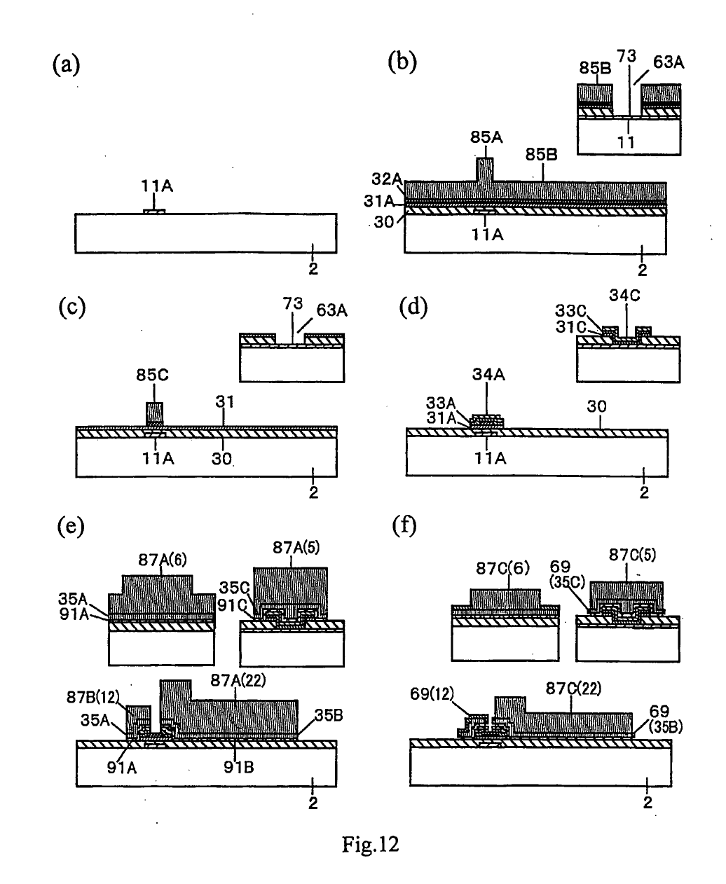

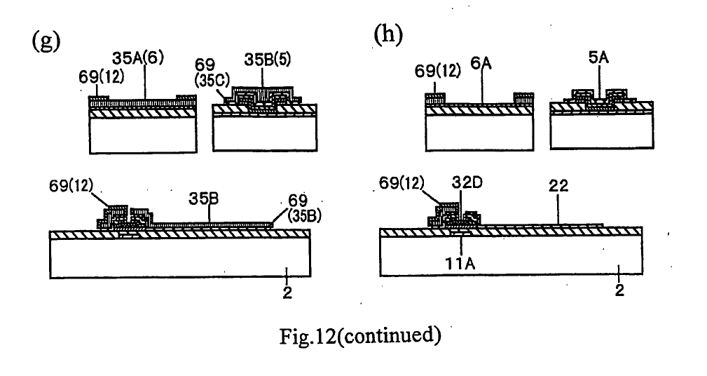

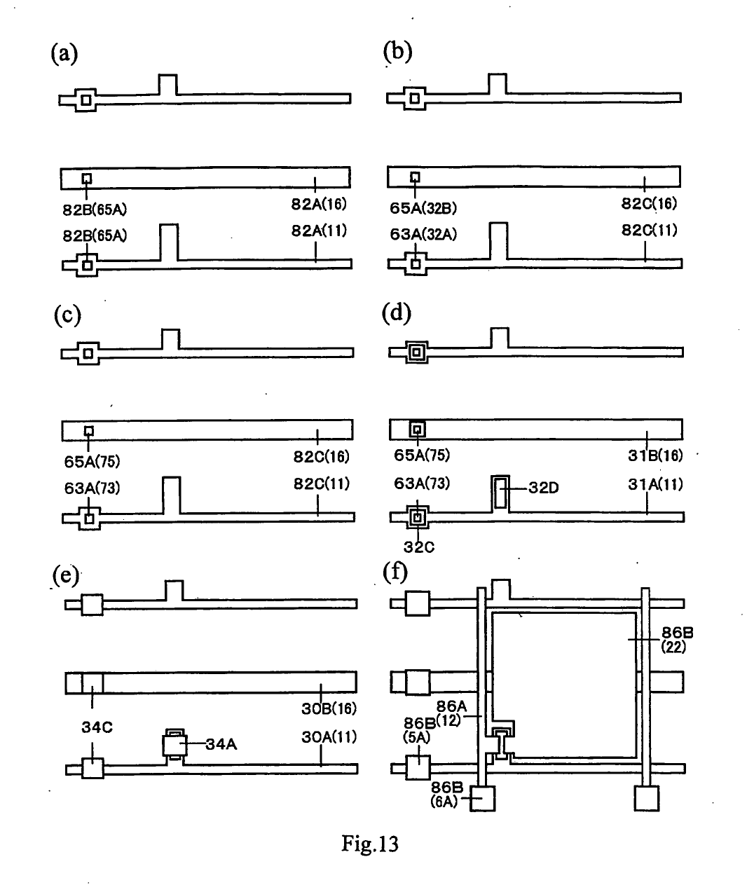

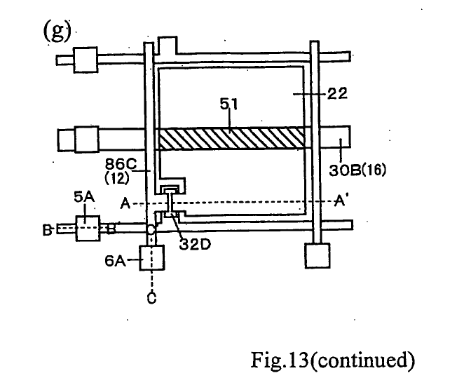

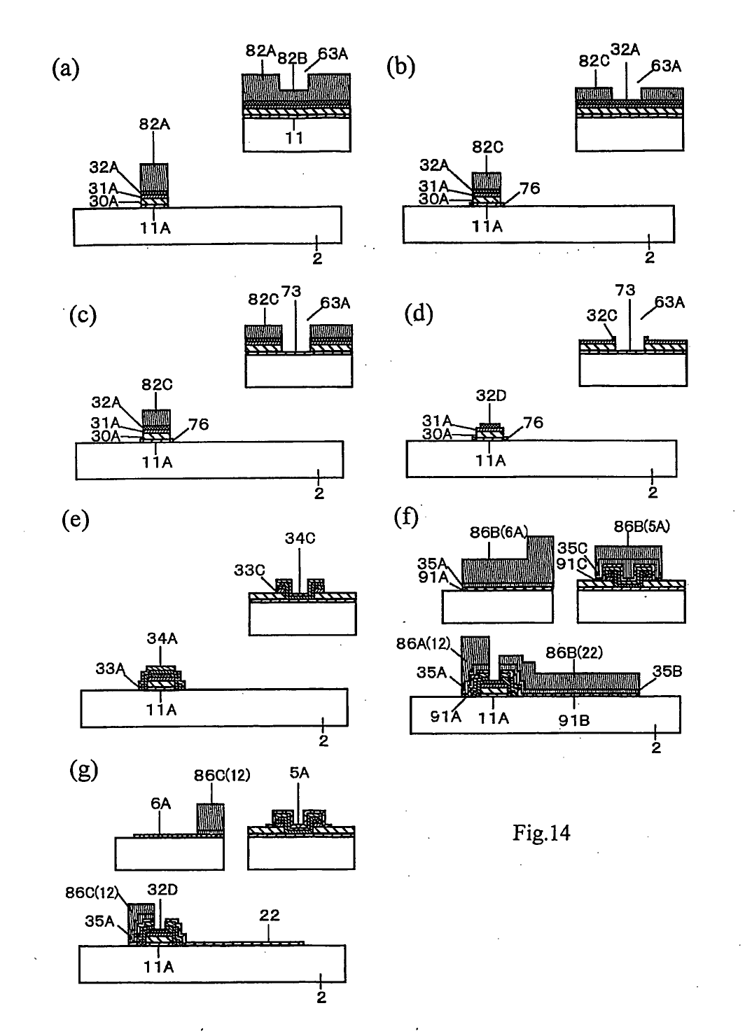

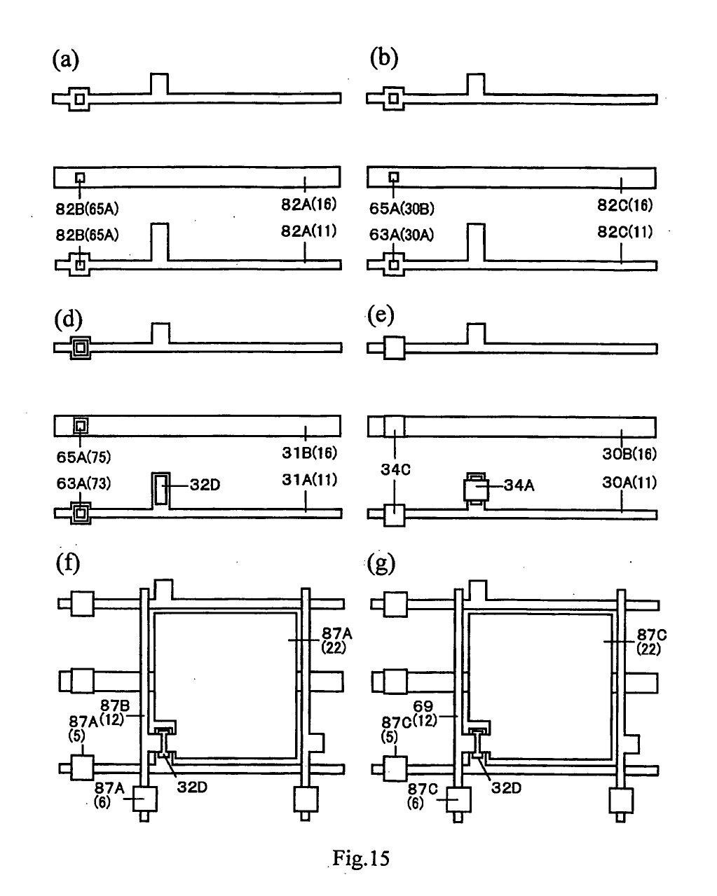

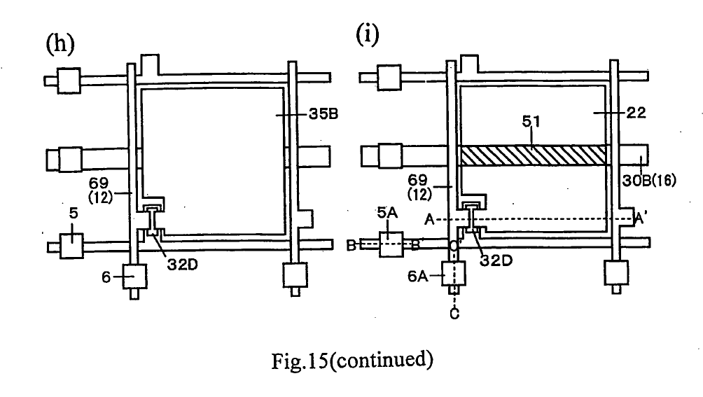

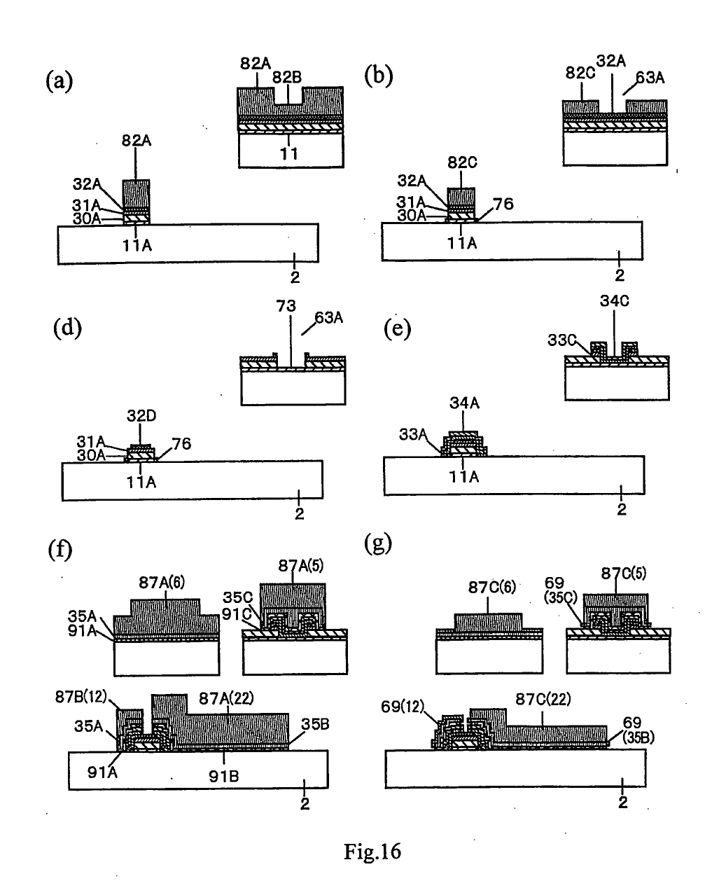

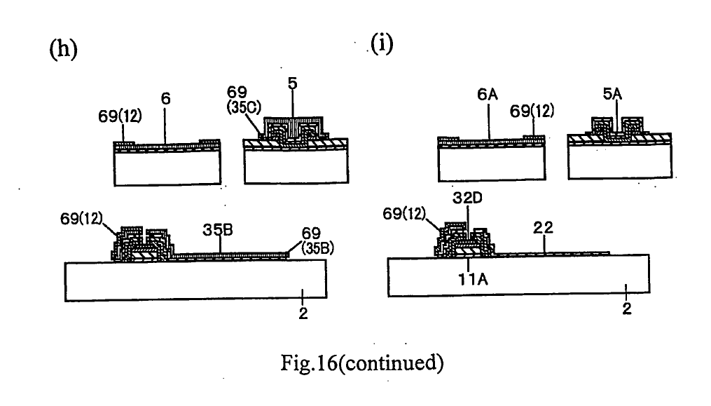

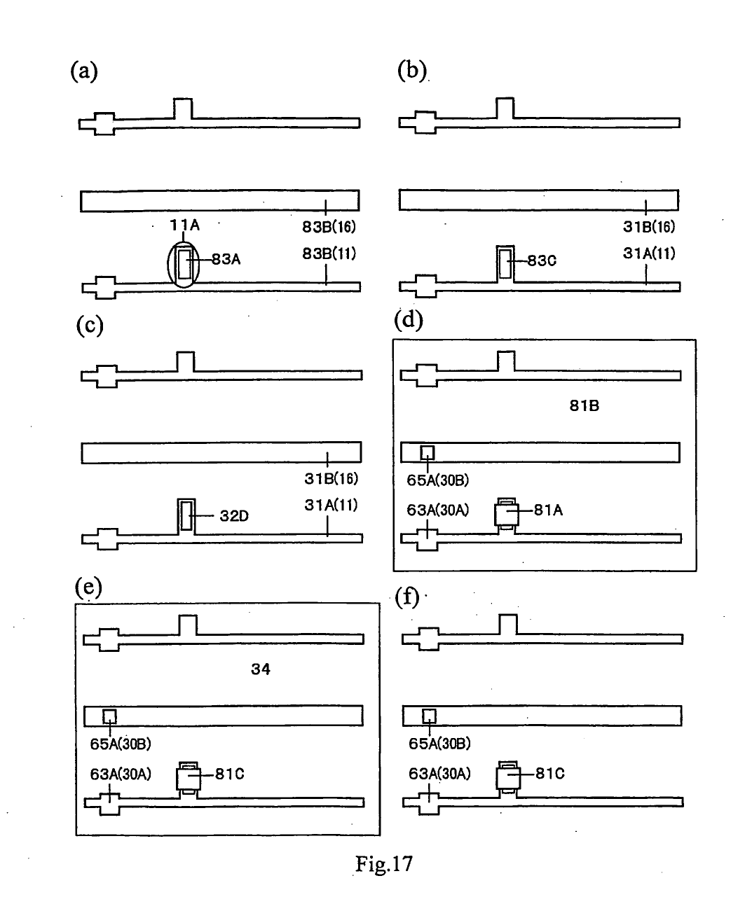

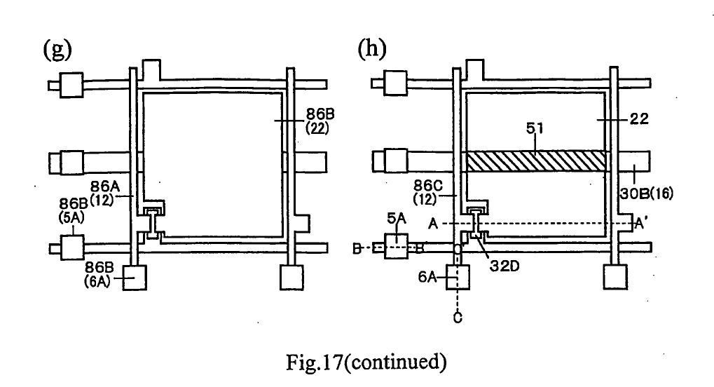

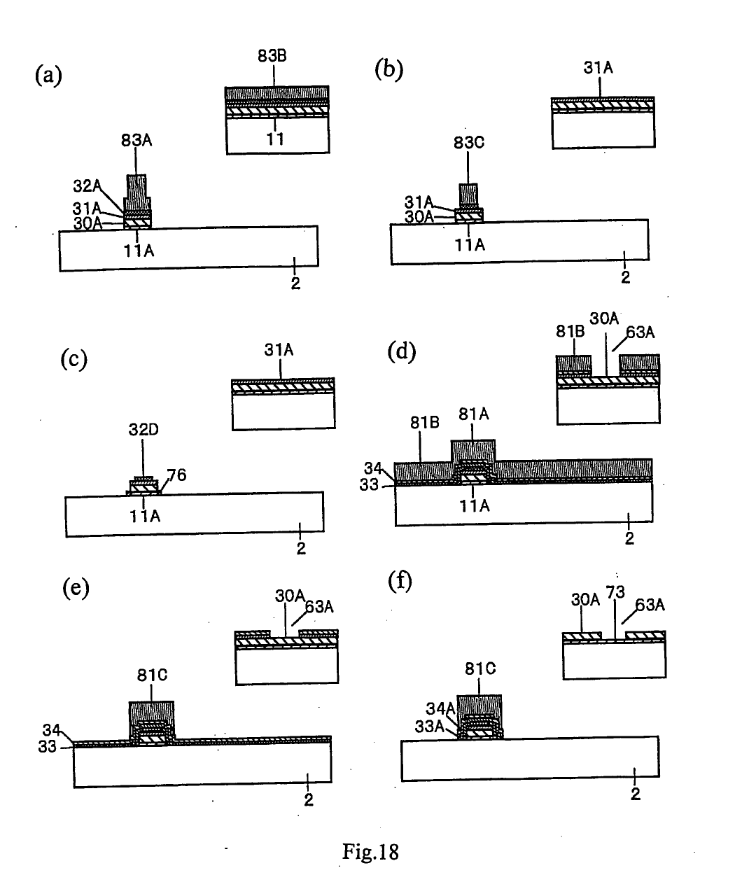

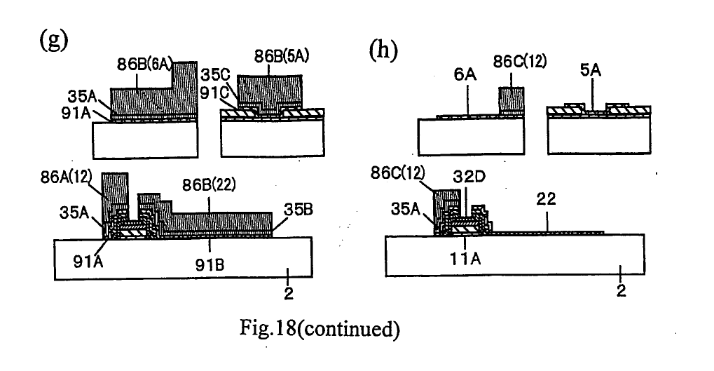

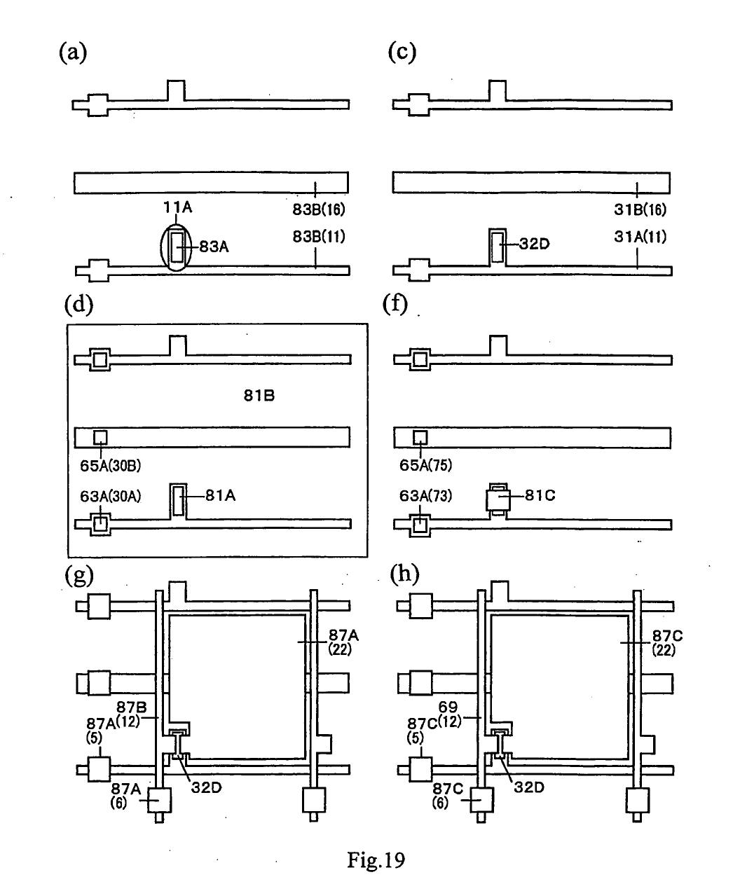

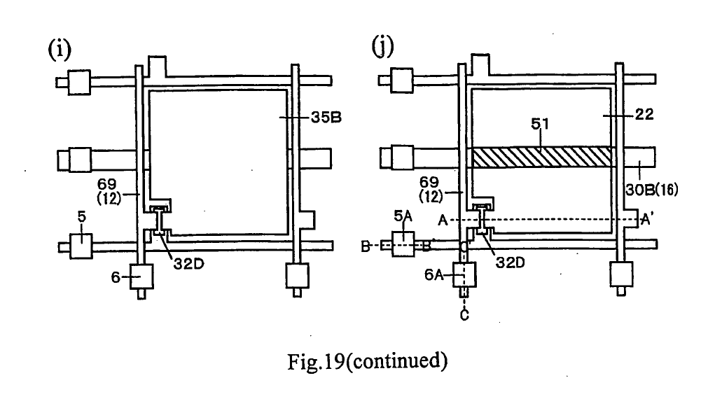

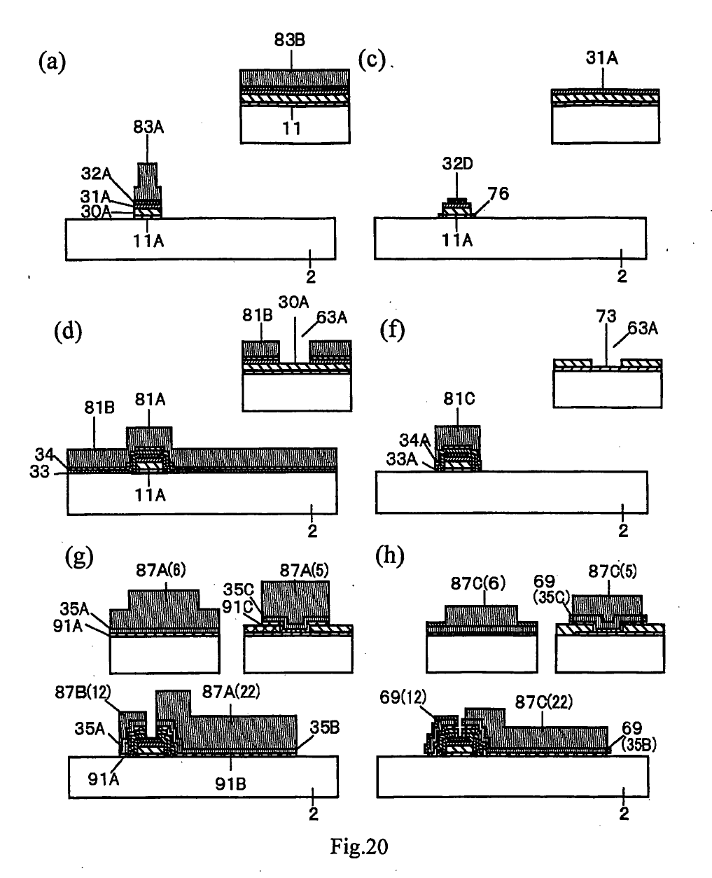

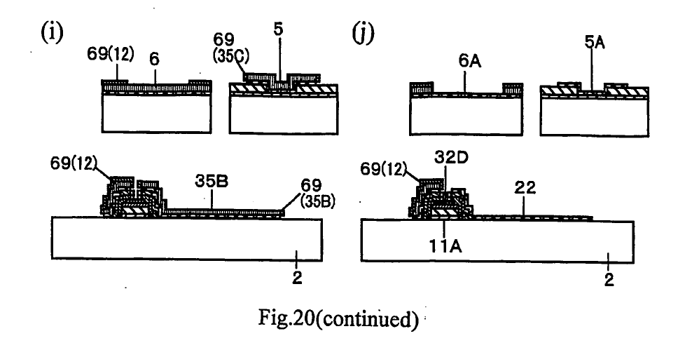

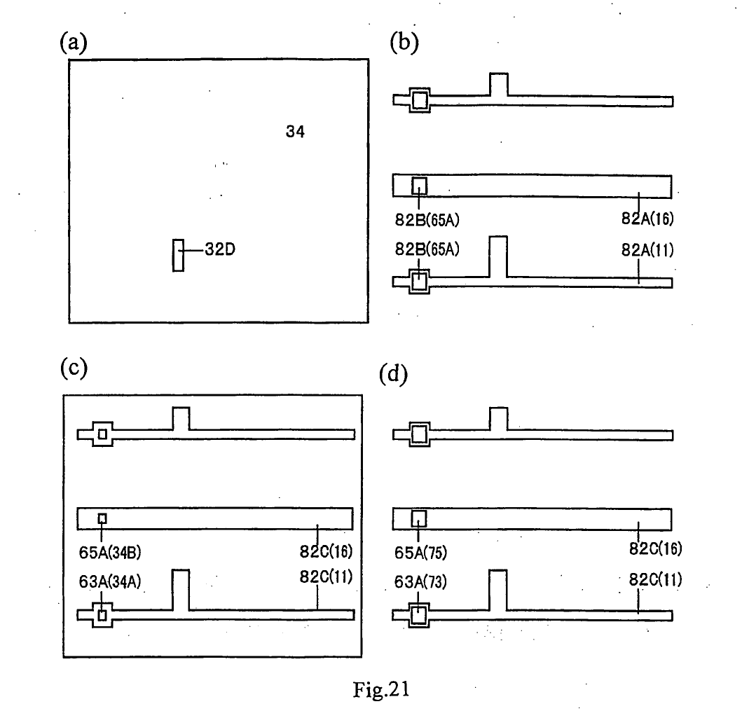

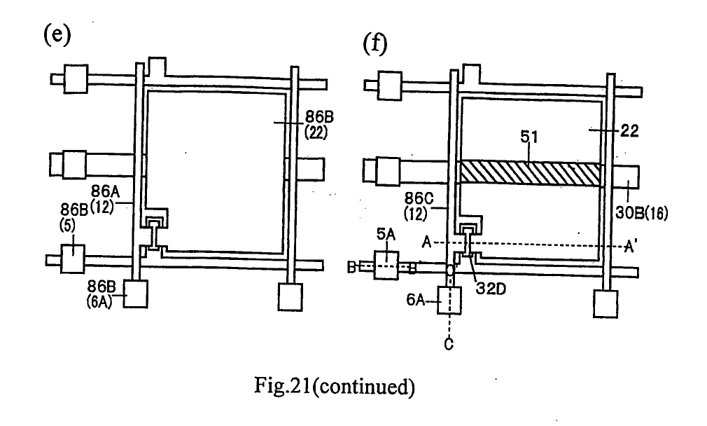

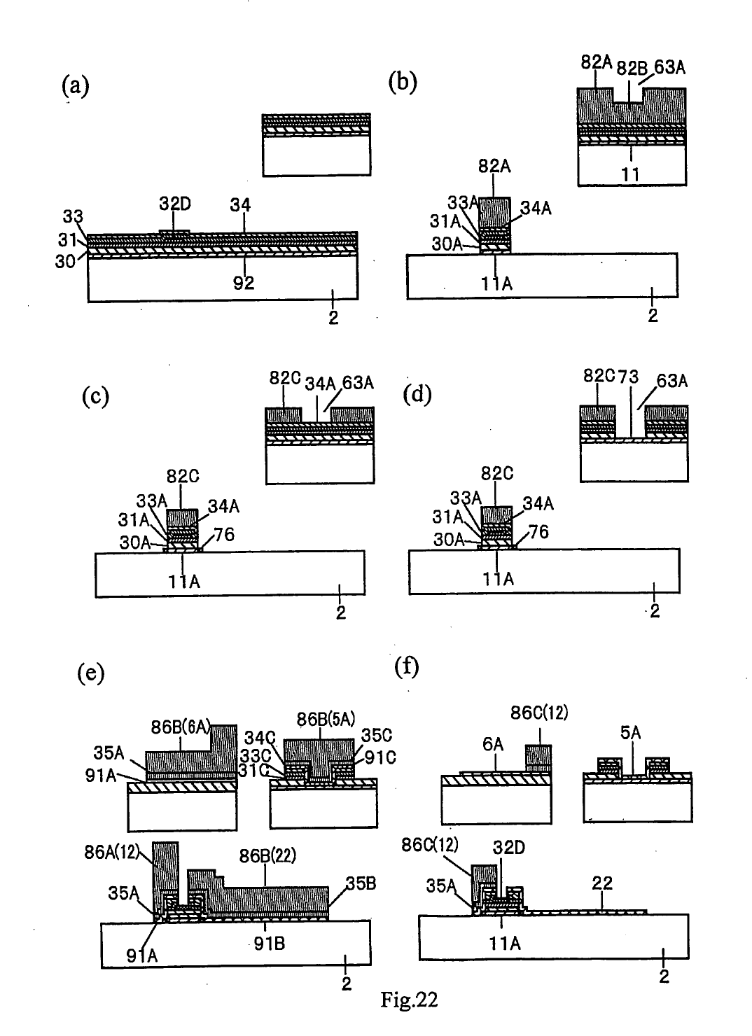

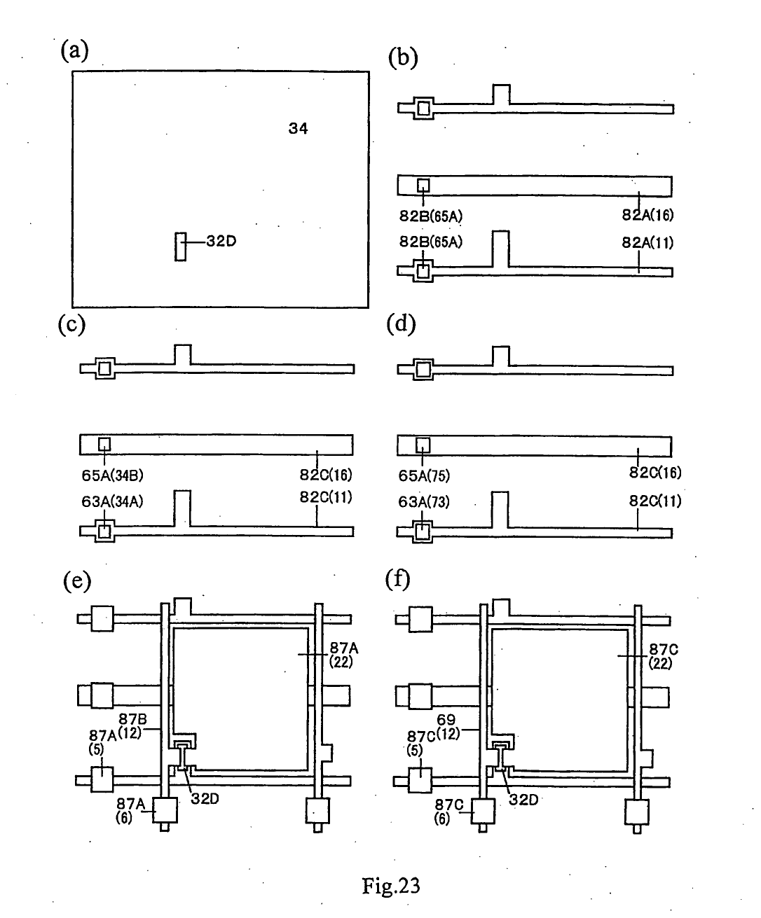

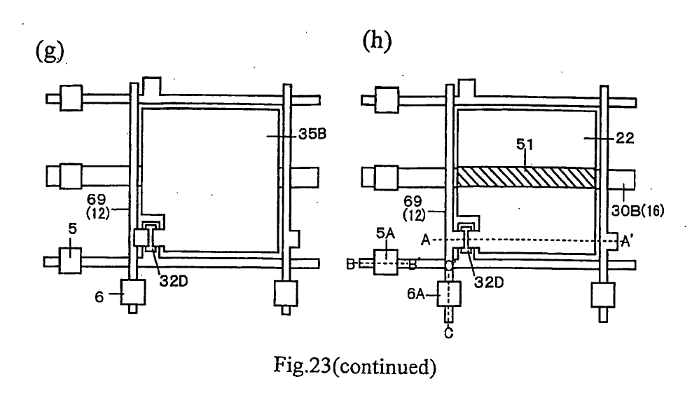

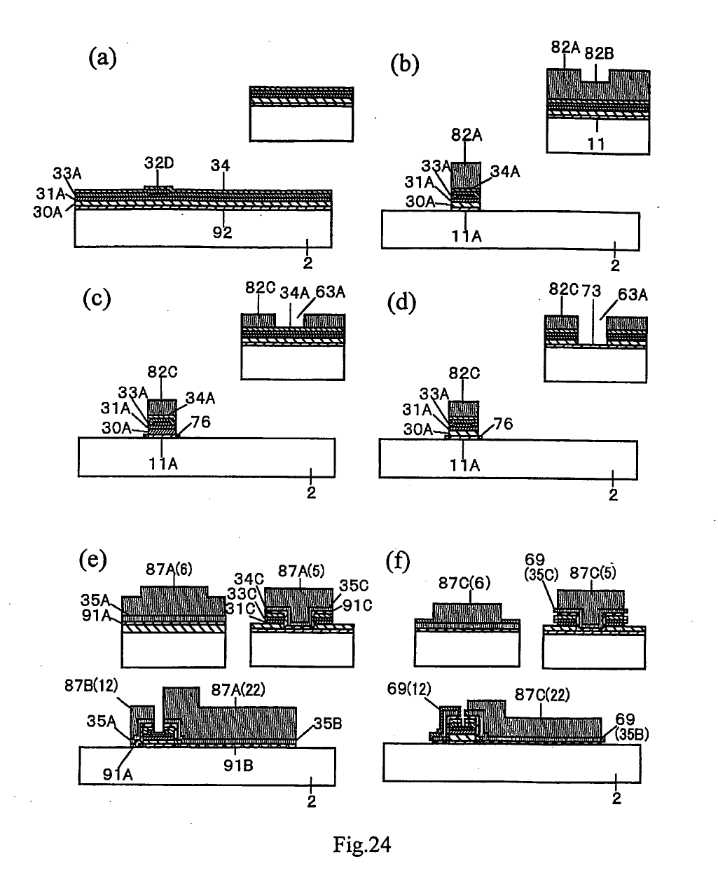

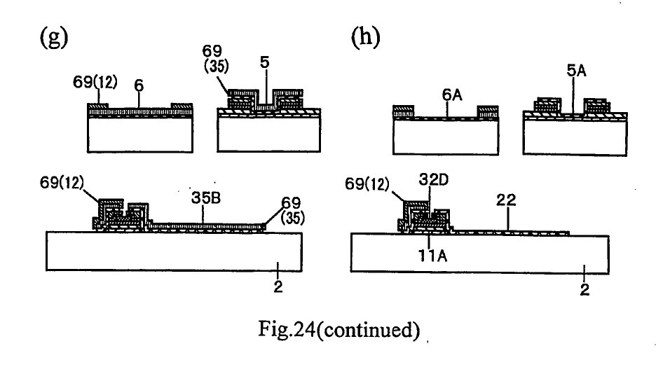

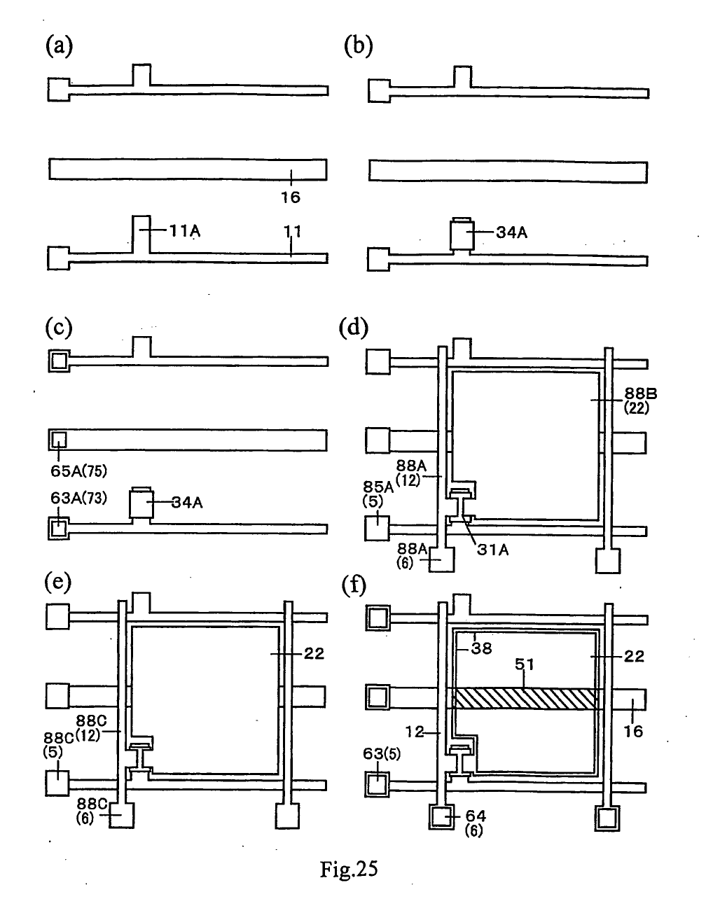

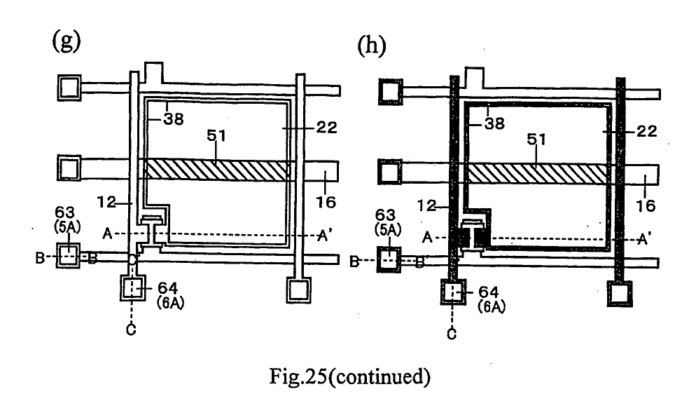

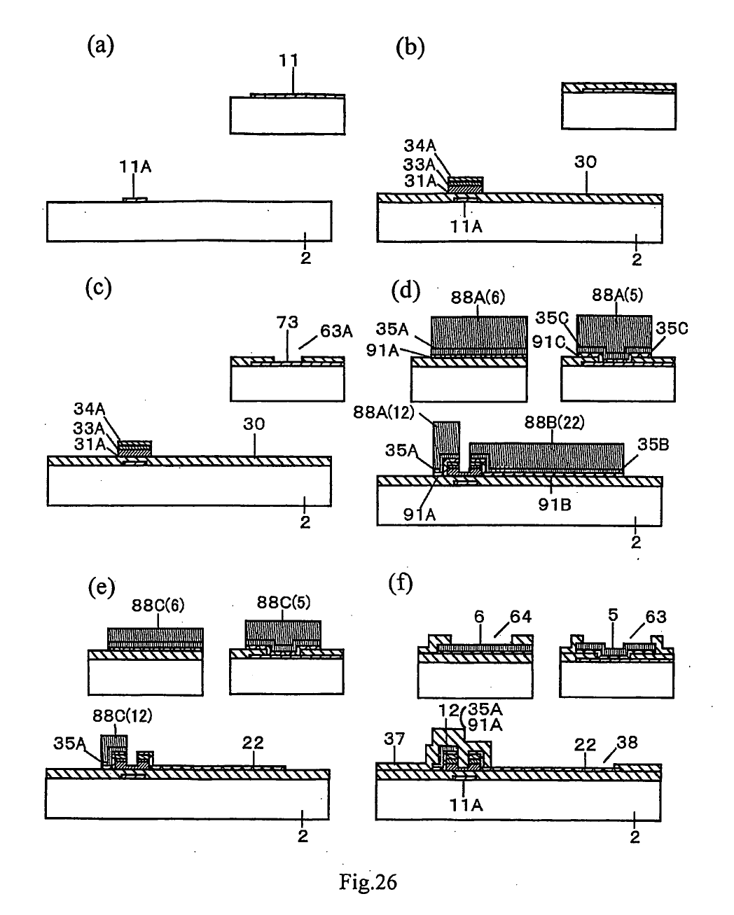

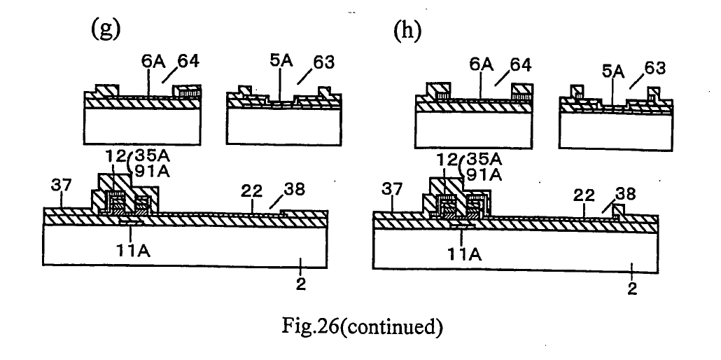

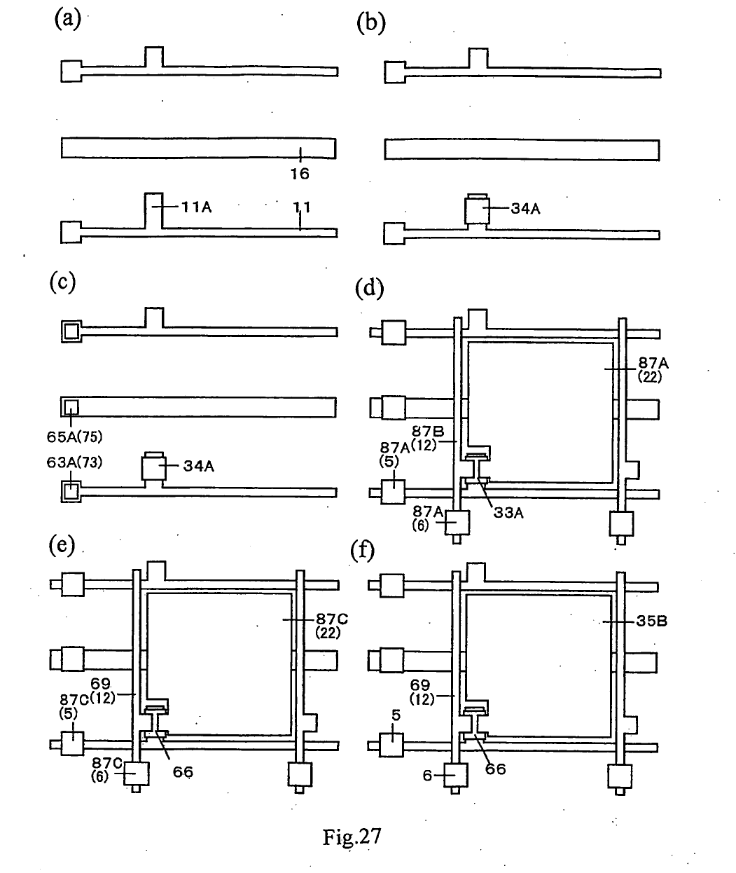

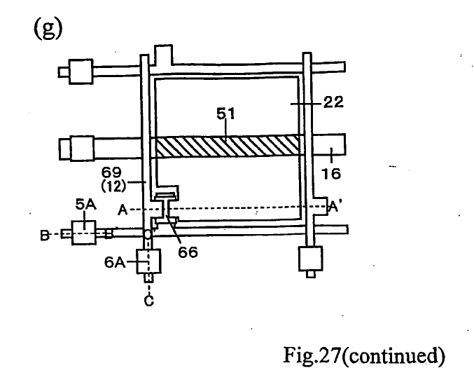

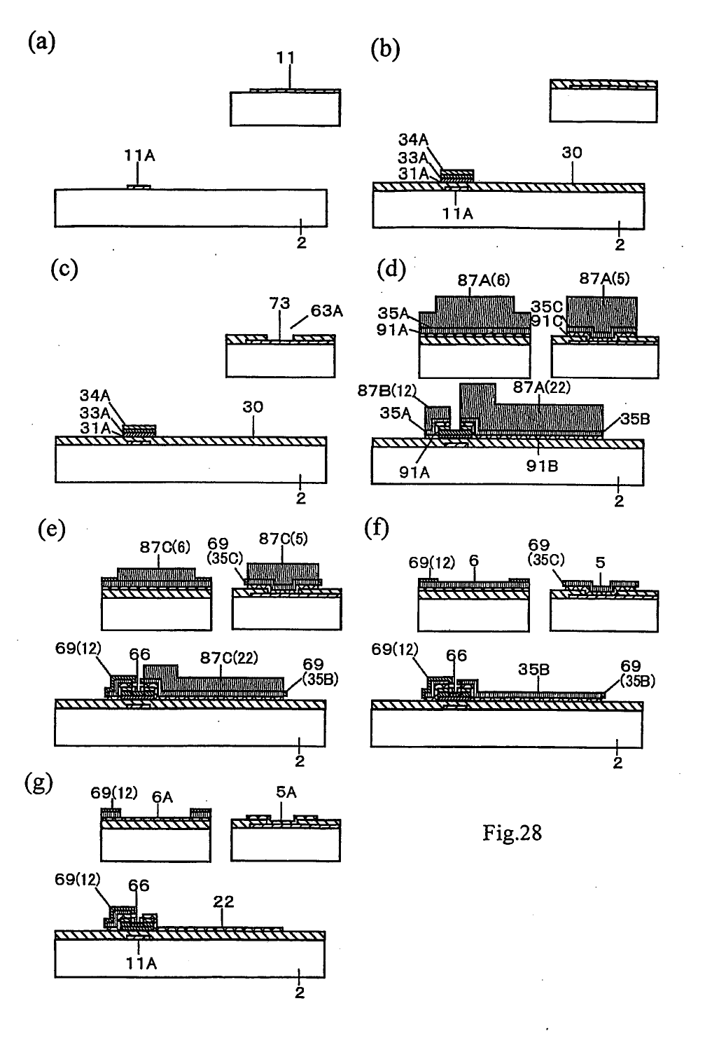

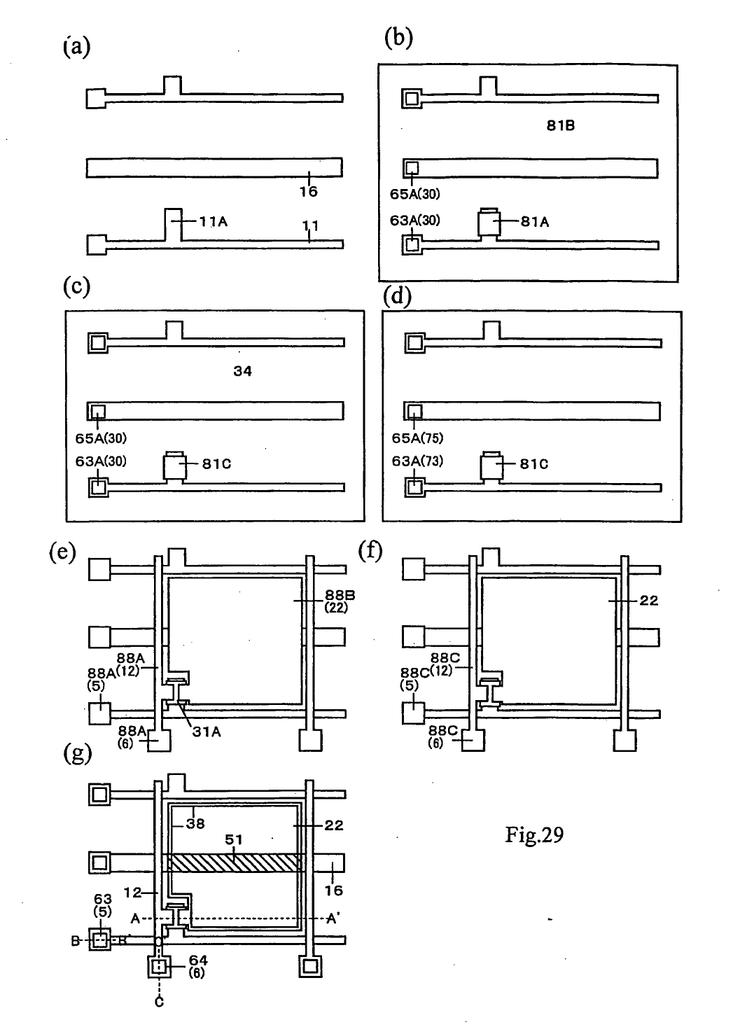

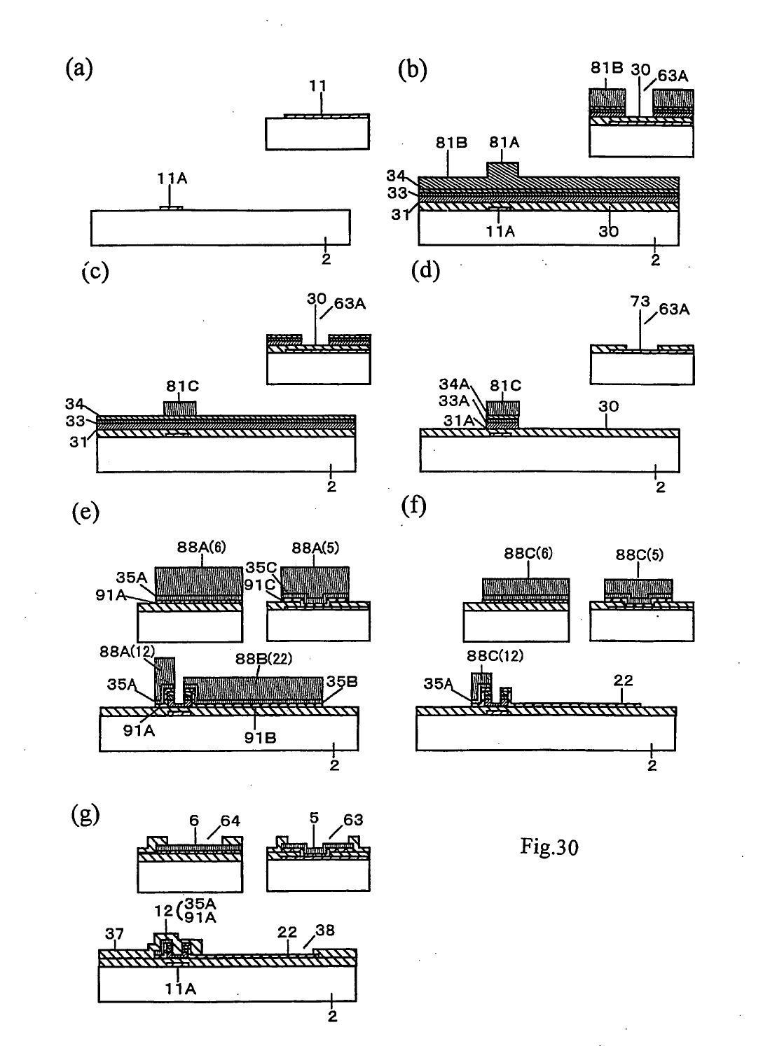

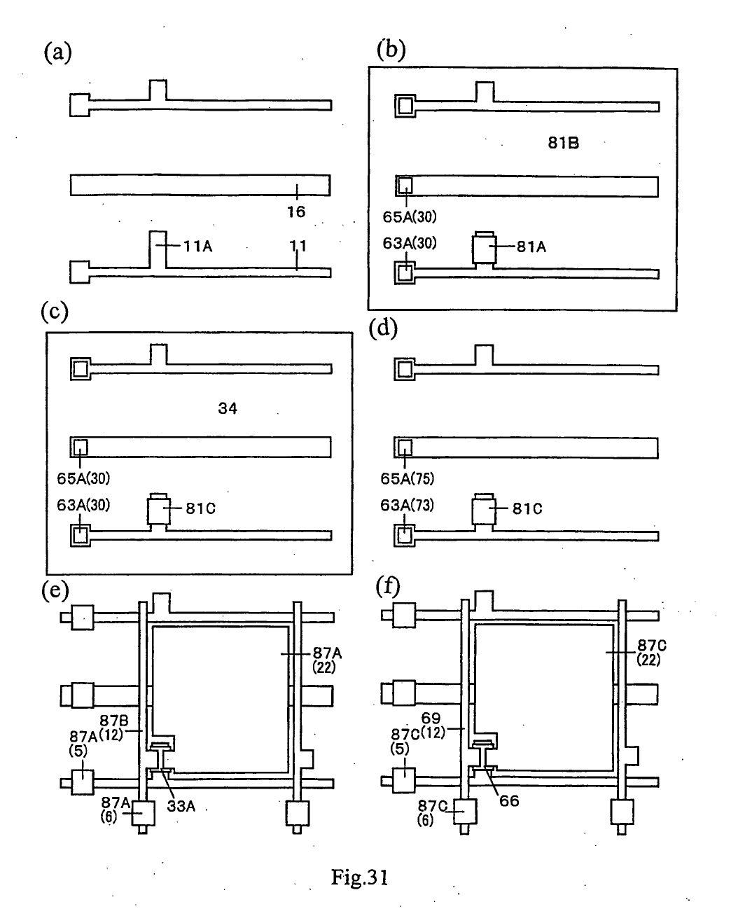

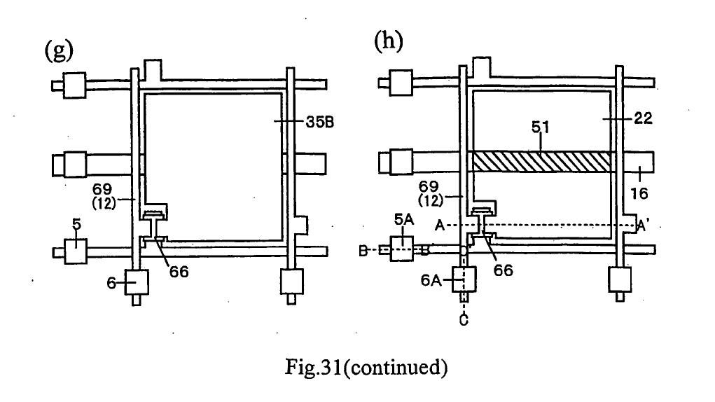

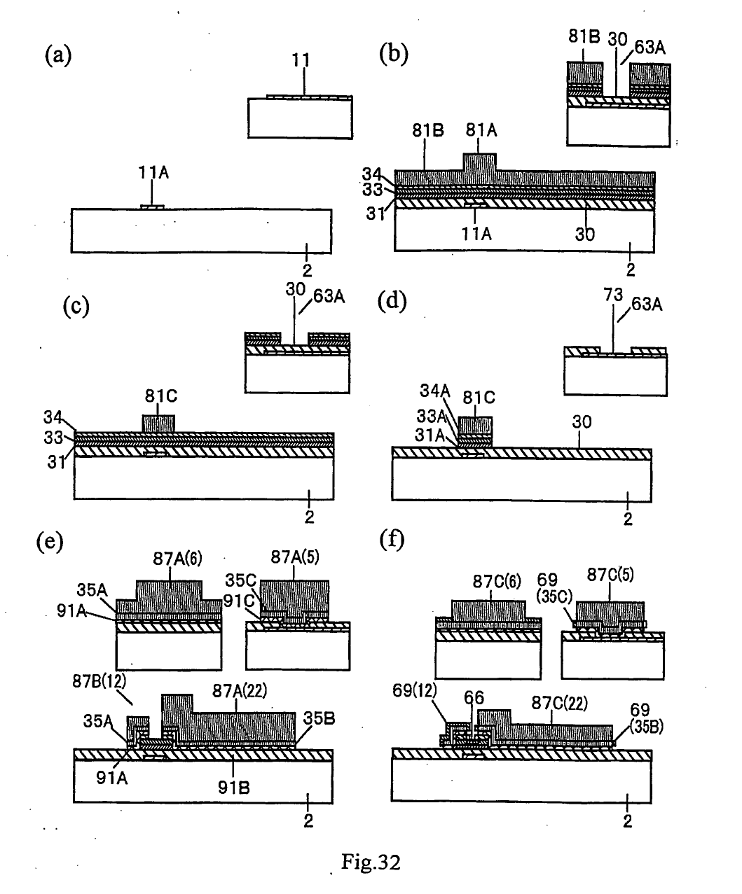

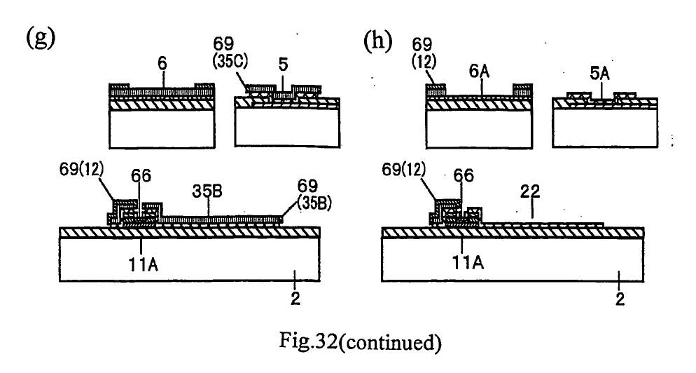

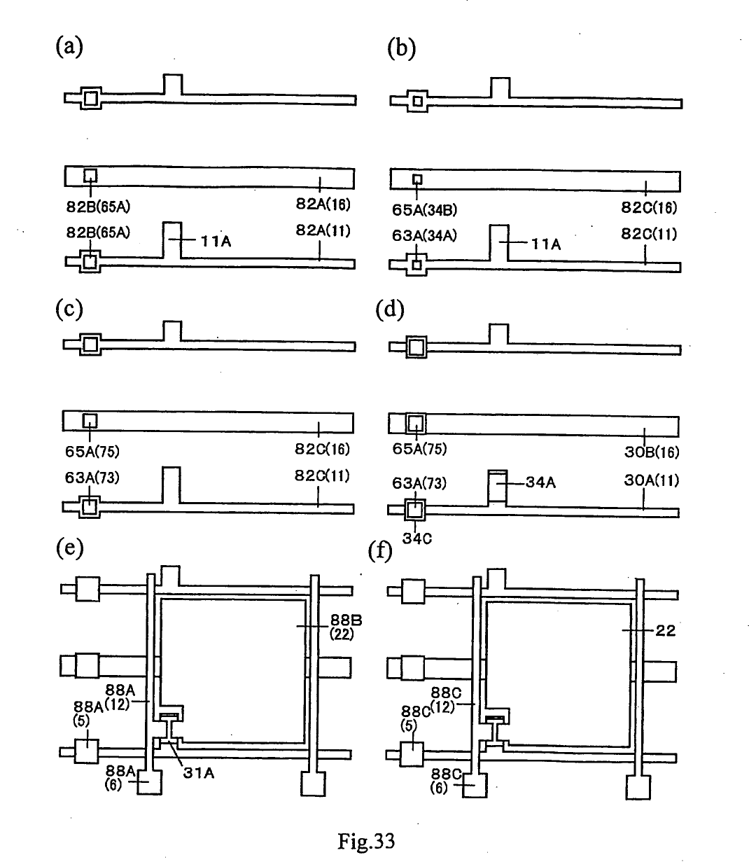

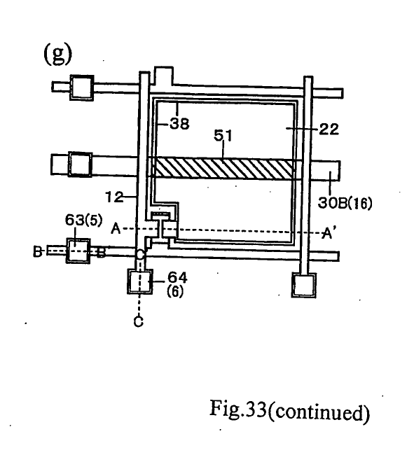

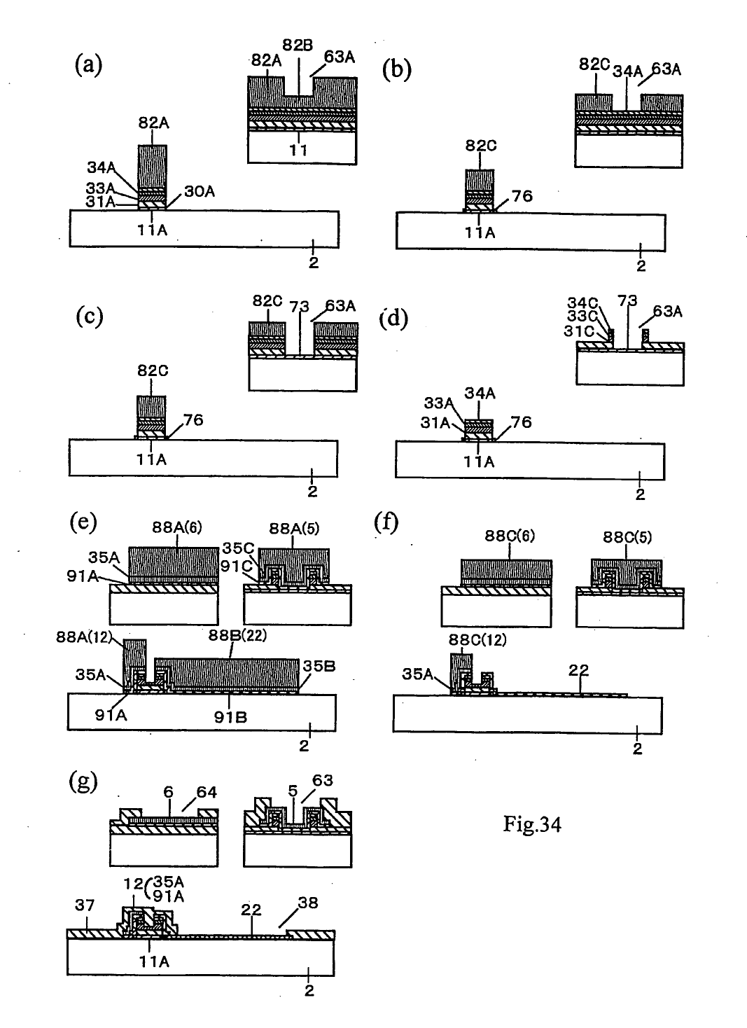

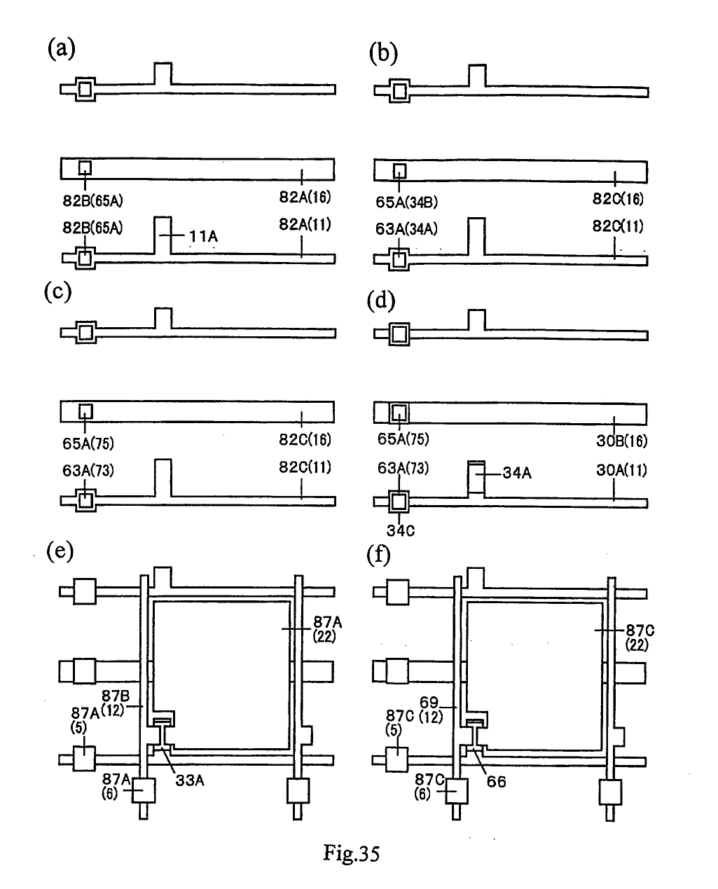

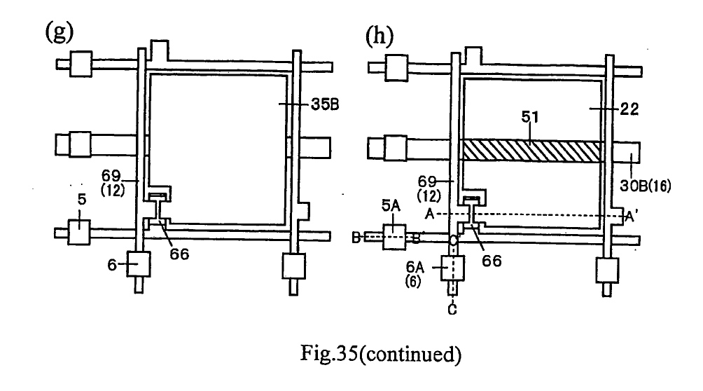

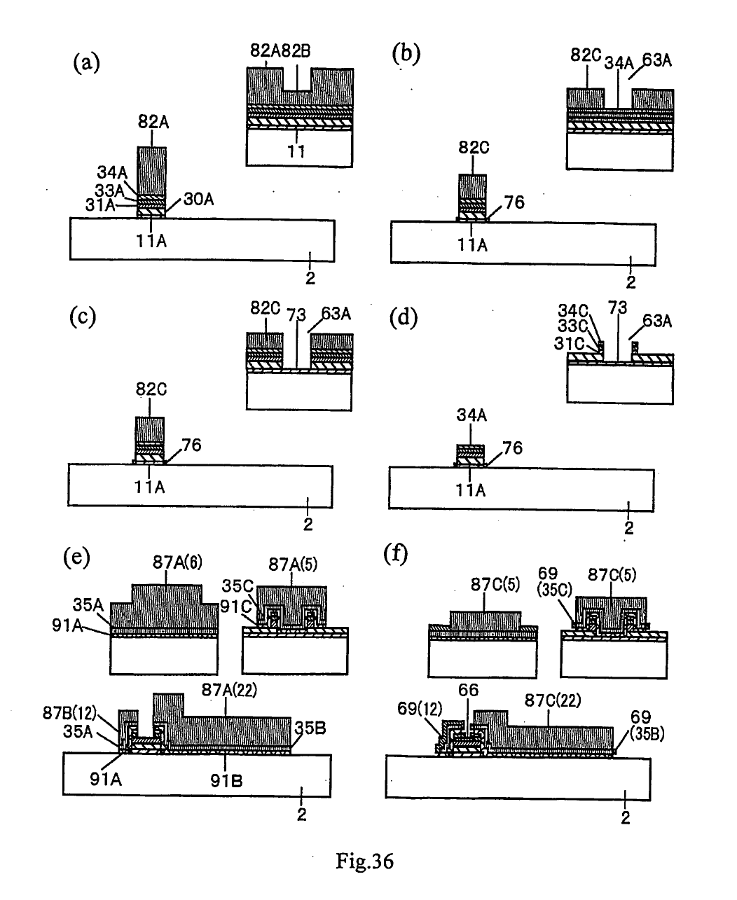

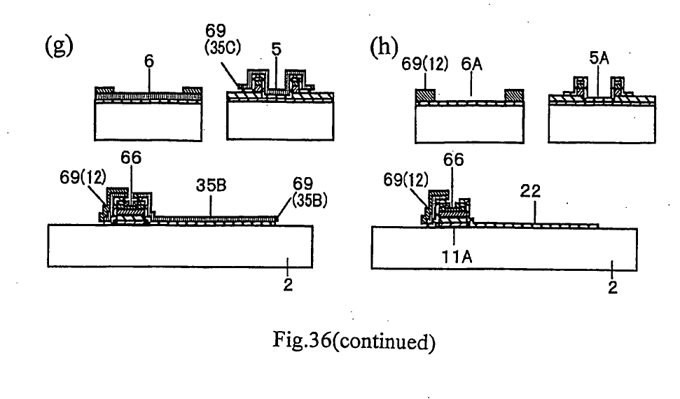

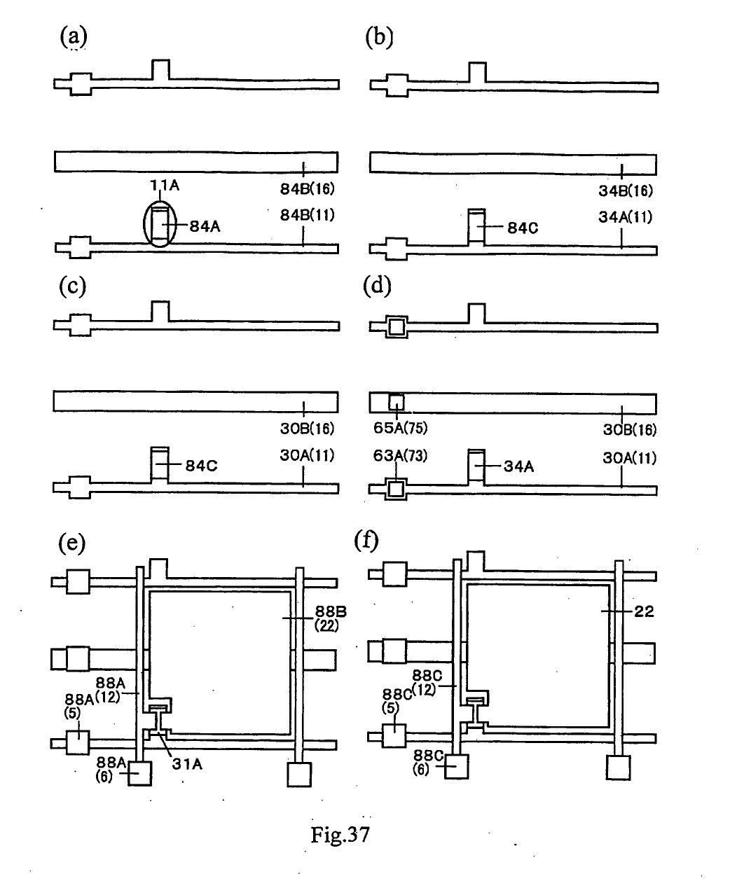

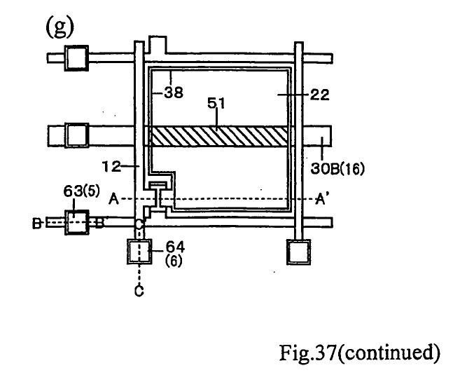

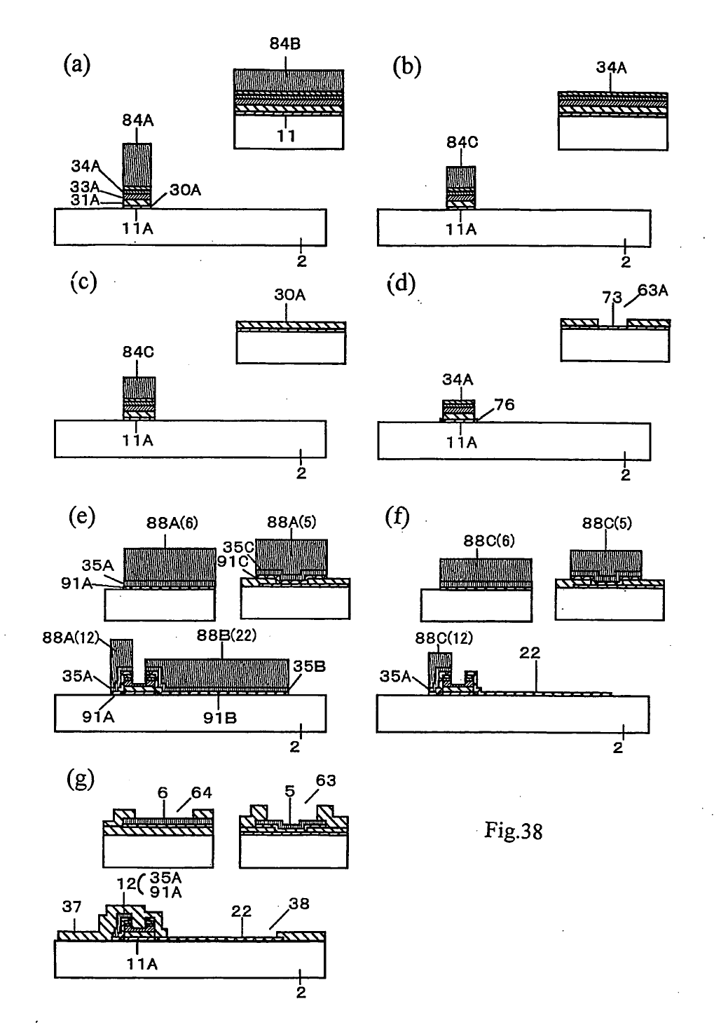

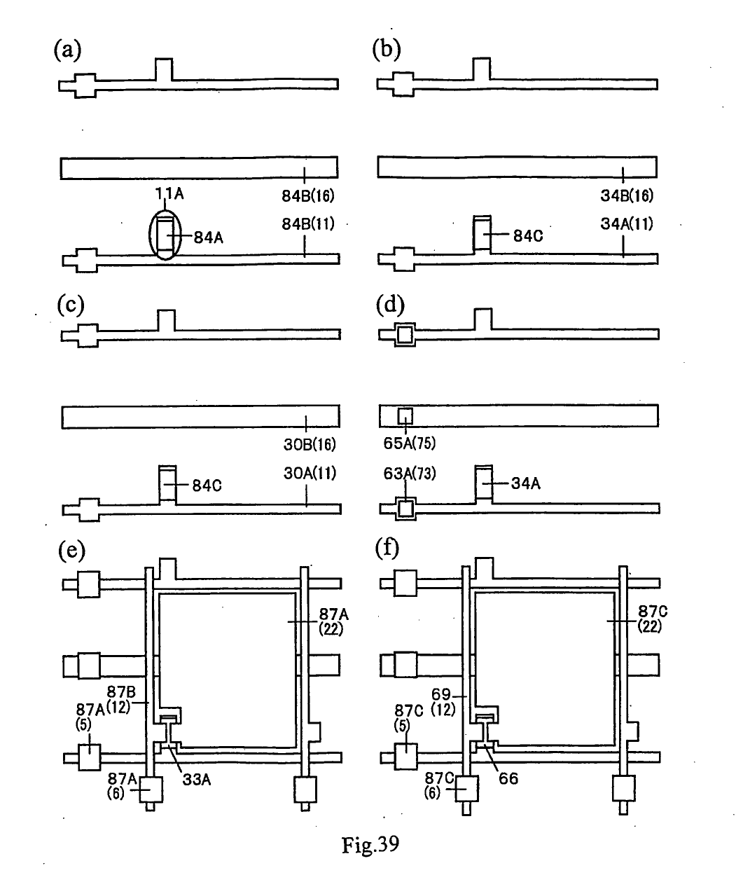

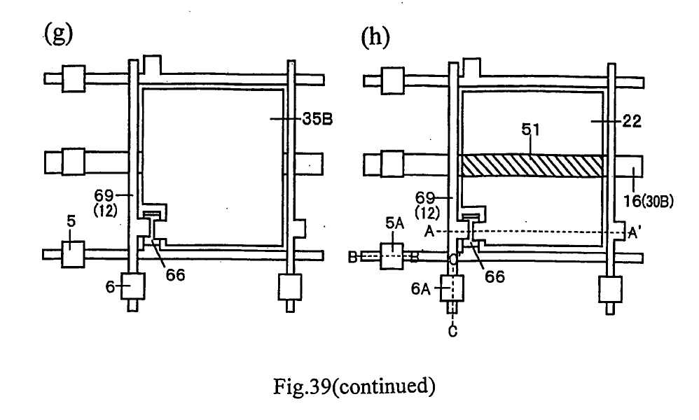

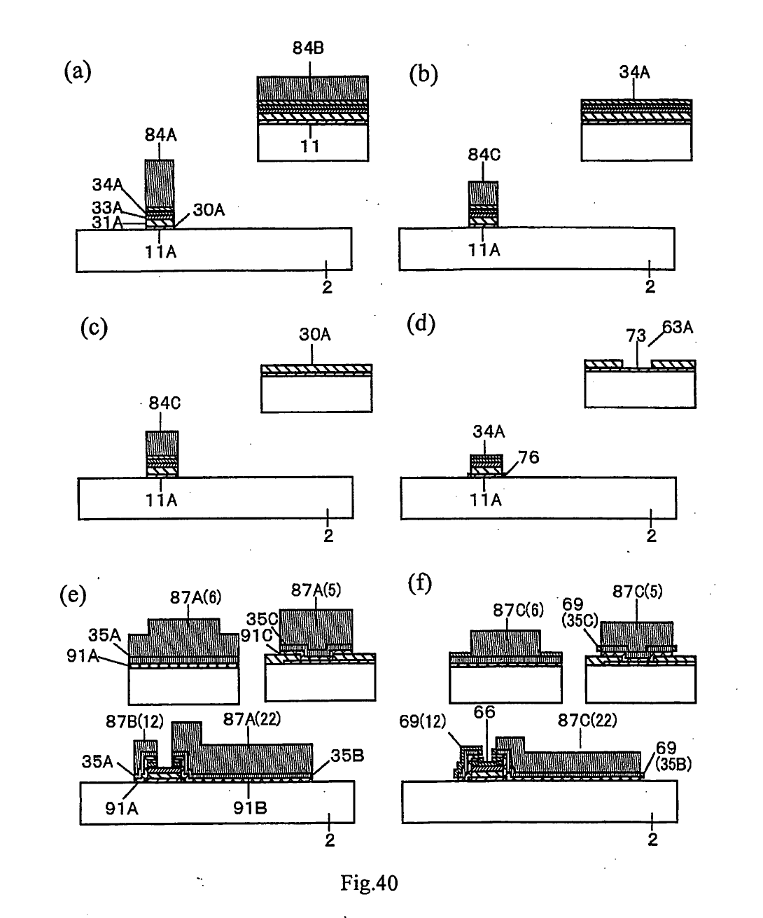

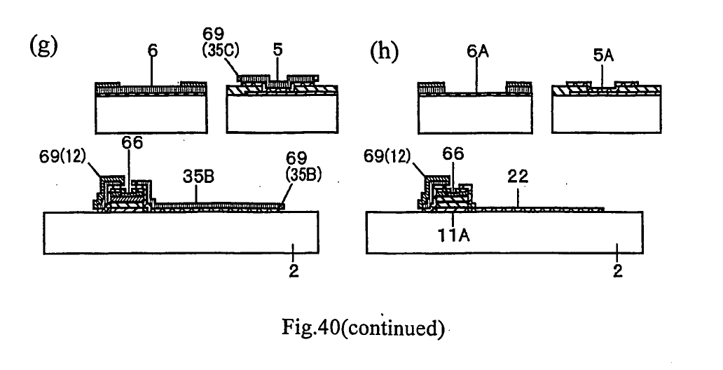

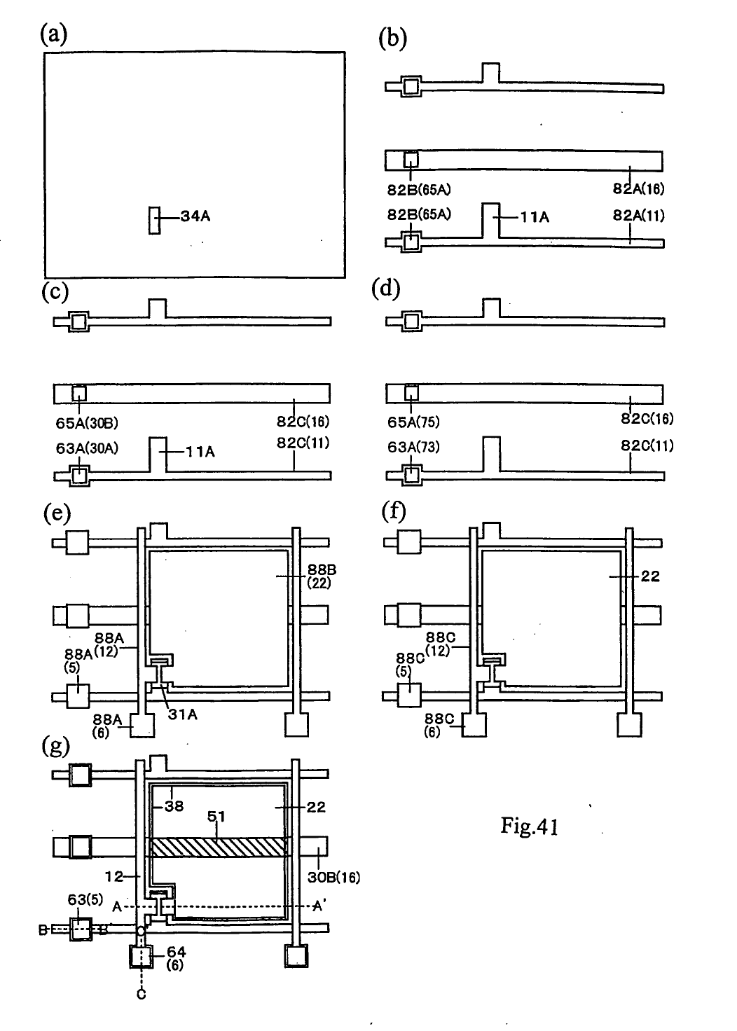

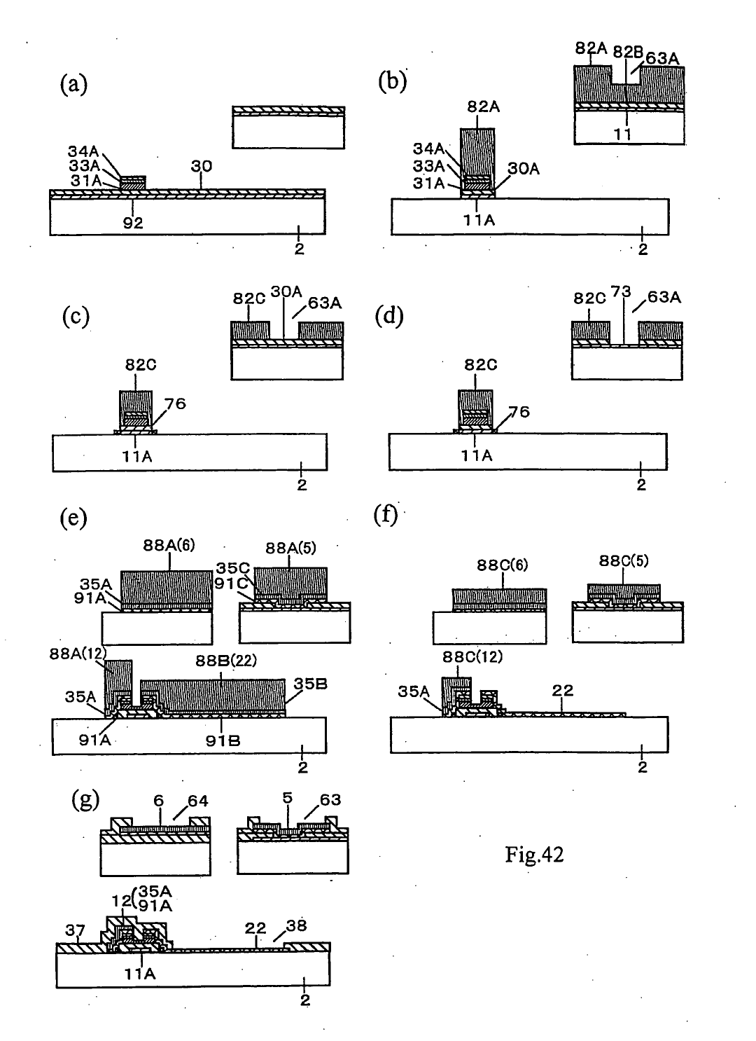

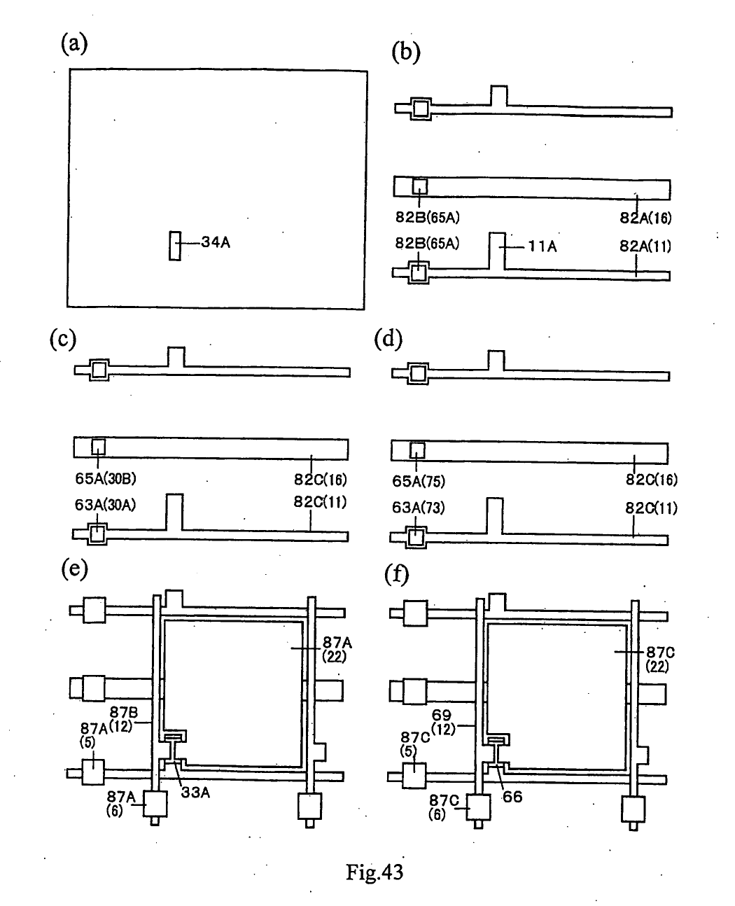

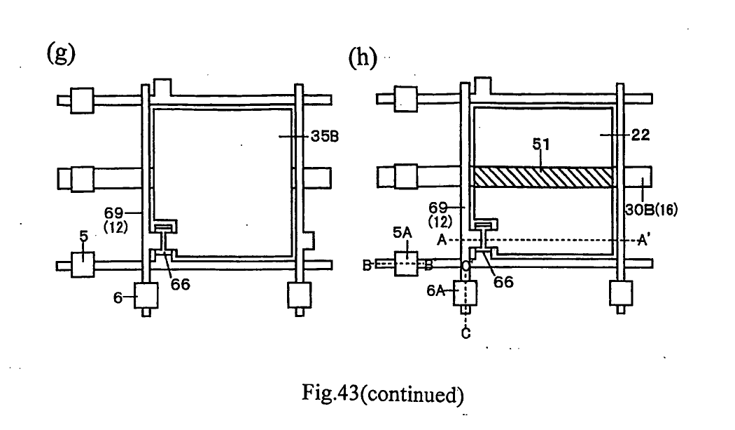

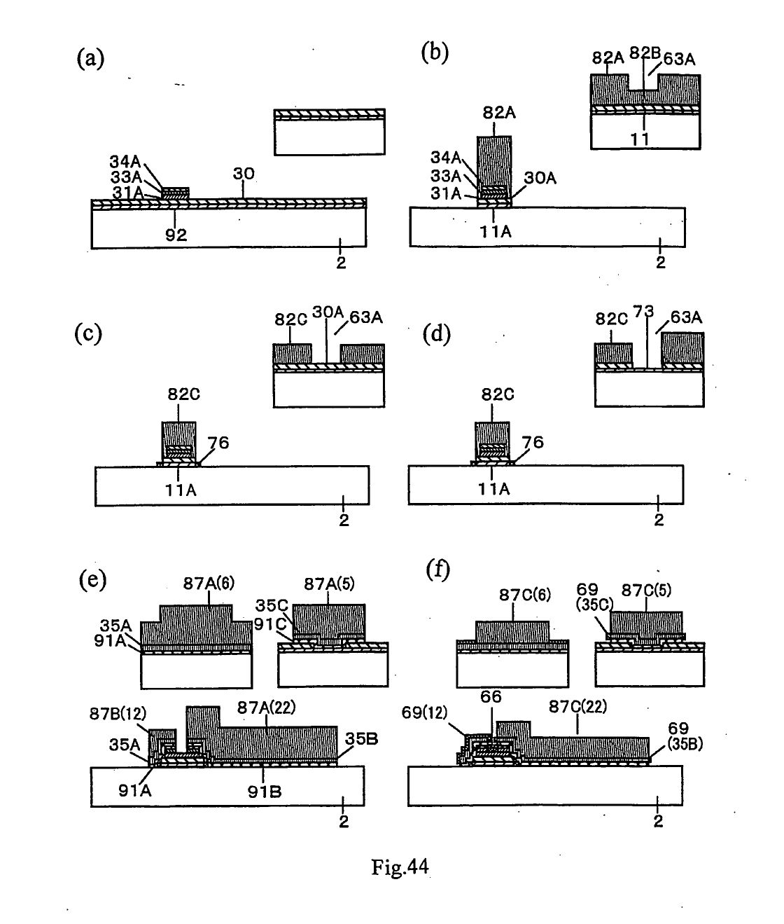

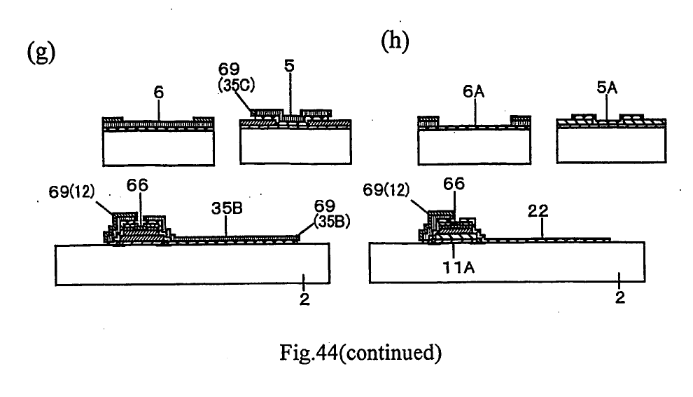

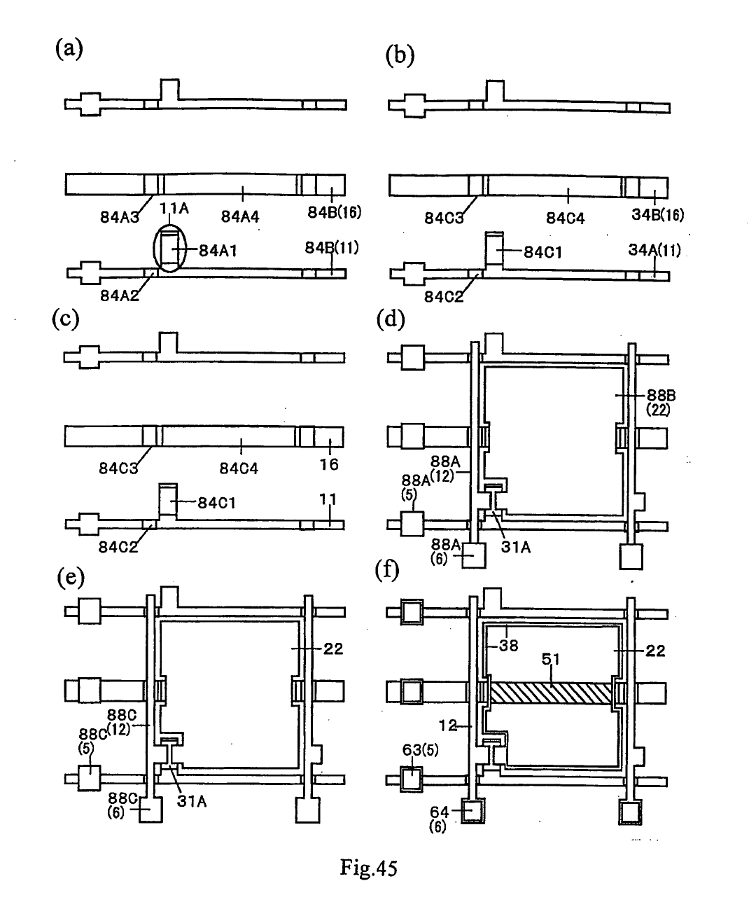

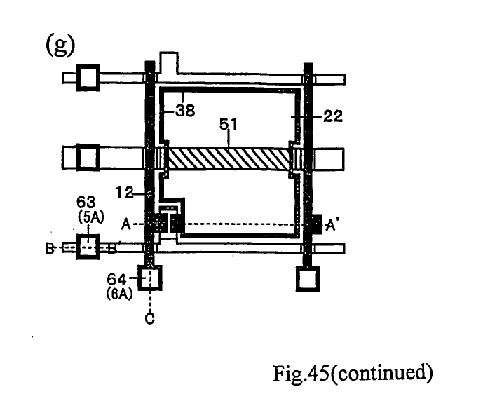

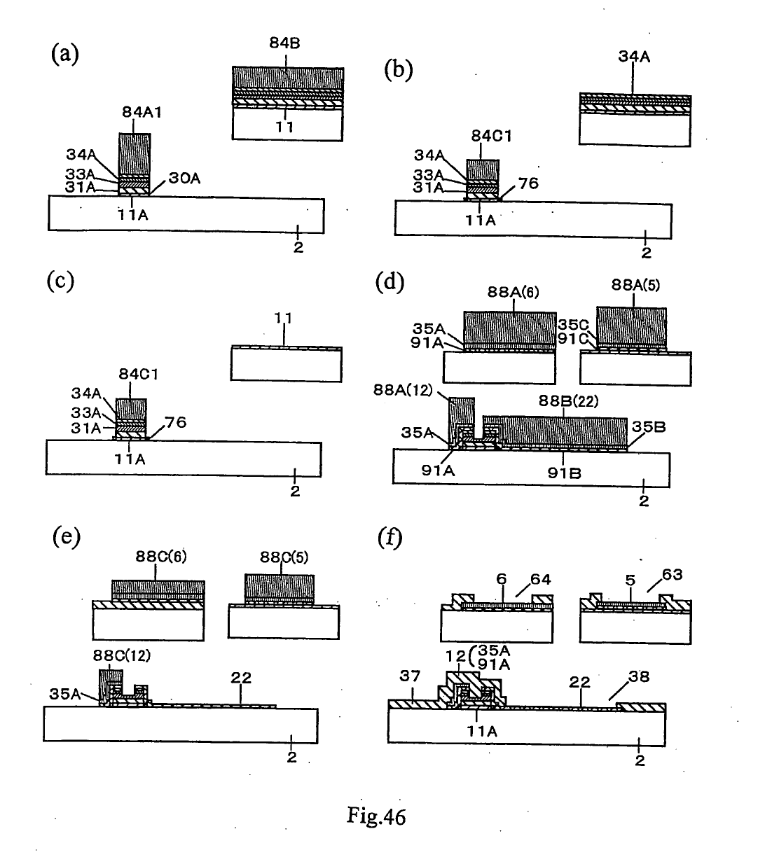

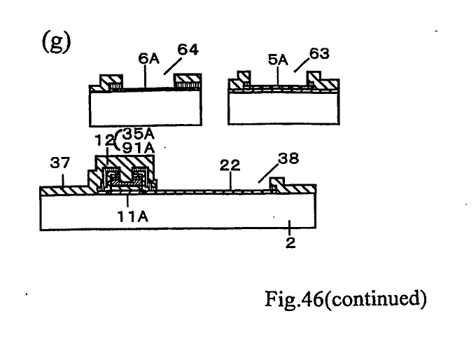

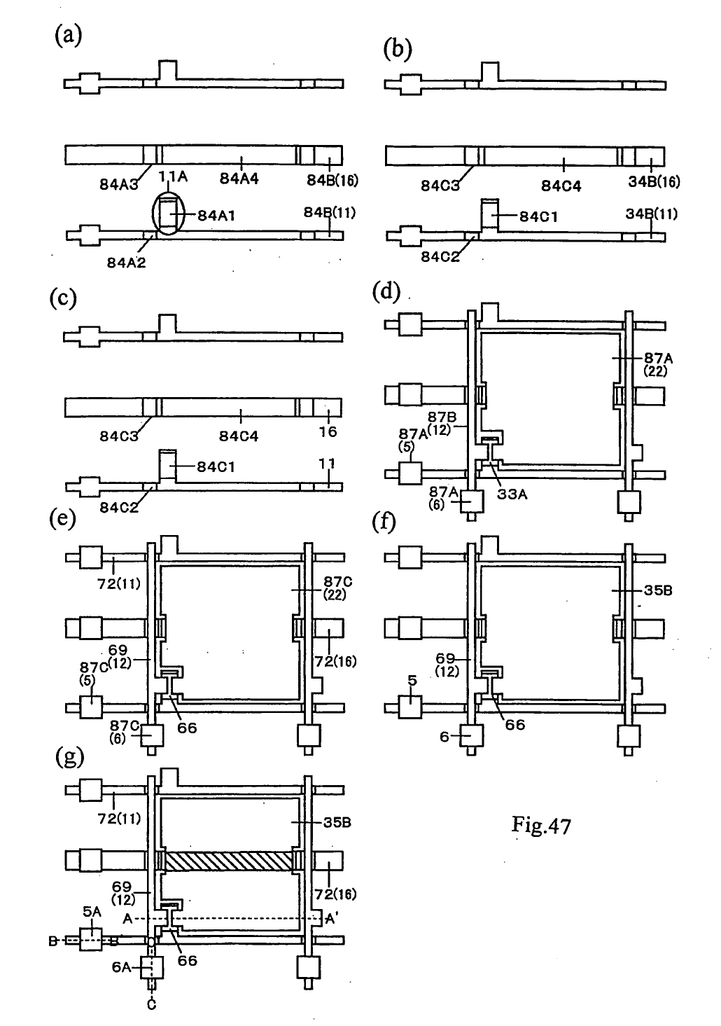

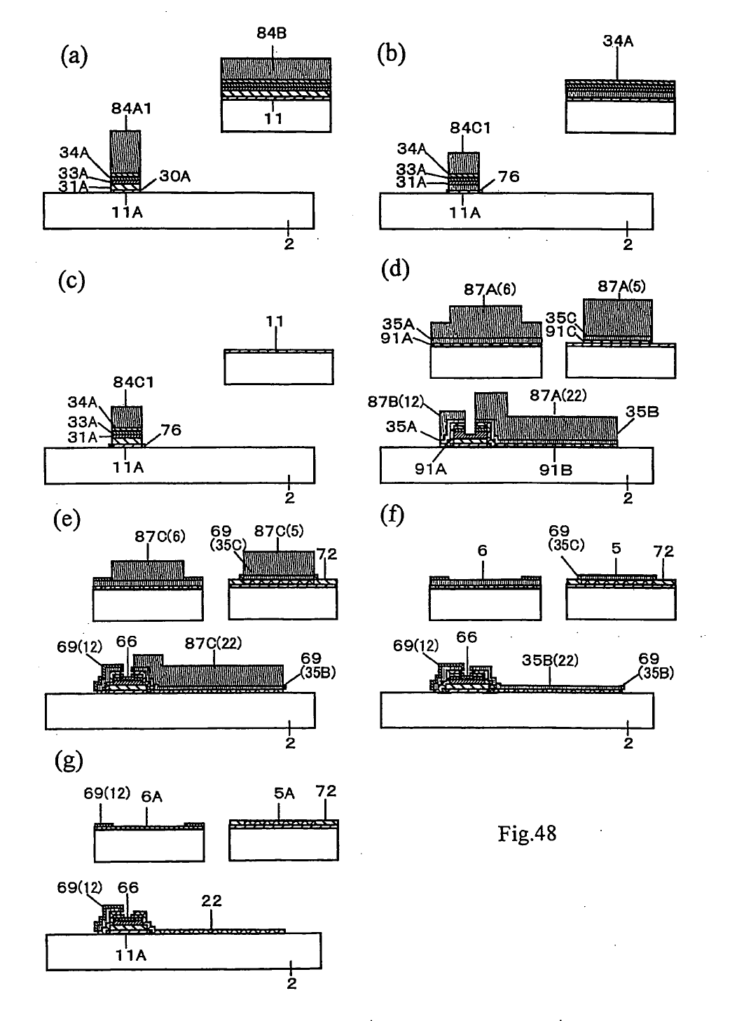

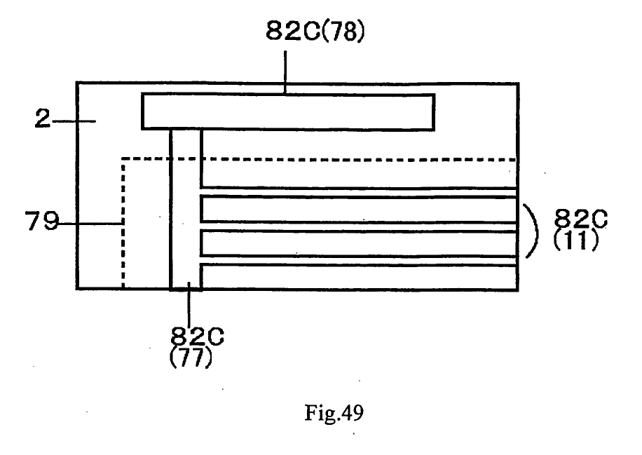

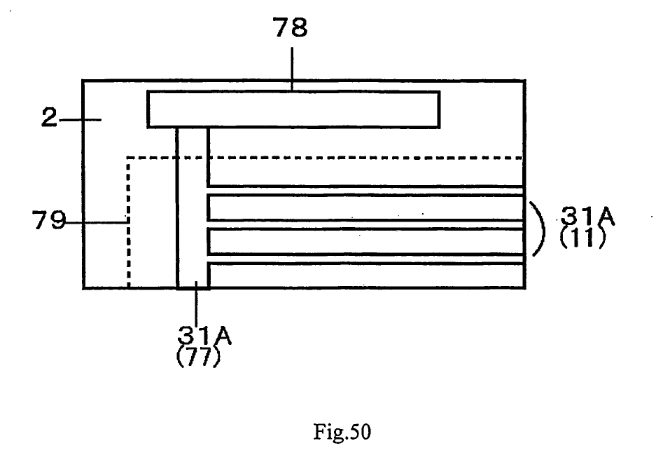

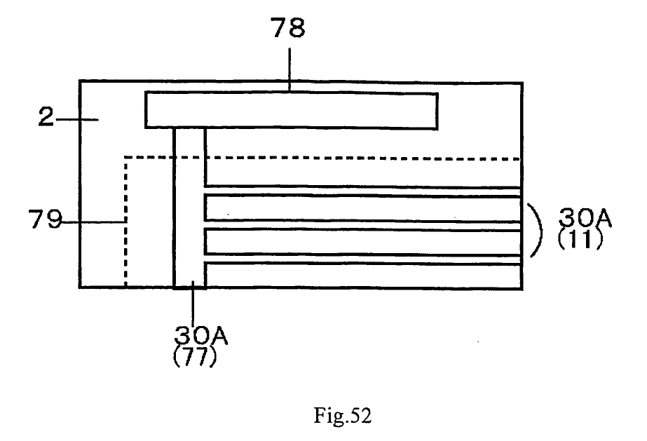

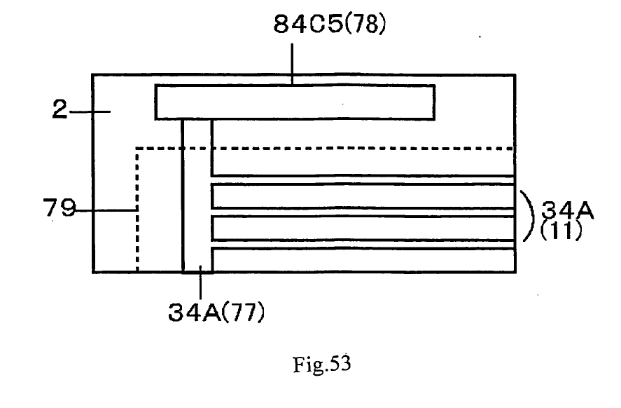

### BRIEF DESCRIPTION OF THE DRAWINGS

[FIG. 1] A plan view of the semiconductor device for the display device according to Embodiment 1 of the present invention.

[FIG. 2] A cross-section view of the manufacturing process for the semiconductor device for the display device according to Embodiment 1 of the present invention.

[FIG. 3] A plan view of the semiconductor device for the display device according to Embodiment 2 of the present invention.

[FIG. 4] A cross-section view of the manufacturing process for the semiconductor device for the display device according to Embodiment 2 of the present invention.

[FIG. 5] A plan view of the semiconductor device for the display device according to Embodiment 3 of the present invention.

[FIG. 6] A cross-section view of the manufacturing process for the semiconductor device for the display device according to Embodiment 3 of the present invention.

[FIG. 7] A plan view of the semiconductor device for the display device according to Embodiment 4 of the present invention.

[FIG. 8] A cross-section view of the manufacturing process for the semiconductor device for the display device according to Embodiment 4 of the present invention.

[FIG. 9] A plan view of the semiconductor device for the display device according to Embodiment 5 of the present invention.

[FIG. 10] A cross-section view of the manufacturing process for the semiconductor device for the display device according to Embodiment 5 of the present invention.

[FIG. 11] A plan view of the semiconductor device for the display device according to Embodiment 6 of the present invention.

[FIG. 12] A cross-section view of the manufacturing process for the semiconductor device for the display device according to Embodiment 6 of the present invention.

[FIG. 13] A plan view of the semiconductor device for the display device according to Embodiment 7 of the present invention.

[FIG. 14] A cross-section view of the manufacturing process for the semiconductor device for the display device according to Embodiment 7 of the present invention.

[FIG. 15] A plan view of the semiconductor device for the display device according to Embodiment 8 of the present invention.

[FIG. 16] A cross-section view of the manufacturing process for the semiconductor device for the display device according to Embodiment 8 of the present invention.

[FIG. 17] A plan view of the semiconductor device for the display device according to Embodiment 9 of the present invention.

[FIG. 18] A cross-section view of the manufacturing process for the semiconductor device for the display device according to Embodiment 9 of the present invention.

[FIG. 19] A plan view of the semiconductor device for the display device according to Embodiment 10 of the present invention.

[FIG. 20] A cross-section view of the manufacturing process for the semiconductor device for the display device according to Embodiment 10 of the present invention.

[FIG. 21] A plan view of the semiconductor device for the display device according to Embodiment 11 of the present invention.

[FIG. 22] A cross-section view of the manufacturing process for the semiconductor device for the display device according to Embodiment 11 of the present invention.

[FIG. 23] A plan view of the semiconductor device for the display device according to Embodiment 12 of the present invention.

[FIG. 24] A cross-section view of the manufacturing process for the semiconductor device for the display device according to Embodiment 12 of the present invention.

[FIG. 25] A plan view of the semiconductor device for the display device according to Embodiment 13 of the present invention.

[FIG. 26] A cross-section view of the manufacturing process for the semiconductor device for the display device according to Embodiment 13 of the present invention.

[FIG. 27] A plan view of the semiconductor device for the display device according to Embodiment 14 of the present invention.

[FIG. 28] A cross-section view of the manufacturing process for the semiconductor device for the display device according to Embodiment 14 of the present invention.

[FIG. 29] A plan view of the semiconductor device for the display device according to Embodiment 15 of the present invention.

[FIG. 30] A cross-section view of the manufacturing process for the semiconductor device for the display device according to Embodiment 15 of the present invention.

[FIG. 31] A plan view of the semiconductor device for the display device according to Embodiment 16 of the present invention.

[FIG. 32] A cross-section view of the manufacturing process for the semiconductor device for the display device according to Embodiment 16 of the present invention.

[FIG. 33] A plan view of the semiconductor device for the display device according to Embodiment 17 of the present invention.

[FIG. 34] A cross-section view of the manufacturing process for the semiconductor device for the display device according to Embodiment 17 of the present invention.

[FIG. 35] A plan view of the semiconductor device for the display device according to Embodiment 18 of the present invention.

[FIG. 36] A cross-section view of the manufacturing process for the semiconductor device for the display device according to Embodiment 18 of the present invention.

[FIG. 37] A plan view of the semiconductor device for the display device according to Embodiment 19 of the present invention.

[FIG. 38] A cross-section view of the manufacturing process for the semiconductor device for the display device according to Embodiment 19 of the present invention.

[FIG. 39] A plan view of the semiconductor device for the display device according to Embodiment 20 of the present invention.

[FIG. 40] A cross-section view of the manufacturing process for the semiconductor device for the display device according to Embodiment 20 of the present invention.

[FIG. 41] A plan view of the semiconductor device for the display device according to Embodiment 21 of the present invention.

[FIG. 42] A cross-section view of the manufacturing process for the semiconductor device for the display device according to Embodiment 21 of the present invention.

[FIG. 43] A plan view of the semiconductor device for the display device according to Embodiment 22 of the present invention.

[FIG. 44] A cross-section view of the manufacturing process for the semiconductor device for the display device according to Embodiment 22 of the present invention.

[FIG. 45] A plan view of the semiconductor device for the display device according to Embodiment 23 of the present invention.

[FIG. 46] A cross-section view of the manufacturing process for the semiconductor device for the display device according to Embodiment 23 of the present invention.

[FIG. 47] A plan view of the semiconductor device for the display device according to Embodiment 24 of the present invention.

[FIG. 48] A cross-section view of the manufacturing process for the semiconductor device for the display device according to Embodiment 24 of the present invention.

[FIG. 49] An arrangement view of the connection pattern for the formation of the insulating layer in Embodiment 7, Embodiment 8, Embodiment 11, Embodiment 12, Embodiment 12, Embodiment 17, Embodiment 18, Embodiment 21, and Embodiment 22.

[FIG. 50] An arrangement view of the connection pattern for the formation of the insulating layer in Embodiment 9 and Embodiment 10.

[FIG. 52] An arrangement view of the connection pattern for the formation of the insulating layer in Embodiment 19 and Embodiment 10.

[FIG. 53] An arrangement view of the connection pattern for the formation of the insulating layer in Embodiment 23 and Embodiment 24.

[FIG. 54] A perspective view showing the packaging state of the liquid crystal panel.

[FIG. 55] An equivalent circuit of the liquid crystal panel.

[FIG. 56] A cross-section view of the liquid crystal panel.

[FIG. 57] A plan view of the active substrate of the Conventional Example.

[FIG. 58] A cross-section view of the manufacturing process for the active substrate of the Conventional Example.

[FIG. 59] A plan view of a streamlined active substrate.

[FIG. 60] A cross-section view of the manufacturing process of a streamlined active substrate.

### DETAILED DESCRIPTION OF THE PREFERRED EMBODIMENT

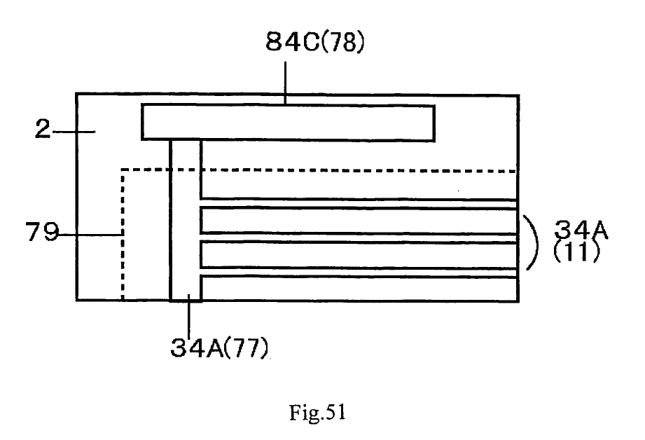

Embodiments of the invention are described below with reference to FIGS. 1 to 53. FIG. 1 shows plan views of a semiconductor device (active substrate) for a display device pertaining to a first embodiment of the present invention. FIG. 2 shows cross-sectional views of the manufacturing processes of lines A-A′, B-B′ and C-C′ of FIG. 1. Similarly, odd FIGS. 3 to 47 and even FIGS. 4 to 48 show plan views of active substrates and cross-sectional views of the manufacturing processes respectively for embodiments 2 to 24. The reference numerals used in one portion of the conventional example are used similarly in other examples, so a detailed description therefor is omitted.

### Embodiment 1

To begin with, in Embodiment 1, Cr, Ta, Mo or the like or an alloy or silicide thereof, for example, is deposited as a first metal layer about 0.1 to 0.3 μm thick on the primary surface of a glass substrate 2 using an SPT or other vacuum film depositing equipment similarly to the conventional example. It goes without saying that a laminate of Al or an Al alloy and one of these metals with a high heat resistance may be used to lower the resistance if required. Next, a scan line 11 doubling as a gate electrode 11A and a storage capacitor line 16 are selectively formed using micro-fabrication technology as shown in FIGS. 1(a) and 2(a).

Next, three thin film layers comprising a first SiNx layer 30 forming a gate insulating layer, a first amorphous silicon layer 31 forming a channel for an insulating gate type transistor containing hardly any impurities, and a second SiNx layer 32 forming an insulating layer for protecting the channel are successively deposited about 0.3, 0.05, and 0.1 μm thick, for example, over the entire surface of the glass substrate 2 using a PCVD equipment. A second SiNx layer is selectively left finer in width than the gate electrode 11A thereupon as a channel protection layer 32D using micro-fabrication technology, exposing a first amorphous silicon layer 31 as shown in FIGS. 1(b) and 2(b).

Continuing, the second amorphous silicon layer 33 containing phosphorous, for example, as an impurity is deposited about 0.05 μm thick, for example, over the entire surface similarly using the PCVD equipment. Then a thin film layer 34 of Ti, Cr, Mo or the like, for example, is deposited as a heat resistant metal layer about 0.1 μm thick using an SPT or other vacuum film depositing equipment, and a semiconductor layer region is formed wider than the gate electrode 11A, comprising a laminate of a heat resistant metal layer 34A, a second amorphous silicon layer 33A and first amorphous silicon layer 31A above the gate electrode 11A using micro-fabrication technology to expose the gate insulating layer 30 as shown in FIGS. 1(c) and 2(c).

Next, openings 63A and 65A are selectively formed above the scan line 11 and the storage capacitor line 16 in the region outside the image display portion, and the gate insulating layer 30 in the aforementioned openings 63A and 65A is etched to expose a part 73 of the scan line 11 and a part 75 of the storage capacitor line 16 using micro-fabrication technology as shown in FIGS. 1(d) and 2(d).

Then, IZO or ITO, for example, is deposited as a transparent conductive layer 91 about 0.1 to 0.2 μm thick over the entire surface of the glass substrate 2 using an SPT or other vacuum film depositing equipment; an Al or Al (Nd) alloy thin layer is subsequently deposited about 0.3 μm thick as a low resistant metal layer; the Al thin film layer 35, the transparent conductive layer 91, the heat resistant metal layer 34A, the second amorphous silicon layer 33A, and the first amorphous silicon layer 31A are removed using micro-fabrication technology with the photosensitive resin patterns 86A and 86B to selectively form a signal wire 12 doubling as a source line comprising a laminate of the low resistance metal layer 35A and a transparent conductive layer 91A containing a part of the semiconductor layer region 34A, and similarly a drain electrode 21 for the insulating gate type transistor doubling as a pixel electrode 22 comprising a laminate of the low resistance metal layer 35B and a transparent conductive layer 91B such as to partially overlap with the channel protective layer 32D as shown in FIGS. 1(e) and 2(e); and an electrode terminal 5 for a scan line and an electrode terminal 6 comprising part of the signal line are formed containing a part of the scan line 73 exposed at the same time as the formation of the source and drain wires 12 and 21. In this manner, the heat resistant metal layer 34A is divided in this process into a set of electrodes 34A1 and 34A2 (neither of which is illustrated), and by forming the signal wire 12 to contain the one electrode 34A1 and the pixel electrode 22 to contain the other electrode 34A2, the former functions as a source electrode for the insulating gate type transistor and the latter as a drain electrode thereof. The remaining description is omitted, but an electrode terminal, the number for which is not provided, for the storage capacitor line 16 is formed containing a part 75 of the storage capacitor line 16 in a similar manner.

The formation of the photosensitive resin patterns 86A and 86B using half-tone exposure technology such that the 3-μm, for example, thick region 86A (the black region) on the signal line 12 is thicker than the 1.5 μm of the region 86B (gray tone region) on the electrode terminals 5 and 6 and on the pixel electrode 22 doubling as a drain electrode is a main feature of Embodiment 1. With the smallest dimension of 86B corresponding to the electrodes 5 and 6 large at several tens of μm, making the photomask and controlling the finishing dimensions is extremely easy, but because the smallest dimension of the region 86A corresponding to the signal line 12 has a comparatively high precision of 4 to 8 μm, a fine pattern is needed for the black region. However, using the source and drain wires 12 and 21 formed in the one exposure treatment and two etching treatments as described with the streamlined Conventional Example for comparison, the source and drain wires 12 and 21 of the present invention are formed with one exposure treatment and 1.5 etching treatments (the second etching is for only the low resistance metal layers 35A and 35B as described below), so there are few causes of fluctuation in the pattern width, making it easier to control the dimensions of the source and drain wires 12 and 21 as well as of the interval between the source and drain wires 21, that is, the channel length than controlling the pattern precision using conventional half-tone exposure technology. In contrast to the channel etch type insulating gate transistor, it is the dimensions of the channel protective insulating layer 32D that determine the on current of the etch stop type insulating gate type transistor, and what is desired to be understood is while the process control is made easier yet, this is not due to the dimensions between the source and drain wires 12 and 21.

When the above-mentioned photosensitive resin patterns 86A and 86B are reduced by at least 1.5 μm using oxygen plasma or other ashing means after the source and drain wires 12 and 22 are formed, the photosensitive resin pattern 86B is eliminated, exposing the low resistance metal layers 35A to 35C on the electrode terminals 5 and 6 and the pixel electrode (drain electrode) 22, and it is possible to leave the reduced photosensitive resin pattern 86C unchanged only on the signal line 12, but when the photosensitive resin pattern 86C is isotropically reduced in the above-mentioned oxygen plasma treatment making its pattern width finer, the top surface of the signal line 12 is exposed, and the reliability of the liquid crystal display device is lowered, so it is desirable to increase the anistropy in the oxygen plasma treatment with RIE (reactive ion etching), or TCP (transfer coupled plasma) or ICP (inductive coupled plasma) having a higher density plasma source to control changes in the pattern dimensions. Then, the low resistance metal layers 35A to 35C are removed using the reduced photosensitive resin pattern 86C as a mask to expose transparent conductive electrodes 91A to 91C as shown in FIGS. 1(f) and 2(f), resulting in an electrode terminal 6A, a pixel electrode 22, and an electrode terminal 5A respectively.

The active substrate 2 thus obtained and the color filter 9 are attached together to form a liquid crystal display, thereby completing Embodiment 1 of the present invention. In Embodiment 1, the photosensitive resin pattern 86C contacts the liquid crystal, so it is important to use a highly heat resistant photosensitive organic insulating layer containing a highly pure acrylic resin or polyimide resin as the main ingredient of the photosensitive resin pattern 86C rather than an ordinary photosensitive resin containing Novolak resin as the main ingredient. It is also possible to compose the photosensitive resin pattern 86C by heating it with a photosensitive organic insulating layer material to fluidize it so it covers the side of the signal wire 12 by which the reliability of the liquid crystal panel is further increased. The composition of the storage capacitor 15 is exemplified in FIG. 1(f) as comprising a region 51 (a right-slanting oblique portion) on which the pixel electrode 22 and the storage capacitor line 16 are overlaid in a planar fashion via the gate insulating layer 30, though the composition of the storage capacitor 15 is not limited thereto, and the construction may be made via an insulating layer containing the gate insulating layer 30 between the scan line 11 at the upper pixel and the pixel electrode 22. Additionally, a transparent conductive layer pattern 40 may be disposed at the outer peripheral of the active substrate 2 as shown in FIG. 1(f) as a countermeasure for static electricity, and the countermeasure in the Conventional Example using a construction with the transparent conductive layer pattern 40 connected to the transparent conductive electrode terminals 5A and 6A may also be used, though other static electricity countermeasures are also easy as a formation process for openings in the gate insulating layer 30 is provided.

The reason why adequate reliability can be obtained in Embodiment 1 by forming an organic insulating layer only on the signal line 12, and exposing the pixel electrode 22 while retaining conductivity is that the drive signal applied on the liquid crystal cell is basically an alternating current signal, and the voltage of an opposing electrode 14 is adjusted at the time of the image testing (adjusted to reduce flickering) so that the direct current voltage component is decreased between the pixel electrode 22 and the opposing electrode 14 formed on the surface opposite the color filter 9, thus an insulating layer may be formed such that the signal line 12 is the only place where the direct current component does not flow.

In this manner, source and drain wires are formed using a photosensitive organic insulating layer, and a photosensitive organic insulating layer is left unchanged on only the signal line 12 in Embodiment 1 so that compared to conventional manufacturing processes, a decrease in the manufacturing processes may be furthered by making the removal process of the photosensitive resin pattern for forming the source and drain wires, the formation process of the passivating insulating layer, and the opening formation process of the passivating insulating layer unnecessary. Nevertheless, the thickness of the organic insulating layer is ordinarily 1 μm or more, so in cases of a high definition panel with small pixels, there is the possibility that the alignment treatment of the alignment film using a rubbing cloth may cause a state of non-alignment in the level difference or that ensuring the gap precision of the liquid crystal cell will be hindered. Therefore, a minimum number of processes are added in Embodiment 2 to provide passivation technology in place of the organic insulating layer.

### Embodiment 2

In Embodiment 2, the manufacturing process is carried out identically to that in Embodiment 1 up to the formation process of the contacts 63A and 65A above the scan line 11 and the storage capacitor line 16 as shown in FIGS. 3(d) and 4(d). However, an anodizable metal is required for the heat resistant metal layer 34, and Cr. Mo, W and the like are not suitable therefor, so at least, Ti, or preferably Ta or a silicide of a metal with a high melting point may be selected.

Then, IZO or ITO, for example, is deposited as a transparent conductive layer 91 about 0.1 to 0.2 μm thick over the entire surface of the glass substrate 2 using an SPT or other vacuum film depositing equipment; an Al or Al (Nd) alloy thin film layer about 0.3 μm thick is subsequently deposited as an anodizable low resistant metal layer; using micro-fabrication technology, the Al or Al(Nd) alloy thin layer 35, the transparent conductive layer 91, the heat resistant metal layer 34A, the second amorphous silicon layer 33A, and the first amorphous silicon layer 31A are removed using the photosensitive resin patterns 87A and 87B to selectively form a signal wire 12 doubling as a source line comprising a laminate of the low resistance metal layer 35A and the transparent conductive layer 91A containing a part of the semiconductor layer region 34A, and similarly a drain electrode 21 for the insulating gate type transistor doubling as a pixel electrode 22 comprising a laminate of the low resistance metal layer 35B and the transparent conductive layer 91 B such as to partially overlap with the channel protective layer 32D as shown in FIGS. 3(e) and 4(e); and an electrode terminal 5 for the scan lines containing a portion 73 of the scan line exposed and an electrode terminal 6 comprising part of the signal lines are formed at the same time as the formation of the source and drain wires 12 and 21. Forming the photosensitive resin patterns 87A and 87B thicker than the 3 μm, for example, of the region 87A (the black region) on the electrode terminals 5 and 6 and the pixel electrode 22 doubling as a drain electrode and the 1.5 μm thickness of the region 87B (the gray tone region) at this time is an important feature of Embodiment 2.

By reducing the above-mentioned photosensitive resin patterns 87A and 87B by at least 1.5 μm using oxygen plasma or other ashing means after the source and drain wires 12 and 22 are formed, the photosensitive resin pattern 87B can be eliminated to expose the signal wire 12 (35A) and leave the reduced photosensitive resin pattern 87C unchanged on the terminal electrodes 5 and 6 and the pixel 22 doubling as a drain electrode. Even if the width of the photosensitive resin pattern 87C is made fine in the above-mentioned oxygen plasma treatment, the fact that the electrical characteristics, yield and quality are affected hardly at all when an anodization layer is formed at the periphery of the electrode terminals 5 and 6 and the pixel electrode 22 having large pattern dimensions is a characteristic worthy of note. Then, the signal wire 12 is anodized and an oxide layer formed on its surface as shown in FIGS. 3(f) and 4(f) using the photosensitive resin pattern 87C as a mask. The Al or Al alloy thin film layer 35A which is a low resistance metal layer is exposed on the top surface of the signal line 12; the laminate of the Al or Al alloy thin layer 35A, the transparent conductive layer 91A, and a Ti thin film layer 34A1(not illustrated) which is a heat resistant metal layer, and the second amorphous silicon layer 33A is exposed on one of the sides of the channel; and the laminate of the Al or Al alloy thin film layer 35A and the transparent conductive layer 91A is exposed on the opposite side of the channel. The Al or Al thin alloy film layer 35A transmutes aluminum oxide (Al2O3) 69 (12) which is an insulating layer, the Ti thin film layer 34A1 not illustrated transmutes titanium oxide (TiO2) 68 (12) which is a semiconductor, and the second amorphous silicon layer 33A similarly not illustrated transmutes a silicon oxide layer (SiO2) 66 containing impurities through anodization. The top surface of the pixel electrode 22 is covered with the photosensitive resin pattern 87C; and the laminate of the Al or Al alloy thin layer 35B, the transparent conductive layer 91B, a Ti thin film layer 34A2 (not illustrated) which is a heat resistant metal layer, and the second amorphous silicon layer 33A is exposed one side of the channel; the laminate of the Al or Al alloy thin layer 351B and the transparent conductive layer 91B is exposed on the other side of the channel; and anodized layers of these thin films are formed similarly. The titanium oxide layer 68 is not an insulating layer, but it is extremely thin and the exposed area is small, so passivation is not a problem, but for the heat resistant metal thin layer 34A, selecting Ta is desirable. Unlike Ti, however, care is needed with Ta as it has a characteristic of lacking the function to easily absorb the surface oxide layer of the base to make ohmic contact. Even if the transparent conductive layer 91A made from IZO or ITO is anodized, an insulating oxide layer is not formed.

An aluminum oxide 69 (35B), an insulating layer, is formed on the side of the low resistance metal layer 35B on the pixel electrode 91B during anodization of the signal line 12, and if the interval of the electrode terminals 5 and 6 for the scan and signal lines is connected with a conductive medium as a countermeasure for static electricity, the chemical current from the signal line 12 flows through the conductive medium, so 69 (35C) is formed similarly on the side of the electrode terminal 5 comprising the low resistance metal layer 35C. The resistance value of the conductive medium is generally high, however, so 69 (35C) should ordinarily be made even thinner than 69 (35B).

For wire passivation, about 0.1 to 0.2 μm is adequate for the thickness of each of the aluminum oxide 69, titanium oxide 68, and silicon oxide layer 66 layers formed with anodization; using a chemical liquid such as ethylene glycol similarly achieves an applied voltage exceeding 100 V. With a thickness of about 0.1 to 0.2 μm, the anodization layer 69 (12) obtains adequate passivation performance, so that there is no danger of trouble occurring in the alignment treatment. Matters for which care is required in the anodization of the source and drain wires 12 and 21 are that all of the signal wires 12 need to be formed in parallel or series electrically, though this is not illustrated, and it goes without saying that if this parallel or series configuration is not undone at some point in the subsequent manufacturing processes, trouble will occur not only in the electrical test of the active substrate 2 but in the actual operation of the resulting liquid crystal display device. These matters are common to all of the embodiments hereinbelow; removal means using transpiration by laser light irradiation or mechanical excision by scribing are simple, and so a detailed explanation therefor is omitted.

After the anodization is complete, the photosensitive resin pattern 87C is removed, exposing the electrode terminals 5 and 6 comprising the low resistance metal layers 35A and 35C, and the drain electrode (pixel electrode) comprising the low resistance metal layer 35B in whose side the anodization layer was formed as shown in FIGS. 3(g) and 4(g).

Further, the low resistance metal layers 35A to 35C are removed using the anodization layer 69 (12) on the signal line 12 to expose the transparent conductive layers 91A to 91C as shown in FIGS. 3(h) and 4(h), the latter layers function respectively as the electrode terminal 6A for the signal line, the pixel electrode 22, and the terminal electrode 5A for the scan line. The existing parental portion (35B and 35C) of the anodized layers 69 (35B) and 69 (35C) on the side of the pixel electrode 22 (35B) and the side of the electrode terminal 5 for the scan lines is eliminated, so the anodized layers 69 (35B) and 69 (35C) are eliminated by being lifted off. The active substrate 2 thus obtained and the color filter 9 are attached together to form a liquid crystal display, and completing Embodiment 2 of the present invention. The construction of the storage capacitor 15 is identical to that in Embodiment 1.

The reason why adequate reliability can be obtained in Embodiment 2 when an anodizing layer is formed only on the signal line 12 to expose the pixel electrode 22 while retaining conductivity is that the drive signal applied on the liquid crystal cell is basically an alternating current signal as described above, and an insulating layer may be formed such that the signal line 12 is the only place where the direct current component does not flow. In a more precise description, the transparent conductive layer 91A is exposed on the bottom surface of the signal wire 12, but the amount of that exposure is small at 0.1 μm wide at the most, so for example, if the pattern width of the signal line 12 is 4 μm, only about 1/40th of that is exposed, so if an insulating layer is formed on the top surface of the signal line 12, the degradation of the liquid crystals due to the direct current component from the exposed transparent conductive layer 91A may be ignored in this process.

In Embodiments 1 and 2, reduction in the processes was achieved by forming the pixel electrode and signal line at the same time to make the passivating insulating layer unnecessary, but the number of masks required for production of the active substrate is not reduced beyond five. Streamlining other main processes to further lower costs is a theme of the invention, and in the below embodiments, the innovation and inventiveness used in further decreasing the four-mask process to a three-mask process by streamlining other major processes while maintaining the simultaneous formation of the pixel electrode and signal line as well as the process reduction by making the passivating insulating layer unnecessary are described.

### Embodiment 3

In Embodiment 3, a second SiNx layer is selectively left above a gate electrode 11A finer in width than said gate electrode to make a protective insulating layer 32D using micro-fabrication technology as shown in FIGS. 5(b) and 6(b), and the manufacturing process is carried out identically to that in Embodiment 1 up to the exposure of the first amorphous silicon layer 31.

Continuing, a second amorphous silicon layer 33 about 0.05 μm thick, for example, containing phosphorous, for example, as an impurity is deposited over the entire surface using a PCVD equipment in a similar manner. Then, a thin film layer 34 of Ti, Cr, Mo or the like, for example, is deposited as a heat resistant metal layer about 0.1 μm thick using an SPT or other vacuum film depositing equipment, and photosensitive resin patterns 81A and 81B are formed using half-tone exposure technology so as to have openings 63 and 65A at the contact formation region of the scan line 11 and the storage capacitor line 16 in the region outside the image display portion, and such that the film thickness of the semiconductor layer formation region, that is, the region 81A above the gate electrode 11A for the insulating gate type transistor is thicker at 2 μm, for example, than the 1 μm of the other region 81B film. Then, a heat resistant metal layer 34, a second amorphous silicon layer 33, and a first amorphous silicon layer 31 exposed 20 in the openings 63A and 65A are successively etched using the photosensitive resin patterns 81A and 81B as shown in FIGS. 5(c) and 6(c) to expose gate insulating layer 30 in the openings 63A and 65A. Because the electrode terminal of the scan line 11 is about half the electrode pitch of the driver LSI at the most, and normally larger than 20 μm, making the photomask and controlling the finishing dimensions is extremely easy for forming the openings 63A and 65A (white regions).

Continuing, by reducing the above-mentioned photosensitive resin patterns 81A and 81B by 1 μm or more using oxygen plasma or other ashing means, the photosensitive resin pattern 81B can be eliminated exposing the heat resistant metal layer 34, and the reduced photosensitive resin pattern 81C can be left unchanged only above the gate electrode 11A as shown in FIGS. 5(d) and 6(d). The pattern width of the etch stop layer 32D, the gate electrode 11A and the islanded semiconductor layer formation region (81C) are each wider in that order by the amount of the mask alignment precision (ordinarily, 2 to 3 μm), mask alignment is carried out on the source and drain wires 12 and 21 with the etch stop layer 32D as the reference, so that even if the semiconductor layer formation region decreases in size somewhat, there are no effects such as the insulating gate type transistor becoming offset and causing malfunction or the electrical characteristics of the insulating gate type transistor changing greatly, so care is not so much needed for dimension changes in the semiconductor layer formation region, that is 81C.

Continuing, the heat resistant metal layer 34, the second amorphous silicon layer 33, and the first amorphous silicon layer 31 are selectively left above the gate electrode 11A wider than the gate electrode 11A using the reduced photosensitive resin pattern 81C as a mask to island 34A, 33A and 31A respectively and expose the gate insulating layer 30 as shown in FIGS. 5(e) and 6(e). The smallest dimension of the photosensitive resin pattern 81C (the black region), that is the semiconductor layer formation region 34A is 16 μm. It should be understood that not only is producing a photomask for making the regions outside the white and black regions half-tone regions easy, but that there is hardly any fluctuation in the electrical characteristics of the insulating gate type transistor even if the dimension precision of the semiconductor layer formation region 34A fluctuated, so process control is made easier.

The etching state of the openings 63A and 65A at this time is as described below, and in the end, the part 73 of the scan line 11 and the part 75 of the storage capacitor line 16 are exposed in the openings 63A and 65A respectively. The etching ordinary used utilizes a chlorine gas for etching the heat resistant metal layer 34, but the gate insulating layer 30 comprising SiNx is hardly reduced at all because of its resistance at that time, so first the heat resistant metal layer 34 is removed to expose the second amorphous silicon layer 33 over the entire surface of the glass substrate 2. Next, dry etching utilizing a fluorine gas is used to etch the second amorphous silicon layer 33 and the first amorphous silicon layer 31. By applying process conditions where the gate insulating layer 30 comprising SiNx is etched somewhat faster (about three times) than the amorphous silicon layers 33 and 31 at this time, etching of the gate insulating layer 30 (film thickness of 0.3 μm) comprising SiNx in the openings 63A and 65A ends when the etching of the second amorphous silicon layer 33 (film thickness of 0.05 μm) and the first amorphous silicon layer 31(film thickness of 0.05 μm) ends, exposing the part 73 of the scan line 11 and the part 75 of the storage capacitor line 16 in the openings 63A and 65A respectively.

To end the etching of the second amorphous silicon layer 33 and the first amorphous silicon layer 31 faster than this suitable etching rate, the gate insulating layer 30 in the openings 63A and 65A must be removed by over etching, but in that case, the gate insulating layer 30 is already exposed over the entire surface of the glass substrate 2, and the entire gate insulating layer 30 is reduced, causing shorts between the layers of the scan line 11 and the source and drain wires 12 and 21 formed in the subsequent manufacturing processes and shorts between the layers of the pixel electrode 22 and the storage capacitor line 16 to occur readily, thereby lowering the yield. A laminate comprising the heat resistant metal layer 34, the second amorphous silicon layer 33, and the first amorphous silicon layer 31 may be left similar to the semiconductor formation region not illustrated above the storage capacitor line 16 and adjacent to the intersection of the signal line 12 and the scan line 12 as a countermeasure to prevent reduction in the gate insulating layer 30. In other words, it is possible to ensure the yield with the pattern design.

During etching of the semiconductor layer formation region, if the etching rate of the part 73 of the scan line 11 and the part 75 of the storage capacitor line 16 exposed by the etching liquid or etching gas of the heat resistant metal layer 34 is extremely low, for example, if the heat resistant metal layer 34 is Cr or Mo (using a blended etching liquid of perchloric acid and cerium nitrate for Cr or an etching liquid with a minute amount of ammonia added to hydrogen peroxide solution for Mo) and the scan line 11 is an Al alloy, the etching may be done in a series all at once including the gate insulating layer 30 to expose the parts 73 and 75 of the scan line 11 and the storage capacitor line 16 in the openings 63A and 65A respectively, oxygen plasma treatment carried out next, the heat resistant metal layer 34 (Cr or Mo) removed using the above-mentioned etching liquid using the reduced photosensitive resin pattern 81C as a mask, and next the second amorphous silicon layer 33 and the first amorphous silicon layer 31 etched with dry etching to expose the gate insulating layer 30. With dry etching, however, the selectively ratio obtained is not generally speaking as high as with a etching liquid, in which case the etching method initially mentioned is adopted.

After removing the aforementioned photosensitive resin pattern 81, IZO or ITO, for example, is deposited as a transparent conductive layer 91 about 0.1 to 0.2 μm thick over the entire surface of the glass substrate 2 using an SPT or other vacuum film depositing equipment as in Embodiment 1, and an Al or Al (Nd) alloy thin film layer 35 about 0.3 μm thick is subsequently deposited as a low resistance metal layer. Then, photosensitive organic insulating layer patterns 86A and 86B are formed thicker than the 1.5-μm thickness of 86B on the electrode terminals 5 and 6 and the pixel electrode 22 doubling as a drain electrode 21 and the 3-μm thickness, for example, of 86A on the signal line 12 using half-tone exposure technology; the signal line 12 doubling as the source wire comprising a laminate of 91A and 35A, and the drain electrode 21 of the insulating gate type transistor doubling as the pixel electrode 22 comprising a laminate of 91B and 35B are selectively formed as shown in FIG. 5(f) and 6(f) using the photosensitive organic insulating layer patterns 86A and 86B; and an electrode terminal 6 comprising a part of the signal line and an electrode terminal 5 of the scan line are formed containing a part 73 of the scan line exposed are formed at the same time as the formation of the source and drain wires 12 and 21.

After the source and drain wires 12 and 21 are formed, the above-mentioned photosensitive organic insulating layer patterns 86A and 86B are reduced by at least 1.5 μm using oxygen plasma or other ashing means to expose the low resistance metal layers 35A to 35C on the electrode terminals 5 and 6 and on the pixel 22 doubling as a drain electrode, the low resistance metal layers 35A to 35C are removed using the reduced photosensitive organic insulating layer pattern 86C as a mask, and a transparent conductive pixel electrode 22 and transparent conductive electrode terminals 5A and 6A are formed as shown in FIGS. 5(g) and 6(g).

The active substrate 2 thus obtained and the color filter 9 are attached together to form a liquid crystal panel, thereby completing Embodiment 3 of the present invention. In Embodiment 3 as well, using an organic insulating layer with a high heat resistance and containing a highly pure acrylic resin or polyimide resin as the main ingredient for the photosensitive organic insulating layer pattern 86C is important. The construction of the storage capacitor 15 is identical to that in Embodiment 1 as shown in FIG. 5(g).

### Embodiment 4

Embodiment 4 is equipped with passivation technology in place of the organic insulating layer as an addition to the minimum number of processes in Embodiment 3, similar to the relationship of Embodiment 1 and Embodiment 2. In Embodiment 4, the same manufacturing process used in Embodiment 3 is carried out up to the formation of a semiconductor layer region comprising a laminate of an anodizable heat resistant metal layer 34A, a second amorphous silicon layer 33A, and a first amorphous silicon layer 31A above the gate electrode 11A, and contacts 63A and 65A on the scan line 11 and the storage capacitor line 16 in the regions outside the image display as shown in FIGS. 7(e) and 8(e). The description for 7(d) and 8(d) is omitted due to considerations of the gazette.

Then, IZO or ITO, for example, is deposited as a transparent conductive layer 91 about 0.1 to 0.2 μm thick over the entire surface of the glass substrate 2 using an SPT or other vacuum film depositing equipment, and an Al or Al (Nd) alloy thin film layer about 0.3 μm thick is subsequently deposited as an anodizable low resistant metal layer. Using half-tone exposure technology, photosensitive resin patterns 87A and 87B are formed thicker than the 1.5-μm thickness of 87B on the signal line 12, with the thickness 3 μm of 87A on the drain electrode 21 and the electrode terminals 5 and 6, for example. A signal line 12 doubling as a source wire comprising a laminate of 91A and 35A, and a drain electrode 21 of an insulating gate type transistor doubling as a pixel electrode 22 comprising a laminate of 91B and 35B are selectively formed as shown in FIGS. 7(f) and 8(f) using the photosensitive resin patterns 87A and 87B. Then, an electrode terminal 6 comprising a part of the signal line and an electrode terminal 5 of the scan line containing a part 73 of the scan line exposed are formed at the same time as the formation of the source and drain wires 12 and 21.

After the source and drain wires 12 and 22 are formed, the above-mentioned photosensitive resin patterns 87A and 87B are reduced by at least 1.5 μm using oxygen plasma or other ashing means to expose the signal line 12 (35A), and the signal line 12 is anodized to form an oxide layer 69 (12) on the surface using the reduced photosensitive resin pattern 87C as a mask as shown in FIGS. 7(g) and 8(g).

After the anodization is done, the photosensitive resin pattern 87C is removed to expose the electrode terminals 6 and 5 comprising the low resistance metal layers 35A and 35C and the pixel electrode comprising the low resistance metal layer 35B in whose side the anodized layer 69 (35B) is formed as shown in FIGS. 7(h) and 8(h).

Next, when the low resistance metal layers 35A to 35C are removed using the anodization layer 69 (12) on the signal line 12 as a mask, the transparent conductive layers 91A to 91C are exposed as shown in FIGS. 7(i) and 8(i), the latter layers are functioning respectively as the electrode terminal 6A for the signal line, the pixel electrode 22, and the terminal electrode 5A for the scan line. The active substrate 2 thus obtained and the color filter 9 are attached together to form a liquid crystal panel, thereby completing Embodiment 4 of the present invention. The construction of the storage capacitor 15 is identical to that in Embodiment 3.

Reduction of the manufacturing processes is thus advanced in Embodiment 3 and Embodiment 4 by carrying out the formation process of the semiconductor layer and the formation process of the contacts with the same photomask using half-tone exposure technology, and a liquid crystal display device is obtained using a four photomasks, but the half-tone exposure technology can be applied to other main processes to make a four-mask process with different details as explained below.

### Embodiment 5

To begin with, in Embodiment 5, Cr, Ta, Mo or the like or an alloy or silicide thereof, for example, is deposited as a first metal layer about 0.1 to 0.3 μm thick on the primary surface of a glass substrate 2 using an SPT or other vacuum film depositing equipment. Then, a scan line 11 doubling as a gate electrode 11A and a storage capacitor line 16 are selectively formed using micro-fabrication technology as shown in FIGS. 9(a) and 10(a).

Next, three thin film layers comprising a first SiNx layer 30 forming a gate insulating layer, a first amorphous silicon layer 31 forming a channel for an insulating gate type transistor containing hardly any impurities, and a second SiNx layer 32 forming an insulating layer for protecting the channel are successively deposited about 0.3, 0.05, and 0.1 μm thick, for example, over the entire surface of the glass substrate 2 using a PCVD equipment. Photosensitive resin patterns 85A and 85B having openings 63A and 65A on a contact formation region of a scan line 11 and a storage capacitor line 16 in the region outside the image display part are formed using half-tone exposure technology such that the protective insulating layer formation region, that is the region 85A above a gate electrode 11A is thicker at 2 μm, for example, than the 1-μm thickness of the other region 85B. A second SiNx layer 32, a first amorphous silicon layer 31 and a first SiNx layer which is a gate insulating layer, are selectively removed in the opening 63A and the opening 65A using the photosensitive resin patterns 85A and 85B as masks to expose a part 73 of the scan line 11 and a part 75 of the storage capacitor line 16. In other words, contacts are formed in the scan line 11 and the storage capacitor line 16. Because the electrode terminal of the scan line 11 is about half the electrode pitch of the driver LSI at the most, and normally larger than 20 μm, producing a photomask for forming the openings 63A and 65A (white regions) and controlling the finishing dimensions are extremely easy.

Continuing, by reducing the above-mentioned photosensitive resin patterns 85A and 85B 1 μm or more using oxygen plasma or other ashing means, the photosensitive resin pattern 85B can be eliminated, exposing the second SiNx layer 32 and leaving the reduced photosensitive resin pattern 85C unchanged only on the protective insulating layer formation region. The width of the photosensitive resin pattern 85C, that is, the etch stop layer is the sum of the mask alignment precision and the length between the source and drain wires, so if the source and drain wire interval is 4 to 6 μm and the alignment precision is ±3 μm, then the width of the photosensitive resin pattern 85C is 10 to 12 μm, not a strict condition for dimension precision. If the resist pattern is isotropically reduced 1 μm during the conversion from the resist pattern 85A to 85C, however, not only does the dimension decrease 2 μm, but the mask alignment precision decreases 1 μm to ±2 μm during source and drain wire formation, with the effects of the latter more strict in terms of process than the former. In the above-mentioned oxygen plasma treatment, it is therefore desirable to suppress change in the pattern dimensions by increasing the anisotropy. In further detail, RIE oxygen plasma treatment is desirable, and ICP or TCP oxygen plasma treatment is even more desirable, having a high density plasma source. Alternatively, that measures such as providing for a process-approach by designing the pattern dimensions of the resist pattern 85A larger beforehand, anticipating the amount of dimension change in the resist pattern, are desirable has already been discussed.

Continuing, the second SiNx layer 32 is selectively etched finer than the gate electrode 11A using the photosensitive resin pattern 85C as a mask to form an etch stop layer 32D and expose the first amorphous silicon layer 31 as shown in FIGS. 9(c) and 10(c). The size of the protective insulating layer formation region, that is the photosensitive resin pattern 85C (the black region) is 10 μm. It should be understood that not only is it easy to produce a photomask for making the regions outside the white and black regions half-tone exposure regions, but that what determines the on current of the insulating gate type transistor is the dimension of the channel protective insulating layer 32D, not the dimension of the interval between the source and drain wires 12 and 21, so process control is made yet easier than with a channel etch type insulating gate transistor. In further detail, the length of the interval between the source and drain wire interval is 5±1 μm with the channel etch type, but with the etch stop type, the length of the protective insulating layer is 10±1 μm, roughly halving the on current fluctuations under identical development conditions.

After exposing the first amorphous silicon layer 31, the above-mentioned photosensitive resin pattern 85C is removed, and a second amorphous silicon layer 33 containing phosphorous, for example, as an impurity is deposited about 0.05 μm thick, for example, over the entire surface of the glass substrate 2 using a PCVD equipment. Then, a thin film layer 34 of Ti, Cr, Mo, or the like, for example, is deposited as a heat resistant metal layer about 0.1 μm thick using an SPT or other vacuum film depositing equipment. A semiconductor layer region is formed comprising a laminate made of a first amorphous silicon layer 31A, a second amorphous silicon layer 33A, and a heat resistant metal layer 34A wider than the gate electrode 11A above the gate electrode 11A using micro-fabrication technology to expose the gate insulating layer 30 as shown in FIGS. 9(d) and 10(d). At this time, it is a general practice to form an intermediate electrode comprising a laminate made of a second amorphous silicon layer 33C and a heat resistant metal layer 34C containing a part 73 of the scan line exposed in the opening 63A. This results in leaving the partial formation of a first amorphous silicon layer 31C at the periphery of the opening 63A below the intermediate electrode.

If a scan line material or etching method is used such as would enhance reactive products are not generated such as will enhance the contact resistance on the part 73 of the scan line when the second amorphous silicon layer 33C and the first amorphous silicon layer 31C are formed, it is possible to expose the part 73 of the scan line without forming the above-mentioned intermediate electrode in which case the construction of the active substrate 2 is identical as in Embodiment 1 and Embodiment 2, supplementing the embodiment to eliminate differences in the constructions thereof.

Similar to Embodiment 1, in the formation process of the source and drain wires and the pixel electrode, IZO or ITO, for example, is deposited as a transparent conductive layer 91 about 0.1 to 0.2 μm thick using an SPT or other vacuum film depositing equipment over the entire surface of the glass substrate 2; an Al or Al (Nd) alloy thin film layer 35 about 0.3 μm thick is subsequently deposited as a low resistance metal layer; photosensitive organic insulating layer patterns 86A and 86B are formed thicker than the 1.5-μm thickness of 86B on the electrode terminals 5 and 6 and on the pixel electrode 22 doubling as a drain electrode and the 3-μm thickness, for example, of 86A on the signal line 12 using half-tone exposure technology; a drain electrode 21 of the insulating gate type transistor doubling as the pixel electrode 22 comprising a laminate made of 91B and 35B, and a signal line 12 doubling as the source wire comprising a laminate made of 91A and 35A are selectively formed as shown in FIGS. 9(e) and 10(e) using the photosensitive organic insulating layer patterns 86A and 86B; and an electrode terminal 6 comprising part of the signal line and an electrode terminal 5 of the scan line containing the intermediate electrode exposed are formed at the same time as the formation of the source and drain wires 12 and 21.

After the source and drain wires 12 and 21 are formed, the above-mentioned photosensitive organic insulating layer patterns 86A and 86B are reduced by at least 1.5 μm using oxygen plasma or other ashing means to expose the low resistance metal layers 35A to 35C on the pixel 22 doubling as a drain electrode and on the electrode terminals 5 and 6, and when the low resistance metal layers 35A to 35C are removed using the reduced photosensitive organic insulating layer pattern 86C as a mask, a transparent conductive pixel electrode 22 and transparent conductive electrode terminals 5A and 6A are formed as shown in FIGS. 9(f) and 10(f).

The active substrate 2 thus obtained and the color filter 9 are attached together to form a liquid crystal panel, thereby completing Embodiment 5 of the present invention. As shown in FIG. 9(f), the composition of the storage capacitor 15 is identical to that exemplified in Embodiment 1 where it comprises a region 51 (a right-slanting oblique part) on which the pixel electrode 22 and the storage capacitor line 16 are overlaid in a planar fashion via the gate insulating layer 30.

### Embodiment 6

Embodiment 6 is equipped with passivation technology in place of the organic insulating layer as an addition to the minimum number of processes in Embodiment 5, similar to the relationship of Embodiment 1 and Embodiment 2. The manufacturing process of Embodiment 6 proceeds identically to that in Embodiment 5 up to where a semiconductor layer region comprising a laminate made of a first amorphous silicon layer 31A, a second amorphous silicon layer 33A, and a anodizable heat resistant metal layer 34A wider than the gate electrode 11A is formed above the gate electrode 11A, and an intermediate electrode comprising a laminate made of a second amorphous silicon layer 33C and an anodizable heat resistant metal layer 34C containing the openings 63A and 65A is formed to expose the gate insulating layer 30 using micro-fabrication technology as shown in FIGS. 11(d) and 12(d).

Then, IZO or ITO, for example, is deposited as a transparent conductive layer 91 about 0.1 to 0.2 μm thick over the entire surface of the glass substrate 2 using an SPT or other vacuum film depositing equipment; an Al or Al (Nd) alloy thin film layer about 0.3 μm thick is subsequently deposited as an anodizable low resistant metal layer; using half-tone exposure technology, photosensitive resin patterns 87A and 87B are formed thicker than the 1.5-μm thickness of 87B on the signal line 12 and the 3-μm thickness, for example, of 87A on the electrode terminals 5 and 6 and the drain electrode 21; the signal line 12 doubling as a source wire comprising a laminate made from 91A and 35A and the drain electrode 21 of an insulating gate type transistor doubling as a pixel electrode 22 comprising a laminate made of 91B and 35B are selectively formed as shown in FIGS. 11(e) and 12(e) using the photosensitive resin patterns 87A and 87B; and an electrode terminal 6 comprising a part of the signal line and an electrode terminal 5 of a scan line containing an intermediate electrode exposed are formed at the same time as the formation of the source and drain wires 12 and 21.

After the source and drain wires 12 and 21 are formed, the above-mentioned photosensitive resin patterns 87A and 87B are reduced at least 1.5 μm using oxygen plasma or other ashing means to expose the signal line 12 (35A), and the signal line 12 is anodized to form an oxide layer 69 (12) on its surface as shown in FIGS. 11(f) and 12(f) using the reduced photosensitive resin pattern 87C as a mask.

After the anodization ends, the photosensitive resin pattern 87C is removed, exposing the electrode terminals 6 and 5 comprising the low resistance metal layers 35A and 35C and the pixel electrode comprising the low resistance metal layer 35B in whose side the anodization layer 69 (35B) was formed as shown in FIGS. 11(g) and 12(g).

Further, the low resistance metal layers 35A to 35C are removed using the anodization layer 69 (12) on the signal line 12 as a mask, exposing the transparent conductive layers 91A to 91C as shown in FIGS. 11(h) and 12(h), the latter layers respectively are functioning as the electrode terminal 6A for the signal line, the pixel electrode 22, and the terminal electrode 5A for the scan line. The active substrate 2 thus obtained and the color filter 9 are attached together to form a liquid crystal panel, thereby completing Embodiment 6 of the present invention. The construction of the storage capacitor 15 is identical to that in Embodiment 5.

Reduction of the manufacturing processes is advanced in Embodiment 5 and Embodiment 6 in this manner by carrying out the formation process of the etch stop layer and the formation process of the contacts with the same photomask using half-tone exposure technology to obtain a liquid crystal display device using four photomasks, but a four-mask process is also possible with different details as explained below.

### Embodiment 7

To begin with, in Embodiment 7, Cr, Ta, Mo or the like or an alloy or silicide thereof, for example, is deposited as a first metal layer about 0.1 to 0.3 μm thick on the primary surface of a glass substrate 2 using an SPT or other vacuum film depositing equipment. When selecting an organic insulating layer for an insulating layer to be formed on the side of a scan line, there are almost no restrictions on the scan line material in Embodiment 7, but when selecting an anodized layer for an insulating layer to be formed on the side of a scan line, the anodized layer needs to retain insularity, in which case a single layer construction of Al (Zr, Ta, Nd) alloy or other high heat resistant alloy or a laminate construction of Al/Ta, Ta/Al/Ta, Al/Al (Ta, Zr, or Nd) alloy or the like may be selected for the construction of the scan line to lower the resistance of thereof when the facts that Ta by itself has high resistance and Al by itself lacks heat resistance are taken into consideration.

Next, three thin film layers comprising a first SiNx layer 30 forming a gate insulating layer, a first amorphous silicon layer 31 forming a channel for an insulating gate type transistor containing hardly any impurities, and a second SiNx layer 32 forming an insulating layer for protecting the channel are successively deposited about 0.3, 0.05, and 0.1 μm thick, for example, over the entire surface of the glass substrate 2 using a PCVD equipment. Photosensitive resin patterns 82A and 82B are formed using half-tone exposure technology thinner than the 2-μm thickness of the region 82A corresponding to the scan line 11 and the storage capacitor line 16 with the contact formation region 82B corresponding to the openings 63A and 65A 1 μm thick, for example, as shown in FIGS. 13(a) and 14(a); and the second SiNx layer 32, the first amorphous silicon layer 31, the gate insulating layer 30 and the first metal layer are selectively removed using the photosensitive resin patterns 82A and 82B as masks to expose the glass substrate 2. The contact is ordinarily 10 μm or wider, equal to the electrode terminal, so control of the precision of the production of the photomask for forming 82B (the gray tone region) and its finished dimensions is easy.

Continuing, by reducing the above-mentioned photosensitive resin patterns 82A and 82B 1 μm or more using oxygen plasma or other ashing means, the photosensitive resin pattern 82B can be eliminated to expose the second SiNx layers 32A and 32B in the openings 63A and 65A, and leave the reduced photosensitive resin pattern 82C unchanged above the scan line 11 and the storage capacitor line 16 as shown in FIGS. 13(d) and 14(d). The pattern width of the photosensitive resin pattern 82C (the black region), that is, the gate electrode 11A is the sum of the mask alignment precision and the dimension of the protective insulating layer, so the dimension precision is not strict, at 16 to 18 μm at the least with the channel protective insulating layer 10 to 12 μm and the alignment precision ±3 μm. Also, the pattern width for the storage capacitor line 16 and the scan line 11 is set ordinarily at 10 μm or wider due to the resistance value. If the resist pattern is isotropically reduced 1 μm during the conversion from the resist pattern 82A to 82C, not only does the dimension decrease 2 μm, but the mask alignment precision decreases 1 μm to ±2 μm during the subsequent protective insulating layer formation, so that effects of the latter are more strict in terms of process than the former. In the above-mentioned oxygen plasma treatment, it is therefore desirable to suppress change in the pattern dimensions by increasing the anisotropy. In further detail, RIE oxygen plasma treatment is desirable, and ICP or TCP oxygen plasma treatment is even more desirable, having a high density plasma source. Alternatively, measures such as providing for a process-approach of designing beforehand the pattern dimensions of the resist pattern 82A larger, anticipating the amount of dimension change in the resist pattern are desirable.

Continuing, an insulating layer 76 is formed on the side of the gate electrode 11A (scan line 11) as shown in FIG. 14(b). Because of this, a connection pattern 78 is needed to provide potential to the scan line 11 during anodization or electrodeposition at the outer periphery of the glass substrate 2 and the wire 77 bundled in parallel with the scan line 11 is needed (as with the storage capacitor line 16 whose illustration is omitted) as shown in FIG. 49, and a film deposition region 79 is limited to inside the pattern 78 using suitable mask means for the silicon nitride layers 30 and 32 and the amorphous silicon layer 31 made with a PCVD equipment; at the least, the connection pattern 78 needs to be exposed electrically. When the photosensitive resin pattern 82C (78) on the connection pattern 78 is pierced to provide a positive potential to cause a chemical liquid whose main ingredient is ethylene glycol to penetrate the glass substrate 2 and anodize using connection means such as an alligator clip having a sharp point on the connection pattern 78, if the scan line 11 is an Al alloy, an aluminum oxide (Al2O3) is formed 0.3 μm thick having a chemical voltage of 200 V, for example. If electrodeposition is used, a polyimide resin layer is formed 0.3 μm thick having an electrodeposition voltage number V using a polyimide electrodeposition liquid with a pendant carboxyl group as shown in the literature, the November 2002 issue of Kobunshi Kako. A point to keep in mind when forming the insulating layer in the exposed sides of scan line 11 and the storage capacitor line 16 is that if the parallel configuration of at least the scan line 11 is not undone at some point in the subsequent manufacturing process, it goes without saying that trouble will occur not only in the electrical test of the active substrate 2 but in the actual operation of the resulting liquid crystal display device as well. Removal means using transpiration by laser light irradiation or mechanical excision by scribing are simple, and so a detailed explanation therefor is omitted.

[Non-Patent Literature 1] Monthly Kobunshi Kako, November 2002 issue.

After the insulating layer 76 is formed, the second SiNx layers 32A and 32B, the first amorphous silicon layers 31A and 31B, and the gate insulating layers 30A and 30B are selectively etched in the openings 63A and 65A using the reduced photosensitive resin pattern 82C as a mask to expose the part 73 of the scan line 11 and the part 75 of the storage capacitor line 16 respectively as shown in FIGS. 13(c) and 14(c).

After removing the above-mentioned photosensitive resin pattern 82C, the second SiNx layer 32A above the gate electrode 11A is selectively etched finer than the gate electrode 11A using micro-fabrication technology to form an etch stop layer 32D and expose the first amorphous silicon layer 31B on the storage capacitor line 16 and the first amorphous silicon layer 31A on the scan line 11 as shown in FIGS. 13(d) and 14(d). If required, by covering the exposed part 73 of the scan line 11 and part 75 of the storage capacitor line 16 with a photosensitive resin (not illustrated), thinning and transmuting during etching of the second SiNx layer 32A can easily be prevented. In more detail, the second SiNx layer 32C remains at the periphery of the openings 63A and 65A, but this does not cause any contact problems for the scan line 11.

After that, a second amorphous silicon layer 33 containing phosphorous, for example, as an impurity is deposited 0.05 μm thick, for example, on the entire surface of the glass substrate 2 using a PCVD equipment, then a thin film layer 34 of Ti, Cr, Mo or the like, for example, is deposited as a heat resistant layer about 0.1 μm thick using an SPT or other vacuum film depositing equipment. Next, a semiconductor layer comprising a laminate made of the heat resistant layer 34A and the second amorphous silicon layer 33A wider than the gate electrode 11A containing same is selectively formed to expose the glass substrate 2, and first amorphous silicon layers 31A and 31B on the scan line 11 and the storage capacitor line 16 are removed by overetching to expose the gate insulating layers 30A and 30B respectively using micro-fabrication technology as shown in FIGS. 13(e) and 14(e). At the same time, an intermediate electrode is formed comprising a laminate made of the second amorphous silicon layer 33C and heat resistant metal layer 34C containing the openings 63A and 65A.

As in Embodiment 1, in the formation process of the source and drain wires and the pixel electrode, IZO or ITO, for example, is deposited as a transparent conductive layer 91 about 0.1 to 0.2 μm thick using an SPT or other vacuum film depositing equipment over the entire surface of the glass substrate 2; an Al or Al (Nd) alloy thin film layer 35 about 0.3 μm thick is subsequently deposited as a low resistance metal layer; photosensitive organic insulating layer patterns 86A and 86B are formed thicker than the 1.5-μm thickness of 86B on the electrode terminals 5 and 6 and the pixel electrode 22 doubling as a drain electrode 21 and the 3-μm thickness, for example, of 86A on the signal line 12 using half-tone exposure technology; a drain electrode 21 of the insulating gate type transistor doubling as the pixel electrode 22 comprising a laminate made from 91B and 35B, and a signal line 12 doubling as a source wire comprising a laminate made of 91A and 35A are selectively formed as shown in FIGS. 13(f) and 14(f) using the photosensitive organic insulating layer patterns 86A and 86B; and an electrode terminal 6 comprising a part of the signal line and an electrode terminal 5 of the scan line containing the intermediate electrode exposed are formed at the same time as the formation of the source and drain wires 12 and 21.

After the source and drain wires 12 and 21 are formed, the above-mentioned photosensitive organic insulating layer patterns 86A and 86B are reduced by at least 1.5 μm using oxygen plasma or other ashing means to expose the low resistance metal layers 35A to 35C on the pixel 22 doubling as a drain electrode and on the electrode terminals 5 and 6, the low resistance metal layers 35A to 35C are removed using the reduced photosensitive organic insulating layer pattern 86C as a mask, and a transparent conductive pixel electrode 22 and transparent conductive electrode terminals 5A and 6A are formed as shown in FIGS. 13(g) and 14(g).

The active substrate 2 thus obtained and the color filter 9 are attached together to form a liquid crystal panel, thereby completing Embodiment 7 of the present invention. As shown in FIG. 13(g), the composition of the storage capacitor 15 is exemplified as constructed by a region 51 (a right-slanting oblique part) on which the pixel electrode 22 and the storage capacitor line 16 are overlaid in a planar fashion via the gate insulating layer 30B, but the construction of the storage capacitor 15 is not limited thereto, and may be made through an insulating layer containing a gate insulating layer 30A between the scan line 11 in the preceding pixel and the pixel electrode 22.

### Embodiment 8

Embodiment 8 is equipped with passivation technology in place of the organic insulating layer in an addition to the minimum number of processes in Embodiment 7, similar to the relationship of Embodiment 1 and Embodiment 2. The manufacturing process in Embodiment 8 is the same as in Embodiment 7 up to when a semiconductor region comprising a laminate made of the anodizable heat resistant metal layer 34A and the second amorphous silicon layer 33A wider than the gate electrode 11A above the gate electrode 11A and an intermediate electrode comprising a laminate made of the second amorphous silicon layer 33C and the anodizable heat resistant metal layer 34C containing the openings 63A and 65A are formed to expose the glass substrate 2 using micro-fabrication technology as shown in FIGS. 15(e) and 16(e). The descriptions for 15(c) and 16(c) are omitted due to considerations of the gazette.

Then, IZO or ITO, for example, is deposited as a transparent conductive layer 91 about 0.1 to 0.2 μm thick over the entire surface of the glass substrate 2 using an SPT or other vacuum film depositing equipment. An Al or Al (Nd) alloy thin film layer about 0.3 μm thick is subsequently deposited as an anodizable low resistant metal layer. Using half-tone exposure technology, photosensitive resin patterns 87A and 87B are formed thicker than the 1.5-μm thickness of 87B on the source and drain wires 12 and 21 and the 3-μm thickness, for example, of 87A on the electrode terminals 5 and 6 and on the drain electrode 21. A signal line 12 doubling as a source wire comprising a laminate made of 91A and 35A and a drain electrode 21 of an insulating gate type transistor doubling as a pixel electrode 22 comprising a laminate made of 91B and 35B are selectively formed using the photosensitive resin patterns 87A and 87B as shown in FIGS. 15(f) and 16(f). An electrode terminal 6 comprising a part of the signal line and an electrode terminal 5 of the scan line containing an intermediate electrode exposed are formed at the same time as the formation of the source and drain wires 12 and 21.

After the source and drain wires 12 and 22 are formed, the above-mentioned photosensitive resin patterns 87A and 87B are reduced by at least 1.5 μm using oxygen plasma or other ashing means to expose a signal line 12 (35A), and the signal line 12 is anodized using the reduced photosensitive resin pattern 87C as a mask to form an oxide layer 69 (12) on its surface as shown in FIGS. 15(g) and 16(g).

After the anodization is done, the photosensitive resin pattern 87C is removed to expose the electrode terminals 6 and 5 comprising the low resistance metal layers 35A and 35C and to expose the pixel electrode comprising the low resistance metal layer 35B in whose side the anodized layer 69 (35B) is formed as shown in FIGS. 15(h) and 16(h).

Further, when the low resistance metal layers 35A to 35C are removed using the anodization layer 69 (12) on the signal line 12 as a mask, the transparent conductive layers 91A to 91C are exposed as shown in FIGS. 15(i) and 16(i), and the latter layers function respectively as the electrode terminal 6A for the signal line, the pixel electrode 22, and the terminal electrode 5A for the scan line. The active substrate 2 thus obtained and the color filter 9 are attached together to form a liquid crystal panel, thereby completing Embodiment 8 of the present invention. The construction of the storage capacitor 15 is identical to that in Embodiment 7.

Reduction of the manufacturing processes is advanced in Embodiment 7 and Embodiment 8 in this manner by carrying out the formation process of the scan line and the formation process of the contacts with the same photomask using half-tone exposure technology, and a liquid crystal display device is obtained using a four photomasks, but the present inventor has devised combinations for further streamlining by which a three-mask process is enabled.

### Embodiment 9

To begin with, in Embodiment 9, Cr, Ta, Mo or the like or an alloy or silicide thereof, for example, is deposited as a first metal layer about 0.1 to 0.3 μm thick on the primary surface of a glass substrate 2 using an SPT or other vacuum film depositing equipment, similar to Embodiment 7. When selecting an anodized layer for the insulating layer formed in the side of the scan line, the need to retain insularity in the anodized layer is the same as in Embodiment 7.

Next, three thin film layers comprising a first SiNx layer 30 forming a gate insulating layer, a first amorphous silicon layer 31 forming a channel for an insulating gate type transistor containing hardly any impurities, and a second SiNx layer 32 forming an insulating layer for protecting the channel are successively deposited about 0.3, 0.05, and 0.1 μm thick, for example, over the entire surface of the glass substrate 2 using a PCVD equipment. Then, photosensitive resin patterns 83A and 83B are formed with half-tone exposure technology thicker than the 1-μm thickness of the region 83B corresponding to the scan line 11 and the capacity storage line 16, and 2 μm thick, for example, of a protective insulating layer formation region, that is, region 83A above the gate electrode 11A; and a second SiNx layer 32, a first amorphous silicon layer 31, a gate insulating layer 30, and a first metal layer are selectively removed with the photosensitive resin patterns 83A and 83B as masks to expose the glass substrate 2 as shown in FIGS. 17(a) and 18(a). The width of the scan line 11 is ordinarily 10 μm or wider at the minimum due to the resistance value, so controlling the production of the photomask for forming 83B (the gray-tone region) and its finishing dimensions is easy.

Continuing, by reducing the above-mentioned photosensitive resin patterns 83A and 83B by 1 μm or more using oxygen plasma or other ashing means, the photosensitive resin pattern 83B can be eliminated to expose the second SiNx layers 32A and 32B (not illustrated), and leave the reduced photosensitive resin pattern 83C unchanged on only the protective insulating layer formation region as shown in FIG. 18(b). In the above-mentioned oxygen plasma treatment, it is desirable to suppress change in the pattern dimensions by increasing the anisotropy. In further detail, RIE oxygen plasma treatment is desirable, and ICP or TCP oxygen plasma treatment is even more desirable, having a high density plasma source. Alternatively, measures such as providing for a process-approach with exposure and development restrictions such as designing the pattern dimensions of the resist pattern 83A larger beforehand, anticipating the amount of dimension change in the resist pattern, or increasing the dimensions of the resist pattern 83A have already been discussed.

Continuing, the second SiNx layer 32A is selectively etched finer than the gate electrode 11A using the reduced photosensitive resin pattern 83C as a mask to make an etch stop layer 32D and to expose the first amorphous silicon layers 31A and 31B above the scan line 11 and the storage capacitor line 16 respectively as shown in FIGS. 17(b) and 18(b).

After removing the above-mentioned photosensitive resin pattern 83C, an insulating layer 76 is formed in the side of the gate electrode 11A as shown in FIGS. 17(c) and 18(c). Because of this, a connection pattern 78 is needed to provide potential during anodization or electrodeposition at the outer periphery of the glass substrate 2 and the wire 77 bundled in parallel with the scan line 11 is needed (as with the storage capacitor line 16 whose illustration is omitted) as shown in FIG. 50, and the film deposition region 79 is limited to inside the pattern 78 using suitable mask means for the silicon nitride layers 30 and 32 and the amorphous silicon layer 31 made with a PCVD equipment; at the least, the connection pattern 78 needs to be exposed electrically. When a positive potential is provided to the scan line 11 to cause a chemical liquid whose main ingredient is ethylene glycol to penetrate the glass substrate 2 using connection means such as an alligator clip having a sharp point on the connection pattern 78, if the scan line 11 is an Al alloy, an aluminum oxide (Al2O3) is formed 0.3 μm thick having a chemical voltage of 200 V, for example. If electrodeposition is used, a polyimide resin layer is formed 0.3 μm thick having an electrodeposition voltage number V using a polyimide electrodeposition liquid with a pendant carboxyl group as described above. It should not be forgotten that there are secondary effects in Embodiment 9 wherein the pinholes generated in the gate insulating layer 30A on the scan line 11 due to the formation of the insulating layer 76 are embedded with polyimide resin or aluminum oxide, which is an insulating layer, so shorts between the layers between the source and drain wires 12 and 21 described below and the scan line 11 are suppressed and the yield is increased.

The manufacturing process hereafter is carried out identically to as in Embodiment 3, so a description is abbreviated. A second amorphous silicon layer 33 is deposited about 0.05 μm thick, for example, containing phosphorous, for example, as an impurity over the entire surface of the glass substrate 2 using a PCVD equipment, and a thin film layer 34 of Ti, Cr, Mo, or the like, for example, is deposited as a heat resistant metal layer about 0.1 μm thick using an SPT or other vacuum film depositing equipment. Then, photosensitive resin patterns 81A and 81B having openings 63A and 65A in a contact formation region of a scan line 11 and a storage capacitor line 16 in the region outside the image display part and thicker than the 2- μm thickness, for example, of the semiconductor layer formation region, that is the region 81A above a gate electrode 11A of the insulating gate type transistor and the 1 -μm thickness of the other region 81B are formed using half-tone exposure technology. Then, a heat resistant metal layer 34, a second amorphous silicon layer 33, and first amorphous silicon layers 31A and 31B exposed in the openings 63A and 65A are successively etched using the photosensitive resin patterns 81A and 81B as masks as shown in FIGS. 17(d) and 18(d) to expose gate insulating layers 30A and 30B in the openings 63A and 65A respectively.

Continuing, by reducing the above-mentioned photosensitive resin patterns 81A and 81B by 1 μm or more using oxygen plasma or other ashing means, the photosensitive resin pattern 81B can be eliminated exposing the heat resistant metal layer 34, and the reduced photosensitive resin pattern 81C can be left unchanged only at the semiconductor layer formation region above the gate electrode 11A as shown in FIGS. 17(d) and 18(d).

Continuing, the heat resistant metal layer 34 and the second amorphous silicon layer 33 are selectively left wider than the gate electrode 11A using the photosensitive resin pattern 81C as a mask to make island forms 34A and 33A and expose the glass substrate 2 as shown in FIGS. 17(f) and 18(f).

The etching state of the openings 63A and 65A as is described in Embodiment 3, and in the end, the parts 73 and 75 of the scan line 11 and the storage capacitor line 16 in the openings 63A and 65A formed in the gate insulating layers 30A and 30B above the scan line 11 and the storage capacitor line 16 are respectively exposed.

After removing the aforementioned photosensitive resin pattern 81C, IZO or ITO, for example, is deposited as a transparent conductive layer 91 about 0.1 to 0.2 μm thick over the entire surface of the glass substrate 2 using an SPT or other vacuum film depositing equipment as in Embodiment 3, and an Al or Al (Nd) alloy thin film layer 35 about 0.3 μm thick is subsequently deposited as a low resistance metal layer. Then, photosensitive organic insulating layer patterns 86A and 86B are formed thicker than the 1.5-μm thickness of 86B on the electrode terminals 5 and 6 and the pixel electrode 21 and the 3-μm thickness, for example, of 86A on the signal line 12 using half-tone exposure technology. A signal line 12 doubling as a source wire comprising a laminate of 91A and 35A, and a drain electrode 21 of the insulating gate type transistor doubling as the pixel electrode 22 comprising a laminate of 91B and 35B are selectively formed as shown in FIG. 17(g) and 18(g) using the photosensitive organic insulating layer patterns 86A and 86B. Then, an electrode terminal 5 of the scan line containing a part 73 of the scan line exposed in the opening 63A and an electrode terminal 6 comprising a part of the signal line are formed at the same time as the formation of the source and drain lines 12 and 21.

After the source and drain wires 12 and 21 are formed, the above-mentioned photosensitive organic insulating layer patterns 86A and 86B are reduced by at least 1.5 μm using oxygen plasma or other ashing means to expose the low resistance metal layers 35A to 35C on the pixel 22 doubling as a drain electrode and on the electrode terminals 5 and 6, and when the low resistance metal layers 35A to 35C are removed using the reduced photosensitive resin pattern 86C as a mask, a transparent conductive pixel electrode 22 and transparent conductive electrode terminals 5A and 6A are formed as shown in FIGS. 17(h) and 18(h).

The active substrate 2 thus obtained and the color filter 9 are attached together to form a liquid crystal panel, thereby completing Embodiment 9 of the present invention. The composition of the storage capacitor is exemplified in FIG. 17(h) as comprising a region 51 (a right-slanting oblique part) on which the pixel electrode 22 and the storage capacitor line 16 are overlaid in a planar fashion via the gate insulating layer 30B, identical to in Embodiment 7.

### Embodiment 10

Embodiment 10 is equipped with passivation technology in place of the organic insulating layer as an addition to the minimum number of processes in Embodiment 9, similar to the relationship of Embodiment 1 and Embodiment 2. In Embodiment 10, the manufacturing process is identical to that in Embodiment 9 up to when a semiconductor layer region comprising a laminate made of a second amorphous silicon layer 33A and an anodizable heat resistant metal layer 34A is formed wider than a gate electrode 11A above the gate electrode 11A, and contacts (openings) 63A and 65A are formed in gate insulating layers 30A and 30B on a scan line 11 and a storage capacitor line 16 respectively outside a image display part region using micro-fabrication technology as shown in FIGS. 19(f) and 20(f). The descriptions for FIGS. 19(b), 19(e), 20(b), and 20(e) are omitted due to considerations of the gazette.

Then, IZO or ITO, for example, is deposited as a transparent conductive layer 91 about 0.1 to 0.2 μm thick over the entire surface of the glass substrate 2 using an SPT or other vacuum film depositing equipment, and An Al or Al (Nd) alloy thin film layer about 0.3 μm thick is subsequently deposited as an anodizable low resistant metal layer. Using half-tone exposure technology, photosensitive resin patterns 87A and 87B are formed thicker than the 1.5-μm thickness of 87B on the signal line 12 and the 3-μm thickness, for example, of 87A on the electrode terminals 5 and 6 and the pixel electrode 22 doubling as a drain electrode. The signal line 12 doubling as a source line comprising a laminate made of 91A and 35A, and the drain electrode 21 of an insulating gate type transistor doubling as the pixel electrode 22 comprising a laminate made of 91B and 35B are selectively formed as shown in FIGS. 19(g) and 20(g) using the photosensitive resin patterns 87A and 87B. An electrode terminal 5 of the scan line and an electrode terminal 6 comprising a part of the signal line are formed containing contacts (openings) 63A and 65A exposed at the same time the source and drain wires 12 and 21 are formed.

After the formation of the source and drain wires 12 and 21, the above-mentioned photosensitive resin patterns 87A and 87B are reduced at least 1.5 μm using oxygen plasma or other ashing means to expose the signal line 12 (35A), and the signal line 12 is anodized and an oxide layer 69(12) formed on its surface as shown in FIGS. 19(h) and 20(h) using the reduced photosensitive resin pattern 87C as a mask.

After the anodization is complete, the photosensitive resin pattern 87C is removed, exposing the electrode terminals 6 and 5 comprising the lower resistance metal layers 35A and 35C and the pixel electrode comprising the low resistance metal layer 35B in whose side the anodized layer 69(35B) is formed as shown in FIGS. 19(i) and 20(i).

Further, when the low resistance metal layers 35A to 35C are removed using the anodized layer 69 (12) on the signal line 12 as a mask, the transparent conductive layers 91A to 91C are exposed as shown in FIGS. 19(j) and 20(j), and the latter layers function respectively as the electrode terminal 6A for the signal line, the pixel electrode 22, and the terminal electrode 5A for the scan line. The active substrate 2 thus obtained and the color filter 9 are attached together to form a liquid crystal panel, thereby completing Embodiment 10 of the present invention. The construction of the storage capacitor is identical to that in Embodiment 9.

By using half-tone exposure technology in this manner in Embodiments 9 and 10 to carry out the formation process of the scan line and the formation process of the etch stop layer, the formation process of the contacts and the formation process of the semiconductor layer, the formation process of the source and drain wires and the formation process of the pixel electrode, that is, all the photographic etching processes, a liquid display device is obtained using three photomasks. Still, by rearranging the sequence of the photographic etching processes from the perspective of not having them conventionally, it is possible to reduce the number of manufacturing processes a bit more. This is described in Embodiment 11 and Embodiment 12.

### Embodiment 11

To begin with, in Embodiment 11, Cr, Ta, Mo or the like or an alloy or silicide thereof, for example, is deposited as a first metal layer 92 about 0.1 to 0.3 μm thick on the primary surface of a glass substrate 2 using an SPT or other vacuum film depositing equipment as in Embodiment 7. When selecting an anodized layer for the insulating layer formed in the side of the scan line, the need to retain insularity in the anodized layer is the same as in Embodiment 7.

Next, three thin film layers comprising a first SiNx layer 30 forming a gate insulating layer, a first amorphous silicon layer 31 forming a channel for an insulating gate type transistor containing hardly any impurities, and a second SiNx layer 32 forming an insulating layer for protecting the channel are successively deposited about 0.3, 0.05, and 0.1 μm thick, for example, over the entire surface of the glass substrate 2 using a PCVD equipment. The topmost second SiNx layer 32 is selectively etched using micro-fabrication technology to make a channel protection layer 32D of an insulating gate type transistor and expose the first amorphous silicon layer 31. Then, a second amorphous silicon layer 33 containing phosphorous, for example, as an impurity is deposited 0.05 μm thick, for example, over the entire surface of the glass substrate 2 using a PCVD equipment, and successively a thin film layer 34 of Ti, Cr, Mo, or the like, for example, is deposited 0.1 μm thick as a heat resistant metal layer using an SPT or other vacuum film depositing equipment.

Continuing, photosensitive resin patterns 82A and 82B are formed using half-tone exposure technology thinner than the 2-μm thickness on a region 82A corresponding to the scan line 11 and the storage capacitor line 16 with the thickness of openings 63A and 65A, which are a contact formation region 82B, being 1 μm, for example, and the heat resistant metal layer 34, the second amorphous silicon layer 33, the first amorphous silicon layer 31, the gate insulating layer 30, and the first metal layer 92 are selectively removed using the photosensitive resin patterns 82A and 82B as masks to expose the glass substrate 2 as shown in FIGS. 21(b) and 22(b).

Continuing, by reducing the above-mentioned photosensitive resin patterns 82A and 82B by 1 μm or more using oxygen plasma or other ashing means, the photosensitive resin pattern 82B can be eliminated, exposing the heat resistant metal layers 34A and 34B in the openings 63A and 65A, and leaving the reduced photosensitive resin pattern 82C unchanged above the scan line 11 and the storage capacitor line 16 as shown in FIGS. 21(c) and 22(c). The pattern width of the photosensitive resin pattern 82C (the black region), that is, the gate electrode 11A is the sum of the mask alignment precision and the dimension of the protective insulating layer, so the dimension precision is not strict, at 16 to 18 μm at the least with the protective insulating layer 10 to 12 μm and the alignment precision ±3 μm. Also, the pattern width for the storage capacitor line 16 and the scan line 11 is set ordinarily at 10 μm or wider due to the resistance value. There is, however, no semiconductor layer formation process in Embodiment 11, and the semiconductor layer is formed with the same dimensions as the gate electrode 11A above the gate electrode 11A, so when the resist pattern is isotropically reduced 1 μm during the conversion from the resist pattern 82A to 82C, not only does the dimension decrease 2 μm, but the mask alignment precision decreases 1 μm to ±2 μm during the subsequent source and drain wire formation, so that effects of the latter are more strict in terms of process than the former. In the above-mentioned oxygen plasma treatment, it is therefore desirable to suppress change in the pattern dimensions by increasing the anisotropy. In further detail, RIE oxygen plasma treatment is desirable and ICP or TCP methods having a high density plasma source is more desirable. Alternatively, measures such as providing for a process-based approach of designing beforehand the pattern dimensions of the resist pattern 82A larger, anticipating the amount of dimension change in the resist pattern are desirable.

Then, an insulating layer 76 is formed in the side of the gate electrode 11A as shown in FIG. 22(c). Because of this, a connection pattern 78 is needed to provide potential during anodization or electrodeposition at the outer periphery of the glass substrate 2 and the wire 77 bundled in parallel with the scan line 11 is needed (as with the storage capacitor line 16 whose illustration is omitted) as shown in FIG. 49, and a film deposition region 79 is limited to inside the connection pattern 78 using suitable mask means for the heat resistant metal layer 34 made with an SPT equipment, and the silicon nitride layers 30 and 32 and the amorphous silicon layers 31 and 33 made with a PCVD equipment; at the least, the connection pattern 78 needs to be exposed electrically. When the photosensitive resin pattern 82C (78) on the connection pattern 78 is pierced to provide a positive potential to the scan line 11 to cause a chemical liquid whose main ingredient is ethylene glycol to penetrate the glass substrate 2 and anodize using connection means such as an alligator clip having a sharp point on the connection pattern 78, if the scan line 11 is an Al alloy, an aluminum oxide (Al3O2) is formed 0.3 μm thick having a chemical voltage of 200 V, for example. If electrodeposition is used, a polyimide resin layer is formed 0.3 μm thick having an electrodeposition voltage number V using a polyimide electrodeposition liquid with a pendant carboxyl group. After the insulating layer 76 is formed, the heat resistant metal layers 34A and 34B, the second crystalloid silicon layers 33A and 33B, the first amorphous silicon layers 31A and 31B and the gate insulating layers 30A and 30B in the openings 63A and 65A are selectively etched with the reduced photosensitive resin pattern 82C as a mask to expose a part 73 of the scan line 11 and a part 75 of the storage capacitor line 16 respectively as shown in FIGS. 21(d) and 22(d).

After removing the aforementioned photosensitive resin pattern 82, as in Embodiment 1, IZO or ITO, for example, is deposited as a transparent conductive layer 91 about 0.1 to 0.2 μm thick over the entire surface of the glass substrate 2 using an SPT or other vacuum film depositing equipment; an Al or Al (Nd) alloy thin film layer 35 about 0.3 μm thick is subsequently deposited as a low resistance metal layer; then, photosensitive organic insulating layer patterns 86A and 86B are formed thicker than the 1.5-μm thickness of 86B on the electrode terminals 5 and 6 and the drain electrode 21 and the 3-μm thickness, for example, of 86A on the signal line 12 using half-tone exposure technology; a signal line 12 doubling as a source wire comprising a laminate of 91A and 35A and a drain electrode 21 of the insulating gate type transistor doubling as the pixel electrode 22 comprising a laminate of 91B and 35B are selectively formed as shown in FIGS. 21(e) and 22(e) using the photosensitive organic insulating layer patterns 86A and 86B; and an electrode terminal 5 of the scan line is formed containing a part 73 of the exposed scan line, the first amorphous silicon layer 31C, the second amorphous silicon layer 33C, and the heat resistant metal layer 34C in the periphery of the opening 63A, and an electrode terminal 6 comprising a part of the signal line is also formed at the same time as the formation of the source and drain lines 12 and 21.

After the source and drain wires 12 and 21 are formed, the above-mentioned photosensitive organic insulating layer patterns 86A and 86B are reduced by at least 1.5 μm using oxygen plasma or other ashing means to expose the low resistance metal layers 35A to 35C on the pixel 22 and on the electrode terminals 5 and 6, and when the low resistance metal layers 35A to 35C are removed using the reduced photosensitive organic insulating layer pattern 86C as a mask, transparent conductive pixel electrode 22 and transparent conductive electrode terminals 5A and 6A are formed as shown in FIGS. 21(f) and 22(f).

The active substrate 2 thus obtained and the color filter 9 are attached together to form a liquid crystal panel, thereby completing Embodiment 11 of the present invention. As shown in FIG. 21(f), the composition of the storage capacitor is exemplified by a region 51 (a right-slanting oblique part) on which the pixel electrode 22 and the storage capacitor line 16 are overlaid in a planar fashion via the heat resistant metal layer 34B, the second amorphous silicon layer 33B, the first amorphous silicon layer 31B and the gate insulating layer 30B.

### Embodiment 12

Embodiment 12 is equipped with passivation technology in place of the organic insulating layer as an addition to the minimum number of processes in Embodiment 11, similar to the relationship of Embodiment 1 and Embodiment 2. In Embodiment 12, the same manufacturing process used in Embodiment 11 is carried out up to the formation of a semiconductor layer region comprising a laminate made of an anodizable heat resistant metal layer 34A, a second amorphous silicon layer 33A, and a first amorphous silicon layer 31A above the gate electrode 11A, and contacts 63A and 65A on the scan line 11 and the storage capacitor line 16 in a region outside the image display as shown in FIGS. 23(d) and 24(d). Then, IZO or ITO, for example, is deposited as a transparent conductive layer 91 about 0.1 to 0.2 μm thick over the entire surface of the glass substrate 2 using an SPT or other vacuum film depositing equipment; and an Al or Al (Nd) alloy thin film layer about 0.3 μm thick is subsequently deposited as an anodizable low resistant metal layer. Using half-tone exposure technology, photosensitive resin patterns 87A and 87B are formed thicker than the 1.5-μm thickness of 87B on the signal line 12 with 87A 3-μm thick, for example, on the electrode terminals 5 and 6 and the pixel electrode 22 doubling as the drain electrode 21. The signal line 12 doubling as a source wire comprising a laminate of 91A and 35A and the drain electrode 21 of the insulating gate type transistor doubling as the pixel electrode 22 comprising a laminate of 91B and 35B are selectively formed as shown in FIGS. 23(e) and 24(e) using the photosensitive resin patterns 87A and 87B and an electrode 5 for the scan line is formed containing a part of the exposed scan line 73, a first amorphous silicon layer 31C, a second amorphous silicon layer 33C, and a heat resistant layer 34C in the periphery of the opening 63A, and an electrode terminal 6 comprising a part of the signal line is also formed at the same time as the formation of the source and drain wires 12 and 21.

After the source and drain wires 12 and 21 are formed, the above-mentioned photosensitive resin patterns 87A and 87B are reduced at least 1.5 μm using oxygen plasma or other ashing means to expose the signal line 12 (35A), and the signal line 12 is anodized to form an oxide layer 69 (12) on its surface as shown in FIGS. 23(f) and 23(f) using the reduced photosensitive resin pattern 87C as a mask.

After the anodization is complete, the photosensitive resin pattern 87C is removed, exposing the electrode terminals 6 and 5 comprising the electrode terminals 35A and 35C and the pixel electrode comprising the low resistance metal layer 35B in whose side the anodized layer 69 (35B) is formed as shown in FIGS. 23(g) and 24(g).

Further, when the low resistance metal layers 35A to 35C are removed using the anodized layer 69 (12) on the signal line 12 as a mask, the transparent conductive layers 91A to 91C are exposed as shown in FIGS. 23(h) and 24(h), the latter layers function respectively as the electrode terminal 6A for the signal line, the pixel electrode 22, and the terminal electrode 5A for the scan line. The active substrate 2 thus obtained and the color filter 9 are attached together to form a liquid crystal panel, and completing Embodiment 12 of the present invention. The construction of the storage capacitor is identical to that in Embodiment 11.

An etch stop insulating gate type transistor was used in the liquid crystal display device described above, but even if a channel etch insulating gate type transistor is used, simultaneous formation of the signal line and pixel electrode which is the main theme of the present invention can be carried out. This is described in the embodiments below.

### Embodiment 13

To begin with, in Embodiment 13, Cr, Ta, Mo or the like or an alloy or silicide thereof, for example, is deposited as a first metal layer about 0.1 to 0.3 μm thick on the primary surface of a glass substrate 2 using an SPT or other vacuum film depositing equipment. Next, a scan line 11 doubling as a gate electrode 11A and a storage capacitor line 16 are selectively formed using micro-fabrication technology as shown in FIGS. 25(a) and 26(a).

Next, three thin film layers comprising a first SiNx layer 30 forming a gate insulating layer, a first amorphous silicon layer 31 forming a channel for an insulating gate type transistor containing hardly any impurities, and a second amorphous silicon layer 33 forming a source and a drain for an insulating gate type transistor containing phosphorous, for example, as an impurity are successively deposited about 0.3, 0.2, and 0.05 μm thick, for example, over the entire surface of the glass substrate 2 using a PCVD device. A thin film layer 34 of Ti, Cr, or Mo, for example, is then deposited as a heat resistant metal layer about 0.1 μm thick using an SPT or other vacuum film depositing equipment, and a semiconductor layer region comprising a laminate made of a first amorphous silicon layer 31A, a second amorphous silicon layer 33A, and a heat resistant metal layer 34A is formed wider than the gate electrode 11A above the gate electrode 11A using micro-fabrication technology to expose the gate insulating layer 30 as shown in FIGS. 25(b) and 26(b).

Continuing, openings 63A and 65A are selectively formed on the scan line 11 and the storage capacitor line 16 outside the image display region using micro-fabrication technology as shown in FIGS. 25(c) and 26(c), and the gate insulating layer 30 in the aforementioned openings 63A and 65A are etched to expose a part 73 of the scan line 11 and a part 75 of the storage capacitor line 16 respectively.

Then, IZO or ITO, for example, is deposited as a transparent conductive layer 91 about 0.1 to 0.2 μm thick over the entire surface of the glass substrate 2 using an SPT or other vacuum film depositing equipment; an Al or Al (Nd) alloy thin film layer is subsequently deposited about 0.3 μm thick as a low resistant metal layer; the Al thin film layer 35, the transparent conductive layer 91, the heat resistant metal layer 34A, the second amorphous silicon layer 33A, and the first amorphous silicon layer 31A being left as thick as 0.05-0.1 μm are removed with micro-fabrication technology with the photosensitive resin patterns 88A and 88B to selectively form a signal line 12 doubling as a source wire comprising a laminate of the low resistance metal layer 35A and a transparent conductive layer 91A, and similarly a drain electrode 21 for the insulating gate type transistor doubling as a pixel electrode 22 comprising a laminated layer of the low resistance metal layer 35B and a transparent conductive layer 91B both partially containing the semiconductor region 34A such as to partially overlap with the gate electrode 11A as shown in FIGS. 25(d) and 26(d); and an electrode terminal 5 for a scan line is formed containing 73 a part of the scan line exposed, and an electrode terminal 6 comprising part of the signal line is also formed at the same time as the formation of the source and drain wires 11 and 12. In this manner, the heat resistant metal layer 34A is divided in this process into a set of electrodes 34A1 and 34A2 (neither of which is illustrated), and by forming the signal wire 12 to contain the one electrode 34A1 and the pixel electrode 22 to contain the other electrode 34A2, the former functions as a source electrode for the insulating gate type transistor and the latter as a drain electrode therefor.

Forming photosensitive resin patterns 88A and 88B thicker than the 1.5-μm thickness of a region 88B (gray tone region) on the pixel electrode 22 doubling as a drain electrode and the 3-μm thickness, for example, of a region 88A (black region) on the electrode terminals 5 and 6 and the signal line 12 at this time using half-tone exposure technology is an important feature of Embodiment 13. With the smallest dimension of 88B corresponding to the electrode terminals 5 and 6 large at several tens of micrometers, producing the photomask and controlling the finishing dimensions is an extremely easy matter, though a fine pattern is needed for the black region as the smallest dimension of the region 88A corresponding to the signal line 12 is relatively precise at 4 to 8 μm. However, using the source and drain wires 12 and 21 formed in the one exposure treatment and two etching treatments as described with the streamlined Conventional Example for comparison, the source and drain wires 12 and 21 of the present invention are formed with one exposure treatment and 1.5 etching treatments, so there are few causes of fluctuation in the pattern width, making it easier to control the dimensions of the source and drain wires 12 and 21 as well as of the interval between the source and drain wires 21, that is, the channel length than controlling the pattern precision using conventional half-tone exposure technology.

When the above-mentioned photosensitive resin patterns 88A and 88B are reduced by at least 1.5 μm using oxygen plasma or other ashing means after the source and drain wires 12 and 21 are formed, the photosensitive resin pattern 88B is eliminated, exposing the low resistance metal layer 35B on the pixel electrode 22 doubling as a drain electrode, and making it possible to leave the reduced photosensitive resin pattern 88C unchanged only on the terminal electrodes 5 and 6 and on the signal line 12, but when the photosensitive resin pattern 88C is isotropically reduced in the above-mentioned oxygen plasma treatment to make its pattern width finer, the signal line 12 (35) becomes finer in the subsequent process for removing the low resistance metal layer 35B, so that it is desirable to increase the anistropy in the oxygen plasma treatment with RIE, or TCP or ICP having a higher density plasma source to control changes in the pattern dimensions. Alternatively, measures such as providing for a process-based approach of designing the pattern dimensions of the resist pattern 88A larger beforehand, anticipating the amount of dimension change in the resist pattern are desirable. Then, when the low resistance metal layer 35B is removed using the reduced photosensitive resin pattern 88C as a mask, a transparent conductive pixel electrode 22 is obtained as shown in FIGS. 25(e) and 26(e). The etching method and material of the low resistant metal layer such that the first amorphous silicon 31A, which is a channel layer for a insulating gate type transistor exposed during removal of the low resistance metal layer 35B, is not reduced or damaged such that the electrical characteristics of the insulating gate type transistor deteriorate are important points in the present invention. From this perspective, Al, Cr, Mo, W or the like is adopted as a low resistance metal layer with a high etching selectivity ratio, and Al etching liquids having phosphoric acid, Cr etching liquids having cerium nitrate and perchloric acid, and Mo or W etching liquids having hydrogen peroxide solution to which a minute amount of ammonia has been added, are optimal respectively therefor.

After the reduced photosensitive resin pattern 88C is removed, a second SiNx layer about 0.3 μm thick is deposited over the entire surface of the glass substrate 2 using a PCVD equipment as a transparent insulating layer to make a passivating insulating layer 37. Openings 38, 63 and 64 are then formed on the pixel electrode 22 and the electrode terminals 5 and 6 respectively as shown in FIGS. 25(f) and 26(f), and the passivating insulating layer in each opening is selectively removed to expose the larger part of the pixel electrode 22 and the electrode terminals 5 and 6.

The active substrate 2 thus obtained and the color filter 9 are attached together to form a liquid crystal panel, thereby completing Embodiment 13 of the present invention. The composition of the storage capacitor is exemplified in FIG. 25(f) as comprising a region 51 (a right-slanting oblique part) on which the pixel electrode 22 and the storage capacitor line 16 are overlaid in a planar fashion via the gate insulating layer 30, though the composition of the storage capacitor is not limited thereto, and the construction may be made via an insulating layer containing the gate insulating layer 30 between the scan line 11 in the previous pixel and the pixel electrode 22. Additionally, a transparent conductive layer pattern 40 may be disposed at the outer circumference of the active substrate 2 as in Embodiment 1 as a countermeasure for static electricity, and the countermeasure in the Conventional Example using a construction with the transparent conductive layer pattern 40 connected to the transparent conductive electrode terminals 5A and 6A may also be used, though other static electricity countermeasures are also easy because a formation process for openings in the gate insulating layer 30 is provided.

Because the electrode terminals 5 and 6 are constructed with the low resistance metal layers 35C and 35B, Embodiment 13 has the advantage of a small connection resistance with TCP or COG packaging. If an Al or Al (Nd) alloy is used as a low resistance metal layer, erosion occurs readily due to water seeping in, so this embodiment also has the issue of requiring a high seal technology for packaging the liquid crystal panel. It is possible to provide transparent conductive electrode terminals 5A and 6A as in Embodiments 1 to 12 because ITO and IZO have a higher resistance to corrosion due to water seepage than Al alloys. To do this, the photosensitive resin patterns 88A and 88B used to form the source and drain wires 12 and 21 need merely be changed to the photosensitive resin patterns 86A and 86B, thicker on the signal line 12 than on the electrode terminals 5 and 6 and on the pixel electrode 22 doubling as a drain electrode. This is a design element applied in Embodiments 15, 17, 19, 21 and 23 described below. The final plan and cross-section views for this are shown in FIGS. 25(g) and 26(g).

Alternatively, it is possible to form source and drain wires 12 and 21 without using half-tone exposure, and remove the low resistance metal layers 35A to 35C in addition to the passivating insulating layer 37 when forming the openings 38, 63 and 64 in the passivating insulating layer 37 to obtain the transparent conductive pixel electrode 22 and the transparent conductive electrode terminals SA and 6A. This method has the advantage that the low resistance metal layer 35A composing the signal line 12 is formed with a single etch, so the pattern precision is increased, the advantage of avoiding the possibility of a finer signal line 12 increasing the resistance value, and the advantage that the channel part is protected by the passivating insulating layer 37 during the second removal of the low resistance metal layers 35A to 35C so that damage does not occur to the channel part. This is a novel inventive element in the device and process applied in Embodiments 15, 17, 19, 21 and 23 described below. The final plan and cross-section views for this are shown in FIGS. 25(h) and 26(h).

Instead of the passivation formation using SiNx in Embodiment 13, an anodizable metal thin film is used for the source and drain wire material as in Embodiment 2. This makes passivation formation of the source and drain wires possible by forming an insulating anodized layer using anodization during the formation of the source and drain wires. This also makes passivation formation of a channel possible at the same time by forming a silicon oxide layer in the channel surface in the channel etch 10 insulating gate type transistor. This anode oxidation technology further decreases the number of photographic etch processes and is described as Embodiment 14 below.

### Embodiment 14

In Embodiment 14, the manufacturing process is identical to that in Embodiment 13 up to when openings 63A and 65A are selectively formed on a scan line 11 and a storage capacitor line 16 outside the image display region using micro-fabrication technology, and the gate insulating layer 30 in the aforementioned openings 63A and 65A is etched to expose a part 73 of the scan line 11 and a part 75 of the storage capacitor line 16 as shown in FIGS. 27(c) and 28(c). The first amorphous silicon layer 31 may be deposited thinner at 0.1 μm. Also, an anodizable metal is required for the heat resistant metal layer 34, and Cr, Mo, W and the like are not suitable therefor, so at least, Ti, or preferably Ta or a silicide of a metal with a high melting point is selected.

In the formation process of the source and drain wires, IZO or ITO, for example, is deposited as a transparent conductive layer 91 about 0.1 to 0.2 μm thick using an SPT or other vacuum film depositing equipment, and then an Al or Al (Nd) alloy thin film layer 35 is subsequently formed about 0.3 μm thick as an anodizable low resistance metal layer. Then, the Al or Al (Nd) alloy thin film layer 35 and the transparent conductive layer 91 are sequentially etched using the photosensitive resin patterns 87A and 87B with micro-fabrication technology, and a signal line 12 doubling as a source wire comprising a laminate made of the low resistance metal layer 35A and the transparent conductive layer 91A, and a drain electrode 21 for an insulating gate type transistor doubling as the pixel electrode 22 comprising a laminate made of the low resistance metal layer 35B and the transparent conductive layer 91B, both are selectively formed containing the semiconductor layer region 34A such as to partially overlap with the gate electrode 11A. Etching of the second amorphous silicon layer 33A containing impurities and the first amorphous silicon layer 31A not containing impurities is not needed. And an electrode terminal 5 of the scan line is formed containing a part 73 of the scan line exposed in the opening 63A, and an electrode terminal 6 comprising a part of the signal line is also formed at the same time as the formation of the source and drain wires 12 and 21. The formation of the photosensitive resin patterns 87A and 87B at this time thicker than the 1.5 μm on the signal line 12 using half-tone exposure technology with the thickness on the electrode terminals 5 and 6 and on the pixel electrode 22 doubling as a drain electrode 3 μm, for example, is an important feature of Embodiment 14.

When the above-mentioned photosensitive resin patterns 87A and 87B are reduced by at least 1.5 μm using oxygen plasma or other ashing means after the source and drain wires 12 and 22 are formed, the photosensitive resin pattern 87B is eliminated to expose the signal line 12 (35A), and it is possible to leave the reduced photosensitive resin pattern 87C unchanged only on the electrode terminals 5 and 6 and on the pixel electrode 22 doubling as a drain electrode. Even if the width of the photosensitive resin pattern 87C is made fine in the above-mentioned oxygen plasma treatment, the fact that the electrical characteristics, yield and quality are affected hardly at all by the mere act of forming an anodized layer at the periphery of the electrode terminals 5 and 6 and the pixel electrode 22 doubling as a drain electrode having large pattern dimensions is a feature worthy of note. Then, the signal line 12 is anodized to form an anodized layer 69 (12) while emitting light similar to in Embodiment 2 using the reduced photosensitive resin pattern 87C as a mask, and a second amorphous silicon layer exposed between the source and drain wires 12 and 21, and a part of the first amorphous silicon layer adjacent in the direction of the thickness with the above-mentioned second amorphous silicon layer 33A are anodized to form a silicon oxide layer 66 containing impurities and a silicon oxide layer (not illustrated) not containing impurities, which are an insulating.

The Al or Al alloy thin film layer 35A, which is a low resistance metal layer, is exposed on the top surface of the signal line 12; a laminate made of the Al or Al alloy thin film layer 35A, the transparent conductive layer 91A, and a Ti thin film layer 34A which is a heat resistant metal layer, is exposed on one of the sides of the channel; and a laminate of the Al or Al alloy thin film layer 35A and the transparent conductive layer 91A is exposed on the opposite side of the channel. The Al or Al thin film alloy layer 35A is transmuted to aluminum oxide (Al2O3) 69 (12), which is an insulating layer, and the Ti thin film layer 34A not illustrated is transmuted to titanium oxide (TiO2) 68 (12), which is a semiconductor, through anodization. The top surface of the pixel electrode (drain electrode) 22 is covered by the photosensitive resin pattern 87C; and a laminate of the Al or Al alloy thin film layer 35B, the transparent conductive layer 91B, and the Ti thin film layer 34A, which is a heat resistant metal layer, is exposed one side of the channel; a laminate of the Al or Al alloy thin layer 35B and the transparent conductive layer 91B is exposed on the other side of the channel; and anodized layers of these thin films are formed similarly. The titanium oxide layer 68 is not an insulating layer, but it is extremely thin and the exposed area is small, so passivation is not a problem, but for the heat resistant metal thin layer 34A, selecting Ta is desirable. Unlike Ti, however, care is needed with Ta as it has a characteristic of lacking the function to easily absorb the surface oxide layer of the base to make ohmic contact. Even if the transparent conductive layer 91A made from IZO or ITO is anodized, an insulating oxide layer is not formed.

An aluminum oxide 69 (35B), an insulating layer, is formed on the side of the low resistance metal layer 35B on the pixel electrode 91B during anodization of the signal line 12, and if the interval of the electrode terminals 5 and 6 for the scan and signal lines is connected with a conductive medium as a countermeasure for static electricity, the chemical current from the signal line 12 flows through the conductive medium, so an aluminum oxide 69 (35C) is formed similarly on the side of the electrode terminal 5 comprising the low resistance metal layer 35C. The resistance value of the conductive medium is generally high, however, so 69 (35C) should ordinarily be made thinner than 69 (35B).

If the second amorphous silicon layer 33A in the channel containing impurities is not made completely into an insulating layer in the thickness direction, an increase in the leak current of the insulating gate type transistor is caused. It is disclosed in the example of prior art that implementing anodization while emitting light at this time is an important part of the anodization process. In further detail, if adequately powerful light is emitted at about 10,000 luxes so the leak current of the insulating gate type transistor exceeds μA, a current density can be obtained to obtain a favorable film quality by anodizing at about 10 mA/cm2 as calculated from the area of the drain electrode 21 and the channel part between the source and drain wires 12 and 21.

The second amorphous silicon layer 33A containing impurities is anodized, transmuting a part (up to about 100 Å) of the first amorphous silicon layer 31A not containing impurities adjacent to the silicon oxide layer 66 containing impurities formed by setting the chemical voltage about 10 V higher than the chemical voltage of 100 V adequate for transmutation to a silicon oxide layer 66, which is an insulating layer, to a silicon oxide layer (not illustrated) not containing impurities. This increases the electrical purity in the channel, making it possible to completely electrically separate the interval between the source and drain wires 12 and 21. In other words, the off current of the insulating gate type transistor is adequately decreased to obtain a high on/off ratio.

After the anodization is complete, the photosensitive resin pattern 87C is removed, exposing the electrode terminals 6 and 5 comprising the low resistance metal layers 35A and 35C and the pixel electrode comprising the low resistance metal layer 35B in whose side the anodized layer 69 (35B) was formed as shown in FIGS. 27(f) and 28(f).

Further, when the low resistance metal layers 35A to 35C are removed using the anodized layer 69 (12) on the signal line 12 as a mask, the transparent conductive layers 91A to 91C are exposed as shown in FIGS. 27(g) and 28(g), the latter layers function respectively as the electrode terminal 6A for the signal line, the pixel electrode 22, and the terminal electrode 5A for the scan line. The existing parental part (35B and 35C) of the anodized layers 69 (35B) and 69 (35C) on the side of the pixel electrode 22 (35B) and the side of the scan line electrode terminal 5 is eliminated, so the anodized layers 69 (35B) and 69 (35C) are eliminated by being lifted off. The active substrate 2 thus obtained and the color filter 9 are attached together to form a liquid crystal panel, thereby completing Embodiment 14 of the present invention. The construction of the storage capacitor is identical to that in Embodiment 13.

In Embodiment 14, the anodized layer 69 (12) is formed only on the signal line 12 to expose the pixel electrode 22 while maintaining its conductivity. The reason this has adequate reliability is that the drive signal applied in the liquid crystal cell is an alternating current basically as described in Embodiment 2. Also, this is because the voltage of the opposing electrode 14 is adjusted (to decrease flickering) during image testing such that the direct voltage component between the pixel electrode 22 and the opposing electrode 14 formed on the opposite surface of the color filter 9 decreases, so an insulating layer may be formed such that the direct current component does not flow only on the signal line 12.

In Embodiments 13 and 14, reduction in the processes was achieved by forming the pixel electrode and signal line at the same time and making a passivating insulating layer unnecessary, but the number of masks required is not reduced beyond five or four respectively. Streamlining other main processes to further lower costs is a theme of the invention, and in the below embodiments, the innovation and inventiveness used in further decreasing the four-mask process to a three-mask process by streamlining other major processes while maintaining the simultaneous formation of the pixel electrode and signal line as well as the process reduction by making the passivating insulating layer unnecessary are described.

### Embodiment 15

To begin with, in Embodiment 15, Cr, Ta, Mo or the like or an alloy or silicide thereof, for example, is deposited as a first metal layer about 0.1 to 0.3 μm thick on the primary surface of a glass substrate 2 using an SPT or other vacuum film depositing equipment. Next, a scan line 11 doubling as a gate electrode 11A and a storage capacitor line 16 are selectively formed using micro-fabrication technology as shown in FIGS. 29(a) and 30(a).

Next, three thin film layers comprising a first SiNx layer 30 forming a gate insulating layer, a first amorphous silicon layer 31 forming a channel for an insulating gate type transistor containing hardly any impurities, and a second amorphous layer 33 forming a source and drain for an insulating gate type transistor containing phosphorous, for example, as an impurity are successively deposited about 0.3, 0.2, and 0.05 μm thick, for example, over the entire surface of the glass substrate 2 using a PCVD equipment. A thin film layer 34 of Ti, Cr, Mo, or the like, for example, is deposited as a heat resistant layer about 0.1 μm thick using an SPT or other vacuum film depositing equipment, and photosensitive resin patterns 81A and 81B are formed using half-tone exposure technology having openings 63A and 65A on the contact formation region for the scan line 11 and the storage capacitor line 16 outside the image display region as well as being thicker than the 2-μm thickness, for example, of the semiconductor formation region, that is, the region 81A on the gate electrode 11A for the insulating gate type transistor and the 1 -μm thickness of the other region 81B. Then, a heat resistant metal layer 34, a second amorphous silicon layer 33 and a first amorphous silicon layer 31 exposed in the openings 63A and 65A are successively etched using the photosensitive resin patterns 81A and 81B as masks as shown in FIGS. 29(b) and 30(b), exposing the gate insulating layer 30 in the openings 63A and 65A.

Continuing, by reducing the above-mentioned photosensitive resin patterns 81A and 81B by 1 μm or more using oxygen plasma or other ashing means, the photosensitive resin pattern 81B can be eliminated exposing the heat resistant metal layer 34, and the reduced photosensitive resin pattern 81C can be left unchanged only above the gate electrode 11A as shown in FIGS. 29(c) and 30(c). The width of the photosensitive resin pattern 81C, that is, the island-form semiconductor layer is the sum of the mask alignment precision and the dimension of the gate electrode 11A, so the dimension precision is not so strict at 16 to 18 μm if the gate electrode 11A is 10 to 12 μm and the alignment precision ±3 μm. If the resist pattern is isotropically reduced 1 μm during the conversion from the resist pattern 81A to 81C, however, not only does the dimension decrease 2 μm, but the mask alignment precision decreases 1 μm to ±2 μm during subsequent source and drain wire formation, with the effects of the latter more strict in terms of process than the former. In the above-mentioned oxygen plasma treatment, it is therefore desirable to suppress change in the pattern dimensions by increasing the anisotropy. Alternatively, the fact that measures such as providing for a process-based approach of designing the pattern dimensions of the resist pattern 81A larger beforehand, anticipating the amount of dimension change in the resist pattern are desirable has been mentioned above.

Continuing, the heat resistant metal layer 34, the second amorphous silicon layer 33, and the first amorphous silicon layer 31 are selectively left wider than the gate electrode 11A using the reduced photosensitive resin pattern 81C as a mask to make island forms 34A, 33A, and 31A, exposing the gate insulating layer 30 as shown in FIGS. 29(d) and 30(d). The etching state of the openings 63A and 65A is markedly similar at this time to Embodiment 3, and in the end, parts 73 and 75 of the scan line 11 and storage capacitor line 16 are exposed in the openings 63A and 65A respectively.

After removing the aforementioned photosensitive resin pattern 81C, IZO or ITO, for example, is deposited as a transparent conductive layer 91 about 0.1 to 0.2 μm thick over the entire surface of the glass substrate 2 using an SPT or other vacuum film depositing equipment as in Embodiment 13, and an Al or Al (Nd) alloy thin film layer 35 about 0.3 μm thick is subsequently deposited as a low resistance metal layer; then, photosensitive resin patterns 88A and 88B are formed thicker than the 1.5-μm thickness of 88B on the pixel electrode 22 doubling as a drain electrode and the 3-μm thickness, for example, of 88A on the electrode terminals 5 and 6 and on the signal line 12 using half-tone exposure technology; the signal line 12 doubling as a source wire comprising a laminate of 91A and 35A, and the drain electrode 21 of the insulating gate type transistor doubling as the pixel electrode 22 comprising a laminate of 91B and 35B are selectively formed as shown in FIGS. 29(e) and 30(e) using the photosensitive resin patterns 88A and 88B; and an electrode terminal 5 of the scan line is formed containing a part 73 of the scan line exposed, and an electrode terminal 6 comprising a part of the signal line is also formed at the same time as the formation of the source and drain wires 12 and 21.

The above-mentioned photosensitive resin patterns 88A and 88B are reduced by at least 1.5 μm using oxygen plasma or other ashing means after the source and drain wires 12 and 22 are formed to expose the low resistance metal layer 35B on the pixel electrode 22 doubling as a drain electrode, and the low resistance metal layer 35B is removed using the reduced photosensitive resin pattern 88C as a mask, exposing the transparent conductive pixel electrode 22 as shown in FIGS. 29(f) and 30(f). Adequate care is required in the removal of the low resistance metal layer 35 as described in Embodiment 13 to ensure the first amorphous silicon layer 31A that is already exposed for forming a channel is not damaged or reduced.

After the reduced photosensitive resin pattern 88C is removed, a second SiNx layer about 0.3 μm thick is deposited over the entire surface of the glass substrate 2 as a transparent insulating layer using a PCVD equipment to make a passivating insulating layer 37. Openings 38, 63 and 64 are then formed on the pixel electrode 22 and the electrode terminals 5 and 6 respectively as shown in FIGS. 29(g) and 30(g), and the passivating insulating layer in each opening is selectively removed to expose the larger part of the pixel electrode 22 and the electrode terminals 5 and 6.

The active substrate 2 thus obtained and the color filter 9 are attached together to form a liquid crystal panel, thereby completing Embodiment 15 of the present invention. As shown in FIG. 29(g), the composition of the storage capacitor is exemplified as comprising a region 51 (a right-slanting oblique part) on which the pixel electrode 22 and the storage capacitor line 16 are overlaid in a planar fashion via the gate insulating layer 30, but it is an easy matter to interpose a laminate of the heat resistant metal layer 34, the second amorphous silicon layer 33 and the first amorphous silicon layer 31 in addition to the gate insulating layer as already described.

### Embodiment 16

Embodiment 16 is equipped with passivation technology in place of the passivating insulating layer as an addition to the minimum number of processes in Embodiment 15, similar to the relationship of Embodiment 13 and Embodiment 14. In Embodiment 16, the same manufacturing process used in Embodiment 15 is carried out up to the formation of a semiconductor layer region comprising a laminate made of an anodizable heat resistant metal layer 34A, a second amorphous silicon layer 33A, and a first amorphous silicon layer 31A above a gate electrode 11A, and contacts 63A and 65A on the scan line 11 and the storage capacitor line 16 outside the image display region as shown in FIGS. 31(d) and 32(d). The thickness of the first amorphous silicon layer 31 may be deposited thinner at 0.1 μm.

Then, IZO or ITO, for example, is deposited as a transparent conductive layer 91 about 0.1 to 0.2 μm thick over the entire surface of the glass substrate 2 using an SPT or other vacuum film depositing equipment; and an Al or Al (Nd) alloy thin film layer 35 about 0.3 μm thick is subsequently deposited as an anodizable low resistant metal layer. Using half-tone exposure technology, photosensitive resin patterns 87A and 87B are formed thicker than the 1.5-μm thickness of 87B on the signal line 12 with 87A 3-μm thick, for example, on the electrode terminals 5 and 6 and the pixel electrode 22 doubling as a drain electrode. The signal line 12 doubling as a source wire comprising a laminate made of 91A and 35A and the drain electrode 21 of the insulating gate type transistor doubling as the pixel electrode 22 comprising a laminate of 91B and 35B are selectively formed as shown in FIGS. 31(e) and 32(e) using the photosensitive resin patterns 87A and 87B. Etching of the second amorphous silicon layer containing impurities and the first amorphous silicon layer 31A not containing impurities is not needed. An electrode terminal 5 of the scan line is formed containing a part 73 of the exposed scan line and an electrode terminal 6 comprising a part of the signal line is also formed at the same time as the formation of the source and drain wires 12 and 21.

After the source and drain wires 12 and 22 are formed, the above-mentioned photosensitive resin patterns 87A and 87B are reduced by at least 1.5 μm using oxygen plasma or other ashing means to expose the signal line 12 (35A). The signal line 12 is anodized to form an oxide layer 69 (12) on the surface using the reduced photosensitive resin pattern 87C as a mask as shown in FIGS. 31(f) and 31(f), and a second amorphous silicon layer 33A exposed between the source and drain wires 12 and 21, and a part of the first amorphous silicon layer 31A adjacent thereto are anodized to form a silicon oxide layer 66 containing impurities and a silicon oxide layer (not illustrated) not containing impurities, which are insulating layers.

After the anodization is complete, the photosensitive resin pattern 87C is removed to expose the electrode terminals 6 and 5 comprising the low resistance metal layers 35A and 35C and the pixel electrode comprising the low resistance metal layer 35B in whose side the anodized layer 69 (35B) was formed as shown in FIGS. 31(g) and 32(g). 10 When the low resistance metal layers 35A to 35C are removed using the anodized layer 69 (12) on the signal line 12 as a mask, the transparent conductive layers 91A to 91C are exposed as shown in FIGS. 31(h) and 32(h), the latter layers function respectively as the electrode terminal 6A for the signal line, the pixel electrode 22, and the terminal electrode 5A for the scan line. The active substrate 2 thus obtained and the color filter 9 are attached together to form a liquid crystal panel, thereby completing Embodiment 16 of the present invention. The construction of the storage capacitor is identical to that in Embodiment 15.

Reduction of the manufacturing processes is thus advanced in Embodiment 15 and Embodiment 16 by carrying out the formation process of the semiconductor layer and the formation process of the contacts with the same photomask using half-tone exposure technology, and a liquid crystal display device is obtained using four and three photomasks respectively, but the half-tone exposure technology can be applied to other main processes to make a four-mask process and a three-mask process with different details as explained below.

### Embodiment 17

To begin with, in Embodiment 17, Cr, Ta, Mo or the like or an alloy or silicide thereof, for example, is deposited as a first metal layer about 0.1 to 0.3 μm thick on the primary surface of a glass substrate 2 using an SPT or other vacuum film depositing equipment. If an anodized layer is selected as the insulating layer to be formed in the side of the scan line, the need for the anodized layer to maintain insularity is the same as in Embodiment 7.

Next, three thin film layers comprising a first SiNx layer 30 forming a gate insulating layer, a first amorphous silicon layer 31 forming a channel for an insulating gate type transistor containing hardly any impurities, and a second amorphous layer 33 forming a source and drain for an insulating gate type transistor containing phosphorous, for example, as an impurity are successively deposited about 0.3, 0.2, and 0.05 μm thick, for example, over the entire surface of the glass substrate 2 using a PCVD equipment. A thin film layer 34 of Ti, Cr, Mo, or the like, for example, is deposited as a heat resistant layer about 0.1 μm thick using an SPT or other vacuum film depositing equipment, and photosensitive resin patterns 82A and 82B are formed using half-tone exposure technology thinner than the 2-μm thickness of the region 82A corresponding to the scan line 11 and the storage capacitor 16 with the 1-μm thickness of the contact formation region 82B corresponding to the openings 63A and 65A 1 μm, for example, as shown in FIGS. 33(a) and 34(a). Then, the heat resistant metal layer 34, the second amorphous silicon layer 33, the first amorphous silicon layer 31, the gate insulating layer 30, and the first metal layer are selectively removed using the photosensitive resin patterns 82A and 82B as masks to expose the glass substrate 2.

Continuing, by reducing the above-mentioned photosensitive resin patterns 82A and 82B by 1 μm or more using oxygen plasma or other ashing means, the photosensitive resin pattern 82B can be eliminated, exposing the heat resistant metal layers 34A and 34B in the openings 63A and 65A, and leaving the reduced photosensitive resin pattern 82C unchanged above the scan line 11 and the storage capacitor line 16 as shown in FIGS. 33(b) and 34(b).

Continuing, an insulating layer 76 is formed in the side of the gate electrode 11A as shown in FIG. 34(b). Because of this, a connection pattern 78 is needed to provide potential during anodization or electrodeposition at the outer periphery of the glass substrate 2 and the wire 77 bundled in parallel with the scan line 11 is also need (as with the storage capacitor line 16 whose illustration is omitted) as shown in FIG. 49, and a film deposition region 79 in which a suitable mask means is used for the heat resistant metal layer 34 made with an SPT or other vacuum film depositing equipment and the silicon nitride layer 30, the amorphous silicon layers 31 and 33 made with a PCVD equipment is limited to inside the connection pattern 78; at the least, the connection pattern 78 needs to be exposed electrically. When the photosensitive resin pattern 82C (78) on the connection pattern 78 is pierced to provide a positive potential to the scan line 11 to cause a chemical liquid whose main ingredient is ethylene glycol to penetrate the glass substrate 2 and anodize using connection means such as an alligator clip having a sharp point on the connection pattern 78, if the scan line 11 is an Al alloy, aluminum oxide (Al2O3) is formed 0.3 μm thick having a chemical voltage of 200 V, for example. If electrodeposition is used, a polyimide resin layer is formed 0.3 μm thick having an electrodeposition voltage number V using a polyimide electrodeposition liquid with a pendant carboxyl group as described in Embodiment 7.

After the insulating layer 76 is formed, the heat resistant metal layers 34A and 34B, the second amorphous silicon layers 33A and 33B, the first amorphous silicon layers 31A and 31B and the gate insulating layers 30A and 30B in the openings 63A and 65A are selectively etched using the photosensitive resin pattern 82C as a mask to expose a part 73 of the scan line 11 and a part 75 of the storage capacitor line 16 respectively as shown in FIGS. 33(c) and 34(c).

After removing the above-mentioned photosensitive resin pattern 82C, an island-form semiconductor layer region comprising a laminate made of a first amorphous silicon layer 31A, a second amorphous silicon layer 33A, and a heat resistant metal layer 34A is selectively left above the gate electrode 11A using micro-fabrication technology to expose a gate insulating layer 30B on the storage capacitor line 16 and the gate insulating layer 30A on the scan line 11.

IZO or ITO, for example, is deposited as a transparent conductive layer 91 about 0.1 to 0.2 μm thick over the entire surface of the glass substrate 2 using an SPT or other vacuum film deposition equipment as in Embodiment 13, and an Al or Al (Nd) alloy thin film layer 35 about 0.3 μm thick is subsequently deposited as a low resistance metal layer; then, photosensitive resin patterns 88A and 88B are formed thicker than the 1.5-μm thickness of 88B on the pixel electrode 22 doubling as a drain electrode and the 3-μm thickness, for example, of 88A on the electrode terminals 5 and 6 and on the signal line 12 using half-tone exposure technology; a signal line 12 doubling as a source wire comprising a laminate of 91A and 35A, and a drain electrode 21 of the insulating gate type transistor doubling as the pixel electrode 22 comprising a laminate of 91B and 35B are selectively formed as shown in FIGS. 33(e) and 34(e) using the photosensitive resin patterns 88A and 88B; and an electrode terminal 6 comprising a part of the signal line, and an electrode terminal 5 of the scan line containing a part 73 of the exposed scan line, the first amorphous silicon layer 31C, the second amorphous silicon layer 33C, and the heat resistant metal layer 34C at the periphery of the openings 63A and 65A, are formed at the same time as the formation of the source and drain wires 12 and 21

After the source and drain wires 12 and 22 are formed, the above-mentioned photosensitive resin patterns 88A and 88B are reduced by at least 1.5 μm using oxygen plasma or other ashing means to expose the low resistance metal layer 35B on the pixel electrode 22 doubling as a drain electrode, and the low resistance metal layer 35B is removed using the reduced photosensitive resin pattern 88C as a mask, exposing the transparent conductive pixel electrode 22 as shown in FIGS. 33(f) and 34(f).

After removing the reduced photosensitive resin pattern 88C, a second SiNx layer about 0.3 μm thick is deposited using a PCVD equipment as a transparent insulating layer over the entire surface of the glass substrate 2, making a passivating insulating layer 37. Openings 38, 63 and 64 are formed respectively on the pixel electrode 22 and the electrode terminals 5 and 6 as shown in FIGS. 33(g) and 34(g), and the passivating insulating layer in each opening selectively removed to expose the larger part of the pixel electrode 22 and the electrode terminals 5 and 6.

The active substrate 2 thus obtained and the color filter 9 are attached together to form a liquid crystal panel, thereby completing Embodiment 17 of the present invention. The composition of the storage capacitor is exemplified in FIG. 33(g) as comprising a region 51 (a right-slanting oblique part) on which the pixel electrode 22 and the storage capacitor line 16 are overlaid in a planar fashion via the gate insulating layer 30B. A description of measures for static electricity is omitted, but it goes without saying that such measures of various constructions may be used having a contact formation process.

### Embodiment 18

Embodiment 18 is equipped with passivation technology in place of the passivating insulating layer as an addition to the minimum number of processes in Embodiment 17, similar to the relationship of Embodiment 13 and Embodiment 14. In Embodiment 18, the same manufacturing process used in Embodiment 17 is carried out up to the formation of a semiconductor layer region comprising a laminate made of an anodizable heat resistant metal layer 34A, a second amorphous silicon layer 33A, and a first amorphous silicon layer 31A above a gate electrode 11A, and contacts 63A and 65A on the scan line 11 and the storage capacitor line 16 outside the image display region as shown in FIGS. 35(d) and 36(d). The thickness of the first amorphous silicon layer 31 may be deposited thinner at 0.1 μm.

Then, IZO or ITO, for example, is deposited as a transparent conductive layer 91 about 0.1 to 0.2 μm thick over the entire surface of the glass substrate 2 using an SPT or other vacuum film depositing equipment; and an Al or Al (Nd) alloy thin film layer 35 about 0.3 μmi thick is subsequently deposited as an anodizable low resistant metal layer. Using half-tone exposure technology, photosensitive resin patterns 87A and 87B are formed thicker than the 1.5-μm thickness of 87B on the signal line 21 with 87A 3 μm thick, for example, on the electrode terminals 5 and 6 and on the pixel electrode 22 doubling as a drain electrode. The signal line 12 doubling as a source wire comprising a laminate of 91A and 35A and the drain electrode 21 of the insulating gate type transistor doubling as the pixel electrode 22 comprising a laminate of 91B and 35B are selectively formed as shown in FIGS. 35(e) and 36(e) using the photosensitive resin patterns 87A and 87B. An electrode terminal 6 comprising a part of the signal line, and an electrode terminal 5 of the scan line containing a part 73 of the exposed scan line, the first amorphous silicon layer 31C, the second amorphous silicon layer 33C, and the heat resistant metal layer 34C at the periphery of the openings 63A and 65A, are formed at the same time as the formation of the source and drain wires 12 and 21.

After the source and drain wires 12 and 12 are formed, the above-mentioned photosensitive resin patterns 87A and 87B are reduced by at least 1.5 μm using oxygen plasma or other ashing means to expose the signal 12 using the reduced photosensitive resin pattern 87C as a mask, the signal line 12 is anodized as shown in FIGS. 35(f) and 36(f) to form an oxide layer 69 (12) on the surface, and the second amorphous silicon layer 33A exposed between the source and drain wires 12 and 21, and a part of the first amorphous silicon layer adjacent thereto are anodized to form a silicon oxide layer 66 containing impurities, and a silicon oxide layer (not illustrated) not containing impurities, which are insulating layers.

After the anodization is complete, the photosensitive resin pattern 87C is removed to expose the electrode terminals 6 and 5 comprising the low resistance metal layers 35A and 35C, and to expose the pixel electrode comprising the low resistance metal layer 35B in whose side the anodized layer 69 (35B) was formed as shown in FIGS. 35(g) and 36(g).

When the low resistance metal layers 35A to 35C are removed using the anodized layer 69 (12) on the signal line 12 as a mask, the transparent conductive layers 91A to 91C are exposed as shown in FIGS. 35(h) and 36(h), the latter layers function respectively as the electrode terminal 6A for the signal line, the pixel electrode 22, and the terminal electrode 5A for the scan line. The active substrate 2 thus obtained and the color filter 9 are attached together to form a liquid crystal panel, thereby completing Embodiment 18 of the present invention. The construction of the storage capacitor is identical to that in Embodiment 17.

Reduction of the manufacturing processes is thus advanced in Embodiment 17 and Embodiment 18 by carrying out the formation process of the scan line and the formation process of the contacts with the same photomask using half-tone exposure technology, and a liquid crystal display device is obtained using four and three photomasks respectively, but the present inventor has devised combinations for further streamlining by which a four-mask process and a three-mask process are enabled having different details as described below.

### Embodiment 19

To begin with, in Embodiment 19, Cr, Ta, Mo or the like or an alloy or silicide thereof, for example, is deposited as a first metal layer about 0.1 to 0.3 μm thick on the primary surface of a glass substrate 2 using an SPT or other vacuum film depositing equipment. If an anodized layer is selected as the insulating layer to be formed in the side of the scan line, the need for the anodized layer to maintain insularity as in Embodiment 7.

Next, three thin film layers comprising a first SiNx layer 30 forming a gate insulating layer, a first amorphous silicon layer 31 forming a channel for an insulating gate type transistor containing hardly any impurities, and a second amorphous layer 33 forming a source and drain for an insulating gate type transistor containing phosphorous, for example, as an impurity are successively deposited about 0.3, 0.2, and 0.05 μm thick, for example, over the entire surface of the glass substrate 2 using a PCVD equipment. A thin film layer 34 of Ti, Cr, Mo, or the like, for example, is deposited as a heat resistant layer about 0.1 μm thick using an SPT or other vacuum film depositing equipment, and photosensitive resin patterns 84A and 84B are formed using half-tone exposure technology thinner than the 1-μm thickness of the region 84B corresponding to the scan line 11 and the storage capacitor 16 with the thickness of the region 84A above the semiconductor layer formation region, that is, the gate electrode 11A 2 μm, for example, as shown in FIGS. 37(a) and 38(a). Then, the heat resistant metal layer 34, the second amorphous silicon layer 33, the first amorphous silicon layer 31, the gate insulating layer 30, and the first metal layer are selectively removed using the photosensitive resin patterns 84A and 84B as masks to expose the glass substrate 2.

Continuing, by reducing the above-mentioned photosensitive resin patterns 84A and 84B by 1 μm or more using oxygen plasma or other ashing means, the photosensitive resin pattern 84B can be eliminated, exposing the heat resistant metal layers 34A and 34B, and leaving the reduced photosensitive resin pattern 84C unchanged at the semiconductor layer formation region as shown in FIGS. 37(b) and 38(b). The pattern width of the photosensitive resin pattern 84C (the black region), that is, the gate electrode 11A (semiconductor layer) is the sum of the length between the source and drain wires and the mask alignment precision, the dimension precision is not strict, with a minimum of 10 to 12 μm, the source and drain wire interval being 4 to 6 μm and the alignment precision being ±3 μm. Nevertheless, when the resist pattern is isotropically reduced 1 μm during the conversion from the resist pattern 84A to 84C, not only does the dimension decrease 2 μm, but the mask alignment precision decreases 1 μm during the formation of the subsequent source and drain wires to ±2 μm, so the latter is stricter in terms of process than the former. Accordingly, it is desirable to increase the anisotropy to control changes in the pattern dimensions during the above-mentioned oxygen plasma treatment. Alternatively, the pattern dimension of the resist pattern 84A can be designed larger beforehand, anticipating the amount of change in the resist pattern dimension, or measures taken such as providing for a process-based approach with exposure and development conditions to increase the pattern dimensions of the resist pattern 84A.

Continuing, the heat resistant metal layers 34A and 34B, the second amorphous silicon layers 33A and 33B and the first amorphous silicon layers 31A and 31B are selectively etched as shown in FIGS. 37(c) and 38(c) using the reduced photosensitive resin pattern 84C as a mask to form a semiconductor layer region comprising a laminate of the heat resistant metal layer 34A, the second amorphous silicon layer 33A and the first amorphous silicon layer 31A above the gate electrode 11A, and expose the gate insulating layers 30A and 30B on the scan line 11 and storage capacitor line 16 respectively.

After removing the above-mentioned photosensitive resin pattern 84C, an insulating layer 76 is formed in the side of the gate electrode 11A, not illustrated. Because of this, a connection pattern 78 is needed to provide potential during anodization or electrodeposition at the outer periphery of the glass substrate 2 and the wire 77 bundled in parallel with the scan line 11 is also needed (as with the storage capacitor line 16 whose illustration is omitted) as shown in FIG. 52, and a film depositing region 79 in which a suitable mask means is used for amorphous silicon layers 31 and 33 and a silicon nitride layer 30 made with a PCVD equipment is limited to inside the connection pattern 78; at the least, the connection pattern 78 needs to be exposed electrically. When a positive potential is provided to the scan line 11 to cause a chemical liquid whose main ingredient is ethylene glycol to penetrate the glass substrate 2 and anodize using connection means such as an alligator clip having a sharp point on the connection pattern 78, if the scan line 11 is an Al alloy, aluminum oxide (Al2O3) is formed 0.3 μm thick having a chemical voltage of 200 V, for example. If electrodeposition is used, a polyimide resin layer is formed 0.3 μm thick having an electrodeposition voltage number V using a polyimide electrodeposition liquid with a pendant carboxyl group as described above. It should not be forgotten that there are secondary effects in Embodiment 19 wherein the pinholes generated in the gate insulating layer 30A on the scan line 11 due to the formation of the insulating layer 76 are embedded with polyimide resin or aluminum oxide, which is an insulating layer, so shorts through the layers between the source and drain wires 12 and 21 described below and the scan line 11 are suppressed.

Openings 63A and 65A are formed in the contact formation region of the scan line 11 and the storage capacitor line 16 outside the image display region using micro-fabrication technology as shown in FIGS. 37(d) and 38(d), and the gate insulating layers 30A and 30B in the openings 63A and 65B are selectively removed to expose a part 73 of the scan line 11 and a part 75 of the storage capacitor line 16 respectively.

Next, IZO or ITO, for example, is deposited as a transparent conductive layer 91 about 0.1 to 0.2 μm thick over the entire surface of the glass substrate 2 using an SPT or other vacuum film depositing equipment as in Embodiment 13, and an Al or Al (Nd) alloy thin layer 35 about 0.3 μm thick is subsequently deposited as a low resistance metal layer; then, photosensitive resin patterns 88A and 88B are formed thicker than the 1.5-μm thickness of 88B on the pixel electrode 22 doubling as a drain electrode and the 3-μm thickness, for example, of 88A on the electrode terminals 5 and 6 and on the signal line 12 using half-tone exposure technology; a signal line 12 doubling as a source wire comprising a laminate of 91A and 35A, and a drain electrode 21 of the insulating gate type transistor doubling as the pixel electrode 22 comprising a laminate of 91B and 35B are selectively formed as shown in FIGS. 37(e) and 38(e) using the photosensitive resin patterns 88A and 88B; an electrode terminal 6 comprising a part of the signal line and an electrode terminal 5 of the scan line containing a part 73 of the exposed scan line in the opening 63A are formed at the same time as the formation of the source and drain wires 12 and 21.

After the source and drain wires 12 and 21 are formed, the above-mentioned photosensitive resin patterns 88A and 88B are reduced by at least 1.5 μm using oxygen plasma or other ashing means to expose the low resistance metal layer 35B on the pixel electrode 22 doubling as the drain electrode 21. The low resistance metal layer 35B is removed using the reduced photosensitive resin pattern 88C as a mask, and the transparent conductive pixel electrode 22 is exposed as shown in FIGS. 37(f) and 38(f).

After removing the reduced photosensitive resin pattern 88C, a second SiNx layer about 0.3 μm thick is deposited using a PCVD equipment as a transparent insulating layer over the entire surface of the glass substrate 2, making a passivating insulating layer 37. Openings 38, 63 and 64 are formed respectively on the pixel electrode 22 and the electrode terminals 5 and 6 as shown in FIGS. 37(g) and 38(g), and the passivating insulating layer in each opening is selectively removed to expose the larger part of the pixel electrode 22 and the electrode terminals 5 and 6.

The active substrate 2 thus obtained and the color filter 9 are attached together to form a liquid crystal panel, thereby completing Embodiment 19 of the present invention. The composition of the storage capacitor is exemplified in FIG. 37(g) as comprising a region 51 (a right-slanting oblique part) on which the pixel electrode 22 and the storage capacitor line 16 are overlaid in a planar fashion via the gate insulating layer 30B.

### Embodiment 20

Embodiment 20 is equipped with passivation technology in place of the passivating insulating layer as an addition to the minimum number of processes in Embodiment 19, similar to the relationship of Embodiment 1 and Embodiment 2. In Embodiment 20, the manufacturing process is advanced identically as in Embodiment 19 up to when contacts (openings) 63A and 65A are formed in gate insulating layers 30A and 30B on the scan line 11 and the storage capacitor line 16 respectively outside the image display region using micro-fabrication technology to expose a part 73 of the scan line 11 and a part 75 of the storage capacitor line 16 as shown in FIGS. 39(d) and 40(d). The thickness of the first amorphous silicon layer 31 may be deposited thinner at 0.1 μm. Also, an anodizable metal is required for the heat resistant metal layer 34, and Cr, Mo, W and the like are not suitable therefor, so at least, Ti, or preferably Ta or a silicide of a metal with a high melting point is selected.

Then, IZO or ITO, for example, is deposited as a transparent conductive layer 91 about 0.1 to 0.2 μm thick over the entire surface of the glass substrate 2 using an SPT or other vacuum film depositing equipment; and an Al or Al (Nd) alloy thin film layer 35 about 0.3 μm thick is subsequently deposited as an anodizable low resistant metal layer. Using half-tone exposure technology, photosensitive resin patterns 87A and 87B are formed thicker than the 1.5-μm thickness of 87B on the signal line 12 and the 3-μm thickness, for example, of 87A on the electrode terminals 5 and 6 and on the pixel electrode 22 doubling as a drain electrode. The signal line 12 doubling as a source wire comprising a laminate of 91A and 35A and the drain electrode 21 of the insulating gate type transistor doubling as the pixel electrode 22 comprising a laminate of 91B and 35B are selectively formed as shown in FIGS. 39(e) and 40(e) using the photosensitive resin patterns 87A and 87B. An electrode terminal 5 of the scan line containing an exposed contact (opening) 63A, and an electrode terminal 6 comprising a part of the signal line are formed at the same at the same time the source and drain wires 12 and 21 are formed.

After the source and drain wires 12 and 22 are formed, the above-mentioned photosensitive resin patterns 87A and 87B are reduced by at least 1.5 μm using oxygen plasma or other ashing means to expose the signal line 12 (35A). The signal line 12 is anodized to form an oxide layer 69 (12) on the surface using the reduced photosensitive resin pattern 87C as a mask as shown in FIGS. 39(f) and 40(f), and a second amorphous silicon layer 33A exposed between the source and drain wires 12 and 21, and a part of the first amorphous silicon layer 31A adjacent thereto are anodized to form a silicon oxide layer 66 containing impurities, and a silicon oxide layer (not illustrated) not containing impurities, which are insulating layers.

After the anodization is complete, the photosensitive resin pattern 87C is removed to expose the electrode terminals 6 and 5 comprising the low resistance metal layers 35A and 35C and to expose the pixel electrode comprising the low resistance metal layer 35B in whose side the anodized layer 69 (35B) was formed as shown in FIGS. 39(g) and 40(g).

When the low resistance metal layers 35A to 35C are removed using the anodized layer 69 (12) on the signal line 12 as a mask, the transparent conductive layers 91A to 91C are exposed as shown in FIGS. 39(h) and 40(h), the latter layers function respectively as the electrode terminal 6A for the signal line, the pixel electrode 22, and the terminal electrode 5A for the scan line. The active substrate 2 thus obtained and the color filter 9 are attached together to form a liquid crystal panel, thereby completing Embodiment 20 of the present invention. The construction of the storage capacitor is identical to that in Embodiment 19.

In this manner, liquid crystal display devices are obtained in Embodiment 19 and Embodiment 20 using four and three photomasks respectively using a formation process for the scan line and a formation process for the semiconductor, and a formation process for the source and drain wires and a formation process for the pixel electrode using half-tone technology. Still, by rearranging the sequence of the photographic etching processes from the perspective of not having them conventionally, it is possible to reduce the number of manufacturing processes a bit more. This is described in Embodiment 21 and Embodiment 22.

### Embodiment 21

To begin with, in Embodiment 21, Cr, Ta, Mo or the like or an alloy or silicide thereof, for example, is deposited as a first metal layer 92 about 0.1 to 0.3 μm thick on the primary surface of a glass substrate 2 using an SPT or other vacuum film deposition equipment as in Embodiment 13. If an anodized layer is selected as the insulating layer to be formed in the side of the scan line, the need for the anodized layer to maintain insularity as in Embodiment 7.

Next, three thin film layers comprising a first SiNx layer 30 forming a gate insulating layer, a first amorphous silicon layer 31 forming a channel for an insulating gate type transistor containing hardly any impurities, and a second amorphous silicon layer 33 forming a source and drain for an insulating gate type transistor containing phosphorous, for example, as an impurity are successively deposited about 0.3, 0.2, and 0.05 μm thick, for example, over the entire surface of the glass substrate 2 using a PCVD equipment. A thin film layer 34 of Ti, Cr, Mo, or the like, for example, is deposited as a heat resistant layer about 0.1 μm thick using an SPT or other vacuum film deposition equipment, and a semiconductor layer region comprising a laminate made of a heat resistant metal layer 34A, a second amorphous silicon layer 33A and a first amorphous silicon layer 31A is selectively formed to expose the gate insulating layer 30 as shown in FIGS. 41(a) and 42(a) using micro-fabrication technology.

Continuing, photosensitive resin patterns 82A and 82B are formed using half-tone exposure technology thinner than the 2-μm thickness on the region 82A corresponding to the scan line 11 and the storage capacitor line 16 with the thickness of the openings 63A and 65A, which is a contact formation region 82B, 1 μm, for example, and the gate insulating layer 30 and the first metal layer 92 are selectively removed using the photosensitive resin patterns 82A and 82B as masks to expose the glass substrate 2 as shown in FIGS. 41(b) and 42(b). Although it is logical to set the pattern width a bit wider than the semiconductor layer region comprising a laminate of a heat resistant metal layer 34A, a second amorphous silicon layer 33A and a first amorphous silicon layer 31A to set the pattern width of the photosensitive resin pattern 82A, defects then occur where the size of the insulating gate type transistor becomes somewhat large. Conversely, even if the pattern width is made a bit narrower than the semiconductor layer region comprising the above-mentioned laminate so the pattern width of the photosensitive resin pattern 82A is set, the semiconductor layer comprising the above-mentioned laminate is used as a mask during etching of the gate insulating layer 30 and the first metal layer 92, and the semiconductor layer is etched to taper the form of the cross-section, so regardless, the pattern width of the semiconductor layer comprising the above-mentioned laminate ends up smaller than the gate electrode 11A and the gate insulating layer 30A.

Continuing, by reducing the above-mentioned photosensitive resin patterns 82A and 82B by 1 μm or more using oxygen plasma or other ashing means, the photosensitive resin pattern 82B can be eliminated, exposing gate insulating layers 30A and 30B in the openings 63A and 65B, and leaving the reduced photosensitive resin pattern 82C unchanged above the scan line 11 and the storage capacitor line 16 as shown in FIGS. 41(c) and 42(c). Accordingly, it is desirable to increase the anisotropy to control changes in the pattern dimensions during the above-mentioned oxygen plasma treatment. Alternatively, the fact that measures such as providing for a process-based approach of designing the pattern dimensions of the resist pattern 82A larger beforehand, anticipating the amount of dimension change in the resist pattern are desirable has been mentioned above.

Then, an insulating layer 76 is formed in the side of the gate electrode 11A as shown in FIG. 42(c). Because of this, a connection pattern 78 is needed to provide potential during anodization or electrodeposition at the outer periphery of the glass substrate 2 and the wire 77 bundled in parallel with the scan line 11 (as with the storage capacitor line 16 whose illustration is omitted) as shown in FIG. 49, and a film deposition region 79 is limited to inside the connection pattern 78 using suitable mask means for a heat resistant metal layer 34 made using an SPT equipment, silicon nitride layers 30 and amorphous silicon layers 31 and 33 made with a PCVD equipment; at the least, the connection pattern 78 needs to be exposed electrically. When the photosensitive resin pattern 82C (78) on the connection pattern 78 is pierced to provide a positive potential to the scan line 11 to cause a chemical liquid whose main ingredient is ethylene glycol to penetrate the glass substrate 2 and anodize using connection means such as an alligator clip having a sharp point on the connection pattern 78, if the scan line 11 is an Al alloy, aluminum oxide (Al2O3) is formed 0.3 μm thick having a chemical voltage of 200 V, for example. If electrodeposition is used, a polyimide resin layer is formed 0.3 μm thick having an electrodeposition voltage number V using a polyimide electrodeposition liquid with a pendant carboxyl group. After formation of the insulating layer 76, the gate insulating layers 30A and 30B in the openings 63A and 65A are selectively etched using the reduced photosensitive resin pattern 82C as a mask to expose a part 73 of the scan line 11 and a part 75 of the storage capacitor line 16 respectively as shown in FIGS. 41(d) and 42(d).

Then, the aforementioned photosensitive resin pattern 82C is removed, ITO or ITO, for example, is deposited as a transparent conductive layer 91 about 0.1 to 0.2 μm thick over the entire surface of the glass substrate 2 using an SPT or other vacuum film deposition equipment as in Embodiment 13, and an Al or Al (Nd) alloy thin film layer 35 about 0.3 μm thick is subsequently deposited as a low resistance metal layer; then, photosensitive resin patterns 88A and 88B are formed thicker than the 1.5-μm thickness of 88B on the pixel electrode 22 doubling as a drain electrode and the 3-μm thickness, for example, of 88A on the electrode terminals 5 and 6 and on the signal line 12 using half-tone exposure technology; a signal line 12 doubling as a source wire comprising a laminate of 91A and 35A, and a drain electrode 21 of the insulating gate type transistor doubling as the pixel electrode 22 comprising a laminate of 91B and 35B are selectively formed as shown in FIGS. 41(e) and 42(e) using the photosensitive resin patterns 88A and 88B; and an electrode terminal 5 of the scan line containing a part 73 of the scan line exposed in the opening 63A and an electrode terminal 6 comprising a part of the signal line are formed at the same time as the formation of the source and drain wires 12 and 21.

After the source and drain wires 12 and 21 are formed, the above-mentioned photosensitive resin patterns 88A and 88B are reduced by at least 1.5 μm using oxygen plasma or other ashing means to expose the low resistance metal layer 35B on the pixel electrode 22 doubling as a drain electrode; the low resistance metal layer 35B is removed using the reduced photosensitive resin pattern 88C as a mask, and a transparent conductive pixel electrode 22 is formed as in FIGS. 41(f) and 42(f).

After removing the reduced photosensitive resin pattern 88C, a second SiNx layer about 0.3 μm thick is deposited using a PCVD equipment as a transparent insulating layer over the entire surface of the glass substrate 2, making a passivating insulating layer 37. Openings 38, 63 and 64 are formed respectively on the pixel electrode 22 and the electrode terminals 5 and 6 as shown in FIGS. 41(g) and 42(g), and the passivating insulating layer in each opening selectively removed to expose the larger part of the pixel electrode 22 and the electrode terminals 5 and 6.

The active substrate 2 thus obtained and the color filter 9 are attached together to form a liquid crystal panel, thereby completing Embodiment 21 of the present invention. The composition of the storage capacitor is exemplified in FIG. 41(g) as comprising a region 51 (a right-slanting oblique part) on which the pixel electrode 22 and the storage capacitor line 16 are overlaid in a planar fashion via the gate insulating layer 30B.

### Embodiment 22

Embodiment 22 is equipped with passivation technology in place of the passivating insulating layer as an addition to the minimum number of processes in Embodiment 21, similar to the relationship of Embodiment 13 and Embodiment 14. In Embodiment 20, the manufacturing process is carried out identically to that in Embodiment 21 up to the formation process of the contacts 63A and 65A on the scan line 11 and the storage capacitor line 16 as shown in FIGS. 43(d) and 44(d). The thickness of the first amorphous silicon layer 31 may be deposited thinner at 0.1 μm. Also, an anodizable metal is required for the heat resistant metal layer 34, and Cr, Mo, W and the like are not suitable therefor, so at least, Ti, or preferably Ta or a silicide of a metal with a high melting point is selected.

Then, IZO or ITO, for example, is deposited as a transparent conductive layer 91 about 0.1 to 0.2 μm thick over the entire surface of the glass substrate 2 using an SPT or other vacuum film deposition equipment; and an Al or Al (Nd) alloy thin film layer 35 about 0.3 μm thick is subsequently deposited as an anodizable low resistant metal layer. Using half-tone exposure technology, photosensitive resin patterns 87A and 87B are formed thicker than the 1.5-μm thickness of 87B on the signal line 12 and the 3-μm thickness, for example, of 87A on the electrode terminals 5 and 6 and on the pixel electrode 22 doubling as a drain electrode. The signal line 12 doubling as a source wire comprising a laminate of 91A and 35A and the drain electrode 21 of the insulating gate type transistor doubling as the pixel electrode 22 comprising a laminate of 91B and 35B are selectively formed as shown in FIGS. 43(e) and 44(e) using the photosensitive resin patterns 87A and 87B. An electrode terminal 5 of the scan line containing an exposed contact (opening) 63A and an electrode terminal 6 comprising a part of the signal line are formed at the same time as the source and drain wires 12 and 21 are formed.

The above-mentioned photosensitive resin patterns 87A and 87B are reduced by at least 1.5 μm using oxygen plasma or other ashing means to expose the signal line 12 (35A) after the source and drain wires 12 and 21 are formed. The signal line 12 is anodized to form an oxide layer 69 (12) on the surface using the reduced photosensitive resin pattern 87C as a mask as shown in FIGS. 43(f) and 44(f), and a second amorphous silicon layer 33A exposed between the source and drain wires 12 and 21, and a part of the first amorphous silicon layer 31A adjacent thereto are anodized to form a silicon oxide layer 66 containing impurities, and a silicon oxide layer (not illustrated) not containing impurities, which are insulating layers.

After the anodization is complete, the photosensitive resin pattern 87C is removed, exposing the electrode terminals 6 and 5 comprising the low resistance metal layers 35A and 35C and the pixel electrode comprising the low resistance metal layer 35B in whose side the anodized layer 69 (35B) was formed as shown in FIGS. 43(g) and 44(g).

Further, the low resistance metal layers 35A to 35C are removed using the anodization layer 69 (12) on the signal line 12 to expose the transparent conductive layers 91A to 91C as shown in FIGS. 43(h) and 44(h), the latter layers function respectively as the electrode terminal 6A for the signal line, the pixel electrode 22, and the terminal electrode 5A for the scan line. The active substrate 2 thus obtained and the color filter 9 are attached together to form a liquid crystal panel, thereby completing Embodiment 22 of the present invention. The construction of the storage capacitor is identical to that in Embodiment 21.

If a suitable insulating layer can be provided to the exposed scan line such that a direct current flows between the scan line 11 and the opposing electrode 14 so the liquid crystal does not deteriorate, it is possible to eliminate the contact formation process by removing the gate insulating layer when the semiconductor layer region is formed to expose the scan line. The scan line is insulated using a conventional passivating insulating layer as an insulating layer to obtain a liquid crystal display device in Embodiment 23, and the scan line comprising an anodizable metal layer is insulated by anodizing to obtain a liquid crystal display device in Embodiment 24.

### Embodiment 23

To begin with, in Embodiment 23, an anodizable first metal layer 92 is deposited about 0.1 to 0.3 μm thick on the primary surface of a glass substrate 2 using an SPT or other vacuum film deposition equipment. Next, three thin film layers comprising a first SiNx layer 30 forming a gate insulating layer, a first amorphous silicon layer 31 forming a channel for an insulating gate type transistor containing hardly any impurities, and a second amorphous silicon layer 33 forming a source and drain for the insulating gate type transistor containing impurities are successively deposited about 0.3, 0.2, and 0.05 μm thick, for example, over the entire surface of the glass substrate 2 using a PCVD equipment. Next, a thin film layer 34 of Ti, Cr, Mo, or the like, for example, is deposited as a heat resistant metal layer about 0.1 μm thick using an SPT or other vacuum film deposition equipment. Photosensitive resin patterns 84A1 to 84A4 and 84B are formed using half-tone exposure technology thicker than the 1-μm of the photosensitive resin pattern 84B corresponding to the storage capacitor line 16 and the scan line 11 doubling as the gate electrode 11A, with the thickness of a region 84A4 at a part of the storage capacitor formation region, that is, the storage capacitor line 16 a region 84A3 at a region proximate to where the storage capacitor line 16 and the signal 12 intersect, a region 84A2 at a region proximate to where the scan line 11 and the signal line 12 intersect, and a region 84A1 at the semiconductor layer formation region, that is, the gate electrode 11A, 2 μm, for example, as shown in FIGS. 45(a) and 46(a). Then, the first metal layer 92 is selectively removed in addition to the heat resistant metal layer 34, the second amorphous silicon layer 33, the first amorphous silicon layer 31, and the gate insulating layer 30 using the photosensitive resin patterns 84A1 to 84A4 and 84B as masks to expose the glass substrate 2.

After obtaining the multi-layer film patterns corresponding to the storage capacitor line 16 and the scan line 11 doubling as the gate electrode 11A in this manner, the above-mentioned photosensitive resin patterns 84A1 to 84A4 and 84B are reduced at least 1 μm using oxygen plasma or other ashing means to eliminate the photosensitive resin pattern 84B. The heat resistant metal layers 34A and 34B are exposed as shown in FIGS. 45(b) and 46(b), and reduced photosensitive resin patterns 84C1 to 84C4 are left unchanged only at the gate electrode 11A, at a region proximate to where the scan line 11 and the signal line 12 intersect, at a region proximate to where the storage capacitor line 16 and the signal line 12 intersect, and at a part of the storage capacitor 16 line. In the above-mentioned oxygen plasma treatment, the fact that it is desirable to control change in the pattern dimensions by increasing the anisotropy such that the mask alignment precision in the subsequent source and drain wire formation process does not drop has already been described.

Then, an insulating layer 76 is formed in the side of the gate electrode 11A as shown in FIG. 46(b). Because of this, a connection pattern 78 is needed to provide potential during anodization or electrodeposition at the outer periphery of the glass substrate 2 and the wire 77 bundled in parallel with the scan line 11 is also needed (as with the storage capacitor line 16 whose illustration is omitted) as shown in FIG. 53, and a film deposition region 79 is limited to inside the connection pattern 78 using suitable mask means for the heat resistant metal layer 34 made by an SPT, as well as the silicon nitride layer 30 and the amorphous silicon layers 31 and 33 made with a PCVD equipment; at the least, the connection pattern 78 needs to be exposed electrically. When a photosensitive resin pattern 84C5 (78) on the connection pattern 78 is pierced to provide a positive potential for the scan line 11 to cause a chemical liquid whose main ingredient is ethylene glycol to penetrate the glass substrate 2 and anodize using connection means such as an alligator clip having a sharp point on the connection pattern 78, if the scan line 11 is an Al alloy, an aluminum oxide (Al2O3) is formed 0.3 μm thick having a chemical voltage of 200 V, for example. If electrodeposition is used, a polyimide resin layer is formed 0.3 μm thick having an electrodeposition voltage number V using a polyimide electrodeposition liquid with a pendant carboxyl group.

Continuing, a laminate made of the gate insulating layer 30A, the first amorphous silicon 31A, the second amorphous silicon 33A, and the heat resistant metal layer 34A is selectively left at a region proximate to where the scan line 11 and the signal line 12 intersect and at the gate electrode 11A; a laminate made of the gate insulating layer 30B, the first amorphous silicon 31B, the second amorphous silicon 33B, and the heat resistant metal layer 34B is left at a part of the storage capacitor 16 line and at a region proximate to where the storage capacitor line 16 and the signal line 12 intersect, using the photosensitive resin patterns 84C1 to 84C4 as masks; the heat resistant metal layer 34A, the second amorphous silicon layer 33A, the first amorphous silicon layer 31A and the gate insulating layer 30A on the scan line 11 are etched to expose the scan line 11, and at the same time, the heat resistant metal layer 34B, the second amorphous silicon layer 33B, the first amorphous silicon layer 31B and the gate insulating layer 30B on the storage capacitor line 16 are etched to expose the storage capacitor line 16 as shown in FIGS. 45(c) and 46(c).

After the above-mentioned photosensitive resin patterns 84C1 to 84C4 are removed, ITO or ITO, for example, is deposited as a transparent conductive layer 91 about 0.1 to 0.2 μm thick over the entire surface of the glass substrate 2 using an SPT or other vacuum film deposition equipment, and an Al or Al (Nd) alloy thin film layer 35 about 0.3 μm thick is subsequently deposited as a low resistance metal layer; then, photosensitive resin patterns 88A and 88B are formed thicker than the 1.5-μm thickness of 88B on the pixel electrode 22 doubling as a drain electrode and the 3-μm thickness, for example, of 88A on the electrode terminals 5 and 6 and on the signal line 12 using half-tone exposure technology; a signal line 12 doubling as a source wire comprising a laminate of 91A and 35A, and a drain electrode 21 of the insulating gate type transistor doubling as the pixel electrode 22 comprising a laminate of 91B and 35B are selectively formed as shown in FIGS. 45(d) and 46(d) using the photosensitive resin patterns 88A and 88B; and an electrode terminal 6 comprising a part of the signal line, and an electrode terminal 5 of the scan line containing a part 73 of the exposed scan line are formed at the same time as the formation of the source and drain wires 12 and 21.

After the source and drain wires 12 and 21 are formed, the above-mentioned photosensitive resin patterns 88A and 88B are reduced at least 1.5 μm using oxygen plasma or other ashing means to expose the low resistance metal layer 35B on the pixel electrode 22 doubling as a drain electrode, and the low resistance metal layer 35B is removed using the reduced photosensitive resin pattern 88C as a mask, exposing the transparent conductive pixel electrode 22 as shown in FIGS. 45(e) and 46(e). It is necessary to select scan line material such that the exposed scan line 11 is not eliminated in the removal of the low resistance metal layer 35B. If an Al alloy is used for the low resistance metal layer 351B, a heat resistant metal such as Ta, Cr, or Mo is optimal for the scan line 11, and if a heat resistant metal such as Cr or Mo is used for the low resistance metal layer 35B, an Al alloy is optimal for the scan line 11. That is, the same types of material must not be used for the scan line 11 and the low resistance metal layer 35B.

After the reduced photosensitive resin pattern 88C is removed, a second SiNx layer about 0.3 μm thick is deposited over the entire surface of the glass substrate 2 using a PCVD equipment as a transparent insulating layer to make a passivating insulating layer 37. Openings 38, 63 and 64 are then formed on the pixel electrode 22 and the electrode terminals 5 and 6 respectively as shown in FIGS. 45(f) and 46(f), and the passivating insulating layer in each opening is selectively removed to expose the larger part of the pixel electrode 22 and the electrode terminals 5 and 6.

If the same type of material is used as for the scan line 11 and the low resistance metal layer 35B, half-tone exposure is unnecessary, in which case, after the formation of the source and drain wires 12 and 21, a second SiNx layer may be deposited as a transparent insulating layer about 0.3 μm thick using a PCVD equipment over the entire surface of the glass substrate 2 to make a passivating insulating layer 37. Openings 38, 63 and 64 may then be formed on the pixel electrode 22 and the electrode terminals 5 and 6 respectively as shown in FIGS. 45(g) and 46(g), and low resistance metal layers 35B, 35C and 35A and the passivating insulating layer in each opening may be selectively removed to obtain the transparent conductive pixel electrode 22 and transparent conductive electrode terminals 5A and 6A.

Excluding Embodiment 23, there are no restrictions on the material for the low resistance metal layer 35B and the scan line 11 because there is at least the gate insulating layer 30 or the gate insulating layer 30A on the scan line 11 for the removal of the low resistance metal layer 35B; after the formation of the source and drain wires 12 and 21 without using half-tone exposure, the depositing of a second SiNx layer about 0.3 μm thick as a transparent insulating layer on the entire surface of the glass substrate 2 using a PCVD equipment to make a passivating insulating layer 37, the formation of openings 38, 63 and 64 on the pixel electrode 22 and the electrode terminals 5 and 6 respectively, and the selective removal of the low resistance metal layers 35B, 35C and 35A and the passivating insulating layer in the openings to obtain the transparent conductive pixel electrode 22 and the transparent conductive electrode terminals 5A and 6A may be applied unchanged to Embodiment 13, Embodiment 15, Embodiment 17, Embodiment 19, and Embodiment 21.

The active substrate 2 thus obtained and the color filter 9 are attached together to form a liquid crystal panel, thereby completing Embodiment 23 of the present 10 invention. As shown in FIG. 45(f), the composition of the storage capacitor is exemplified by a construction of a region 51 (a right-slanting oblique part) on which the pixel electrode 22 and the storage capacitor line 16 are overlaid in a planar fashion via the gate insulating layer 30B, the first amorphous silicon 31B, the second amorphous silicon 33B, and the heat resistant metal layer 34B.

### Embodiment 24

Embodiment 24 is equipped with passivation technology in place of the passivating insulating layer as an addition to the minimum number of processes in Embodiment 23, similar to the relationship of Embodiment 13 and Embodiment 14. The manufacturing process in Embodiment 24 is carried out the same as in Embodiment 23 up to when a laminate made of a heat resistant 34A, the second amorphous silicon 33A, the first amorphous silicon 31A and the gate insulating layer 30A is selectively left at a region proximate to where the scan line 11 and the signal line 12 intersect and at the gate electrode 11A, a laminate made of the heat resistant metal layer 34B, the second amorphous silicon 33B, the first amorphous silicon 31B and the gate insulating layer 30B is selectively left at a part of the storage capacitor 16 line and at a region proximate to where the storage capacitor line 16 and the signal line 12 intersect, and at the same time the heat resistant metal layer 34A, the second amorphous silicon layer 33A, the first amorphous silicon layer 31A and the gate insulating layer 30A on the scan line 11 are etched to expose the scan line 11, the heat resistant metal layer 34B, the second amorphous silicon layer 33B, the first amorphous silicon layer 31B and the gate insulating layer 30B on the storage capacitor line 16 are etched to expose the storage capacitor line 16 as shown in FIGS. 47(c) and 48(c). The thickness of the first amorphous silicon layer 31 may be produced thinner at 0.1 μm. Also, the heat resistant metal layer 34 needs to be an anodizable metal.

Then, IZO or ITO, for example, is deposited as a transparent conductive layer 91 about 0.1 to 0.2 μm thick over the entire surface of the glass substrate 2 using an SPT or other vacuum film deposition equipment; an Al or Al (Nd) alloy thin film layer 35 about 0.3 μm thick is subsequently deposited as an anodizable low resistant metal layer; using half-tone exposure technology, photosensitive resin patterns 87A and 87B are formed thicker than the 1.5-μm thickness of 87B on the signal line 12 and the 3-μm thickness, for example, of 87A on the electrode terminals 5 and 6 and on the pixel electrode 22 doubling as a drain electrode, and a signal line 12 doubling as a source wire comprising a laminate of 91A and 35A and a drain electrode 21 for the insulating gate type transistor doubling as the pixel electrode 22 comprising 91B and 35B are selectively formed as shown in FIGS. 47(d) and 48(d) using the photosensitive resin patterns 87A and 87B. An electrode terminal 5 of the scan line containing a part of the exposed scan line and an electrode terminal 6 comprising a part of the signal line are formed at the same time as the formation of the source and drain wires 12 and 21.

After the source and drain wires 12 and 12 are formed, the above-mentioned photosensitive resin patterns 87A and 87B are reduced by at least 1.5 μm using oxygen plasma or other ashing means to expose the signal line 12 (35A); the signal line 12 is anodized and an oxide layer 69 (12) is formed in the side, and a second amorphous silicon layer 33A exposed between the source and drain wires 12 and 21, and a part of the first amorphous silicon layer 31A adjacent to the second amorphous silicon layer 33A are anodized to form a silicon oxide layer 66 containing impurities, and a silicon oxide layer (not illustrated) not containing impurities, which are insulating layers, as shown in FIGS. 47(e) and 48(e). Then, the exposed scan line 11 and storage capacitor 10 line 16 are anodized at the same time to form an oxide layer 72 in the surface. A connection pattern 78 and wire 77 bundled in parallel with the scan line 11 are formed as shown in FIG. 53, so anodization of the scan line 11 and the storage capacitor line 16 can be easily carried out at the same time as the anodization of the source and drain wires 12 and 21. The exposed second amorphous silicon layers 33A and 33B are also anodized on the storage capacitor line 16, on a region proximate to where the storage capacitor line 16 and the signal line 12 intersect, and on a region proximate to where the scan line 11 and signal line 12 intersect, and due to the anodization, also are transmuted to a silicon oxide layer 66 containing impurities and a silicon oxide layer not containing impurities (not illustrated). In order to form an insulating layer by anodizing the top surface of the scan line 11 and the storage capacitor line 16, a single Ta layer, a signal layer construction of Al (Zr or Ta) alloy or the like, or a laminate construction of Al/Ta, Ta/Al/Ta, Al/Al (Ta or Zr) or the like may be selected as the anodizable metal for the scan line 11.

After the anodization is complete, the photosensitive resin pattern 87C is removed, exposing the electrode terminals 6 and 5 comprising the low resistance metal layers 35A and 35C and the pixel electrode comprising the low resistance metal layer 35B in whose side the anodized layer 69 (35B) was formed as shown in FIGS. 47(f) and 48(f).

Further, the low resistance metal layers 35A to 35C are removed using the anodized layer 69 (12) on the signal line 12 as a mask, exposing the transparent conductive layers 91A to 91C as shown in FIGS. 47(g) and 48(g), the latter layers function respectively as the electrode terminal 6A for the signal line, the pixel electrode 22, and the terminal electrode 5A for the scan line. The active substrate 2 thus obtained and the color filter 9 are attached together to form a liquid crystal panel, thereby completing Embodiment 24 of the present invention. The construction of the storage capacitor is identical to that in Embodiment 23.

Although the present invention has been explained in relation to its preferred embodiment, it is to be understood that many other possible modifications and variations can be made without departing from the spirit and scope of the invention as hereinafter claimed.

1. A liquid crystal display device made by filling liquid crystal between a first transparent insulating substrate (an active substrate) in which unit pixels having at least an insulating gate type transistor, a signal line doubling as a source wire and a scan line doubling as a gate electrode for the aforementioned insulating gate type transistor, and a pixel electrode connected to a drain wire are arranged in a two-dimensional matrix on a main surface and a second transparent insulating substrate or color filter opposite the aforementioned first transparent insulating substrate, wherein:
a source wire of an insulating gate type transistor comprising a laminate made of a transparent conductive layer and a low resistance metal layer is connected to a first semiconductor layer not containing impurities for forming a channel through a second semiconductor layer containing impurities and a heat resistant metal layer, and
a transparent conductive pixel electrode is connected to the aforementioned first semiconductor layer through a second semiconductor layer containing impurities and a heat resistant metal layer.

2. The display device recited in claim 1 made by filling liquid crystal between a first transparent insulating substrate (active substrate) and a second transparent insulating substrate or color filter opposite the aforementioned first transparent insulating substrate, wherein at least;
a scan line comprising a first metal layer of one or more layers is formed on a main surface of a first transparent insulating substrate,
a first semiconductor layer not containing impurities is formed in an island form through a gate insulating layer of one or more layers above a gate electrode,
a protective insulating layer is formed finer than the aforementioned gate electrode on the first semiconductor layer,
an opening is formed in a gate insulating layer on a scan line to expose a part of the scan line in the opening outside an image display region,
a pair of source and drain electrodes comprising a laminate of a heat resistant metal layer and a second semiconductor layer containing impurities is formed on a part of the aforementioned protective insulating layer and on a first semiconductor layer,
a signal line comprising a laminate made of a low resistance metal layer having a photosensitive organic insulating layer on its surface and a transparent conductive layer is formed on the aforementioned source electrode and gate insulating layer, a transparent conductive pixel electrode is formed on the aforementioned drain electrode and gate insulating layer, and a transparent conductive electrode terminal of a scan line is formed containing the aforementioned opening, and
the aforementioned photosensitive organic insulating layer and low resistance metal layer on the signal line are removed outside an image display region to expose a transparent conductive electrode terminal of a signal line.

3. The liquid crystal display device recited in claim 1 made by filling liquid crystal between a first transparent insulating substrate (active substrate) and a second transparent insulating substrate or color filter opposite the aforementioned first transparent insulating substrate, wherein at least;
a scan line comprising a first metal layer of one or more layers is formed on a main surface of a first transparent insulating substrate,
a first semiconductor layer not containing impurities is formed in an island form through a gate insulating layer of one or more layers above a gate electrode,
a protective insulating layer is formed finer than the aforementioned gate electrode on the first semiconductor layer,
an opening is formed in a gate insulating layer on a scan line to expose a part of the scan line in the opening outside an image display region,
a pair of source and drain electrodes comprising a laminate made of an anodizable heat resistant metal layer having an anodized layer on its side and a second semiconductor layer containing impurities and having a silicon oxide layer on its side is formed on a part of the aforementioned protective insulating layer and on a first semiconductor layer except in a region where a pixel electrode and a signal line overlap,
a signal line comprising a laminate made of an anodizable low resistance metal layer having an anodized layer on its surface and a transparent conductive layer is formed on the aforementioned source electrode and gate insulating layer, and a transparent conductive pixel electrode is formed on the aforementioned drain electrode and gate insulating layer, and a transparent conductive electrode terminal of a scan line is formed containing the aforementioned opening, and
an anodized layer and a low resistance metal layer on the aforementioned signal line are removed outside an image display region to expose a transparent conductive electrode terminal of a signal line.

4. The liquid crystal display device recited in claim 1 made by filling liquid crystal between a first transparent insulating substrate (active substrate) and a second transparent insulating substrate or color filter opposite the aforementioned transparent insulating substrate, wherein at least;
a scan line comprising a first metal layer of one or more layers is formed on a main surface of a first transparent insulating substrate,
a first semiconductor layer not containing impurities is formed in an island form through a gate insulating layer of one or more layers above a gate electrode,
a protective insulating layer is formed finer than the aforementioned gate electrode on the first semiconductor layer,
an opening is formed in a gate insulating layer on a scan line to expose a part of the scan line in the opening outside an image display region,
a pair of source and drain electrodes comprising a laminate of a heat resistant metal layer and a second semiconductor layer containing impurities is formed on a part of the aforementioned protective insulating layer and on a first semiconductor layer,
a signal line comprising a laminate made of a low resistance metal layer having a photosensitive organic insulating layer on its surface and a transparent conductive layer is formed on the aforementioned source electrode and gate insulating layer, a transparent conductive pixel electrode is formed on the aforementioned drain electrode and gate insulating layer, and a transparent conductive electrode terminal of a scan line is formed on an intermediate electrode comprising a laminate of a heat resistant metal layer and a second semiconductor layer formed containing the aforementioned opening and a first semiconductor layer in its periphery, and
the aforementioned photosensitive organic insulating layer and low resistance metal layer on the signal line are removed outside an image display region to expose a transparent conductive electrode terminal of a signal line.

5. The liquid crystal display device recited in claim 1 made by filling liquid crystal between a first transparent insulating substrate (active substrate) and a second transparent insulating substrate or color filter opposite the aforementioned transparent insulating substrate, wherein at least;
a scan line comprising a first metal layer of one or more layers is formed on a main surface of a first transparent insulating substrate,
a first semiconductor layer not containing impurities is formed in an island form through a gate insulating layer of one or more layers above a gate electrode,
a protective insulating layer is formed finer than the aforementioned gate electrode on the first semiconductor layer,
an opening is formed in a gate insulating layer on a scan line to expose a part of the scan line in the opening outside an image display region,
a pair of source and drain electrodes comprising a laminate made of an anodizable heat resistant metal layer having an anodized layer on its side and a second semiconductor layer containing impurities and having a silicon oxide layer on its side is formed on a part of the aforementioned protective insulating layer and on a first semiconductor layer except in a region where a pixel electrode and a signal line overlap,
a signal line comprising a laminate made of an anodizable low resistant metal layer having an anodized layer on its surface and a transparent conductive layer is formed on the aforementioned source electrode and gate insulating layer, a transparent conductive pixel electrode is formed on the aforementioned drain electrode and gate insulating layer, and a transparent conductive electrode terminal of a scan line is formed on an intermediate electrode comprising a laminate of a heat resistant metal layer and a second semiconductor layer formed containing the aforementioned opening and a first semiconductor layer in its periphery, and
an anodized layer and a low resistance metal layer on the aforementioned signal line are removed outside an image display region to expose a transparent conductive electrode terminal of a signal line.

6. The liquid crystal display device recited in claim 1 made by filling liquid crystal between a first transparent insulating substrate (active substrate) and a second transparent insulating substrate or color filter opposite the aforementioned transparent insulating substrate, wherein at least;
a scan line having an insulating layer in a side thereof and comprising a first metal layer of one or more layers is formed on a main surface of a first transparent insulating substrate,
a gate insulating layer of one or more layers is formed on the aforementioned scan line,
a first semiconductor layer not containing impurities is formed in an island form on a gate insulating layer above a gate electrode,
a protective insulating layer is formed finer than the aforementioned gate electrode on the first semiconductor layer,
an opening is formed in a gate insulating layer on a scan line to expose a part of the scan line in the opening outside an image display region,
a pair of source and drain electrodes comprising a laminate of a heat resistant metal layer and a second semiconductor layer containing impurities is formed on a part of the aforementioned protective insulating layer, on a first semiconductor layer and on a first transparent insulating substrate,
a signal line comprising a laminate made of a low resistance metal layer having a photosensitive organic insulating layer on its surface and a transparent conductive layer is formed on the aforementioned source electrode and a first transparent insulating substrate, a transparent conductive pixel electrode is formed on the aforementioned drain electrode and on a first transparent insulating substrate, and a transparent conductive electrode terminal of a scan line is formed on an intermediate electrode comprising a laminate made of a heat resistant metal layer and a second semiconductor layer formed containing the aforementioned opening and a protective insulating layer and a first semiconductor layer in the periphery of the opening, and
the aforementioned photosensitive organic insulating layer and low resistance metal layer on the signal line are removed outside an image display region to expose a transparent conductive electrode terminal of a signal line.

7. The liquid crystal display device recited in claim 1 made by filling liquid crystal between a first transparent insulating substrate (active substrate) and a second transparent insulating substrate or color filter opposite the aforementioned transparent insulating substrate, wherein at least;
a scan line having an insulating layer in a side thereof and comprising a first metal layer of one or more layers is formed on a main surface of a first transparent insulating substrate,
a gate insulating layer of one or more layers is formed on the aforementioned scan line,
a first semiconductor layer not containing impurities is formed in an island form on a gate insulating layer above a gate electrode,
a protective insulating layer is formed finer than the aforementioned gate electrode on the first semiconductor layer,
an opening is formed in a gate insulating layer on a scan line to expose a part of the scan line in the opening outside an image display region,
a pair of source and drain electrodes comprising a laminate made of an anodizable heat resistant metal layer having an anodized layer on its side and a second semiconductor layer containing impurities and having a silicon oxide layer on its side is formed on a part of the aforementioned protective insulating layer, on a first semiconductor layer and on a first transparent insulating substrate except in a region where a pixel electrode and a signal line overlap,
a signal line comprising a laminate made of an anodizable low resistance metal layer having an anodized layer on its surface and a transparent conductive layer is formed on the aforementioned source electrode and a first transparent insulating substrate, a transparent conductive pixel electrode is formed on the aforementioned drain electrode and a first transparent insulating substrate, and a transparent conductive electrode terminal of a scan line is formed on an intermediate electrode comprising a laminate made of a heat resistant metal layer and a second semiconductor layer formed containing the aforementioned opening, a protective insulating layer and a first semiconductor layer in the periphery of the opening, and
an anodized layer and a low resistance metal layer on the aforementioned signal line are removed outside an image display region to expose a transparent conductive electrode terminal of a signal line.

8. The liquid crystal display device recited in claim 1 made by filling liquid crystal between a first transparent insulating substrate (active substrate) and a second transparent insulating substrate or color filter opposite the aforementioned transparent insulating substrate, wherein at least;
a scan line having an insulating layer in a side thereof and comprising a first metal layer of one or more layers is formed on a main surface of a first transparent insulating substrate,
a gate insulating layer of one or more layers is formed on the aforementioned scan line,
a first semiconductor layer not containing impurities is formed in an island form on a gate insulating layer above a gate electrode,
a protective insulating layer is formed finer than the aforementioned gate electrode on the first semiconductor layer,
an opening is formed in a gate insulating layer on a scan line to expose a part of the scan line in the opening outside an image display region,
a pair of source and drain electrodes comprising a laminate of a heat resistant metal layer and a second semiconductor layer containing impurities is formed on a part of the aforementioned protective insulating layer, on a first semiconductor layer and on a first transparent insulating substrate,
a signal line comprising a laminate made of a low resistance metal layer having a photosensitive organic insulating layer on its surface and a transparent conductive layer is formed on the aforementioned source electrode and a first transparent insulating substrate, a transparent conductive pixel electrode is formed on the aforementioned drain electrode and a first transparent insulating substrate, and a transparent conductive electrode terminal of a scan line is formed containing the aforementioned opening, and
the aforementioned photosensitive organic insulating layer and low resistance metal layer on the signal line are removed outside an image display region to expose a transparent conductive electrode terminal of a signal line.

9. The liquid crystal display device recited in claim 1 made by filling liquid crystal between a first transparent insulating substrate (active substrate) and a second transparent insulating substrate or color filter opposite the aforementioned transparent insulating substrate, wherein at least;
a scan line having an insulating layer in a side thereof and comprising a first metal layer of one or more layers is formed on a main surface of a first transparent insulating substrate,
a gate insulating layer of one or more layers is formed on the aforementioned scan line,
a first semiconductor layer not containing impurities is formed in an island form on a gate insulating layer above a gate electrode,
a protective insulating layer is formed finer than the aforementioned gate electrode on the first semiconductor layer,
an opening is formed in a gate insulating layer on a scan line to expose a part of the scan line in the opening outside an image display region,
a pair of source and drain electrodes comprising a laminate made of an anodizable heat resistant metal layer having an anodized layer on its side and a second semiconductor layer containing impurities and having a silicon oxide layer on its side is formed on a part of the aforementioned protective insulating layer, on a first semiconductor layer and on a first transparent insulating substrate except in a region where a pixel electrode and a signal line overlap,
a signal line comprising a laminate made of an anodizable low resistance metal layer having an anodized layer on its surface and a transparent conductive layer is formed on the aforementioned source electrode and a first transparent insulating substrate, a transparent conductive pixel electrode is formed on the aforementioned drain electrode and a first transparent insulating substrate, and a transparent conductive electrode terminal of a scan line is formed containing the aforementioned opening, and
an anodized layer and a low resistance metal layer on the aforementioned signal line are removed outside an image display region to expose a transparent conductive electrode terminal of a signal line.

10. The liquid crystal display device recited in claim 1 made by filling liquid crystal between a first transparent insulating substrate (active substrate) and a second transparent insulating substrate or color filter opposite the aforementioned transparent insulating substrate, wherein at least:
a scan line having an insulating layer in a side thereof and comprising a first metal layer of one or more layers is formed on a main surface of a first transparent insulating substrate,
a gate insulating layer of one or more layers is formed on the aforementioned scan line,
a first semiconductor layer not containing impurities is formed in an island form on a gate insulating layer above a gate electrode,
a protective insulating layer is formed finer than the aforementioned gate electrode on the first semiconductor layer,
an opening is formed in a gate insulating layer on a scan line to expose a part of the scan line in the opening outside an image display region,
a pair of source and drain electrodes comprising a laminate of a heat resistant metal layer and a second semiconductor layer containing impurities is formed on a part of the aforementioned protective insulating layer and on a first semiconductor layer,
a signal line comprising a laminate made of a low resistance metal layer having a photosensitive organic insulating layer on its surface and a transparent conductive layer is formed on the aforementioned source electrode and a first transparent insulating substrate, a transparent conductive pixel electrode is formed on the aforementioned drain electrode and a first transparent insulating substrate, and a transparent conductive electrode terminal of a scan line is formed containing the aforementioned opening, and a heat resistant metal layer, a second semiconductor layer and a first semiconductor layer in the periphery of the opening, and
the aforementioned photosensitive organic insulating layer and low resistance metal layer on the signal line are removed outside an image display region to expose a transparent conductive electrode terminal of a signal line.

11. The liquid crystal display device recited in claim 1 made by filling liquid crystal between a first transparent insulating substrate (active substrate) and a second transparent insulating substrate or color filter opposite the aforementioned transparent insulating substrate, wherein at least:
a scan line having an insulating layer in a side thereof and comprising a first metal layer of one or more layers is formed on a main surface of a first transparent insulating substrate,
a gate insulating layer of one or more layers is formed on the aforementioned scan line,
a first semiconductor layer not containing impurities is formed in an island form on a gate insulating layer above a gate electrode,
a protective insulating layer is formed finer than the aforementioned gate electrode on the first semiconductor layer,
an opening is formed in a gate insulating layer on a scan line to expose a part of the scan line in the opening outside an image display region,
a pair of source and drain electrodes comprising a laminate made of an anodizable heat resistant metal layer having an anodized layer on its side and a second semiconductor layer containing impurities and having a silicon oxide layer on its side is formed on a part of the aforementioned protective insulating layer and on a first semiconductor layer except in a region where a pixel electrode and a signal line overlap,
a signal line comprising a laminate made of an anodizable low resistance metal layer having an anodized layer on its surface and a transparent conductive layer is formed on the aforementioned source electrode and a first transparent insulating substrate, a transparent conductive pixel electrode is formed on the aforementioned drain electrode and a first transparent insulating substrate, and a transparent conductive electrode terminal of a scan line is formed containing the aforementioned opening, a heat resistant metal layer, a second semiconductor layer, and a first semiconductor layer (having an anodized layer and silicon oxide layer in the side respectively) in the periphery of the opening, and
an anodized layer and a low resistance metal layer on a signal line are removed outside an image display region to expose a transparent conductive electrode terminal of a signal line.

12. The liquid crystal display device recited in claim 1 made by filling liquid crystal between a first transparent insulating substrate (active substrate) and a second transparent insulating substrate or color filter opposite the aforementioned transparent insulating substrate, wherein at least:
a scan line comprising a first metal layer of one or more layers is formed on a main surface of a first transparent insulating substrate,
a first semiconductor layer not containing impurities is formed in an island form through a gate insulating layer of one or more layers above a gate electrode,
a pair of source and drain electrodes comprising a laminate made of a second semiconductor layer containing impurities and a heat resistant metal layer is formed on the aforementioned first semiconductor layer,
an opening is formed in a gate insulating layer on a scan line to expose a part of the scan line in the opening outside an image display region,
a signal line comprising a laminate made of a low resistance metal layer and a transparent conductive layer is formed on the aforementioned source electrode and gate insulating layer, a transparent conductive pixel electrode is formed on the aforementioned drain electrode and gate insulating layer, an electrode terminal of a scan line comprising a laminate made of a low resistance metal layer and a transparent conductive layer or a transparent conductive layer is formed containing the aforementioned opening, and an electrode terminal of a signal line comprising a laminate made of a low resistance metal layer and a transparent conductive layer or a transparent conductive layer comprising a part of the signal line is formed outside an image display part region, and
passivating insulating layer having openings on the aforementioned pixel electrode and on the aforementioned electrode terminals of the scan line and signal line is formed on the aforementioned first transparent insulating substrate.

13. The liquid crystal display device recited in claim 1 made by filling liquid crystal between a first transparent insulating substrate (active substrate) and a second transparent insulating substrate or color filter opposite the aforementioned transparent insulating substrate, wherein at least:
a scan line comprising a first metal layer of one or more layers is formed on a main surface of a first transparent insulating substrate,
a first semiconductor layer not containing impurities is formed in an island form through a gate insulating layer of one or more layers above a gate electrode,
a pair of source and drain electrodes comprising a laminate made of an anodizable heat resistant metal layer having an anodized layer on its side and a second semiconductor layer containing impurities and having a silicon oxide layer on its side is formed on the aforementioned first semiconductor layer except in a region where a pixel electrode and a signal line overlap,
a silicon oxide layer is formed on a first semiconductor layer between the aforementioned source and drain electrodes,
an opening is formed in a gate insulating layer on a scan line to expose a part of the scan line in the opening outside an image display region,
a signal line comprising a laminate made of an anodizable low resistance metal layer having an anodized layer on its surface and a transparent conductive layer is formed on the aforementioned source electrode and gate insulating layer, a transparent conductive pixel electrode is formed on the aforementioned drain electrode and gate insulating layer, a transparent conductive electrode terminal of a scan line is formed containing the aforementioned opening, and
an anodized layer and a low resistance metal layer on a signal line are removed outside an image display region to expose a transparent conductive electrode terminal of a signal line.

14. The liquid crystal display device recited in claim 1 made by filling liquid crystal between a first transparent insulating substrate (active substrate) and a second transparent insulating substrate or color filter opposite the aforementioned transparent insulating substrate, wherein at least:
a scan line having an insulating layer in a side thereof and comprising a first metal layer of one or more layers is formed on a main surface of a first transparent insulating substrate,
a gate insulating layer of one or more layers is formed on the aforementioned scan line,
a first semiconductor layer not containing impurities is formed in an island form on a gate insulating layer above a gate electrode,
a pair of source and drain electrodes comprising a laminate made of a second semiconductor layer containing impurities and a heat resistant metal layer is formed on the aforementioned first semiconductor layer,
an opening is formed in a gate insulating layer on a scan line to expose a part of the scan line in the opening outside an image display region,
a signal line comprising a laminate made of a low resistance metal layer and a transparent conductive layer is formed on the aforementioned source electrode and first transparent insulating substrate, and a transparent conductive pixel electrode is formed on the aforementioned drain electrode and a first transparent insulating substrate, an electrode terminal of a scan line comprising a laminate made of a low resistance metal layer and a transparent conductive layer or a transparent conductive layer is formed containing the aforementioned opening and a heat resistant metal layer, a second semiconductor layer and a first semiconductor layer in the periphery of the opening, and an electrode terminal of a signal line comprising a laminate made of a low resistance metal layer and a transparent conductive layer or a transparent conductive layer comprising a part of a signal line is formed outside an image display part region, and
a passivating insulating layer having openings on the aforementioned pixel electrode and on the aforementioned electrode terminals of the scan line and the signal line is formed on the aforementioned first transparent insulating substrate.

15. The liquid crystal display device recited in claim 1 made by filling liquid crystal between a first transparent insulating substrate (active substrate) and a second transparent insulating substrate or color filter opposite the aforementioned transparent insulating substrate, wherein at least:
a scan line having an insulating layer in a side thereof and comprising a first metal layer of one or more layers is formed on a main surface of a first transparent insulating substrate,
a gate insulating layer of one or more layers is formed on the aforementioned scan line,
a first semiconductor layer not containing impurities is formed in an island form on a gate insulating layer above a gate electrode,
a pair of source and drain electrodes comprising a laminate made of an anodizable heat resistant metal layer having an anodized layer on its side and a second semiconductor layer containing impurities and having a silicon oxide layer on its side is formed on the aforementioned first semiconductor layer except in a region where a pixel electrode and a-signal line overlap,
a silicon oxide layer is formed on a first semiconductor layer between the aforementioned source and drain electrodes,
an opening is formed in a gate insulating layer on a scan line to expose a part of the scan line in the opening outside an image display region,
a signal line comprising a laminate made of an anodizable low resistance metal layer having an anodized layer on its surface and a transparent conductive layer is formed on the aforementioned source electrode and a first transparent insulating substrate, a transparent conductive pixel electrode is formed on the aforementioned drain electrode and a first transparent insulating substrate, and a transparent conductive electrode terminal of a scan line is formed containing the aforementioned opening, and a heat resistant metal layer, a second semiconductor layer and a first semiconductor layer in the periphery of the opening, and
an anodized layer and a low resistance metal layer on a signal line are removed outside an image display region to expose a transparent conductive electrode terminal of a signal line.

16. The liquid crystal display device recited in claim 1 made by filling liquid crystal between a first transparent insulating substrate (active substrate) and a second transparent insulating substrate or color filter opposite the aforementioned transparent insulating substrate, wherein at least:
a scan line having an insulating layer in a side thereof and comprising a first metal layer of one or more layers is formed on a main surface of a first transparent insulating substrate,
a gate insulating layer of one or more layers is formed on the aforementioned scan line,
a first semiconductor layer not containing impurities is formed in an island form on a gate insulating layer above a gate electrode,
a pair of source and drain electrodes comprising a laminate made of a second semiconductor layer containing impurities and a heat resistant metal layer is formed on the aforementioned first semiconductor layer,
an opening is formed in a gate insulating layer on a scan line to expose a part of the scan line in the opening outside an image display region,
a signal line comprising a laminate made of a low resistance metal layer and a transparent conductive layer is formed on the aforementioned source electrode and first transparent insulating substrate, and a transparent conductive pixel electrode is formed on the aforementioned drain electrode and a first transparent insulating substrate, an electrode terminal of a scan line comprising a laminate made of a low resistance metal layer and transparent conductive layer or a transparent conductive layer is formed containing the aforementioned opening, and an electrode terminal of a signal line comprising a laminate made of a low resistance metal layer and a transparent conductive layer or a transparent conductive layer comprising a part of a signal line is formed outside an image display region, and
a passivating insulating layer having openings on the aforementioned pixel electrode and on the aforementioned electrode terminals of the scan line and the signal line is formed on the aforementioned first transparent insulating substrate.

17. The liquid crystal display device recited in claim 1 made by filling liquid crystal between a first transparent insulating substrate (active substrate) and a second transparent insulating substrate or color filter opposite the aforementioned transparent insulating substrate, wherein at least:
a scan line having an insulating layer in a side thereof and comprising a first metal layer of one or more layers is formed on a main surface of a first transparent insulating substrate,
a gate insulating layer of one or more layers is formed on the aforementioned scan line,
a first semiconductor layer not containing impurities is formed in an island form on a gate insulating layer above a gate electrode,
a pair of source and drain electrodes comprising a laminate made of an anodizable heat resistant metal layer having an anodized layer on its side and a second semiconductor layer containing impurities and having a silicon oxide layer on its side is formed on the aforementioned first semiconductor layer except in a region where a pixel electrode and a signal line overlap,
a silicon oxide layer is formed on a first semiconductor layer between the aforementioned source and drain electrodes,
an opening is formed in a gate insulating layer on a scan line to expose a part of the scan line in the opening outside an image display region,
a signal line comprising a laminate made of an anodizable low resistance metal layer having an anodized layer on its surface and a transparent conductive layer is formed on the aforementioned source electrode and a first transparent insulating substrate, a transparent conductive pixel electrode is formed on the aforementioned drain electrode and a first transparent insulating substrate, and a transparent conductive electrode terminal of a scan line is formed containing the aforementioned opening, and
an anodized layer and a low resistance metal layer on a signal line are removed outside an image display region to expose a transparent electrode terminal of a signal line.

18. The liquid crystal display device recited in claim 1 made by filling liquid crystal between a first transparent insulating substrate (active substrate) and a second transparent insulating substrate or color filter opposite the aforementioned transparent insulating substrate, wherein at least:
a scan line having an insulating layer in a side thereof and comprising a first metal layer of one or more layers is formed on a main surface of a first transparent insulating substrate,
a gate insulating layer of one or more layers is formed on the aforementioned scan line,
a first semiconductor layer not containing impurities is formed in an island form slightly smaller than the aforementioned gate insulating layer on a gate insulating layer above gate electrode,
a pair of source and drain electrodes comprising a laminate made of a second semiconductor layer containing impurities and a heat resistant metal layer is formed on the aforementioned first semiconductor layer,
an opening is formed in a gate insulating layer on a scan line to expose a part of the scan line in the opening outside an image display region,
a signal line comprising a laminate made of a low resistance metal layer and a transparent conductive layer is formed on the aforementioned source electrode and first transparent insulating substrate, and a transparent conductive pixel electrode is formed on the aforementioned drain electrode and a first transparent insulating substrate, an electrode terminal of a scan line comprising a laminate made of a low resistance metal layer and a transparent conductive layer or a transparent conductive layer is formed containing the aforementioned opening, and an electrode terminal of a signal line comprising a laminate made of a low resistance metal layer and a transparent conductive layer or a transparent conductive layer comprising a part of a signal line is formed outside an image display region, and
a passivating insulating layer having openings on the aforementioned pixel electrode and on the aforementioned electrode terminals of the scan line and the signal line is formed on the aforementioned first transparent insulating substrate.

19. The liquid crystal display device recited in claim 1 made by filling liquid crystal between a first transparent insulating substrate (active substrate) and a second transparent insulating substrate or color filter opposite the aforementioned transparent insulating substrate, wherein at least:
a scan line having an insulating layer in a side thereof and comprising a first metal layer of one or more layers is formed on a main surface of a first transparent insulating substrate,
a gate insulating layer of one or more layers is formed on the aforementioned scan line,
a first semiconductor layer not containing impurities is formed in an island form slightly smaller than the aforementioned gate insulating layer on a gate insulating layer above a gate electrode,
a pair of source and drain electrodes is formed comprising a laminate made of an anodizable heat resistant metal layer having an anodized layer on its side and a second semiconductor layer containing impurities and having a silicon oxide layer on its side is formed on the aforementioned first semiconductor layer except in a region where a pixel electrode and a signal line overlap,
a silicon oxide layer is formed on a first semiconductor layer between the aforementioned source and drain electrodes,
an opening is formed in a gate insulating layer on a scan line to expose a part of the scan line in the opening outside an image display region,
a signal line comprising a laminate made of a transparent conductive layer and an anodizable low resistance metal layer having an anodized layer on its surface is formed on the aforementioned source electrode and a first transparent insulating substrate, a transparent conductive pixel electrode is formed on the aforementioned drain electrode and a first transparent insulating substrate, and a transparent conductive electrode terminal of a scan line is formed containing the aforementioned opening, and
an anodized layer and a low resistance metal layer on a signal line are removed outside an image display region to expose a transparent conductive electrode terminal of a signal line.

20. The liquid crystal display device recited in claim 1 made by filling liquid crystal between a first transparent insulating substrate (active substrate) and a second transparent insulating substrate or color filter opposite the aforementioned transparent insulating substrate, wherein at least:
a scan line having an insulating layer in a side thereof and comprising a first metal layer of one or more layers is formed on a main surface of a first transparent insulating substrate,
a first semiconductor layer not including impurities and a gate insulating layer of at least one layer are formed in an island form at a proximity of an intersection of a signal line and a scan line and on a gate electrode,
a pair of source and drain electrodes comprising a laminate made of a heat resistant metal layer and a second semiconductor layer containing impurities is formed on the aforementioned first semiconductor layer above a gate electrode, and a heat resistant metal layer and a second semiconductor containing impurities are formed on a first semiconductor layer at an intersection of a scan line and a signal line,
a signal line comprising a laminate of a transparent conductive layer and a low resistance metal layer is formed on the aforementioned source electrode, on a first transparent insulating substrate, and on a heat resistant metal layer at an intersection of a signal line and a scan line, a transparent conductive pixel electrode is formed on the aforementioned drain electrode and on a first transparent insulating substrate, an electrode terminal for a scan line comprising a laminate made of a low resistance metal layer and a transparent conductive layer or a transparent conductive layer is formed on a part of a scan line outside an image display region, and an electrode terminal for a signal line comprising a laminate made of a low resistance metal layer and a transparent conductive layer or a transparent conductive layer comprising a part of signal line is formed outside an image display region, and
a passivating insulating layer having openings on the aforementioned pixel electrode and on the aforementioned electrode terminals of the scan line and the signal line is formed on the aforementioned first transparent insulating substrate.

21. The liquid crystal display device recited in claim 1 made by filling liquid crystal between a first transparent insulating substrate (active substrate) and a second transparent insulating substrate or color filter opposite the aforementioned transparent insulating substrate, wherein at least:
a scan line having an insulating layer in its side comprising an anodizable first metal layer of one or more layers is formed on a main surface of a first transparent insulating substrate,
a first semiconductor layer not containing impurities and a gate insulating layer of at least one layer are formed in an island form at a proximity of an intersection of a signal line and a scan line and on a gate electrode,
a pair of source and drain electrodes comprising a laminate made of an anodizable heat resistant metal layer having an anodized layer on its side and a second semiconductor layer containing impurities and having a silicon oxide layer on its side is formed on a first semiconductor layer above a gate electrode except in a region where a pixel electrode and a signal line overlap, and a silicon oxide layer is formed on a first semiconductor layer at a proximity of an intersection of a signal line and a scan line except an intersection of a scan line and a signal line, and a heat resistant metal layer having an anodizable layer in its side and a second semiconductor layer having a silicon oxide layer in its side are formed on a first semiconductor layer at an intersection of a scan line and a signal line,
a silicon oxide layer is formed on the aforementioned first semiconductor layer between the source and drain electrodes,
a signal line comprising a laminate made of a transparent conductive layer and an anodizable low resistance metal layer having an anodized layer on its surface is formed on the aforementioned source electrode, on a first transparent insulating substrate and on a heat resistant metal layer at the aforementioned intersection of a signal line and a scan line, a transparent conductive pixel electrode is formed on the aforementioned drain electrode and on a first transparent insulating substrate, and a transparent conductive electrode terminal of a scan line is formed on a part of a scan line outside an image display region,
an anodizable layer is formed on a scan line except for the aforementioned electrode terminal of the scan line, and
an anodized layer and a low resistance metal layer on a signal line are removed outside an image display region to expose a transparent conductive electrode terminal of a signal line.

22. A liquid crystal display device recited in claim 6 characterized by the fact that an insulating layer formed in a side of a scan line is an organic insulating layer.

23. A liquid crystal display device recited in claim 6 characterized by the fact that a first metal layer comprises an anodizable metal layer and that the insulating layer formed in the side of the scan line is an anodized layer.

24. A manufacturing method for a liquid crystal display device made by filling liquid crystal between a first transparent insulating substrate (active substrate) and a second transparent insulating substrate opposing the aforementioned first transparent insulating substrate or a color filter, wherein, formation of source and drain lines and a pixel electrode comprise:
a process for forming a photosensitive organic insulating layer pattern thicker at a signal line than other regions corresponding to a source wire (signal line), a drain wire comprising a pixel electrode, an electrode terminal of a scan line, and an electrode terminal of a signal line comprising a part of a signal line after depositing a transparent conductive layer and a low resistance metal layer,
a process for forming electrode terminals for a scan line and a signal line, and source and drain wires using the aforementioned photosensitive organic insulating layer pattern as a mask,
a process for decreasing a thickness of the aforementioned photosensitive organic insulating layer pattern to expose a low resistance metal layer on electrode terminals for a scan line and a signal line and on a pixel electrode, and
a process for removing an exposed low resistance metal layer using the aforementioned photosensitive organic insulating layer pattern whose thickness was reduced as a mask, and forming a transparent conductive pixel electrode and transparent conductive electrode terminals of a scan line and a signal line.

25. A manufacturing method for a liquid crystal display device made by filling liquid crystal between a first transparent insulating substrate (active substrate) and a second transparent insulating substrate opposing the aforementioned first transparent insulating substrate or a color filter, wherein formation of a pixel electrode and source and drain wires comprise:
a process for forming a photosensitive resin pattern thinner at a signal line than other regions corresponding to a source wire (signal line), a drain wire comprising a pixel electrode, an electrode terminal of a scan line, and an electrode terminal of a signal line comprising a part of a signal line after depositing a transparent conductive layer and an anodizable low resistance metal layer,
a process for forming electrode terminals for a scan line and a signal line, and source and drain wires using the aforementioned photosensitive resin pattern as a mask,
a process for decreasing a thickness of the aforementioned photosensitive resin pattern to expose a signal line,
a process for forming an anodized layer on an exposed signal line using the aforementioned photosensitive resin pattern whose thickness was reduced as a mask, and
a process for removing the aforementioned photosensitive resin pattern whose thickness was reduced, removing a low resistance metal layer using the aforementioned anodized layer as a mask, and forming a transparent conductive pixel electrode and transparent conductive electrode terminals of a scan line and a signal line.

26. A manufacturing method for a liquid crystal display device made by filling liquid crystal between a first transparent insulating substrate (active substrate) and a second transparent insulating substrate opposing the aforementioned first transparent insulating substrate or a color filter, wherein formation of a pixel electrode and source and drain wires comprise:
a process for forming a photosensitive resin pattern thinner at least at a pixel electrode than at a signal line corresponding to a source wire (signal line), a drain wire comprising a pixel electrode, an electrode terminal of a scan line, and an electrode terminal of a signal line comprising a part of a signal line after depositing a transparent conductive layer and a low resistance metal layer,
a process for forming electrode terminals for a scan line and a signal line, and source and drain wires using the aforementioned photosensitive resin pattern as a mask,
a process for reducing a thickness of the aforementioned photosensitive resin pattern to expose a low resistance metal layer on a pixel electrode, and
a process for removing an exposed low resistance metal layer using the aforementioned photosensitive resin pattern whose thickness was reduced as a mask, and forming a transparent conductive pixel electrode.

27. A manufacturing method of the liquid crystal display device recited in claim 24, comprising at least,
a process for forming at least a scan line comprising a metal layer of one or more layers on a main surface of a first transparent insulating substrate,
a process for successively depositing a gate insulating layer of at least one layer, a first amorphous silicon layer not containing impurities, and a protective insulating layer,
a process for forming a protective insulating layer narrower than a gate electrode above a gate electrode to expose the aforementioned first amorphous silicon layer,
a process for depositing a second amorphous silicon layer containing impurities and a heat resistant metal layer,
a process for forming a first amorphous silicon layer, a second amorphous silicon layer, and a heat resistant metal layer in an island form wider than a gate electrode above a gate electrode to expose a gate insulating layer,
a process to form an opening in a gate insulating layer on a scan line outside an image display region to expose a part of a scan line,
a process for forming a photosensitive organic insulating layer pattern thicker at a signal line than other regions corresponding to a source wire (signal line) and a drain wire comprising a pixel electrode both such as to partially overlap the aforementioned protective insulating layer, an electrode terminal of a scan line containing the aforementioned opening, and an electrode terminal of a signal line comprising a part of a signal line outside an image display region after depositing a transparent conductive layer and a low resistance metal layer,
a process for selectively removing a low resistance metal layer, a transparent conductive layer, a heat resistant metal layer, a second amorphous silicon layer, and a first amorphous silicon layer using the aforementioned photosensitive organic insulating layer pattern as a mask to form source and drain wires, and electrode terminals for a scan line and a signal line,
a process for decreasing a thickness of the aforementioned photosensitive organic insulating layer pattern to expose a low resistance metal layer on a pixel electrode and on electrode terminals for a scan line and a signal line and
a process for removing an exposed low resistance metal layer using the aforementioned photosensitive organic insulating layer pattern whose thickness was reduced as a mask, and forming a transparent conductive pixel electrode and transparent conductive terminals of a signal line and a signal line.

28. A manufacturing method of the liquid crystal display device recited in claim 25, comprising at least,
a process for forming at least a scan line comprising a metal layer of one or more layers on a main surface of a first transparent insulating substrate,
a process for successively depositing a gate insulating layer of at least one layer, a first amorphous silicon layer not containing impurities, and a protective insulating layer,
a process for forming a protective insulating layer narrower than a gate electrode above a gate electrode to expose the aforementioned first amorphous silicon layer,
a process for depositing a second amorphous silicon layer containing impurities and an anodizable heat resistant metal layer,
a process for forming a first amorphous silicon layer, a second amorphous silicon layer, and a heat resistant metal layer in an island form wider than a gate electrode above a gate electrode to expose a gate insulating layer,
a process to form an opening in a gate insulating layer on a scan line outside an image display region to expose a part of a scan line,
a process for forming a photosensitive resin pattern thinner at a signal line than other regions corresponding to a source wire (signal line) and a drain wire comprising a pixel electrode both such as to partially overlap the aforementioned protective insulating layer, an electrode terminal of a scan line containing the aforementioned opening, and an electrode terminal of a signal line comprising a part of a signal line outside an image display region after depositing a transparent conductive layer and an anodizable low resistance metal layer,
a process for selectively removing a low resistance metal layer, a transparent conductive layer, a heat resistant metal layer, a second amorphous silicon layer and a first amorphous silicon layer using the aforementioned photosensitive resin pattern as a mask to form source and drain wires and electrode terminals for a scan line and a signal line,
a process for decreasing a thickness of the aforementioned photosensitive resin pattern to expose a signal line,
a process for forming an anodized layer on an exposed signal line using the aforementioned photosensitive resin pattern whose thickness was reduced as a mask,
a process for removing the aforementioned photosensitive resin pattern whose thickness was reduced, removing a low resistance metal layer using the aforementioned anodized layer as a mask, and forming a transparent conductive pixel electrode and transparent conductive terminals of a gate line and a signal line.

29. A manufacturing method of the liquid crystal display device recited in claim 24, comprising at least,
a process for forming at least a scan line comprising a metal layer of one or more layers on a main surface of a first transparent insulating substrate,
a process for successively depositing a gate insulating layer of at least one layer, a first amorphous silicon layer not containing impurities, and a protective insulating layer,
a process for forming a protective insulating layer narrower than a gate electrode above a gate electrode to expose the aforementioned first amorphous silicon layer,
a process for depositing a second amorphous silicon layer containing impurities and an anodizable heat resistant metal layer,
a process for forming a photosensitive resin pattern thicker at a semiconductor layer formation region above a gate electrode than other regions having an opening at a contact formation region of a scan line outside an image display region,
a process for removing a heat resistant metal layer, a second amorphous silicon layer and a first amorphous silicon layer in the aforementioned opening using the aforementioned photosensitive resin pattern as a mask to expose a gate insulating layer,
a process for reducing a thickness of the aforementioned photosensitive resin pattern to expose the aforementioned heat resistant metal layer, and
a process for forming a heat resistant metal layer, a second amorphous silicon layer and a first amorphous silicon layer in an island form wider than a gate electrode above a gate electrode using the aforementioned photosensitive resin pattern whose thickness was reduced as a mask to expose a gate insulating layer as well as for removing a gate insulating layer in the aforementioned opening to expose a part of a scan line,
a process for forming a photosensitive organic insulating layer pattern thicker at a signal line than other regions corresponding to a source wire (signal line) and a drain wire comprising a pixel electrode both such as to partially overlap the aforementioned protective insulating layer, an electrode terminal of a scan line containing the aforementioned opening, and an electrode terminal of a signal line comprising a part of a signal line outside an image display region after depositing a transparent conductive layer and a low resistance metal layer,
a process for selectively removing a low resistance metal layer, a transparent conductive layer, a heat resistant metal layer, a second amorphous silicon layer and a first amorphous silicon layer using the aforementioned photosensitive organic insulating layer pattern as a mask to form source and drain wires, and electrode terminals for a scan line and a signal line,
a process for decreasing a thickness of the aforementioned photosensitive organic insulating layer pattern to expose a low resistance metal layer on a pixel electrode and on electrode terminals for a scan line and a signal line and
a process for removing an exposed low resistance metal layer using the aforementioned photosensitive organic insulating layer pattern whose thickness was reduced as a mask, and forming a transparent conductive pixel electrode and transparent conductive electrode terminals of a scan line and a signal line.

30. A manufacturing method of the liquid crystal display device recited in claim 25, comprising at least,
a process for forming at least a scan line comprising a metal layer of one or more layers on a main surface of a first transparent insulating substrate,
a process for successively depositing a gate insulating layer of at least one layer, a first amorphous silicon layer not containing impurities, and a protective insulating layer,
a process for forming a protective insulating layer narrower than a gate electrode above a gate electrode to expose the aforementioned first amorphous silicon layer,
a process for depositing a second amorphous silicon layer containing impurities and an anodizable heat resistant metal layer,
a process for forming a photosensitive resin pattern thicker at a semiconductor formation region above a gate electrode than other regions having an opening at a contact formation region of a scan line outside an image display region,
a process for removing a heat resistant metal layer, a second amorphous silicon layer and a first amorphous silicon layer in the aforementioned opening using the aforementioned photosensitive resin pattern as a mask to expose a gate insulating layer,
a process for reducing a thickness of the aforementioned photosensitive resin pattern to expose the aforementioned heat resistant metal layer,
a process for forming a heat resistant metal layer, a second amorphous silicon layer and a first amorphous silicon layer in an island form wider than a gate electrode above a gate electrode using the aforementioned photosensitive resin pattern whose thickness was reduced as a mask to expose a gate insulating layer as well as for removing a gate insulating layer in the aforementioned opening to expose a part of a scan line,
a process for forming a photosensitive resin pattern thinner at a signal line than other regions corresponding to a source wire (signal line) and a drain wire comprising a pixel electrode both such as to partially overlap the aforementioned protective insulating layer, an electrode terminal of a scan line containing the aforementioned opening, and an electrode terminal of a signal line comprising a part of a signal line outside an image display region after depositing a transparent conductive layer and an anodizable low resistance metal layer,
a process for selectively removing a low resistance metal layer, a transparent conductive layer, a heat resistant metal layer, a second amorphous silicon layer and a first amorphous silicon layer using the aforementioned photosensitive resin pattern as a mask to form source and drain wires and electrode terminals for a scan line and a signal line,
a process for decreasing a thickness of the aforementioned photosensitive resin pattern to expose a signal line,
a process for forming an anodized layer on an exposed signal line using the aforementioned photosensitive resin pattern whose thickness was reduced as a mask,
a process for removing the aforementioned photosensitive resin pattern whose thickness was reduced, removing a low resistance metal layer using the aforementioned anodized layer as a mask, and forming a transparent conductive pixel electrode and transparent conductive terminals of a scan line and a signal line.

31. A manufacturing method of the liquid crystal display device recited in claim 24, comprising at least,
a process for forming at least a scan line comprising a metal layer of one or more layers on a main surface of a first transparent insulating substrate,
a process for successively depositing a gate insulating layer of at least one layer, a first amorphous silicon layer not containing impurities, and a protective insulating layer,
a process for forming a photosensitive resin pattern thicker at a protective insulating layer formation region above a gate electrode than other regions and having an opening at a contact formation region of a scan line,
a process for removing a protective insulating layer, a first amorphous silicon layer and a gate insulating layer in the aforementioned opening using the aforementioned photosensitive resin pattern as a mask to expose a part of a scan line,
a process for reducing a thickness of the aforementioned photosensitive resin pattern to expose the aforementioned protective insulating layer,
a process for leaving a protective insulating layer narrower than a gate electrode above a gate electrode using the aforementioned photosensitive resin pattern whose thickness was reduced as a mask to expose a first amorphous silicon layer,
a process for depositing a second amorphous silicon layer containing impurities and a heat resistant metal layer,
a process for forming a heat resistant metal layer, a second amorphous silicon layer and a first amorphous silicon layer in an island form wider than a gate electrode above a gate electrode to expose a gate insulating layer as well as forming an intermediate electrode comprising a laminate of a heat resistant metal layer and a second amorphous silicon layer containing the aforementioned opening,
a process for forming a photosensitive organic insulating layer pattern thicker at a signal line than other regions corresponding to a source wire (signal line) and a drain wire comprising a pixel electrode both such as to partially overlap the aforementioned protective insulating layer, an electrode terminal of a scan line containing the aforementioned intermediate electrode, and an electrode terminal of a signal line comprising a part of a signal line outside an image display region after depositing a transparent conductive layer and a low resistance metal layer,
a process for selectively removing a low resistance metal layer, a transparent conductive layer, a heat resistant metal layer, a second amorphous silicon layer and a first amorphous silicon layer using the aforementioned photosensitive organic insulating layer pattern as a mask to form source and drain wires, and electrode terminals for a scan line and a signal line,
a process for decreasing a thickness of the aforementioned photosensitive organic insulating layer pattern to expose a low resistance metal layer on a pixel electrode and on electrode terminals for a scan line and a signal line and,
a process for removing an exposed low resistance metal layer using the aforementioned photosensitive organic insulating layer pattern whose thickness was reduced as a mask, and forming a transparent conductive pixel electrode and transparent conductive electrode terminals of a scan line and a signal line.

32. A manufacturing method of the liquid crystal display device recited in claim 25, comprising at least,
a process for forming at least a scan line comprising a metal layer of one or more layers on a main surface of a first transparent insulating substrate,
a process for successively depositing a gate insulating layer of at least one layer, a first amorphous silicon layer not containing impurities, and a protective insulating layer,
a process for forming a photosensitive resin pattern thicker at a protective insulating layer formation region above a gate electrode than other regions having an opening at a contact formation region of a scan line,
a process for removing a protective insulating layer, a first amorphous silicon layer and a gate insulating layer in the aforementioned opening using the aforementioned photosensitive resin pattern as a mask to expose a part of a scan line,
a process for reducing a thickness of the aforementioned photosensitive resin pattern to expose the aforementioned protective insulating layer,
a process for leaving a protective insulating layer narrower than a gate electrode above a gate electrode using the aforementioned photosensitive resin pattern whose thickness was reduced as a mask to expose a first amorphous silicon layer,
a process for depositing a second amorphous silicon layer containing impurities and an anodizable heat resistant metal layer,
a process for forming a heat resistant metal layer, a second amorphous silicon layer and a first amorphous silicon layer in an island form wider than a gate electrode above a gate electrode to expose a gate insulating layer as well as forming an intermediate electrode comprising a laminate of a heat resistant metal layer and a second amorphous silicon layer containing the aforementioned opening,
a process for forming a photosensitive resin pattern thinner at a signal line than other regions corresponding to a source wire (signal line) and a drain wire comprising a pixel electrode both such as to partially overlap the aforementioned protective insulating layer, an electrode terminal of a scan line containing the aforementioned intermediate electrode, and an electrode terminal of a signal line comprising a part of a signal line outside an image display region after depositing a transparent conductive layer and an anodizable low resistance metal layer,
a process for selectively removing a low resistance metal layer, a transparent conductive layer, a heat resistant metal layer, a second amorphous silicon layer and a first amorphous silicon layer using the aforementioned photosensitive resin pattern as a mask to form source and drain wires, and electrode terminals for a scan line and a signal line,
a process for decreasing a thickness of the aforementioned photosensitive resin pattern to expose a signal line,
a process for forming an anodized layer on an exposed signal line using the aforementioned photosensitive resin pattern whose thickness was reduced as a mask, and
a process for removing the aforementioned photosensitive resin pattern whose thickness was reduced, removing a low resistance metal layer using the aforementioned anodized layer as a mask, and forming a transparent conductive pixel electrode and transparent conductive electrode terminals of a scan line and a signal line.

33. A manufacturing method of the liquid crystal display device recited in claim 24, comprising at least,
a process for successively depositing at least a first metal layer of one or more layers, a gate insulating layer of one or more layers, a first amorphous silicon layer not containing impurities and a protective insulating layer on a main surface of a first transparent insulating substrate,
a process for forming a photosensitive resin pattern thinner at a contact formation region for a scan line than other regions outside an image display region corresponding to a scan line,
a process for successively etching the aforementioned protective insulating layer, a first amorphous silicon layer, a gate insulating layer and a first metal layer using the aforementioned photosensitive resin pattern as a mask,
a process for reducing a thickness of the aforementioned photosensitive resin pattern to expose a protective insulating layer in a contact formation region, a process for forming an insulating layer in a side of a scan line,
a process for etching a protective insulating layer, a first amorphous silicon layer and a gate insulating layer in the aforementioned contact region using the aforementioned photosensitive resin pattern whose thickness was reduced as a mask to expose a part of a scan line,
a process for selectively forming a protective insulating layer narrower than a gate electrode above a gate electrode to expose the aforementioned first amorphous silicon layer,
a process for depositing a second amorphous silicon layer containing impurities and a heat resistant metal layer,
a process for forming a first amorphous silicon layer, a second amorphous silicon layer, and a heat resistant metal layer in an island form wider than a gate electrode above a gate electrode to expose a first transparent insulating substrate as well as for forming an intermediate electrode comprising a laminate made of a second amorphous silicon layer and a heat resistant metal layer containing the aforementioned contact region,
a process for forming a photosensitive organic insulating layer pattern thicker at a signal line than other regions corresponding to a source wire (signal line) and a drain wire comprising a pixel electrode both such as to partially overlap the aforementioned protective insulating layer, an electrode terminal of a scan line containing the aforementioned intermediate electrode, and an electrode terminal of a signal line comprising a part of a signal line outside an image display region after depositing a transparent conductive layer and an low resistance metal layer,
a process for selectively removing a low resistance metal, a transparent conductive layer, a heat resistant metal layer, a second amorphous silicon layer and a first amorphous silicon layer using the aforementioned photosensitive organic insulating layer pattern as a mask to form source and drain wires, and electrode terminals for a scan line and a signal line,
a process for decreasing a thickness of the aforementioned photosensitive organic insulating layer pattern to expose a low resistance metal layer on a pixel electrode and on electrode terminals for a scan line and a signal line, and
a process for removing an exposed low resistance metal layer using the aforementioned photosensitive organic insulating layer pattern whose thickness was reduced as a mask, and forming a transparent conductive pixel electrode and electrode terminals of a scan line and a signal line.

34. A manufacturing method of the liquid crystal display device recited in claim 25, comprising at least,
a process for successively depositing at least a first metal layer of one or more layers, a gate insulating layer of one or more layers, a first amorphous silicon layer not containing impurities and a protective insulating layer on a main surface of a first transparent insulating substrate,
a process for forming a photosensitive resin pattern thinner at a contact formation region for a scan line than other regions outside an image display region corresponding to a scan line,
a process for successively etching the aforementioned protective insulating layer, a first amorphous silicon layer, a gate insulating layer and a first metal layer using the aforementioned photosensitive resin pattern as a mask,
a process for reducing a thickness of the aforementioned photosensitive resin pattern to expose a protective insulating layer in a contact formation region, a process for forming an insulating layer in a side of a scan line,
a process for etching a protective insulating layer, a first amorphous silicon layer and a gate insulating layer in the aforementioned contact region using the aforementioned photosensitive resin pattern whose thickness was reduced as a mask to expose a part of a scan line,
a process for selectively forming a protective insulating layer narrower than a gate electrode above a gate electrode to expose the aforementioned first amorphous silicon layer,
a process for depositing a second amorphous silicon layer containing impurities and an anodizable heat resistant metal layer,
a process for forming a first amorphous silicon layer, a second amorphous silicon layer, and a heat resistant metal layer in an island form wider than a gate electrode above a gate electrode to expose a first transparent insulating substrate and a process for forming an intermediate electrode comprising a laminate made of a second amorphous silicon layer and a heat resistant metal layer containing the aforementioned contact region,
a process for forming a photosensitive resin pattern thinner at a signal line than other regions corresponding to a source wire (signal line) and a drain wire comprising a pixel electrode both such as to partially overlap the aforementioned protective insulating layer, an electrode terminal of a scan line containing the aforementioned intermediate electrode, and an electrode terminal of a signal line comprising a part of a signal line outside an image display region after depositing a transparent conductive layer and an anodizable low resistance metal layer,
a process for selectively removing a low resistance metal layer, a transparent conductive layer, a heat resistant metal layer, a second amorphous silicon layer, and a first amorphous silicon layer using the aforementioned photosensitive resin pattern as a mask to form source and drain wires, and electrode terminals for a scan line and a signal line,
a process for decreasing a thickness of the aforementioned photosensitive resin pattern to expose a signal line,
a process for forming an anodized layer on an exposed signal line using the aforementioned photosensitive resin pattern whose thickness was reduced as a mask,
a process for removing the aforementioned photosensitive resin pattern whose thickness was reduced, removing a low resistance metal layer using the aforementioned anodized layer as a mask, and forming a transparent conductive pixel electrode and transparent conductive electrode terminals of a scan line and a signal line.

35. A manufacturing method of the liquid crystal display device recited in claim 24, comprising at least,
a process for successively depositing at least a first metal layer of one or more layers, a gate insulating layer of one or more layers, a first amorphous silicon layer not containing impurities and a protective insulating layer on a main surface of a first transparent insulating substrate,
a process for forming a photosensitive resin pattern thicker at a protective insulating layer formation region above a gate electrode than other regions corresponding to a scan line,
a process for successively etching the aforementioned protective insulating layer, a first amorphous silicon layer, a gate insulating layer and a first metal layer using the aforementioned photosensitive resin pattern as a mask,
a process for reducing a thickness of the aforementioned photosensitive resin pattern to expose the aforementioned protective insulating layer,
a process for leaving a protective insulating layer narrower than a gate electrode above a gate electrode using the aforementioned photosensitive resin pattern whose thickness was reduced as a mask to expose the aforementioned first amorphous silicon layer,
a process for forming an insulating layer in a side of a scan line,
a process for depositing a second amorphous silicon layer containing impurities and a heat resistant metal layer,
a process for forming a photosensitive resin pattern thicker at a semiconductor layer formation region above a gate electrode than other regions having an opening at a contact formation region of a scan line outside an image display region,
a process for removing a heat resistant metal layer, a second amorphous silicon layer and a first amorphous silicon layer in the aforementioned opening using the aforementioned photosensitive resin pattern as a mask to expose a gate insulating layer, a process for reducing a thickness of the aforementioned photosensitive resin pattern to expose the aforementioned heat resistant metal layer,
a process for forming a first amorphous silicon layer, a second amorphous silicon layer, and a heat resistant metal layer in an island form wider than a gate electrode above a gate electrode using the aforementioned photosensitive resin pattern whose thickness was reduced as a mask to expose a first transparent insulating substrate as well as for removing a gate insulating layer in the aforementioned opening to expose a part of a scan line,
a process for forming a photosensitive organic insulating layer pattern thicker at a signal line than other regions corresponding to a source wire (signal line) and a drain wire comprising a pixel electrode both such as to partially overlap the aforementioned protective insulating layer, an electrode terminal of a scan line containing the aforementioned opening, and an electrode terminal of a signal line comprising a part of a signal line outside an image display region after depositing a transparent conductive layer and a low resistance metal layer,
a process for selectively removing a low resistance metal layer, a transparent conductive layer, a heat resistant metal layer, a second amorphous silicon layer and a first amorphous silicon layer using the aforementioned photosensitive organic insulating layer pattern as a mask to form source and drain wires, and electrode terminals for a scan line and a signal line,
a process for decreasing a thickness of the aforementioned photosensitive organic insulating layer pattern to expose a low resistance metal layer on a pixel electrode and on electrode terminals for a scan line and a signal line, and
a process for removing an exposed low resistance metal layer using the aforementioned photosensitive organic insulating layer pattern whose thickness was reduced as a mask, and forming a transparent conductive pixel electrode and transparent conductive electrode terminals of a scan line a signal line.

36. A manufacturing method of the liquid crystal display device recited in claim 25, comprising at least,
a process for successively depositing at least a first metal layer of one or more layers, a gate insulating layer of one or more layers, a first amorphous silicon layer not containing impurities and a protective insulating layer on a main surface of a first transparent insulating substrate,
a process for forming a photosensitive resin pattern thicker at a protective insulating layer formation region above a gate electrode than other regions corresponding to a scan line,
a process for successively etching the aforementioned protective insulating layer, a first amorphous silicon layer, a gate insulating layer and a first metal layer using the aforementioned photosensitive resin pattern as a mask,
a process for reducing a thickness of the aforementioned photosensitive resin pattern to expose the aforementioned protective insulating layer,
a process for leaving a protective insulating layer narrower than a gate electrode above a gate electrode using the aforementioned photosensitive resin pattern whose thickness was reduced as a mask to expose the aforementioned first amorphous silicon layer,
a process for forming an insulating layer in a side of a scan line, a process for depositing a second amorphous silicon layer containing impurities and an anodizable heat resistant metal layer,
a process for forming a photosensitive resin pattern thicker at a semiconductor layer formation region above a gate electrode than other regions having an opening at a contact formation region of a scan line outside an image display region,
a process for removing a heat resistant metal layer, a second amorphous silicon layer and a first amorphous silicon layer in the aforementioned opening using the aforementioned photosensitive resin pattern as a mask to expose a gate insulating layer,
a process for reducing a thickness of the aforementioned photosensitive resin pattern to expose the aforementioned heat resistant metal layer,
A process for forming a first amorphous silicon layer, a second amorphous silicon layer, and a heat resistant metal layer in an island form wider than a gate electrode above a gate electrode using the aforementioned photosensitive resin pattern whose thickness was reduced as a mask to expose a first transparent insulating substrate as well as for removing a gate insulating layer in the aforementioned opening to expose a part of a scan line,
a process for forming a photosensitive resin pattern thinner at a signal line than other regions corresponding to a source wire (signal line) and a drain wire comprising a pixel electrode both such as to partially overlap the aforementioned protective insulating layer, an electrode terminal of a scan line containing the aforementioned opening, and an electrode terminal of a signal line comprising a part of a signal line outside an image display region after depositing a transparent conductive layer and an anodizable low resistance metal layer,
a process for selectively removing a low resistance metal layer, a transparent conductive layer, a heat resistant metal layer, a second amorphous silicon layer and a first amorphous silicon layer using the aforementioned photosensitive resin pattern as a mask to form source and drain wires, and electrode terminals for a scan line and a signal line,
a process for decreasing a thickness of the aforementioned photosensitive resin pattern to expose a signal line,
a process for forming an anodized layer on an exposed signal line using the aforementioned photosensitive resin pattern whose thickness was reduced as a mask, process for removing the aforementioned photosensitive resin pattern whose thickness was reduced, removing a low resistance metal layer using the aforementioned anodized layer as a mask, and forming a transparent conductive pixel electrode and electrode terminals of a scan line and a signal line.

37. A manufacturing method of the liquid crystal display device recited in claim 24, comprising at least,
a process for successively depositing at least a first metal layer of one or more layers, a gate insulating layer of one or more layers, a first amorphous silicon layer not containing impurities and a protective insulating layer on a main surface of a first transparent insulating substrate,
a process for selectively forming a protective insulating layer comprising a channel protection layer for a insulating gate type transistor to expose the aforementioned first amorphous silicon layer,
a process for depositing a second amorphous silicon layer containing impurities and a heat resistant metal layer,
a process for forming a photosensitive resin pattern thinner at a contact formation region for a scan line than other regions corresponding to a scan line outside an image display region,
a process for successively etching the aforementioned heat resistant metal layer, a second amorphous silicon layer, a first amorphous silicon layer, a gate insulating layer and a first metal layer using the aforementioned photosensitive resin pattern as a mask,
a process for reducing a thickness of the aforementioned photosensitive resin pattern to expose a heat resistant metal layer in a contact formation region,
a process for forming an insulating layer in a side of a scan line,
a process for etching a heat resistant metal layer, a second amorphous silicon layer, a first amorphous silicon layer and a gate insulating layer in the aforementioned contact region using the aforementioned photosensitive resin pattern whose thickness was reduced as a mask to expose a part of a scan line,
a process for forming a photosensitive organic insulating layer pattern thicker at a signal line than other regions corresponding to a source wire (signal line) and a drain wire comprising a pixel electrode both such as to partially overlap the aforementioned protective insulating layer, an electrode terminal of a scan line containing the aforementioned part of a scan line, and an electrode terminal of a signal line comprising a part of a signal line outside an image display region after depositing a transparent conductive layer and a low resistance metal layer,
a process for selectively removing a low resistance metal layer, a transparent conductive layer, a heat resistant metal layer, a second amorphous silicon layer and a first amorphous silicon layer using the aforementioned photosensitive organic insulating layer pattern as a mask to form source and drain wires, and electrode terminals for a scan line and a signal line,
a process for decreasing a thickness of the aforementioned photosensitive organic insulating layer pattern to expose a low resistance metal layer on a pixel electrode and on electrode terminals for a scan line and a signal line and
a process for removing an exposed low resistance metal layer using the aforementioned photosensitive organic insulating layer pattern whose thickness was reduced as a mask, and forming a transparent conductive pixel electrode and transparent electrode terminals of a scan line a signal line.

38. A manufacturing method of the liquid crystal display device recited in claim 25, comprising at least,
a process for successively depositing at least a first metal layer of one or more layers, a gate insulating layer of one or more layers, a first amorphous silicon layer not containing impurities and a protective insulating layer on a main surface of a first transparent insulating substrate,
a process for selectively forming a protective insulating layer comprising a channel protection layer for a insulating gate type transistor to expose the aforementioned first amorphous silicon layer,
a process for depositing a second amorphous silicon layer containing impurities and an anodizable heat resistant metal layer,
a process for forming a photosensitive resin pattern thinner at a contact formation region for a scan line than other regions corresponding to a scan line outside an image display region,
a process for successively etching the aforementioned heat resistant metal layer, a second amorphous silicon layer, a first amorphous silicon layer, a gate insulating layer and a first metal layer using the aforementioned photosensitive resin pattern as a mask,
a process for reducing a thickness of the aforementioned photosensitive resin pattern to expose a heat resistant metal layer in a contact formation region,
a process for forming an insulating layer in a side of a scan line,
a process for etching a heat resistant metal layer, a second amorphous silicon layer, a first amorphous silicon layer and a gate insulating layer in the aforementioned contact region using the aforementioned photosensitive resin pattern whose thickness was reduced as a mask to expose a part of a scan line,
a process for forming a photosensitive resin pattern thinner at a signal line than other regions corresponding to a source wire (signal line) and a drain wire comprising a pixel electrode both such as to partially overlap the aforementioned protective insulating layer, an electrode terminal of a scan line containing the aforementioned part of a scan line, and an electrode terminal of a signal line comprising a part of a signal line outside an image display region after depositing a transparent conductive layer and an anodizable low resistance metal layer,
a process for selectively removing a low resistance metal layer, a transparent conductive layer, a heat resistant metal layer, a second amorphous silicon layer and a first amorphous silicon layer using the aforementioned photosensitive resin pattern as a mask to form source and drain wires, and electrode terminals for a scan line and a signal line,
a process for decreasing a thickness of the aforementioned photosensitive resin pattern to expose a signal line,
a process for forming an anodized layer on an exposed signal line using the aforementioned photosensitive resin pattern whose thickness was reduced as a mask, and
a process for removing the aforementioned photosensitive resin pattern whose thickness was reduced, removing a low resistance metal layer using the aforementioned anodized layer as a mask, and forming a transparent conductive pixel electrode and transparent conductive electrode terminals of a scan line and a signal line.

39. A manufacturing method of the liquid crystal display device recited in claim 26, comprising at least,
a process for forming at least a scan line comprising a first metal layer of one or more layers on a main surface of a first transparent insulating substrate,
a process for successively depositing a gate insulating layer of one or more layers, a first amorphous silicon layer not containing impurities, a second amorphous silicon layer containing impurities and a heat resistant metal layer,
a process for forming the aforementioned heat resistant metal layer, a second amorphous silicon layer and a first amorphous silicon layer in an island form wider than a gate electrode above a gate electrode to expose a gate insulating layer,
a process to form an opening in a gate insulating layer on a scan line outside an image display region to expose a part of a scan line,
a process for forming a photosensitive resin pattern thinner at least at a pixel electrode than at a signal line corresponding to a source wire (signal line) and a drain wire comprising a pixel electrode both such as to partially overlap a gate electrode, an electrode terminal of a scan line containing the aforementioned opening, and an electrode terminal of a signal line comprising a part of a signal line outside an image display region after depositing a transparent conductive layer and a low resistance metal layer,
a process for selectively removing a low resistance metal layer, a transparent conductive layer, a heat resistant metal layer, a second amorphous silicon layer, and a first amorphous silicon layer using the aforementioned photosensitive resin pattern as a mask to form source and drain wires, and electrode terminals for a scan line and a signal line,
a process for reducing a thickness of the aforementioned photosensitive resin pattern to expose a low resistance metal layer at least on a pixel electrode,
a process for removing an exposed low resistance metal layer using the aforementioned photosensitive resin pattern whose thickness was reduced as a mask, and forming at least a transparent conductive pixel electrode, and
a process for forming a passivating insulating layer on the aforementioned first transparent insulating substrate having openings on electrode terminals for a signal line and a scan line and on a pixel electrode.

40. A manufacturing method of the liquid crystal display device recited in claim 25, comprising at least,
a process for forming at least a scan line comprising a first metal layer of one or more layers on a main surface of a first transparent insulating substrate,
a process for successively depositing a gate insulating layer of one or more layers, a first amorphous silicon layer not containing impurities, a second amorphous silicon layer containing impurities and an anodizable heat resistant metal layer,
a process for forming the aforementioned heat resistant metal layer, a second amorphous silicon layer and a first amorphous silicon layer in an island form wider than a gate electrode above a gate electrode to expose a gate insulating layer,
a process to form an opening in a gate insulating layer on a scan line outside an image display region to expose a part of a scan line,
a process for forming a photosensitive resin pattern thinner at a signal line than other regions corresponding to a source wire (signal line) and a drain wire comprising a pixel electrode both such as to partially overlap a gate electrode, an electrode terminal of a scan line containing the aforementioned opening, and an electrode terminal of a signal line comprising a part of a signal line outside an image display region after depositing a transparent conductive layer and an anodizable low resistance metal layer,
a process for selectively removing a low resistance metal layer, a transparent conductive layer and a heat resistant metal layer using the aforementioned photosensitive resin pattern as a mask to form source and drain wires, and electrode terminals for a scan line and a signal line,
a process for reducing a thickness of the aforementioned photosensitive resin pattern to expose a low resistance metal layer on a signal line,
a process for anodizing an amorphous silicon layer between the aforementioned source and drain wires and an exposed signal line using the aforementioned photosensitive resin pattern whose thickness was reduced as a mask, and forming anodized layers thereof, and
a process for removing the aforementioned photosensitive resin pattern whose thickness was reduced, removing a low resistance metal layer using the aforementioned anodized layer as a mask, and forming a transparent conductive pixel electrode and transparent conductive electrode terminals of a scan line and a signal line.

41. A manufacturing method of the liquid crystal display device recited in claim 26, comprising at least,
a process for forming at least a scan line comprising a first metal layer of one or more layers on a main surface of a first transparent insulating substrate,
a process for successively depositing a gate insulating layer of one or more layers, a first amorphous silicon layer not containing impurities, a second amorphous silicon layer containing impurities and a heat resistant metal layer,
a process for forming a photosensitive resin pattern thicker at semiconductor layer formation region above a gate electrode than other regions having an opening on a contact formation region of a scan line outside an image display region,
a process for removing a heat resistant metal layer, a second amorphous silicon layer and a first amorphous silicon layer in the aforementioned opening using the aforementioned photosensitive resin pattern as a mask to expose a gate insulating layer,
a process for reducing a thickness of the aforementioned photosensitive resin pattern to expose the aforementioned heat resistant metal layer,
a process for forming a first amorphous silicon layer, a second amorphous silicon layer, and a heat resistant metal layer in an island form wider than a gate electrode above a gate electrode using the aforementioned photosensitive resin pattern whose thickness was reduced as a mask to expose a gate insulating layer as well as for removing a gate insulating layer in the aforementioned opening to expose a part of a scan line,
a process for forming a photosensitive resin pattern thinner at least at a pixel electrode than at a signal line corresponding to a source wire (signal line) and a drain wire comprising a pixel electrode both such as to partially overlap a gate electrode, an electrode terminal of a scan line containing the aforementioned opening, and an electrode terminal of a signal line comprising a part of a signal line outside an image display region after depositing a transparent conductive layer and a low resistance metal layer,
a process for selectively removing a low resistance metal layer, a transparent conductive layer, a heat resistant metal layer, a second amorphous silicon layer, and a first amorphous silicon layer using the aforementioned photosensitive resin pattern as a mask to form source and drain wires, and electrode terminals for a scan line and a signal line,
a process for reducing a thickness of the aforementioned photosensitive resin pattern to expose a low resistance metal layer at least on a pixel electrode,
a process for removing an exposed low resistance metal layer using the aforementioned photosensitive resin pattern whose thickness was reduced as a mask, and forming at least a transparent conductive pixel electrode, and
a process for forming a passivating insulating layer on the aforementioned first transparent insulating substrate having openings on electrode terminals for a signal line and a scan line and on a pixel electrode.

42. A manufacturing method of the liquid crystal display device recited in claim 25, comprising at least,
a process for forming at least a scan line comprising a first metal layer of one or more layers on a main surface of a first transparent insulating substrate,
a process for successively depositing a gate insulating layer of one or more layers, a first amorphous silicon layer not containing impurities, a second amorphous silicon layer containing impurities and an anodizable heat resistant metal layer,
a process for forming a photosensitive resin pattern thicker at semiconductor layer formation region above a gate electrode than other regions having an opening on a contact formation region of a scan line outside an image display region,
a process for removing a heat resistant metal layer, a second amorphous silicon layer and a first amorphous silicon layer in the aforementioned opening using the aforementioned photosensitive resin pattern as a mask to expose a gate insulating layer,
a process for reducing a thickness of the aforementioned photosensitive resin pattern to expose the aforementioned heat resistant metal layer,
a process for forming a first amorphous silicon layer, a second amorphous silicon layer, and a heat resistant metal layer in an island form wider than a gate electrode above a gate electrode using the aforementioned photosensitive resin pattern whose thickness was reduced as a mask to expose a gate insulating layer as well as for removing a gate insulating layer in the aforementioned opening to expose a part of a scan line,
a process for forming a photosensitive resin pattern thinner at a signal line than other regions corresponding to a source wire (signal line) and a drain wire comprising a pixel electrode both such as to partially overlap a gate electrode, an electrode terminal of a scan line containing the aforementioned opening, and an electrode terminal of a signal line comprising a part of a signal line outside an image display region after depositing a transparent conductive layer and an anodizable low resistance metal layer,
a process for selectively removing a low resistance metal layer, a transparent conductive layer and a heat resistant metal layer using the aforementioned photosensitive resin pattern as a mask to form source and drain wires, and electrode terminals for a scan line and a signal line,
a process for reducing a thickness of the aforementioned photosensitive resin pattern to expose a low resistance metal layer on a signal line,
a process for anodizing an amorphous silicon layer between the aforementioned source and drain wires and an exposed signal line using the aforementioned photosensitive resin pattern whose thickness was reduced as a mask, and forming anodized layers thereof, and
a process for removing the aforementioned photosensitive resin pattern whose thickness was reduced, removing a low resistance metal layer using the aforementioned anodized layer as a mask, and forming a transparent conductive pixel electrode and transparent conductive electrode terminals of a scan line and a signal line.

43. A manufacturing method of the liquid crystal display device recited in claim 26, comprising at least,
a process for successively depositing at least a first metal layer of one or more layers, a gate insulating layer of one or more layers, a first amorphous silicon layer not containing impurities, a second amorphous silicon layer containing impurities and a heat resistant metal layer on a main surface of a first transparent insulating substrate,
a process for forming a photosensitive resin pattern thinner at a contact formation region for a scan line than other regions corresponding to a scan line outside an image display region,
a process for successively etching the aforementioned heat resistant metal layer, a second amorphous silicon layer, a first amorphous silicon layer, a gate insulating layer and a first metal layer using the aforementioned photosensitive resin pattern as a mask,
a process for reducing a thickness of the aforementioned photosensitive resin pattern to expose a heat resistant metal layer in a contact formation region,
a process for forming an insulating layer in a side of a scan line,
a process for etching a heat resistant metal layer, a second amorphous silicon layer, a first amorphous silicon layer and a gate insulating layer in the aforementioned contact region using the aforementioned photosensitive resin pattern whose thickness was reduced as a mask to expose a part of a scan line,
a process for forming a first amorphous silicon layer, a second amorphous silicon layer, and a heat resistant metal layer in an island form above a gate electrode to expose a gate insulating layer as well as to protecting the aforementioned contact region to form a first amorphous silicon layer, a second amorphous silicon layer, and a heat resistant metal layer in a periphery of a contact,
a process for forming a photosensitive resin pattern thinner at least at a pixel electrode than at a signal line corresponding to a source wire (signal line) and a drain wire comprising a pixel electrode both such as to partially overlap a gate electrode, an electrode terminal of a scan line containing the aforementioned contact region, and an electrode terminal of a signal line comprising a part of a signal line outside an image display region after depositing a transparent conductive layer and a low resistance metal layer,
a process for selectively removing a low resistance metal layer, a transparent conductive layer, a heat resistant metal layer, a second amorphous silicon layer, and a first amorphous silicon layer using the aforementioned photosensitive resin pattern as a mask to form source and drain wires, and electrode terminals for a scan line and a signal line,
a process for reducing a thickness of the aforementioned photosensitive resin pattern to expose a low resistance metal layer at least on a pixel electrode,
a process for removing an exposed low resistance metal layer using the aforementioned photosensitive resin pattern whose thickness was reduced as a mask, and forming at least a transparent conductive pixel electrode, and
a process for forming a passivating insulating layer on the aforementioned first transparent insulating substrate having openings on electrode terminals for a signal line and a scan line and on a pixel electrode.

44. A manufacturing method of the liquid crystal display device recited in claim 25, comprising at least,
a process for successively depositing at least a first metal layer of one or more layers, a gate insulating layer of one or more layers, a first amorphous silicon layer not containing impurities, a second amorphous silicon layer containing impurities and an anodizable heat resistant metal layer on a main surface of a first transparent insulating substrate,
a process for forming a photosensitive resin pattern thinner at a contact formation region for a scan line than other regions corresponding to a scan line outside an image display region,
a process for successively etching the aforementioned heat resistant metal layer, a second amorphous silicon layer, a first amorphous silicon layer, a gate insulating layer and a first metal layer using the aforementioned photosensitive resin pattern as a mask,
a process for reducing a thickness of the aforementioned photosensitive resin pattern to expose a heat resistant metal layer in a contact formation region,
a process for forming an insulating layer in a side of a scan line,
a process for etching a heat resistant metal layer, a second amorphous silicon layer, a first amorphous silicon layer and a gate insulating layer in the aforementioned contact region using the aforementioned photosensitive resin pattern whose thickness was reduced as a mask to expose a part of a scan line,
a process for forming a first amorphous silicon layer, a second amorphous silicon layer, and a heat resistant metal layer in an island form above a gate electrode to expose a gate insulating layer as well as to protecting the aforementioned contact region to form a first amorphous silicon layer, a second amorphous silicon layer, and a heat resistant metal layer in a periphery of a contact,
a process for forming a photosensitive resin pattern thinner at a signal line than other regions corresponding to a source wire (signal line) and a drain wire comprising a pixel electrode both such as to partially overlap a gate electrode, an electrode terminal of a scan line containing the aforementioned contact region, and an electrode terminal of a signal line comprising a part of a signal line outside an image display region after depositing a transparent conductive layer and an anodizable low resistance metal layer,
a process for selectively removing a low resistance metal layer, a transparent conductive layer and a heat resistant metal layer using the aforementioned photosensitive resin pattern as a mask to form source and drain wires, and electrode terminals for a scan line and a signal line,
a process for reducing a thickness of the aforementioned photosensitive resin pattern to expose a low resistance metal layer on a signal line,
a process for anodizing an amorphous silicon layer between the aforementioned source and drain wires and an exposed signal line using the aforementioned photosensitive resin pattern whose thickness was reduced as a mask, and forming anodized layers thereof, and
a process for removing the aforementioned photosensitive resin pattern whose thickness was reduced, removing a low resistance metal layer using the aforementioned anodized layer as a mask, and forming a transparent conductive pixel electrode and transparent conductive electrode terminals of a scan line and a signal line.

45. A manufacturing method of the liquid crystal display device recited in claim 26, comprising at least,
a process for successively depositing at least a first metal layer of one or more layers, a gate insulating layer of one or more layers, a first amorphous silicon layer not containing impurities, a second amorphous silicon layer containing impurities and a heat resistant metal layer on a main surface of a first transparent insulating substrate,
a process for forming a photosensitive resin pattern thicker at a semiconductor layer formation region above a gate electrode than other regions corresponding to a scan line,
a process for successively etching the aforementioned heat resistant metal layer, a second amorphous silicon layer, a first amorphous silicon layer, a gate insulating layer and a first metal layer using the aforementioned photosensitive resin pattern as a mask,
a process for reducing a thickness of the aforementioned photosensitive resin pattern to expose the aforementioned heat resistant metal layer,
a process for forming a first amorphous silicon layer, a second amorphous silicon layer, and a heat resistant metal layer in an island form above a gate electrode using the aforementioned photosensitive resin pattern whose thickness was reduced as a mask to expose a gate insulating layer,
a process for forming an insulating layer in a side of a scan line,
a process for forming an opening at a contact formation region of a scan line outside an image display region to expose a part of a scan line in the aforementioned opening,
a process for forming a photosensitive resin pattern thinner at least at a pixel electrode than at a signal line corresponding to a source wire (signal line) and a drain wire comprising a pixel electrode both such as to partially overlap a gate electrode, an electrode terminal of a scan line containing the aforementioned opening, and an electrode terminal of a signal line comprising a part of a signal line outside an image display region after depositing a transparent conductive layer and a low resistance metal layer,
a process for selectively removing a low resistance metal layer, a transparent conductive layer, a heat resistant metal layer, a second amorphous silicon layer, and a first amorphous silicon layer using the aforementioned photosensitive resin pattern as a mask to form source and drain wires, and electrode terminals for a scan line and a signal line,
a process for reducing a thickness of the aforementioned photosensitive resin pattern to expose a low resistance metal layer at least on a pixel electrode,
a process for removing an exposed low resistance metal layer using the aforementioned photosensitive resin pattern whose thickness was reduced as a mask, and forming at least a transparent conductive pixel electrode, and
a process for forming a passivating insulating layer on the aforementioned first transparent insulating substrate having openings on electrode terminals for a signal line and a scan line and on a pixel electrode.

46. A manufacturing method of the liquid crystal display device recited in claim 25, comprising at least,
a process for successively depositing at least a first metal layer of one or more layers, a gate insulating layer of one or more layers, a first amorphous silicon layer not containing impurities, a second amorphous silicon layer containing impurities and an anodizable heat resistant metal layer on a main surface of a first transparent insulating substrate,
a process for forming a photosensitive resin pattern thicker at a semiconductor layer formation region above a gate electrode than other regions corresponding to a scan line,
a process for successively etching the aforementioned heat resistant metal layer, a second amorphous silicon layer, a first amorphous silicon layer, a gate insulating layer and a first metal layer using the aforementioned photosensitive resin pattern as a mask,
a process for reducing a thickness of the aforementioned photosensitive resin pattern to expose the aforementioned heat resistant metal layer,
a process for forming a first amorphous silicon layer, a second amorphous silicon layer, and a heat resistant metal layer in an island form above a gate electrode using the aforementioned photosensitive resin pattern whose thickness was reduced as a mask to expose a gate insulating layer,
a process for forming an insulating layer in a side of a scan line,
a process for forming an opening at a contact formation region of a scan line outside an image display region to expose a part of a scan line in the aforementioned opening,
a process for forming a photosensitive resin pattern thinner at a signal line than other regions corresponding to a source wire (signal line) and a drain wire comprising a pixel electrode both such as to partially overlap a gate electrode, an electrode terminal of a scan line containing the aforementioned opening, and an electrode terminal of a signal line comprising a part of a signal line outside an image display region after depositing a transparent conductive layer and an anodizable low resistance metal layer,
a process for selectively removing a low resistance metal, a transparent conductive layer and a heat resistant metal layer using the aforementioned photosensitive resin pattern as a mask to form source and drain wires, and electrode terminals for a scan line and a signal line,
a process for reducing a thickness of the aforementioned photosensitive resin pattern to expose a low resistance metal layer on a signal line,
a process for anodizing an amorphous silicon layer between the aforementioned source and drain wires and an exposed signal line using the aforementioned photosensitive resin pattern whose thickness was reduced as a mask, and forming anodized layers thereof, and
a process for removing the aforementioned photosensitive resin pattern whose thickness was reduced, removing a low resistance metal layer using the aforementioned anodized layer as a mask, and forming a transparent conductive pixel electrode and transparent conductive electrode terminals of a scan line and a signal line.

47. A manufacturing method of the liquid crystal display device recited in claim 26, comprising at least,
a process for successively depositing at least a first metal layer of one or more layers, a gate insulating layer of one or more layers, a first amorphous silicon layer not containing impurities, a second amorphous silicon layer containing impurities and a heat resistant metal layer on a main surface of a first transparent insulating substrate,
a process for forming a first amorphous silicon layer, a second amorphous silicon layer, and a heat resistant metal layer in an island form at a semiconductor layer formation region to expose a gate insulating layer,
a process for forming a photosensitive resin pattern thinner at a contact formation region for a scan line than other regions outside an image display region corresponding to a scan line,
a process for successively etching the aforementioned heat resistant metal layer, a second amorphous silicon layer, a first amorphous silicon layer, a gate insulating layer and a first metal layer using the aforementioned photosensitive resin pattern as a mask,
a process for reducing a thickness of the aforementioned photosensitive resin pattern to expose a gate insulating layer at a contact formation region,
a process for forming an insulating layer in a side of a scan line, a process for etching a gate insulating layer in the aforementioned contact region using the aforementioned photosensitive resin pattern whose thickness was reduced as a mask to expose a part of a scan line,
a process for forming a photosensitive resin pattern thinner at least at a pixel electrode than at a signal line corresponding to a source wire (signal line) and a drain wire comprising a pixel electrode both such as to partially overlap a gate electrode, an electrode terminal of a scan line containing the aforementioned contact region, and an electrode terminal of a signal line comprising a part of a signal line outside an image display region after depositing a transparent conductive layer and a low resistance metal layer,
a process for selectively removing a low resistance metal layer, a transparent conductive layer, a heat resistant metal layer, a second amorphous silicon layer, and a first amorphous silicon layer using the aforementioned photosensitive resin pattern as a mask to form source and drain wires, and electrode terminals for a scan line and a signal line,
a process for reducing a thickness of the aforementioned photosensitive resin pattern to expose a low resistance metal layer at least on a pixel electrode,
a process for removing an exposed low resistance metal layer using the aforementioned photosensitive resin pattern whose thickness was reduced as a mask, and forming at least a transparent conductive pixel electrode, and
a process for forming a passivating insulating layer on the aforementioned first transparent insulating substrate having openings on electrode terminals for a signal line and a scan line and on a pixel electrode.

48. A manufacturing method of the liquid crystal display device recited in claim 25, comprising at least,
a process for successively depositing at least a first metal layer of one or more layers, a gate insulating layer of one or more layers, a first amorphous silicon layer not containing impurities, a second amorphous silicon layer containing impurities and an anodizable heat resistant metal layer on a main surface of a first transparent insulating substrate,
a process for forming a first amorphous silicon layer, a second amorphous silicon layer, and a heat resistant metal layer in an island form at a semiconductor layer formation region to expose a gate insulating layer,
a process for forming a photosensitive resin pattern thinner at a contact formation region for a scan line than other regions outside an image display region corresponding to a scan line,
a process for successively etching the aforementioned heat resistant metal layer, a second amorphous silicon layer, a first amorphous silicon layer, a gate insulating layer and a first metal layer using the aforementioned photosensitive resin pattern as a mask,
a process for reducing a thickness of the aforementioned photosensitive resin pattern to expose a gate insulating layer at a contact formation region,
a process for forming an insulating layer in a side of a scan line,
a process for etching a gate insulating layer in the aforementioned contact region using the aforementioned photosensitive resin pattern whose thickness was reduced as a mask to expose a part of a scan line,
a process for forming a photosensitive resin pattern thinner at a signal line than other regions corresponding to a source wire (signal line) and a drain wire comprising a pixel electrode both such as to partially overlap a gate electrode, an electrode terminal of a scan line containing the aforementioned contact region, and an electrode terminal of a signal line comprising a part of a signal line outside an image display region after depositing a transparent conductive layer and an anodizable low resistance metal layer,
a process for selectively removing a low resistance metal, a transparent conductive layer and a heat resistant metal layer using the aforementioned photosensitive resin pattern as a mask to form source and drain wires, and electrode terminals for a scan line and a signal line,
a process for reducing a thickness of the aforementioned photosensitive resin pattern to expose a low resistance metal layer on a signal line,
a process for anodizing an amorphous silicon layer between the aforementioned source and drain wires and an exposed signal line using the aforementioned photosensitive resin pattern whose thickness was reduced as a mask, and forming anodized layers thereof, and
a process for removing the aforementioned photosensitive resin pattern whose thickness was reduced, removing a low resistance metal layer using the aforementioned anodized layer as a mask, and forming a transparent conductive pixel electrode and transparent conductive electrode terminals of a scan line and a signal line.

49. A manufacturing method of the liquid crystal display device recited in claim 26, comprising at least,
a process for successively depositing at least a first metal layer of one or more layers, a gate insulating layer of one or more layers, a first amorphous silicon layer not containing impurities, a second amorphous silicon layer containing impurities and a heat resistant metal layer on a main surface of a first transparent insulating substrate,
a process for forming a photosensitive resin pattern thicker both at a proximity of an intersection of a signal line and a scan line, and at a gate electrode than other regions corresponding to a scan line,
a process for successively etching the aforementioned heat resistant metal layer, a second amorphous silicon layer, a first amorphous silicon layer, a gate insulating layer and a first metal layer using the aforementioned photosensitive resin pattern as a mask,
a process for reducing the aforementioned photosensitive resin pattern to selectively expose a heat resistant metal layer on a scan line,
a process for successively etching a heat resistant metal layer, a second amorphous silicon layer and a first amorphous silicon layer on a scan line using the aforementioned photosensitive resin pattern whose thickness was reduced as a mask to expose a gate insulating layer,
a process for forming an insulating layer in a side of a scan line,
a process for etching a gate insulating layer on a scan line using the aforementioned photosensitive resin pattern whose thickness was reduced as a mask to expose a scan line,
a process for forming a photosensitive resin pattern thinner at least at a pixel electrode than at a signal line corresponding to a source wire (signal line) and a drain wire comprising a pixel electrode both such as to partially overlap a gate electrode, an electrode terminal of a scan line containing the aforementioned exposed scan line, and an electrode terminal of a signal line comprising a part of a signal line outside an image display region after depositing a transparent conductive layer and a low resistance metal layer,
a process for selectively removing a low resistance metal layer, a transparent conductive layer, a heat resistant metal layer, a second amorphous silicon layer, and a first amorphous silicon layer using the aforementioned photosensitive resin pattern as a mask to form source and drain wires, and electrode terminals for a scan line and a signal line,
a process for reducing a thickness of the aforementioned photosensitive resin pattern to expose a low resistance metal layer at least on a pixel electrode,
a process for removing an exposed low resistance metal layer using the aforementioned photosensitive resin pattern whose thickness was reduced as a mask, and forming at least a transparent conductive pixel electrode, and
a process for forming a passivating insulating layer on the aforementioned first transparent insulating substrate having openings on electrode terminals for a signal line and a scan line and on a pixel electrode.

50. A manufacturing method of the liquid crystal display device recited in claim 25, comprising at least,
a process for successively depositing at least a first metal layer of one or more layers, a gate insulating layer of one or more layers, a first amorphous silicon layer not containing impurities, a second amorphous silicon layer containing impurities and an anodizable heat resistant metal layer on a main surface of a first transparent insulating substrate,
a process for forming a photosensitive resin pattern thicker both at a proximity of an intersection of a signal line and a scan line, and at a gate electrode than at other regions corresponding to a scan line,
a process for successively etching the aforementioned heat resistant metal layer, a second amorphous silicon layer, a first amorphous silicon layer, a gate insulating layer and a first metal layer using the aforementioned photosensitive resin pattern as a mask,
a process for reducing the aforementioned photosensitive resin pattern to selectively expose a heat resistant metal layer on a scan line,
a process for successively etching a heat resistant metal layer, a second amorphous silicon layer and a first amorphous silicon layer on a scan line using the aforementioned photosensitive resin pattern whose thickness was reduced as a mask to expose a gate insulating layer,
a process for forming an insulating layer in a side of a scan line,
a process for etching a gate insulating layer on a scan line using the aforementioned photosensitive resin pattern whose thickness was reduced as a mask to expose a scan line,
a process for forming a photosensitive resin pattern thinner at a signal line than other regions corresponding to a source wire (signal line) and a drain wire comprising a pixel electrode both such as to partially overlap a gate electrode, an electrode terminal of a scan line containing the aforementioned exposed scan line, and an electrode terminal of a signal line comprising a part of a signal line outside an image display region after depositing a transparent conductive layer and an anodizable low resistance metal layer,
a process for selectively removing a low resistance metal, a transparent conductive layer and a heat resistant metal layer using the aforementioned photosensitive resin pattern as a mask to form source and drain wires, and electrode terminals for a scan line and a signal line,
a process for reducing a thickness of the aforementioned photosensitive resin pattern to expose a low resistance metal layer on a signal line,
a process for anodizing an amorphous silicon layer between the aforementioned source and drain wires and an exposed signal using the aforementioned photosensitive resin pattern whose thickness was reduced as a mask, and forming anodized layers thereof as well as forming an anodized layer on an exposed scan line, and
a process for removing the aforementioned photosensitive resin pattern whose thickness was reduced, removing a low resistance metal layer using the aforementioned anodized layer as a mask, and forming a transparent conductive pixel electrode and transparent conductive electrode terminals of a scan line and a signal line.
